(19) United States
(12) Patent Application Publication
(10) Pub. No.: US 2010/0073667 A1
(43) Pub. Date: Mar. 25, 2010

(54) Method and Apparatus for Determining Differential Group Delay and Polarization Mode Dispersion

(76) Inventors: Normand Cyr, Quebec (CA); Hongxin Chen, Quebec (CA)

Correspondence Address: ADAMS PATENT & TRADEMARK AGENCY, P.O. BOX 11100, STATION H, OTTAWA, ON, K2H 7T8, CA

(21) Appl. No.: 12/568,554

(22) Filed: Sep. 28, 2009

Related U.S. Application Data
(63) Continuation-in-part of application No. PCT/CA2008/000577, filed on Mar. 28, 2008.
Application No. PCT/CA2008/000577 is a continuation-in-part of application No. 11/727,759, filed on Mar. 28, 2007, now abandoned.
Application No. 11/727,759 is a continuation-in-part of application No. 11/992,797, filed on Mar. 28, 2008.
(60) Provisional application No. 60/907,313, filed on Mar. 28, 2007.

(51) Int. Cl. G01N 21/84

(52) U.S. Cl. 356/73.1

(57) ABSTRACT

A method and apparatus for measuring at least one polarization-related characteristic of an optical path (FUT) uses an optical source means connected to the FUT at or adjacent a proximal end of the FUT and an analyzing-and-detection unit connected to the FUT at or adjacent its proximal or distal end. The optical source means injects into the FUT at least partially polarized light having a controlled state of polarization (I-SOP). The analyzer-and-detection unit extracts corresponding light from the FUT, analyzes and detects the extracted light corresponding to at least one transmission axis (A-SOP), and processes the corresponding electrical signal to obtain transmitted coherent optical power at each wavelength of light in each of at least two groups of wavelengths, wherein the lowermost (λₗ) and uppermost (λ_{U}) said wavelengths in each said group of wavelengths are closely-spaced. A processing unit than computes at least one difference in a measured power parameter corresponding to each wavelength in a wavelength pair for each of the at least two groups, the measured power parameter being proportional to the power of the said analyzed and subsequently detected light, thereby defining a set of at least two measured power parameter differences; computes the mean-square value of said set of differences; and calculating the at least one polarization-related FUT characteristic as at least one predetermined function of said mean-square value, the predetermined function being dependent upon the small optical frequency difference between the wavelengths corresponding to the said each at least said two pairs of closely-spaced wavelengths.

### CROSS-REFERENCE TO RELATED DOCUMENTS

This application is a Continuation-in-Part of International patent application number PCT/CA2008/000577 filed Mar. 28, 2008 claiming priority from U.S. Provisional patent application No. 60/907,313 filed 28 Mar. 2007; a Continuation-in-Part of U.S. patent application Ser. No. 11/727,759 filed 28 Mar. 2007 and a Continuation-in-Part of U.S. patent application Ser. No. 11/992,797 effective filing date Mar. 28, 2008. The entire contents of each of these patent applications are incorporated herein by reference.

### TECHNICAL FIELD

This invention relates to a method and apparatus for measuring polarization-dependent characteristics of optical paths and is especially applicable to the measurement of differential group delay (DGD) at a particular wavelength, or root-mean-square or mean DGD over a specified wavelength range, of an optical path which comprises mostly optical waveguide, such as an optical fiber link. When the specified wavelength range is sufficiently wide, the root-mean-square or mean DGD measurement closely approximates the polarization mode dispersion (PMD) behavior of the optical path.

### BACKGROUND ART

Orthogonal polarization modes in optical fibers used for optical communications systems have different group delays; known as differential group delay (DGD). This causes the polarization mode dispersion (PMD) phenomenon, i.e., a spreading of the pulses propagating along the fibers. Where long optical fiber links are involved, PMD may be sufficient to cause increased bit error rate, thus limiting the transmission rate or maximum transmission path length. This is particularly problematical at higher bit rates. Thus, it is desirable to be able to obtain the PMD value of the optical fiber. If one knows the actual PMD value of a communications link, one can accurately estimate the bit error rate or outage probability (probability that the communication will fail over a period of time), or the power penalty (how much more power must be launched to maintain the same bit error rate as if there were no PMD). As a variable or quantity characterizing the said PMD phenomenon, the PMD value of a device is defined as either the root-mean-square (rms) value or mean value of DGD, the DGD of a given device being a variable that can vary randomly over both wavelength and time. (For simplicity in the text that follows, “average DGD” will sometimes be used when either rms or mean DGD definitions may apply.)

Depending on the application, it is often desirable to measure the DGD at a given wavelength, average DGD over a narrow wavelength range, and average DGD over a wide wavelength range. However, in many cases, it is not possible to measure the DGD at a given wavelength or average DGD over a wide wavelength range, and hence it is not possible to obtain a reliable determination of the PMD from a measurement taken at a given moment.

This is the case, for example, when measuring “PMD” in a narrow bandpass channel of a fiber link, such as when the measurement can only be taken using an available (i.e. unlit or “dark”) DWDM channel, having a usable bandwidth of, for instance ˜70 GHz (corresponding to 100 GHz DWDM channel spacing) or ˜30 GHz (corresponding to 50 GHz channel spacing).

“In-channel” DGD or average DGD measurements for a given small wavelength range within the channel are of particular importance for telecom network providers using DWDM networks. For instance, it may be desired to add one or more very high bitrate channels (e.g. 40 Gbit/s) to a “dark” channel on an active telecommunications fiber link already carrying multiple lower bitrate channels (e.g. 10 Gbps). On account of the tighter PMD tolerances at the higher bit-rates, it is often necessary to characterize the fiber link, or at least the dark channel that will actually be used, for its suitability to adequately transport such high bitrate traffic, and this characterization must not at the same time disrupt the active lower bitrate channels.

If the goal is to measure the PMD of the fiber link itself, despite the fact that the DWDM multiplexers/demultiplexers are attached to it, it is highly preferable to perform the in-channel measurements in as many dark channels as may be available, to obtain a plurality of respective DGD values. A PMD value of the fiber link is then determined by averaging the DGD values determined in this way. Preferably, these measurements should be taken in dark channels encompassing a relatively wide wavelength range (e.g. the telecom C-band).

Alternatively, or in addition to the above-mentioned “multi-dark-channel” measurements, the characterization of a single narrow channel should be repeated at intervals over a relatively long time period, for example days, weeks or months, to obtain DGD measurements that more closely estimate the actual PMD of the fiber link. A number of two-ended measurement techniques are known in the art for both the measurement of (end-to-end) PMD in a “broadband” (i.e., unfiltered) fiber link and the measurement of DGD in a narrow-band channel on a fiber.

The phase shift method, taught in Jones (U.S. Pat. No. 4,750,833[4]), can be used for the measurement of PMD. As described by Williams et al. (Proceedings SOFM, Boulder Colo., 1998, pp. 23-26[5]), it can also be used for measurement of DGD in a narrowband channel. (The PMD can then be calculated as an average of these so-determined DGD values.) However, the method as described is inherently slow, as it entails maximizing the measured phase-shift difference by adjustment of polarization controllers, and is hence not suitable for outside-plant applications where fibers may be subject to relatively rapid movement.

The “pulse-delay method” of PMD measurement can measure DGD at a given wavelength by launching short light pulses into the fast and slow polarization modes of the fiber and measuring the difference between arrival times of the light pulses emerging from the corresponding output principle states, but it requires the use of high-speed electronic circuitry. PMD may be measured or estimated using polarization-scrambled short light pulses based on detection of arrival time for the polarization-scrambled short light pulses, such as described by Noe et al (J. Lightwave Technology, Vol. 20(2), 2002, pp. 229-235[6]). However, this technique not only requires a high-speed electronics detection system but also involves rapidly-modulated light for the measurement.

Measurement apparatus for monitoring using actual telecommunications live traffic on a WDM or DWDM channel (generally referred to as “in-band” monitoring in the scientific literature), as described by Yao (US 2005/020175 A1 [7]) or by Boroditsky et al (U.S. Pat. No. 7,256,876) and Wang et al (J. Lightwave Technology, Vol. 24(11), 2006, pp. 4120-4126[8]), permit direct determination of the PMD penalty (i.e. the extra system margin required to compensate for PMD impairment for the particular live traffic). However, they do not permit determination of the in-channel DGD or “PMD” value of the link. Indeed, these in-band monitoring methods have advantage for DOP or SOP monitoring in the presence of the high bit rate carrier signals. Waarts et al (U.S. Pat. No. 7,203,428, Apr. 10, 2007 [9]) describe estimation of PMD using heterodyne detection with a tunable laser source, where a signal from a local oscillator (i.e. tunable laser source) is combined with an optical signal from the link and the beat frequency amplitude and phase are then analyzed for two orthogonal polarization states simultaneously to obtain an SOP. Thus, “PMD” may be estimated from the averaging of a plurality of SOPs. However, again this measurement may only give DOP or SOP information. This method also needs high speed electronics as well as an additional high coherence light source for the detection.

The use of high-speed electronics may be avoided by using a nonlinear detection technique, as described by Wielandy et al (J. Lightwave Technology, Vol. 22(3), 2004, pp. 784-793[10]), but it will complicate the design of the instrument.

It should be noted that the above described DOP or SOP measurement technique may also be affected by amplified spontaneous emission (ASE), fiber nonlinearities, etc. (N. Kikuchi, Journal of Lightwave Technology, Vol. 19(4), 2001, pp. 480-486[11])). Its sensitivity to the ASE etc. is an important issue because most long fiber links are likely to use optical amplifiers, either EDFAs (erbium-doped fiber amplifiers) or Raman optical amplifiers. Moreover, the DGD range measurable using the SOP or DOP analysis method is limited.

The fixed analyzer (or equivalently, wavelength scanning) method, as described by C. D. Poole et al (J. Lightwave Technology, Vol. 12 (6), 1994, pp. 917-929[1]), was one of the first methods applied for PMD measurement. It provides limited accuracy for small PMD values even when a large wavelength range is used or for measuring PMD using small wavelength range. Moreover, it may not provide wavelength-dependent DGD information. Consequently, it is also unsuitable for measurement of narrowband channels.

The generalized interferometric method, as described by Cyr in J. Lightwave Technology, Vol. 22 (3), 2004, pp. 794-805 and U.S. Pat. No. 7,227,645[2,3], the latter commonly owned with the present invention, provides accurate PMD measurement (corresponding to the spectral width of the broadband source), but is also unable to provide the DGD as a function of wavelength, and is not well suited for use in a narrowband channel.

Thus, currently potentially-available DGD or PMD measurement techniques adapted to measure DGD or PMD in a narrow-band individual channel of a DWDM systems will be either inherently expensive, be unreliable, have a limited dynamic range, or may introduce instabilities in rapid gain equalizers that are often found with reconfigurable optical add-drop multiplexers (ROADMs) and optical amplifiers. Thus, their realization as a viable commercial instrument is difficult.

Accordingly, there is a need for a new improved method for enabling reliable, modest cost, and high accuracy measurement and monitoring of an in-channel DGD value. Depending upon the application, embodiments of this method should be able to respond to the need for “moderate-speed” monitoring (update speed ˜1 s) or “high-speed” monitoring (update speed ˜1 ms).

For reasons of convenience and operational expenses when characterizing a fiber, it is sometimes desirable to be able to measure the overall PMD of optical fiber from one end only, but currently most developed methods for carrying out such measurements in the fields are “two-ended”, i.e. a special polarized source must be used at one (proximal) end and the analysis equipment at the other (distal) end [1,3]. A reliable and practical “single-ended” measurement method would be advantageous in terms of technician traveling and logistics and because no specialized sources or other equipment would need to be placed at the distal end. It might/would also be desirable to able to use much the same technique or instrument to make either single-ended or two-ended measurements.

It is known to use a so-called single-ended PMD measurement technique to measure total (or “overall”) PMD for fibers by accessing only one end of a FUT [12-14,17]. Basically, the simplest single-ended PMD measurement comprises a CW tunable laser [12,17] or pulsed tunable laser [14] having a polarization controller (or polarization-state generator) or polarizer between its output and the FUT and has an analyzer to analyze the corresponding backreflected light. Usually the CW light from the tunable CW laser or pulsed light pulse from the tunable pulse laser is sent into the FUT and the backreflected light from the localized reflection (such as Fresnel reflection) at the distal end of the FUT is analyzed to obtain the total PMD value of the FUT.

Although single-ended PMD measurement concepts and approaches have been put forward previously, their realization as a viable commercial instrument for single-ended PMD measurement is difficult. This difficulty arises because test and measurement instruments based on such concepts will either be not very reliable, or be very expensive, or have a long acquisition time, or require the fiber to be very stable over long periods (i.e. not robust), or have a very limited dynamic range.

For example, for most single-ended PMD measurement techniques [12-16], the fiber-under-test (FUT) should not move during the measurement. As is also the case with the conventional fixed-analyzer method [13,15], any fiber movement will affect the number of extrema (i.e. maxima and minima) so that it may wrongly estimate the PMD value. Any power variation in backreflected light from the FUT for the single-ended version of the fixed-analyzer method may also result in wrong estimates of DGD (or PMD). Unfortunately, such stability of the FUT throughout the time period over which all of the data are measured cannot be assured, especially where the DGD/PMD of an installed fiber is being measured.

Also, a fixed analyzer method as described in references [13,15] not only entails a strict requirement to restrict fiber movement, but also has one major potential drawback with respect to measurement reliability because the method measures fiber absolute loss only (not a normalized light power or transmission) using only one detector without considering other potential factors, such as fiber spectral attenuation, spectral loss of related components used for an instrument, or wavelength dependent gain of the detector. For example, if spectral attenuation of fibers is not taken into account, error or uncertainty in the measurement results may be introduced, especially for fibers having significant spectral variation (versus wavelength) as is often observed with older fiber cables.

In addition, among those known techniques using a CW light source, whether a broadband source or a tunable laser [12,13,17], the measured results may not be reliable because the backreflected light may comprise a significant contribution from Rayleigh backscattering, as well as any spurious localized reflections from connectors, etc. not located at the distal end of the FUT. The Rayleigh contribution grows significantly with fiber length whereas the reflected light intensity from the localized reflection(s) (such as Fresnel reflection at the distal end of FUT) decreases with fiber length, thus rendering a CW-light-source method impractical for the multi-kilometer FUT lengths of interest in most telecommunications applications.

Hence, although presently-known techniques meeting the above-mentioned requirements may permit a reasonably successful measurement of DGD/PMD to be made, at present their scope of application and performance would be insufficient for a commercially-viable, stand-alone instrument.

Thus, known techniques and instruments, as discussed, for example, in references [12-17], cannot readily be adapted to develop a robust, reliable and cost effective commercial single-ended PMD test and measurement instrument. To measure total or overall PMD accurately from only one end of a fiber link, currently available techniques and concepts reported in the literature have significant limitations as described above.

Furthermore, as also explained in commonly-owned U.S. Pat. No. 6,724,469 (Leblanc) [18], in optical communication systems, an unacceptable overall polarization mode dispersion (PMD) level for a particular long optical fiber may be caused by one or more short sections of the optical fiber link. Where, for example, a network service provider wishes to increase the bit rate carried by an installed optical fiber link, say up to 40 Gb/s, it is important to be able to obtain a distributed measurement of PMD, i.e., obtain the PMD information against distance along the fiber, and locate the singularly bad fiber section(s) so that it/they can be replaced—rather than replace the whole cable.

Accordingly, Leblanc discloses a method of measuring distributed PMD which uses a polarization OTDR, to identify high or low PMD fiber sections, but does not provide a real quantitative PMD value for the FUT. Consequently, because of its inherently “qualitative” nature, Leblanc's technique is not entirely suitable for development as a commercial single-ended overall PMD testing instrument that may measure the total PMD value for the entire of fiber link.

It is known to use a so-called polarization-sensitive optical time domain reflectometer (POTDR; also commonly referred to as a “Polarization optical time domain reflectometer”) to try to locate such “bad” sections. Basically, a POTDR is an optical time domain reflectometer (OTDR) that is sensitive to the state of polarization (SOP) of the backreflected signal. Whereas conventional OTDRs measure only the intensity of backreflected light to determine variation of attenuation along the length of an optical path, e.g., an installed optical fiber, POTDRs utilize the fact that the backreflected light also exhibits polarization dependency in order to monitor polarization dependent characteristics of the transmission path. Thus, the simplest POTDR comprises an OTDR having a polarizer between its output and the fiber-under-test (FUT) and an analyzer in the return path, between its photodetector and the FUT. (It should be appreciated that, although a typical optical transmission path will comprise mostly optical fiber, there will often be other components, such as couplers, connectors, etc., in the path. For convenience of description, however, such other components will be ignored, it being understood, however, that the term “FUT” used herein will embrace both an optical fiber and the overall transmission path according to context.)

Generally, such POTDRs can be grouped into two classes or types. Examples of the first type of POTDR are disclosed in the documents [19-24].

The first type of POTDR basically measures local birefringence (1/beat-length) as a function of distance z along the fiber, or, in other words, distributed birefringence. Referring to the simple and well-known example of a retardation waveplate, birefringence is the retardation (phase difference) per unit length between the “slow” and “fast” axes. In other words, the retardation is the birefringence times the thickness of the waveplate. This is not a PMD measurement, though that is a common misconception. First, in a simplified picture, DGD(z) is the derivative, as a function of optical frequency (wavelength), of the overall retardation of the fiber section extending from 0 to z. Second, a long optical fiber behaves as a concatenation of a large number of elementary “waveplates” for which the orientations of the fast and slow axes, as well as the retardation per unit length, vary randomly as a function of distance z.

Accordingly, DGD(z) is the result of a complicated integral over all that lies upstream that exhibits random birefringence and random orientation of the birefringence axis as a function of z, whereas birefringence is the retardation per unit length at some given location. Additionally, as mentioned above, the derivative, as a function of optical frequency, of such integral must be applied in order to obtain DGD as per its definition.

A general limitation of techniques of this first type, therefore, is that they do not provide a direct, reliable, valid in all cases and quantitative measurement of PMD with respect to distance along the optical fiber. Instead, they measure local birefringence (or beat-length) and/or one or more related parameters and infer the PMD from them based notably on assumptions about the fiber characteristics and specific models of the birefringence. For instance, they generally assume a relationship between PMD and local values of the birefringence and so-called coupling-length (or perturbation-length), which is not necessarily valid locally even when it is valid on average.

As an example, such techniques assume that fibers exhibit exclusively “linear” birefringence. If circular birefringence is indeed present, it is “missed” or not seen, because an OTDR technique inherently involves round trip propagation through the fiber. Notably, correct measurement of modern “spun fibers” already requires assumptions to be made about their behavior, and consequently is not acceptable for a commercial instrument.

As a second example, the birefringence and other parameters must be measured accurately throughout the length, even in sections where the local characteristics of the fiber do not satisfy the assumed models and conditions; otherwise, the inferred PMD of such sections, which is an integral over some long length, can be largely misestimated, even qualitatively speaking. In practice, although they can measure birefringence quantitatively (cf. F. Corsa et al. [19]supra), or statistically screen high birefringence sections (Chen et al. [23] supra), or obtain qualitative and relative estimates of the PMD of short sections provided that one accepts frequently-occurring exceptions (Leblanc [18], Huttner [22], supra), POTDR techniques of this first type cannot reliably and quantitatively measure PMD, particularly of unknown, mixed installed fibers in the field. Furthermore, they are incapable of inferring, even approximately, the overall PMD of a long length of fiber, such as for example 10 kilometers.

Fayolle et al. [24] (supra) claim to disclose a technique that is “genuinely quantitative, at least over a given range of polarization mode dispersion”. However, this technique also suffers from the fundamental limitations associated with this type, as mentioned above. In fact, while their use of two SOPs (45° apart) with two trace variances might yield a modest improvement over the similar POTDRs of the first type (e.g., Chen et al.'s [23], whose VOS is essentially the same as Fayolle et al.'s [24] trace variance), perhaps by a factor of \sqrt{2}, it will not lead to a truly quantitative measurement of the PMD with respect to distance along the FUT with an acceptable degree of accuracy. It measures a parameter that is well-known to be related or correlated with beat-length (birefringence), but not representative of the PMD coefficient. Indeed, even the simulation results disclosed in Fayolle et al.'s specification indicate an uncertainty margin of 200 percent.

It is desirable to be able to obtain direct, quantitative measurements of PMD, i.e., to measure the actual cumulative PMD at discrete positions along the optical fiber, as if the fiber were terminated at each of a series of positions along its length and a classical end-to-end PMD measurement made. This is desirable because the parameter that determines pulse-spreading is PMD, not birefringence. If one knows the actual PMD value of a communications link one can determine, accurately, the bit error rate or outage probability (probability that the communication will fail over a period of time), or the power penalty (how much more power must be launched to maintain the same bit error rate as if there were no PMD).

(In this specification, the term “cumulative PMD” is used to distinguish from the overall PMD that is traditionally measured from end-to-end. Because PMD is not a localized quantity, PMD(z) is an integral from 0 to z, bearing resemblance to a cumulative probability rather than the probability distribution. When distance z is equal to the overall length of the FUT, of course, the cumulative PMD is equal to the overall PMD.)

The second type of known POTDR is dedicated specifically to PMD measurement. This type does not suffer from the above-mentioned fundamental limitations of the first type of POTDR and so represents a significant improvement over them, at least in terms of PMD measurement. It uses the relationship between POTDR traces obtained at two or more closely-spaced wavelengths in order to measure PMD directly at a particular distance z, i.e., cumulative PMD, with no need for any assumption about the birefringence characteristics of the fibers, no need for an explicit or implicit integral over length, no missed sections, no problem with spun fibers, and so on. Even the PMD of a circularly birefringent fiber or a section of polarization-maintaining fiber (PMF) is measured correctly. In contrast to implementations of the first type, there is no need to invoke assumptions and complicated models in order to infer PMD qualitatively.

Thus, measurement of cumulative PMD as a function of distance z along the fiber, and its corresponding slope (rate of change of PMD with distance), as allowed by a POTDR of this second type, facilitates reliable identification and quantitative characterization of those singular, relatively-short “bad” sections described hereinbefore.

Most known POTDR techniques of this second type rely upon there being a deterministic relationship between the OTDR traces obtained with a small number of specific input-SOPs and output polarization analyzer axes, as disclosed, for example, in U.S. Pat. No. 6,229,599 (Galtarossa) [16] and articles by H. Sunnerud et al [14,15]. This requires the FUT to be spatially stable throughout the time period over which all of the traces are measured. Unfortunately, such stability cannot be assured, especially where an installed fiber is being measured.

In addition, known techniques of the second type require the use of short pulses; “short” meaning much shorter than the beat length and coupling length of any section of the FUT. In order for them to measure PMD properly in fibers having short beat lengths, they must use OTDR optical pulse widths of typically less ˜10 ns. Unfortunately, practical OTDRs do not have a useful dynamic range with such short pulses. On the other hand, if a long light pulse is used, only fibers having long beat lengths can be measured, which limits these techniques, overall, to measurement of short distances and/or with long measurement times, or to fibers with large beat length (typically small PMD coefficient). Hence, although it might be possible, using known techniques and meeting the above-mentioned requirements, to make a reasonably successful measurement of PMD, at present their scope of application and performance would be insufficient for a commercially-viable, stand-alone instrument.

In addition, the use of short pulses exacerbates signal-to-noise ratio (SNR) problems due to so-called coherence noise that superimposes on OTDR traces and is large when short pulses are used. It is due to the fact that the power of the backreflected light is not exactly the sum of powers emanating from each element (dz) of the fiber. With a coherent source such as a narrowband laser, as used in POTDR applications, there is interference between the different backscattering sources. This interference or coherence noise that is superimposed on the ideal trace (sum of powers) is inversely proportional to both the pulse width (or duration) and the laser linewidth. It can be decreased by increasing the equivalent laser linewidth, i.e., the intrinsic laser linewidth as such, or, possibly, by using “dithering” or averaging traces over wavelength, but this reduces the maximum measurable PMD and hence may also limit the maximum length that can be measured, since PMD increases with increasing length. Roughly speaking, the condition is PMD·Linewidth<1 (where the linewidth is in optical frequency units); otherwise the useful POTDR signal is “washed out” by depolarization.

It would be desirable, therefore, for there to be a technique to quantitatively measure cumulative PMD using pulses whose length could be greater than the beat length of the FUT (for high dynamic range, while maintaining a satisfactory spatial resolution), without stringent requirements regarding the stability of the FUT or making assumptions about the fiber behavior (e.g. strong mode coupling).

In summary, there is a need for a new method for characterizing such polarization-dependent characteristics of optical paths that is inherently robust to fiber movement and perturbations prevalent in field conditions, and does not require expensive and cumbersome polarization optics. Preferably, this basic method should underlie several different embodiments that are particularly well suited for either or both of single-ended and two-ended measurements of DGD within a narrow DWDM channel, DGD at multiple wavelengths, PMD and cumulative PMD as a function of distance along a fiber link.

### SUMMARY OF THE INVENTION

The present invention seeks to eliminate, or at least mitigate, the disadvantages of the prior art discussed above, or at least provide an alternative.

According to a first aspect of the invention, there is provided a method of measuring at least one polarization-related characteristic of an optical path (FUT) using optical source means connected to the optical path at or adjacent a proximal end thereof, and analyzing-and-detection means connected to the optical path at or adjacent either the proximal end thereof or a distal end thereof, the optical source means comprising light source means for supplying at least partially polarized light and means for controlling the state of polarization (I-SOP) of said at least partially polarized light and injecting said light into the FUT, and analyzing-and-detection means comprising means for extracting corresponding light from the FUT, analyzing means for analyzing the extracted light and detection means for detecting the analyzed light corresponding to the at least one transmission axis of the analyzer means (A-SOP) to provide transmitted coherent optical power at each wavelength of light in each of at least two groups of wavelengths, wherein the lowermost (λₗ) and uppermost (λ_{U}) said wavelengths in each said group of wavelengths are closely-spaced;

and wherein the said group comprises a wavelength pair, said pair in each group corresponding to a small optical-frequency difference and defining a midpoint wavelength therebetween, and wherein the I-SOP and A-SOP are substantially constant for each said wavelength in each said group, and wherein at least one of the midpoint wavelength, I-SOP and A-SOP is different between the respective said groups, the method including the steps of:
i. Computing the at least one difference in a measured power parameter corresponding to each wavelength in said wavelength pair for each of the said at least two groups, said measured power parameter being proportional to the power of the said analyzed and subsequently detected light, thereby defining a set of at least two measured power parameter differences;
ii. Computing the mean-square value of said set of differences; and
iii. Calculating the at least one polarization-related FUT characteristic as at least one predetermined function of said mean-square value, said predetermined function being dependent upon the said small optical frequency difference between the wavelengths corresponding to the said each at least said two pairs of closely-spaced wavelengths.

For two-ended measurement, the said analyzing-and-detection means may be connected to the FUT at or adjacent the distal end of the FUT.

Preferably, for measurement of DGD at a specified wavelength, for example, for narrow DWDM channel measurement, each said group comprises wavelength pairs having substantially said prescribed midpoint wavelength, and the said at least one polarization-related FUT characteristic is the differential group delay (DGD) at the said midpoint wavelength.

The said measured power parameter may be the computed normalized power T(ν), and said predetermined function can be expressed, for small optical-frequency differences (δν), according to the following differential formula:

$$DGD ( v ) = \frac{{α}_{ds}}{π δ v} \cdot \sqrt{{〈 Δ {T}^{2} ( v ) 〉}_{SOP}}$$

where the constant

$${α}_{ds} = \sqrt{\frac{9}{2}} ,$$

and ν is the optical frequency corresponding to the said midpoint wavelength.

According to a second aspect of the invention, there is provided measurement instrumentation, for measuring at least one polarization-related characteristic of an optical path (FUT), comprising:

optical source means for connection to the optical path at or adjacent a proximal end thereof, and

analyzing-and-detection means for connection to the optical path at or adjacent either the proximal end thereof or a distal end thereof for extracting, analyzing and detecting light that has traveled at least part of the FUT and providing corresponding electrical signals, and

processing means for processing the electrical signals from the analyzing-and-detection means to determine said at least one polarization-related characteristic;

the optical source means comprising:
light source means for supplying at least partially polarized light at each wavelength in at least two groups of wavelengths, and
SOP controller means for controlling the state of polarization (I-SOP) of said at least partially polarized light and injecting said light into the FUT, wherein the lowermost (λ_{L}) and uppermost (λ_{U}) of said wavelengths in each said group of wavelengths are closely-spaced,
the said group comprises a wavelength pair, said pair in each group corresponding to a small optical-frequency difference and defining a midpoint wavelength therebetween, and
the SOP of the injected light and A-SOP are substantially constant for each said wavelength in each said group, and wherein at least one of the midpoint wavelength, I-SOP and A-SOP is different between the respective said groups, and

the analyzing-and-detection means comprising:
extraction and analysis means for extracting corresponding light from the FUT and analyzing the extracted light, and
detection means for detecting the analyzed light corresponding to at least one transmission axis of the analyzer means (A-SOP) to provide transmitted coherent optical power at each wavelength of the analyzed light in each of said at least two groups of wavelengths, wherein the lowermost (λ_{L}) and uppermost (λ_{U}) said wavelengths in each said group of wavelengths are closely-spaced and

the processing means being configured and operable for:
i. computing the at least one difference in a measured power parameter corresponding to each wavelength in said wavelength pair for each of the said at least two groups, said measured power parameter being proportional to the power of the said analyzed and subsequently detected light, thereby defining a set of at least two measured power parameter differences;
ii. computing the mean-square value of said set of differences; and
iii. calculating the at least one polarization-related FUT characteristic as at least one predetermined function of said mean-square value, said predetermined function being dependent upon the said small optical frequency difference between the wavelengths corresponding to the said each at least said two pairs of closely-spaced wavelengths; and
iv. outputting the value of said at least one polarization-related FUT characteristic for display, transmission or further processing.

Preferred embodiments and species of the foregoing aspects of the invention are set out in the dependent claims appended hereto.

The foregoing and other objects, features, aspects and advantages of the present invention will become more apparent from the following detailed description, in conjunction with the accompanying drawing, of preferred embodiments of the invention which are described by way of example only.

### BRIEF DESCRIPTION OF THE DRAWINGS

### Two-Ended PMD Measurement

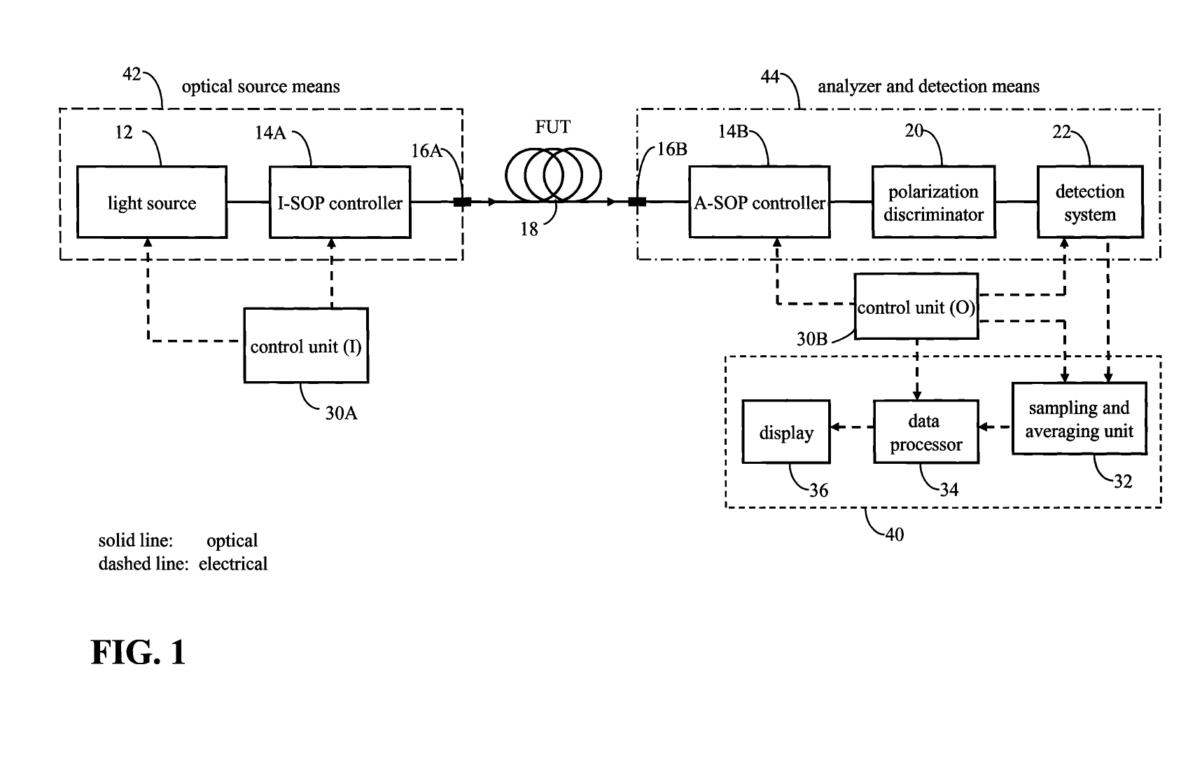

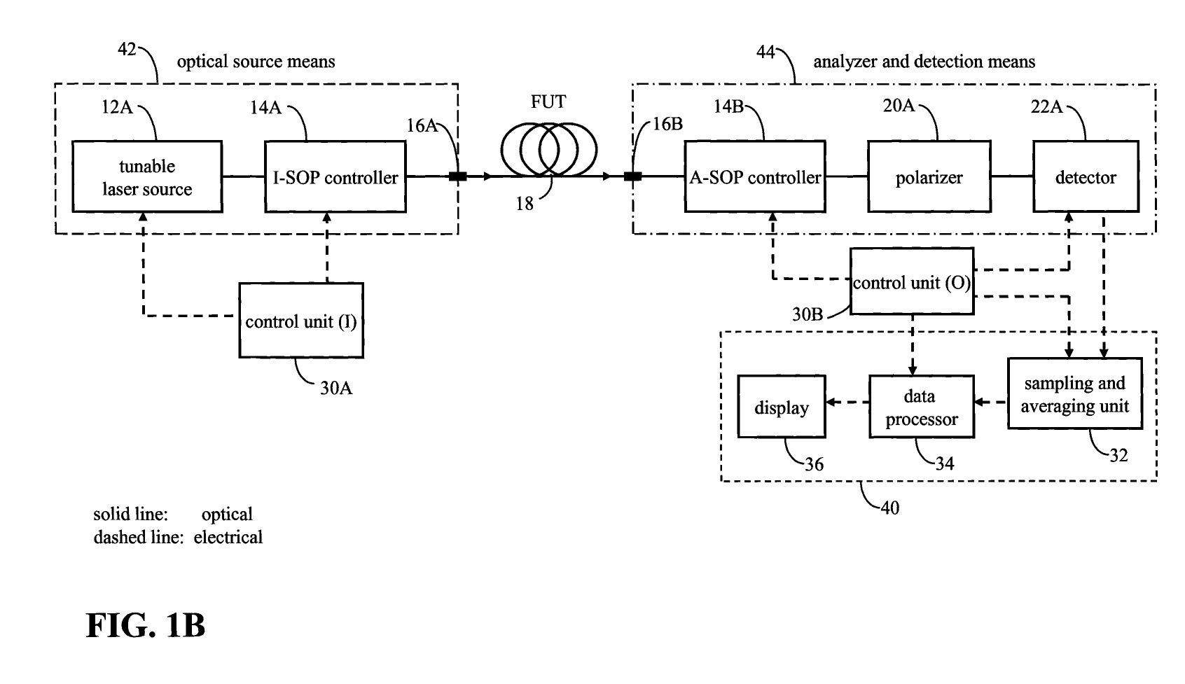

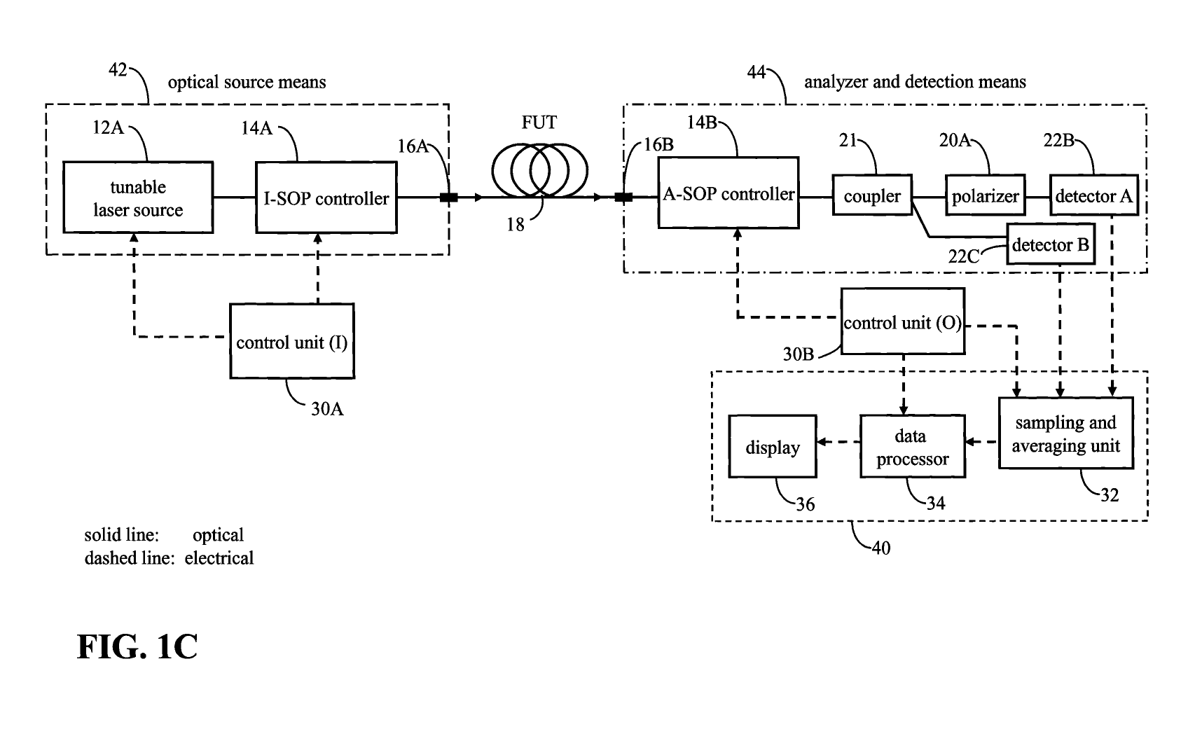

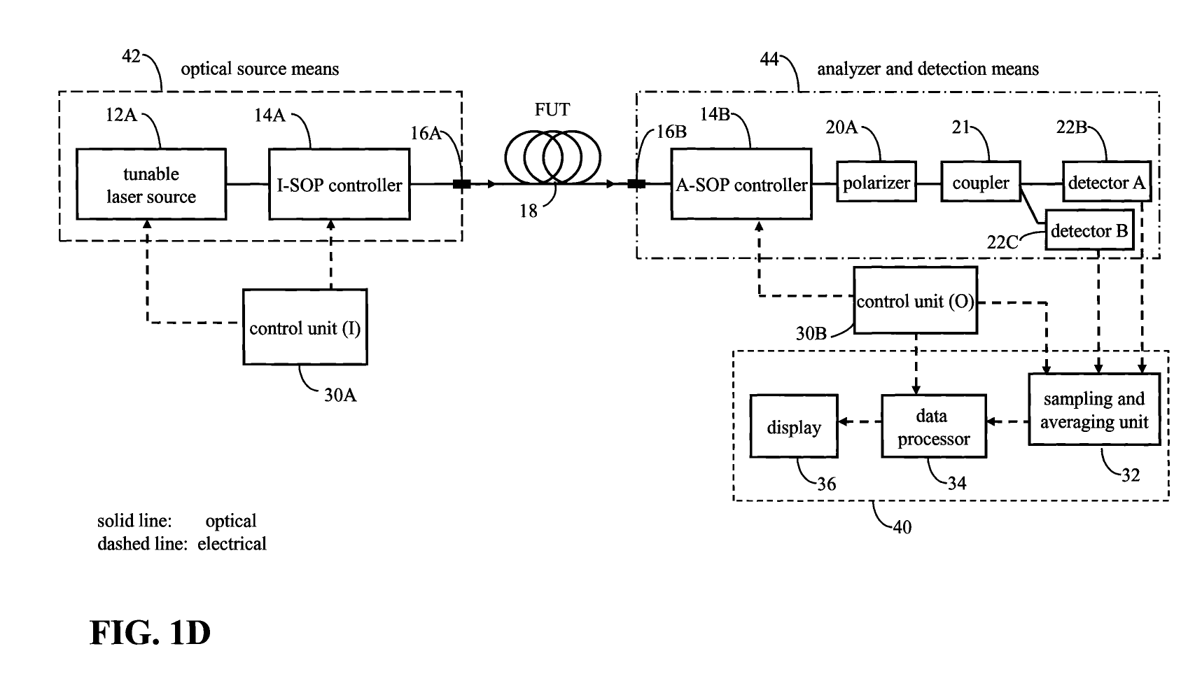

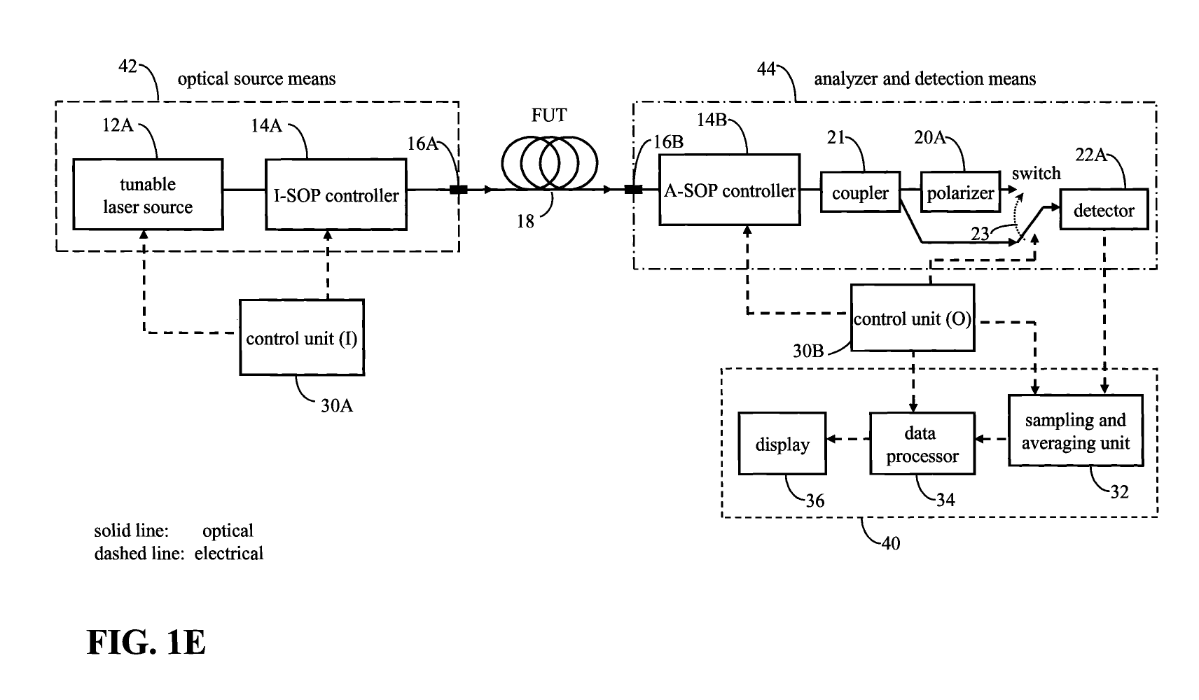

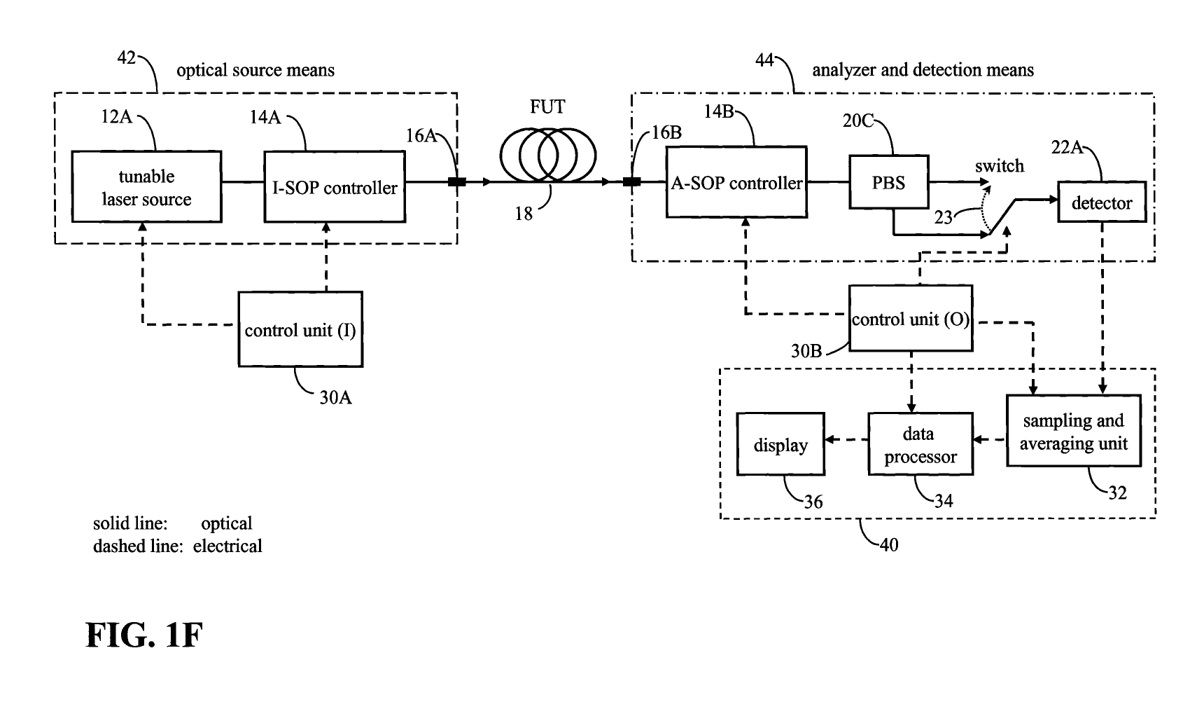

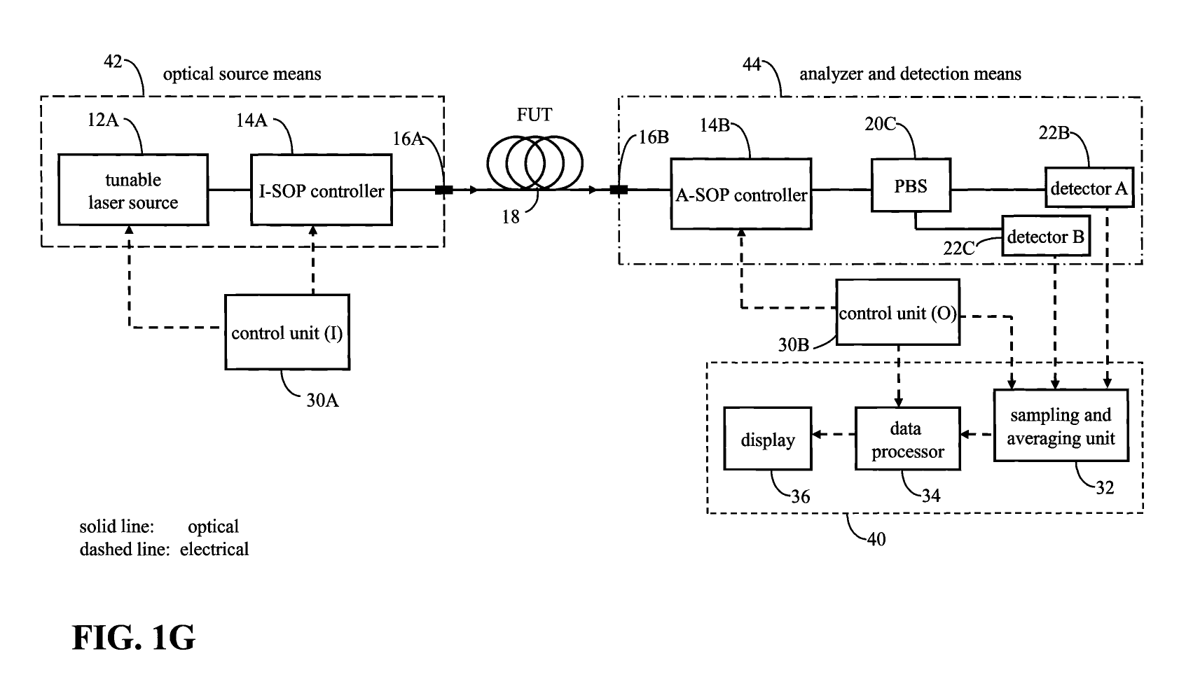

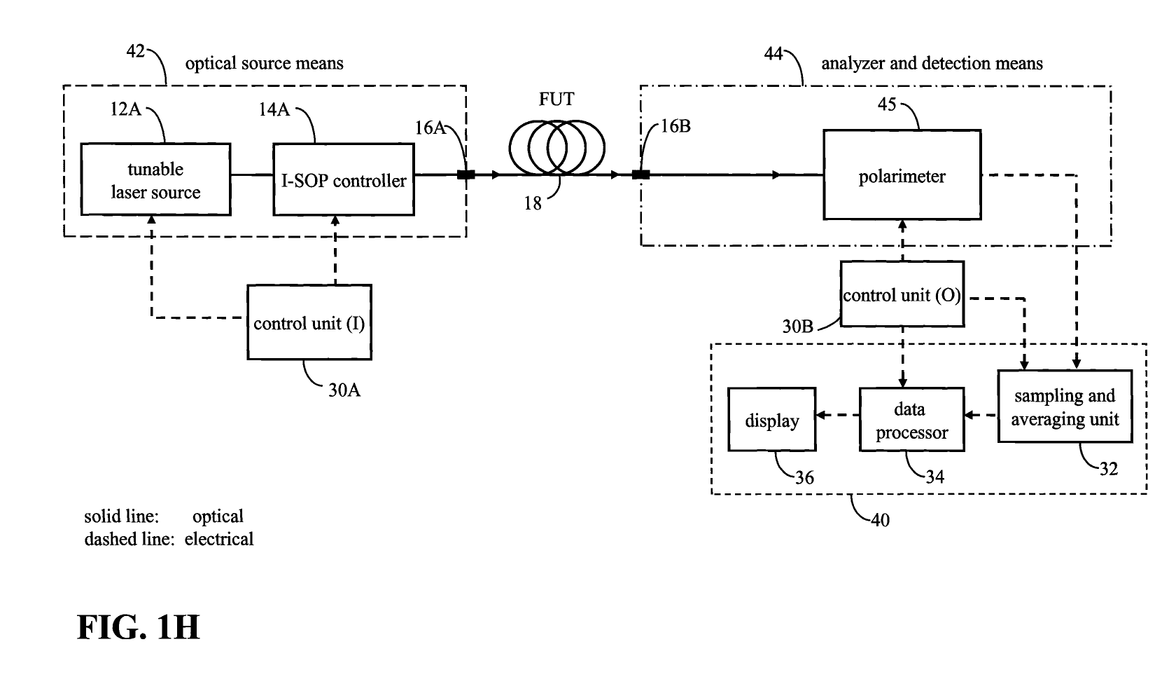

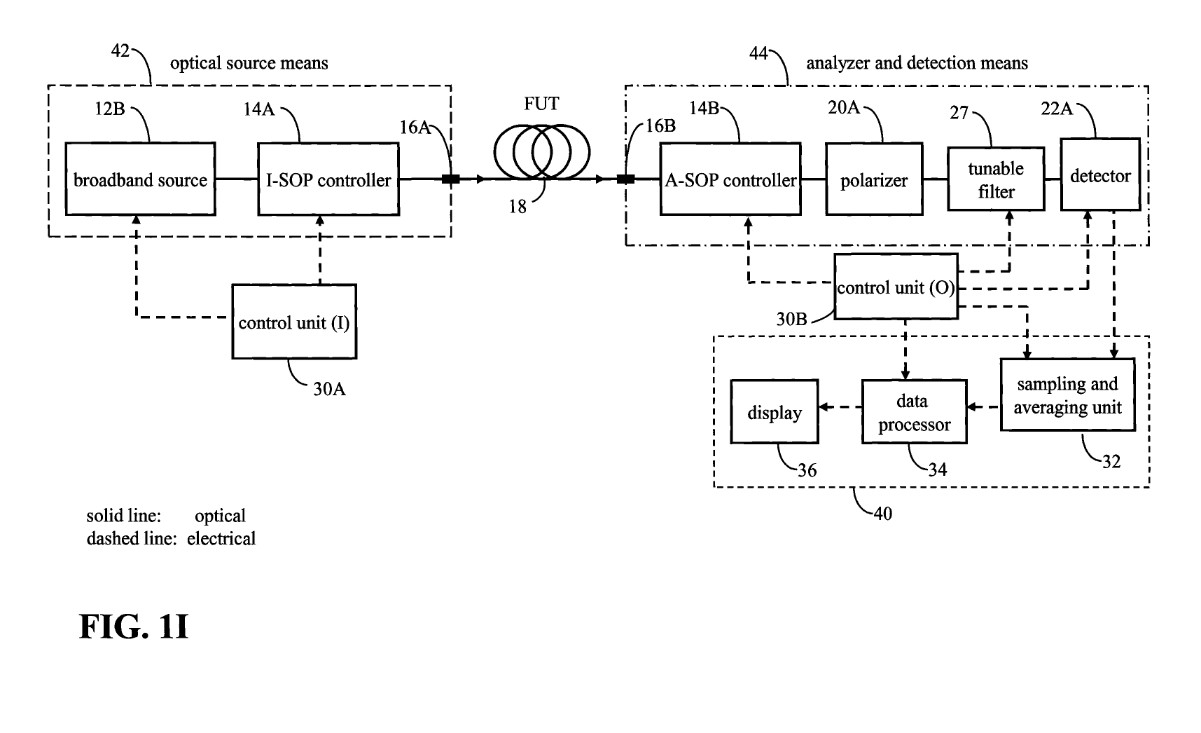

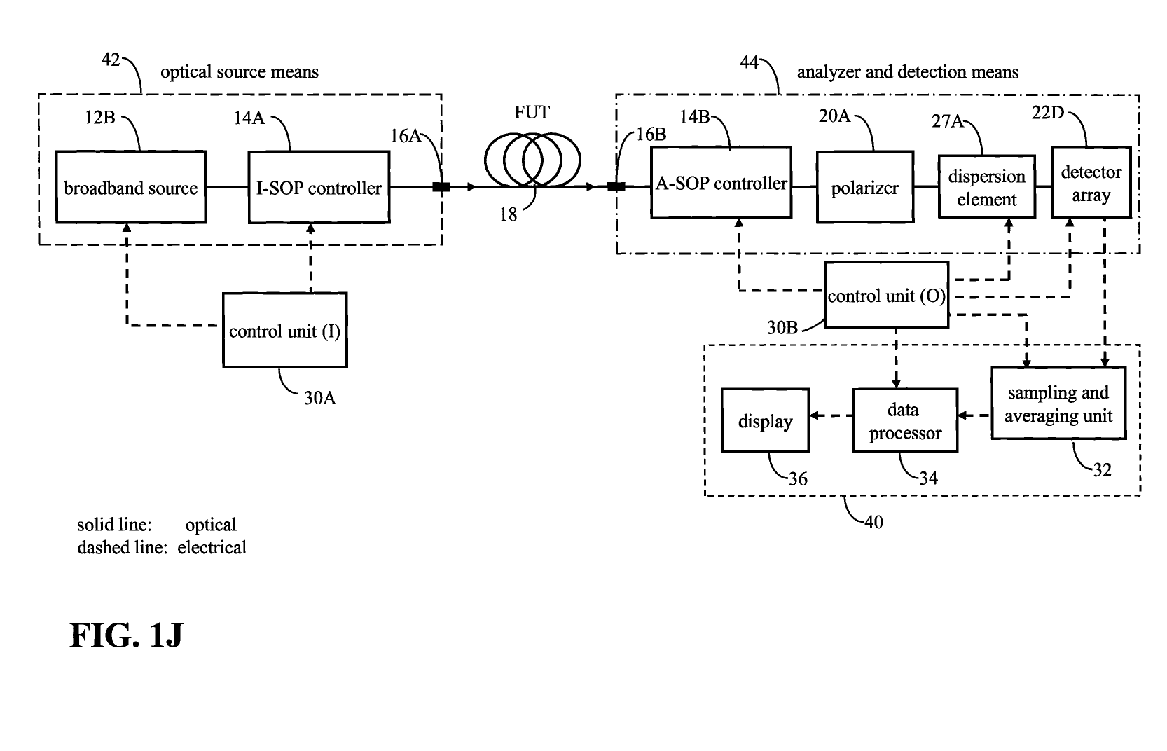

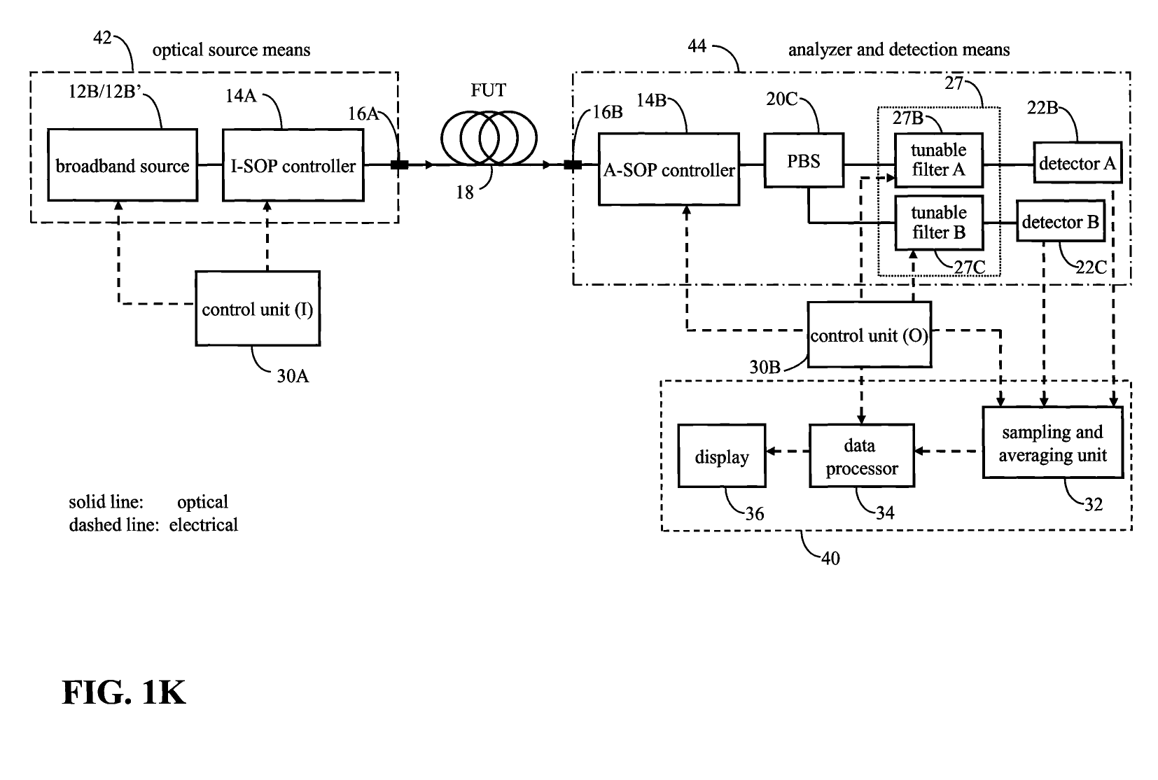

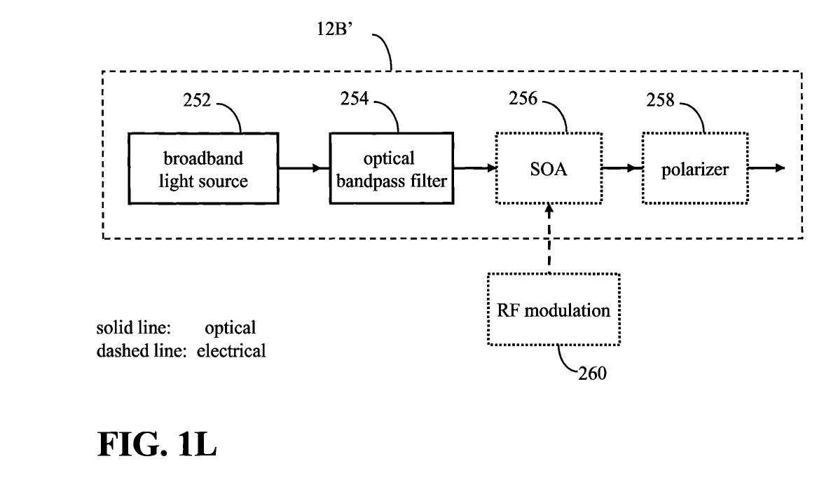

FIG. 1 is a simplified generalized schematic illustration of parts of a measuring instrument connected to opposite ends of a fiber-under-test (FUT) for performing two-ended measurements on the FUT to determine DGD at one or more wavelengths and/or mean DGD and/or rms DGD;

FIG. 1B is a simplified schematic diagram similar to FIG. 1 but of an instrument using a tunable laser light source, one input-SOP controller (scrambler), one output-SOP controller (scrambler), a polarizer/analyzer and one detector to measure analyzed light;

FIG. 1C is a simplified schematic diagram of an instrument similar to that shown in FIG. 1B but which uses a coupler, a polarizer and two detectors; one detector for measuring analyzed light after the polarizer and the other detector for measuring light that is proportional to a total output light power from FUT;

FIG. 1D is a simplified schematic diagram of an instrument similar to that illustrated in FIG. 1B but having two detectors connected to the coupler to measure two repeated powers in order to reduce uncorrelated noise contributions to the measurement;

FIG. 1E is a simplified schematic diagram of an instrument similar to that shown in FIG. 1C but having a single detector and an optical switch for connecting the detector alternatively to measure analyzed light from the polarizer and light from the coupler proportional to a total output light power from the FUT;

FIG. 1F is a simplified schematic diagram of an instrument similar to that shown in FIG. 1E but with the coupler and polarizer replaced by a polarization beam splitter (PBS), the optical switch connecting the single detector to alternatively to the output ports of the PBS;

FIG. 1G is a simplified schematic diagram of an instrument similar to that shown in FIG. 1B but which involves polarization-diverse detection, employing a PBS and two detectors;

FIG. 1H is a simplified schematic diagram of an instrument similar to that shown in FIG. 1 but which has a polarimeter for analyzing and detecting light from the FUT;

FIG. 1I is a simplified schematic diagram of a broadband light source based two-ended PMD measurement/test instrument which is similar to that shown in FIG. 1B but uses a light source to provide the spectrally wide light encompassing the desired wavelength range and narrow-band tunable filter (between polarizer and a detector) to enable detection of only light corresponding to a small spectral width centered about the passband wavelength of the narrow-band tunable filter;

FIG. 1J is a simplified schematic diagram of a broadband light source based two-ended PMD measurement/test instrument similar to that shown in FIG. 1I but using a dispersion element (multi-channel filter) and multi-channel detector array means that measures analyzed light after the polarizer simultaneously or within a short time period;

FIG. 1K is a simplified schematic diagram of a broadband light source-based two-ended PMD measurement/test instrument which is similar to that shown in FIG. 1G but uses a light source to provide the spectrally wide light encompassing the desired wavelength range, a PBS in the analyzing-and-detection means, two synchronously-controlled narrow-band tunable filters between the PBS and the respective detectors, to enable polarization-diverse detection of light corresponding to a small spectral width centered about the passband wavelength of the narrow-band tunable filter; and

FIG. 1L illustrates schematically an alternative broadband source for the instruments of FIGS. 1I, 1J and 1K that is particularly well-suited for in-channel measurement of DGD and shows, in broken lines, an optional optical amplifier, preferably a semiconductor optical amplifier, and, for use where chromatic dispersion is to be measured, a source of RF modulation and, if appropriate, a polarizer.

### Single-Ended Overall PMD Measurement

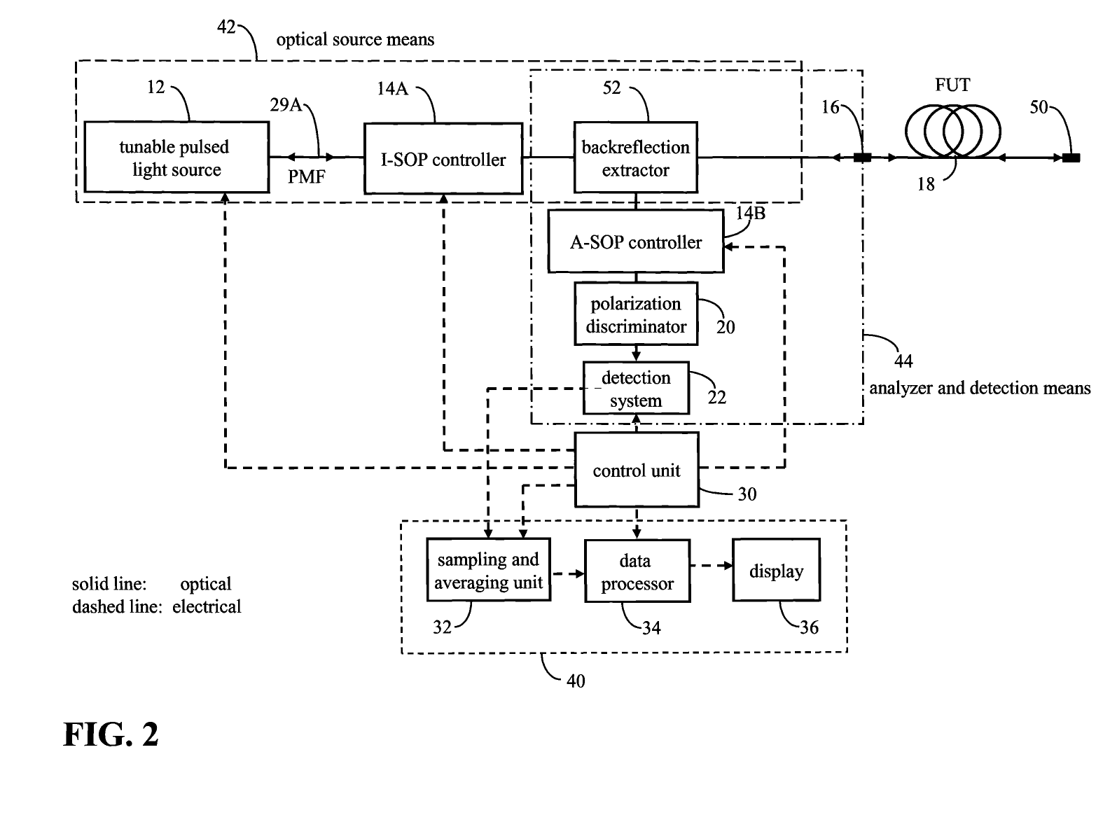

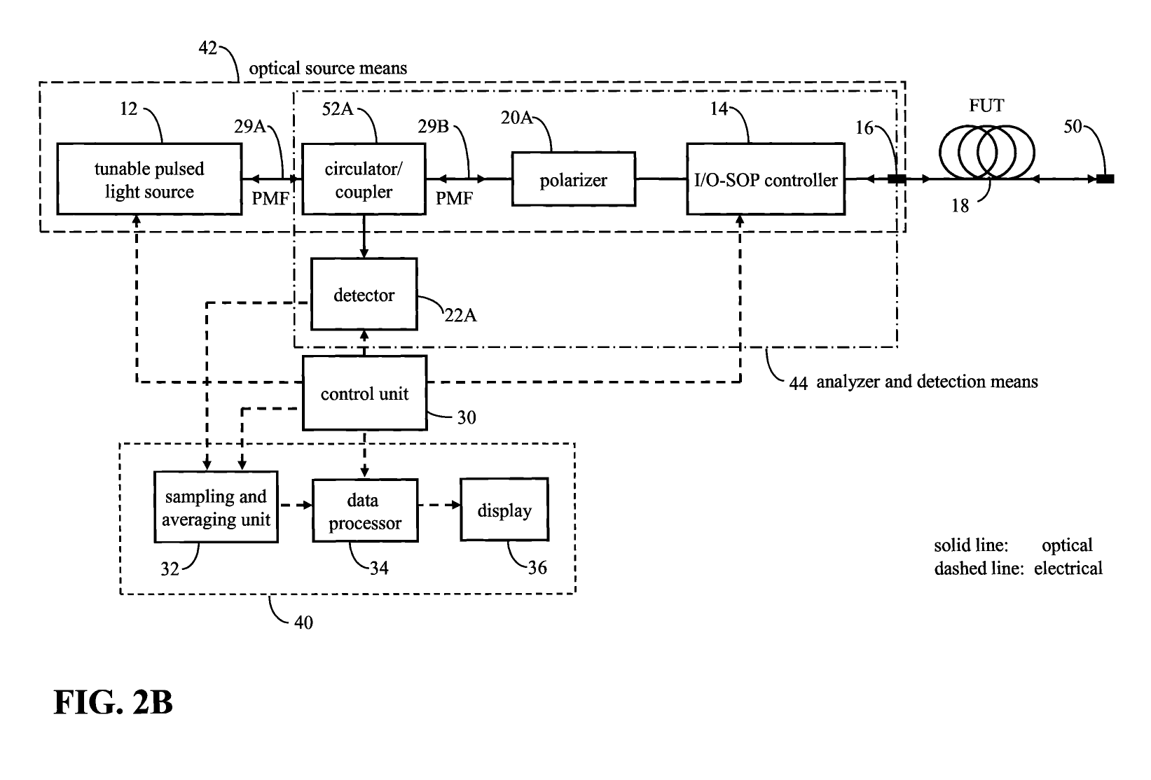

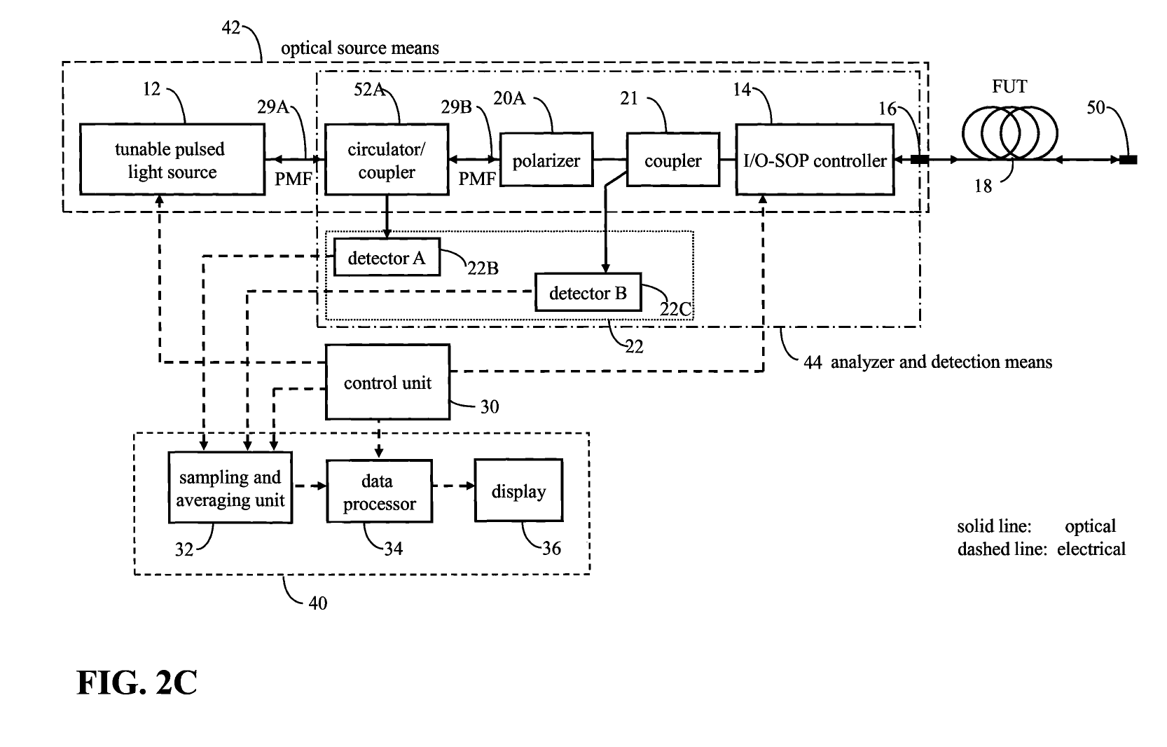

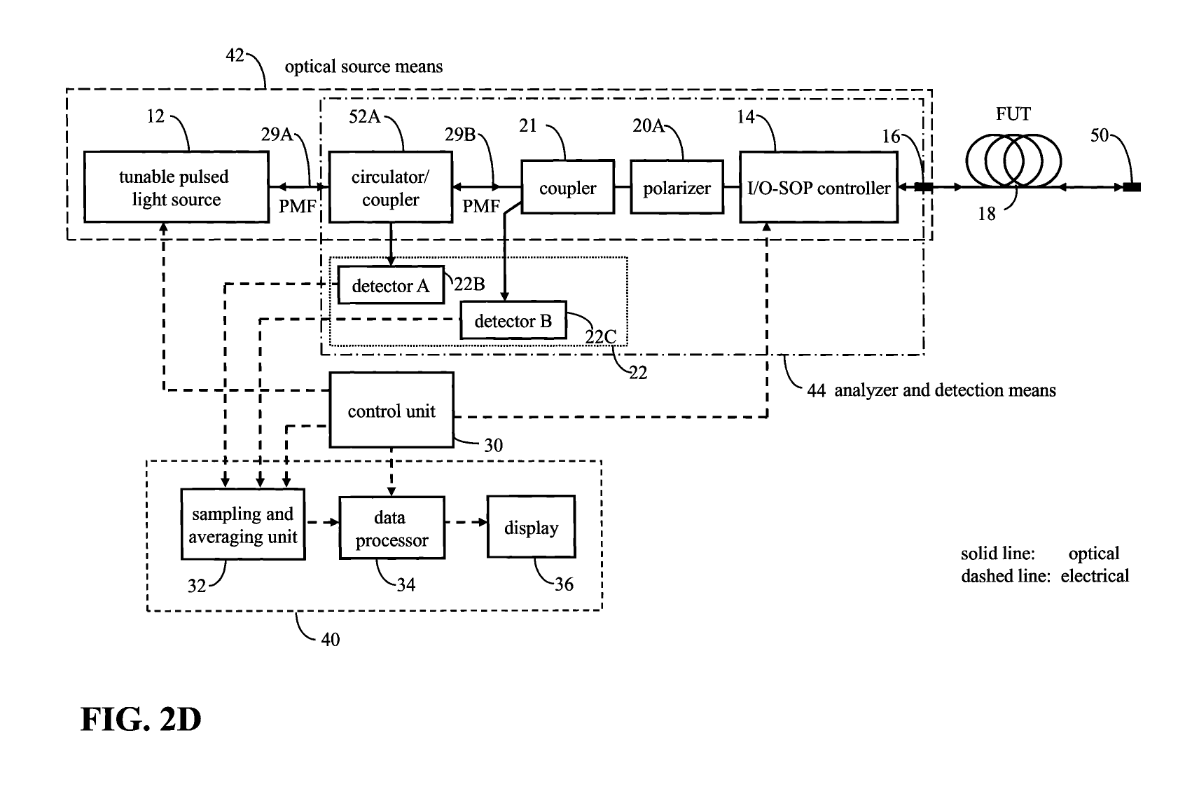

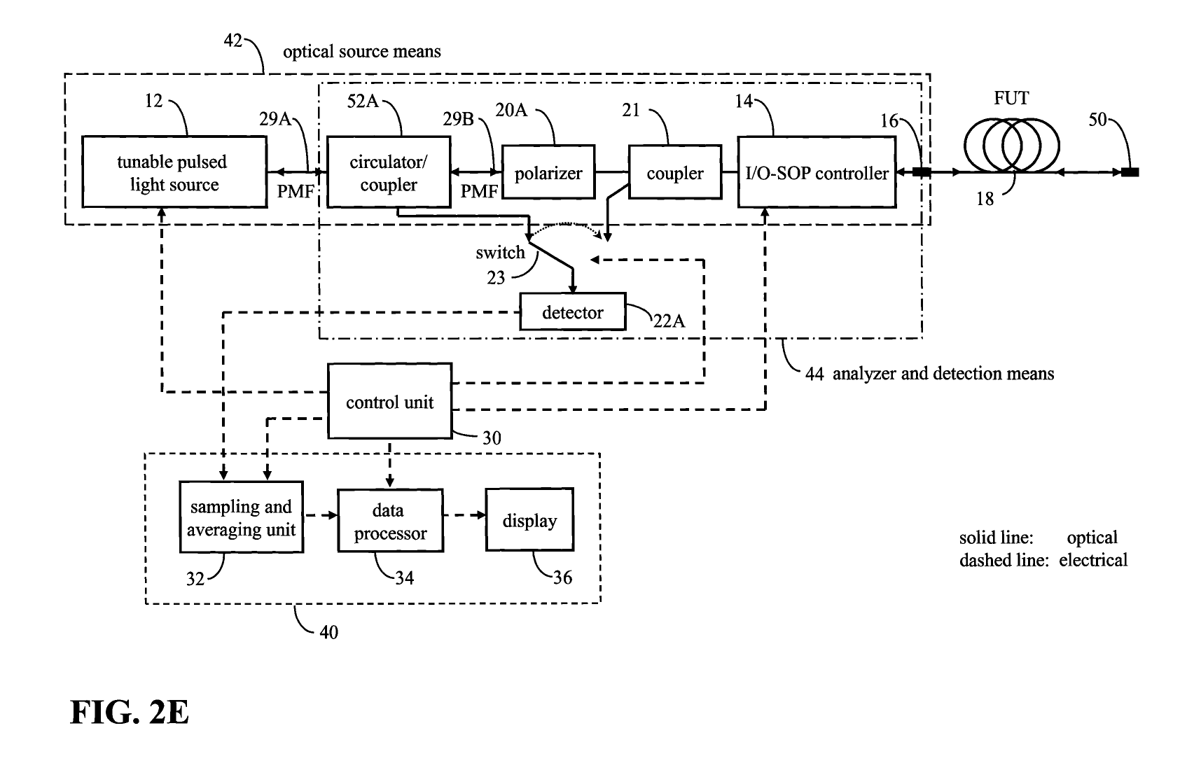

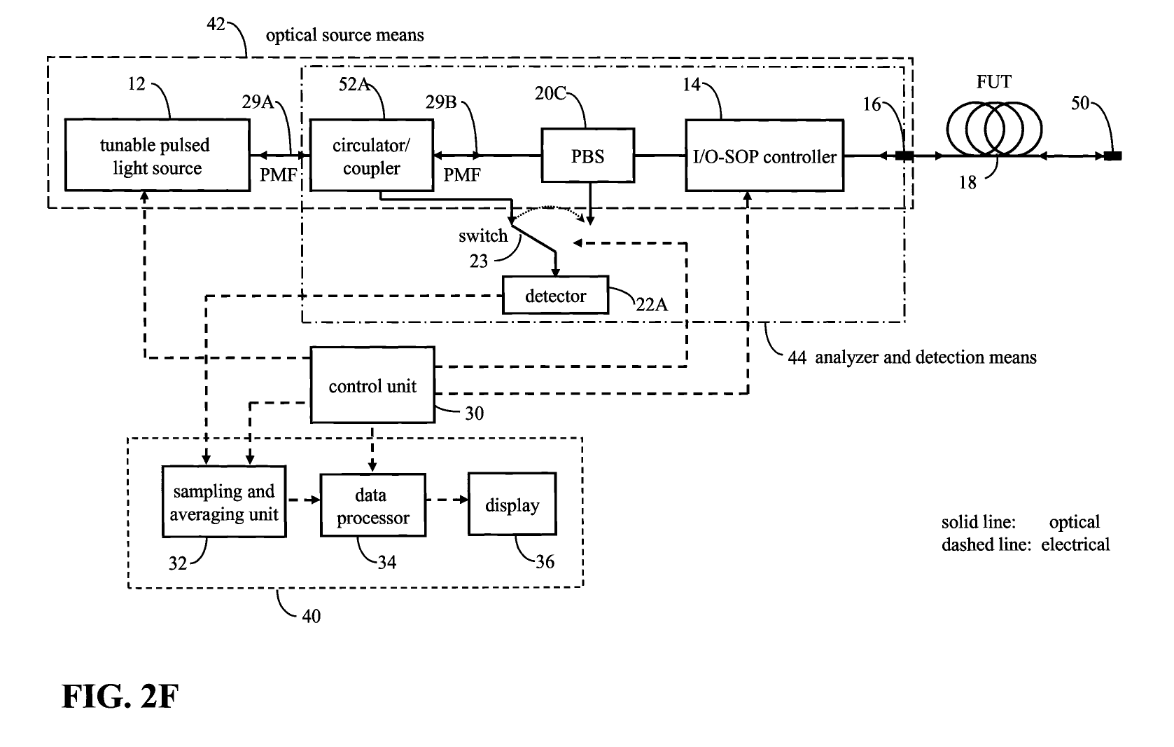

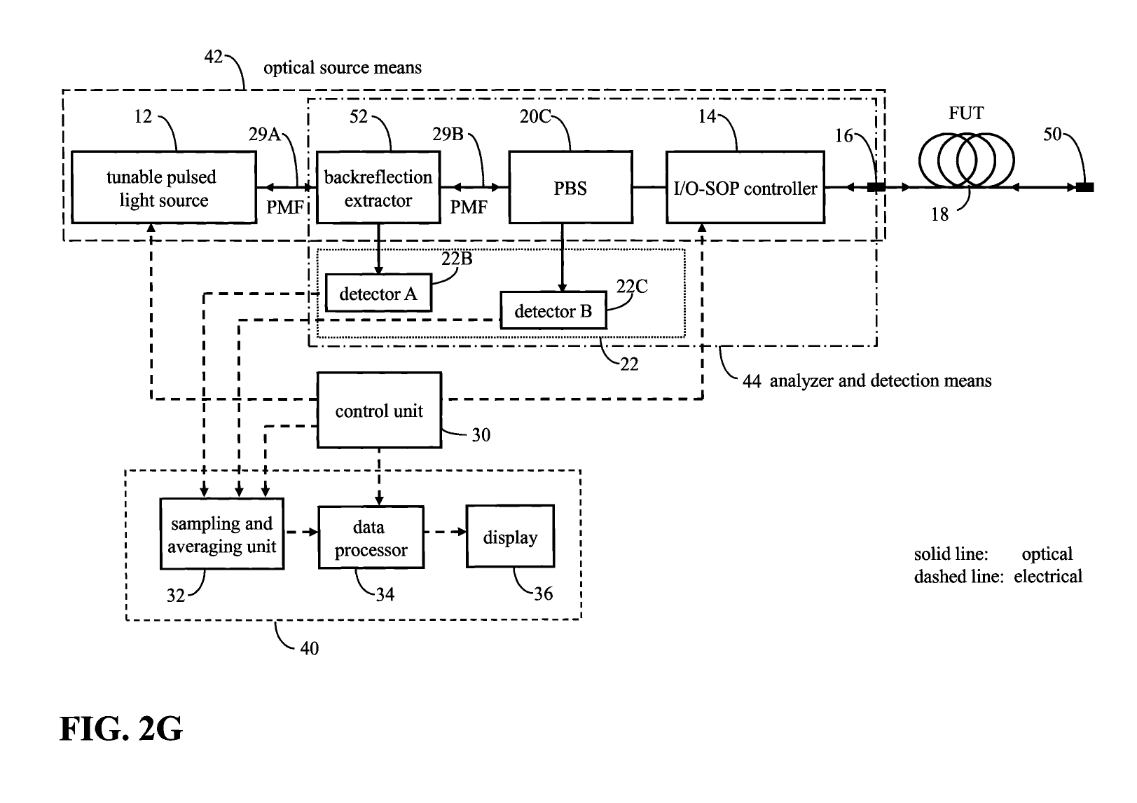

FIG. 2 corresponds to FIG. 1 but is a simplified schematic diagram of measurement test instrument for single-ended measurement of overall PMD;

FIGS. 2B to 2G correspond to FIGS. 1B to 1G, respectively, and illustrate corresponding single-ended measuring instruments in which both parts of the measuring instrument are at the same, proximal end of the FUT;

### Single-Ended Cumulative PMD Measurement

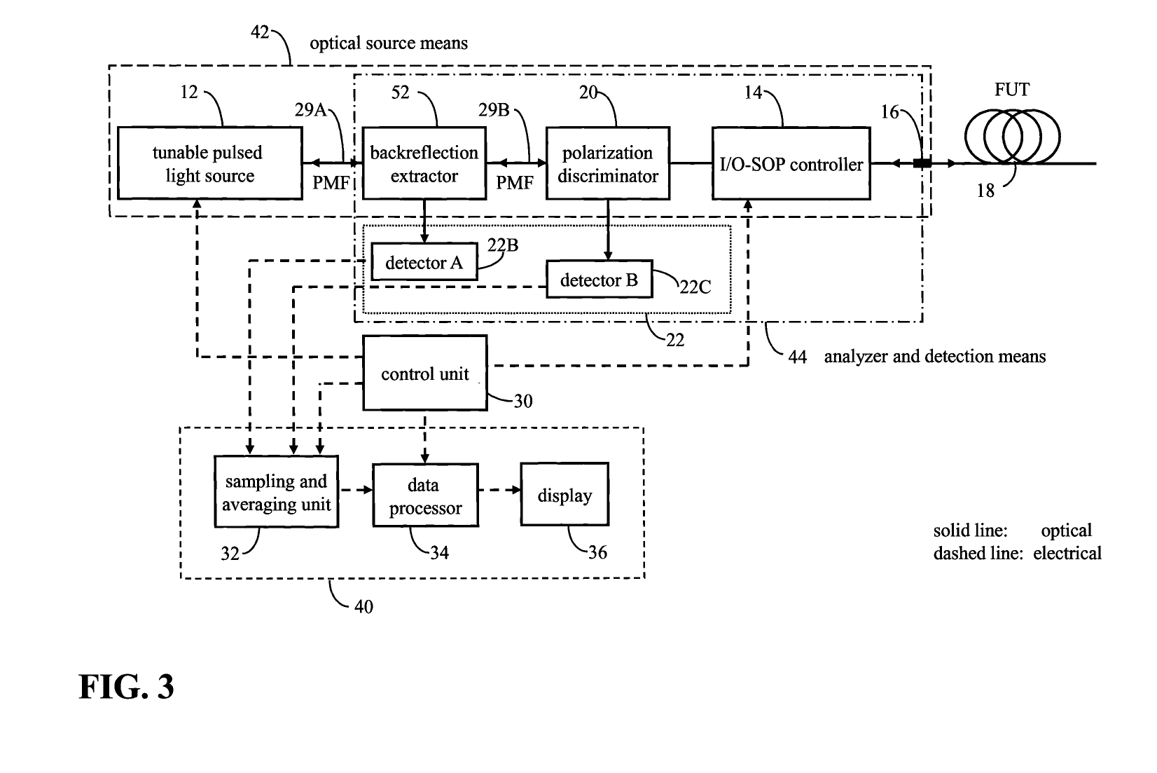

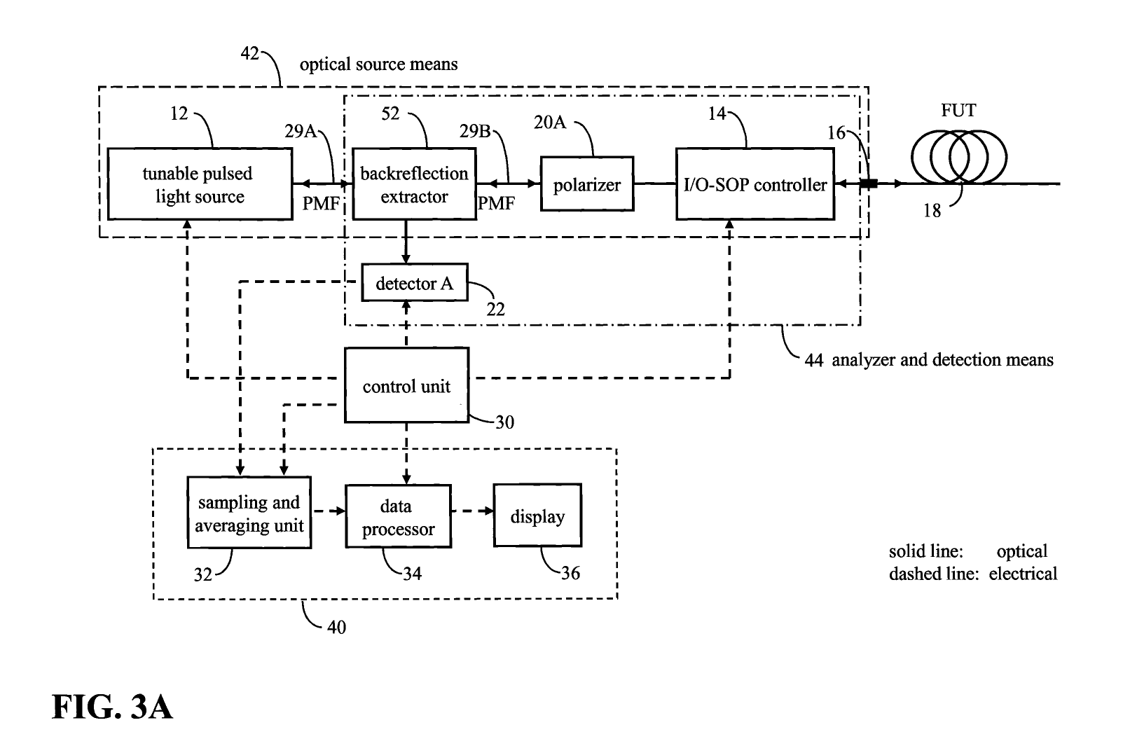

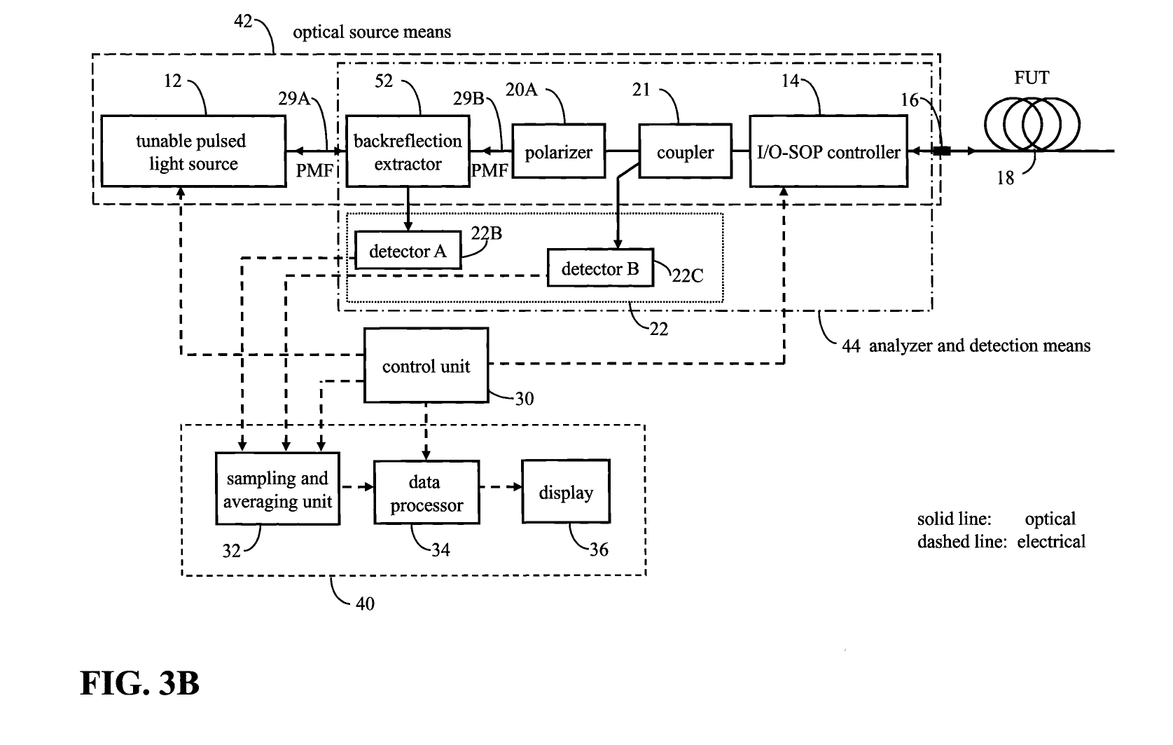

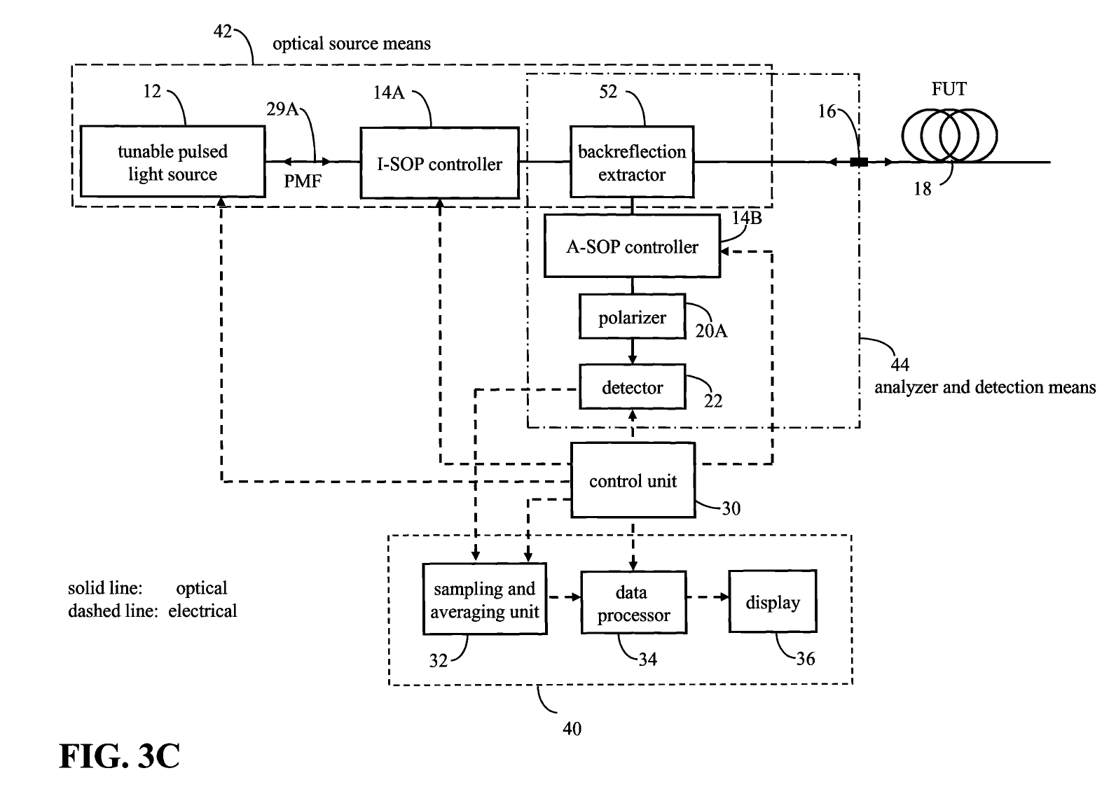

FIG. 3 is a simplified schematic diagram of a polarization-sensitive optical time domain reflectometer (POTDR) embodying an aspect of the present invention;

FIG. 3A is a simplified schematic diagram of a polarization-sensitive optical time domain reflectometer embodying an aspect of the present invention;

FIG. 3B is a polarization-sensitive optical time domain reflectometer embodying an aspect of the present invention;

FIG. 3C is a polarization-sensitive optical time domain reflectometer embodying an aspect of the present invention;

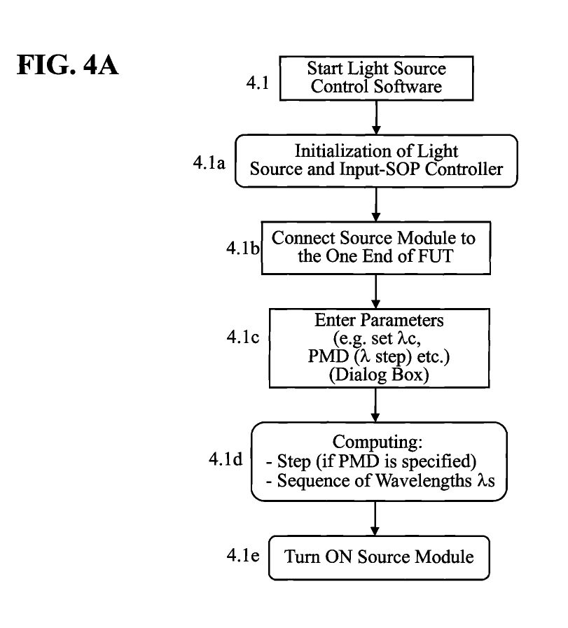

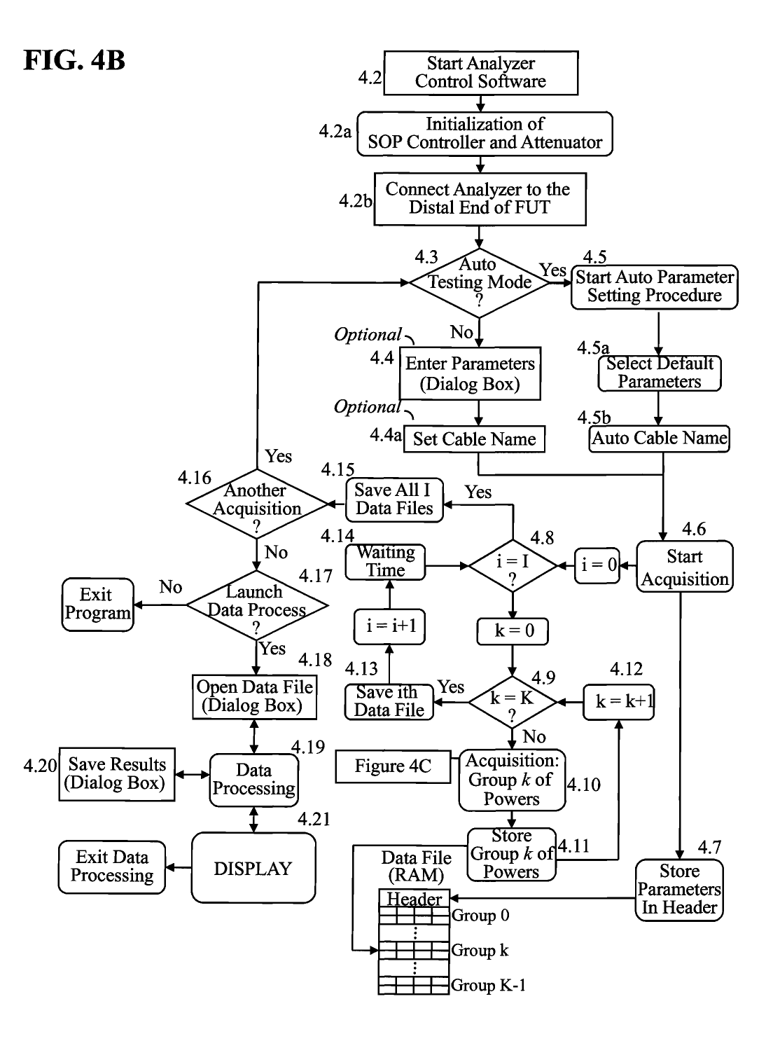

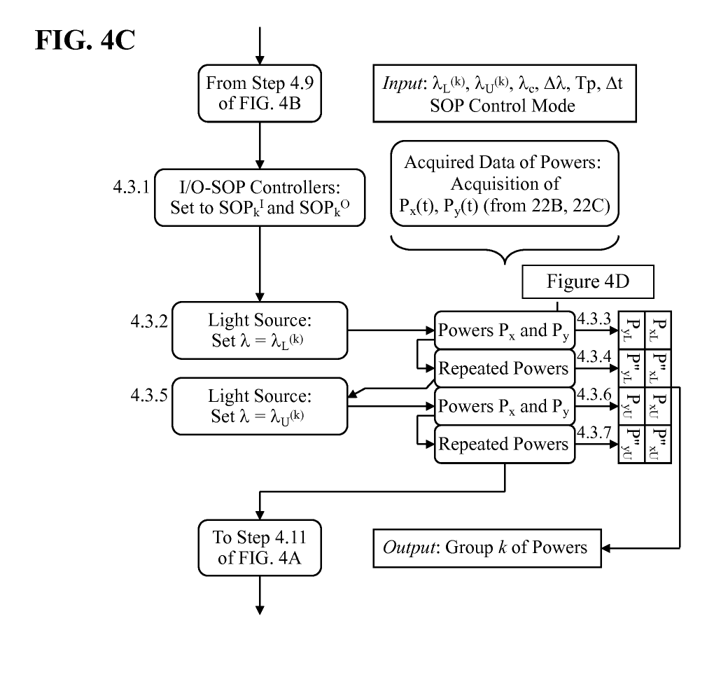

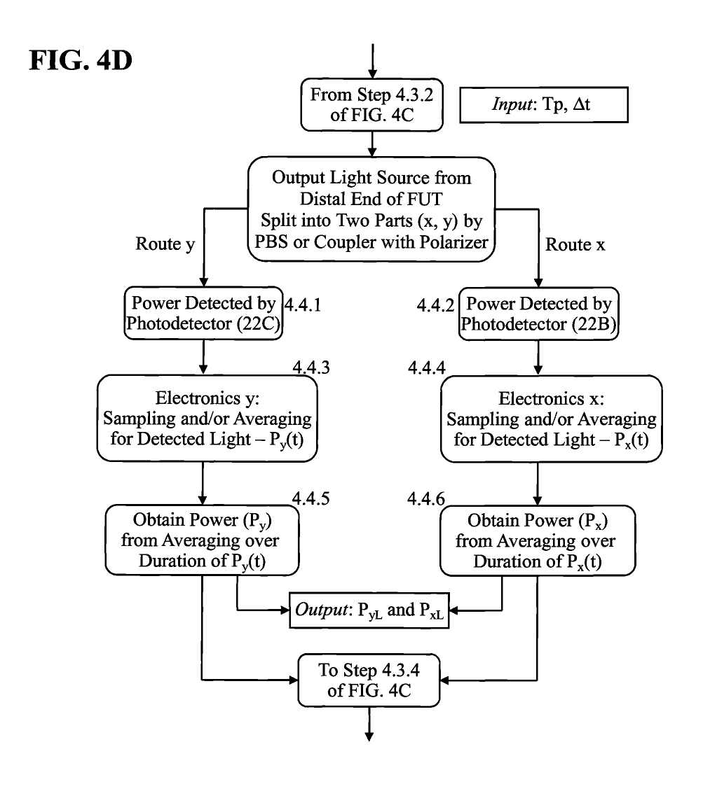

FIG. 4A is a flowchart illustrating operation of light source and input SOP controller of the two-ended PMD measurement instrument of FIGS. 1C and 1G;

FIG. 4B is a flowchart illustrating operation of an analyzer and detection unit of the two-ended PMD measurement instrument of FIGS. 1C and 1G;

FIG. 4C is a flowchart illustrating a group of power (data) acquisition step of the flowchart of FIG. 4B;

FIG. 4D is a flowchart illustrating a power (data) acquisition step of the flowchart of FIG. 4C;

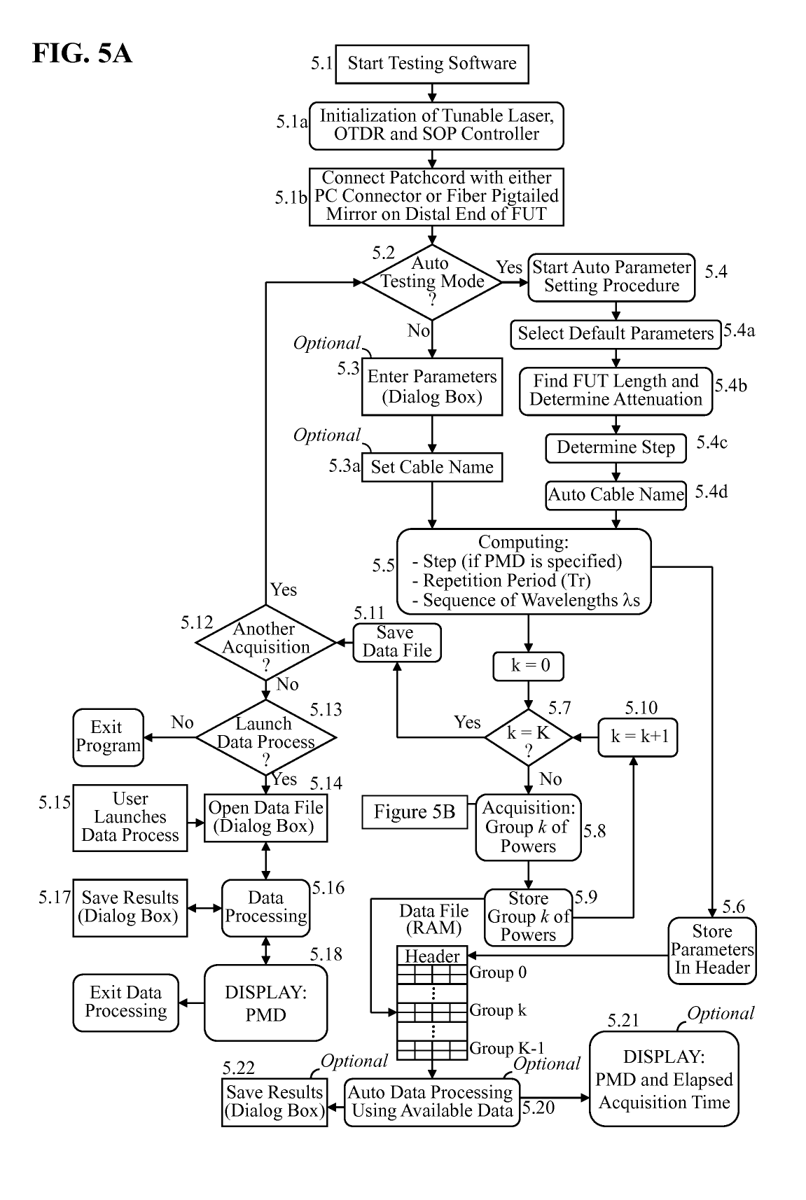

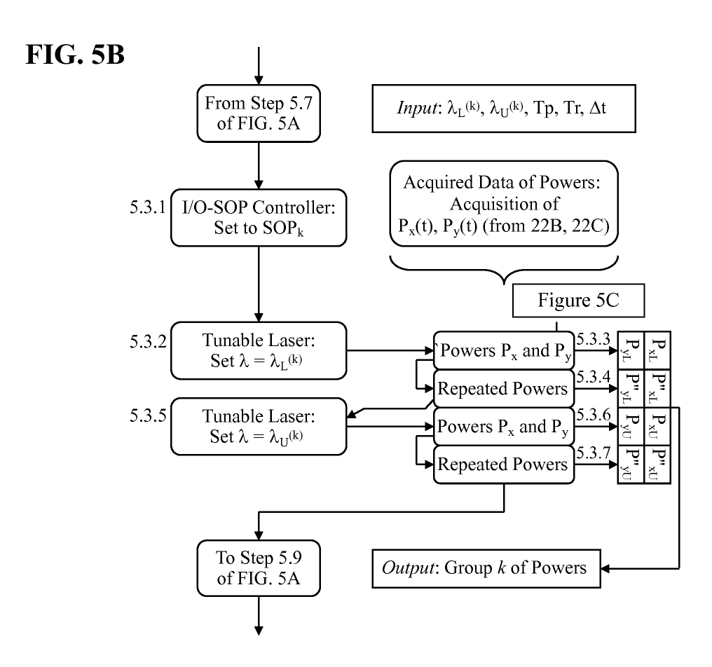

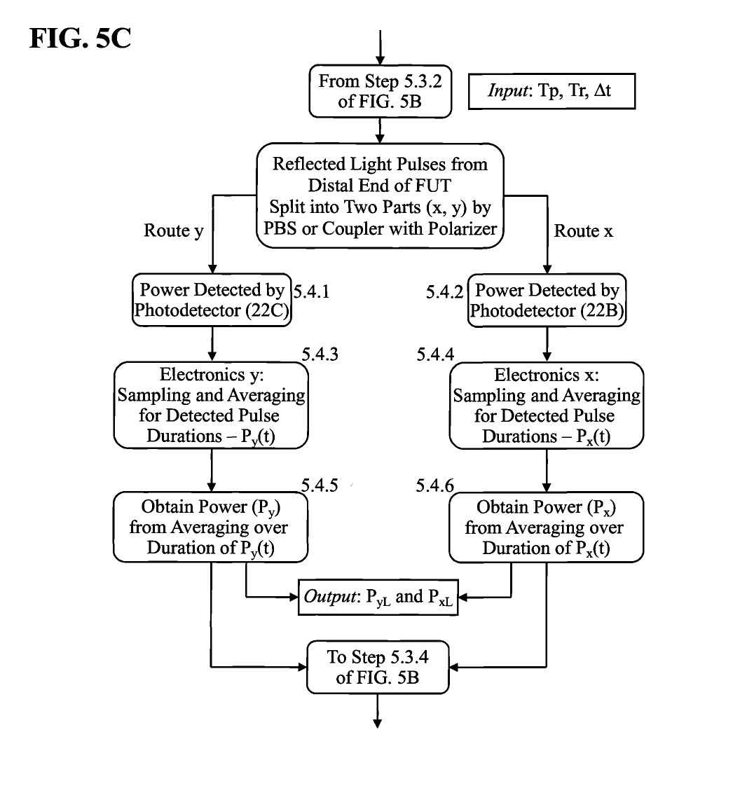

FIG. 5A illustrates sections of a flowchart illustrating operation of the single-ended PMD measurement of FIGS. 2C and 2G;

FIG. 5B is a flowchart illustrating a group of power (data) acquisition step of the flowchart of FIG. 5A;

FIG. 5C is a flowchart illustrating a power (data) acquisition step of the flowchart of FIG. 5B;

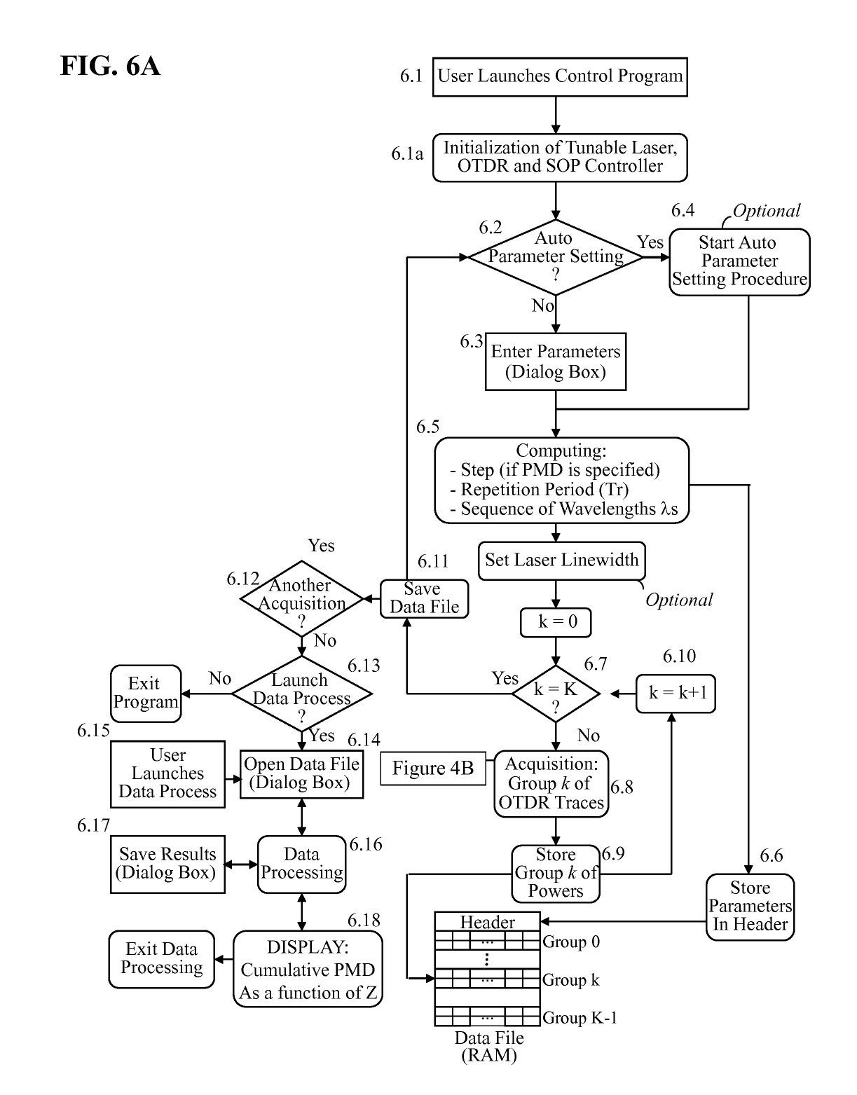

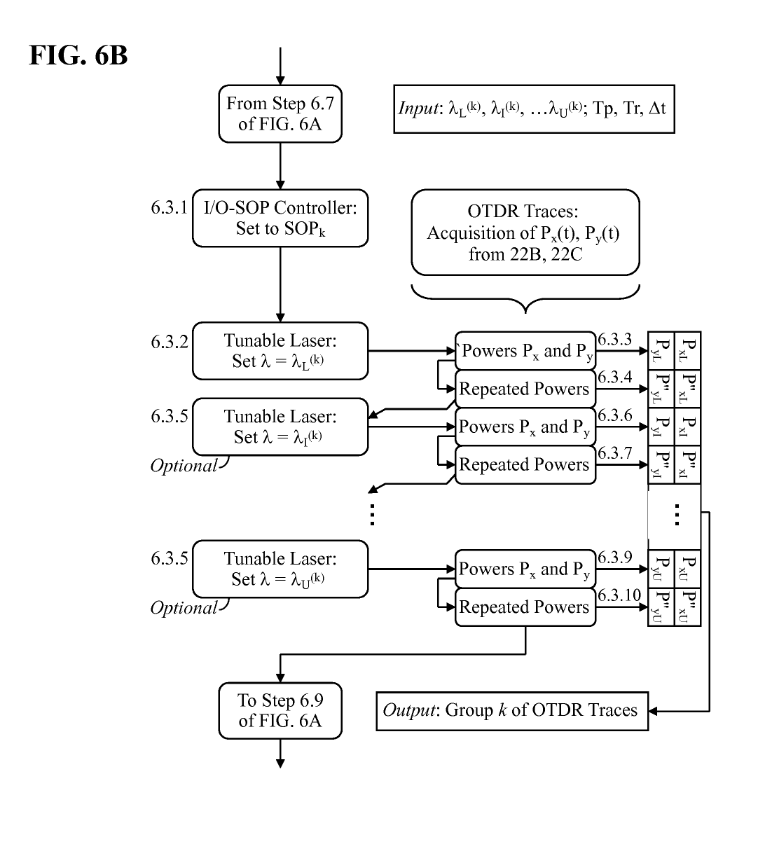

FIG. 6A is a flowchart illustrating operation of the POTDR of FIG. 3;

FIG. 6B is a flowchart illustrating a trace acquisition step of the flowchart of FIG. 6A;

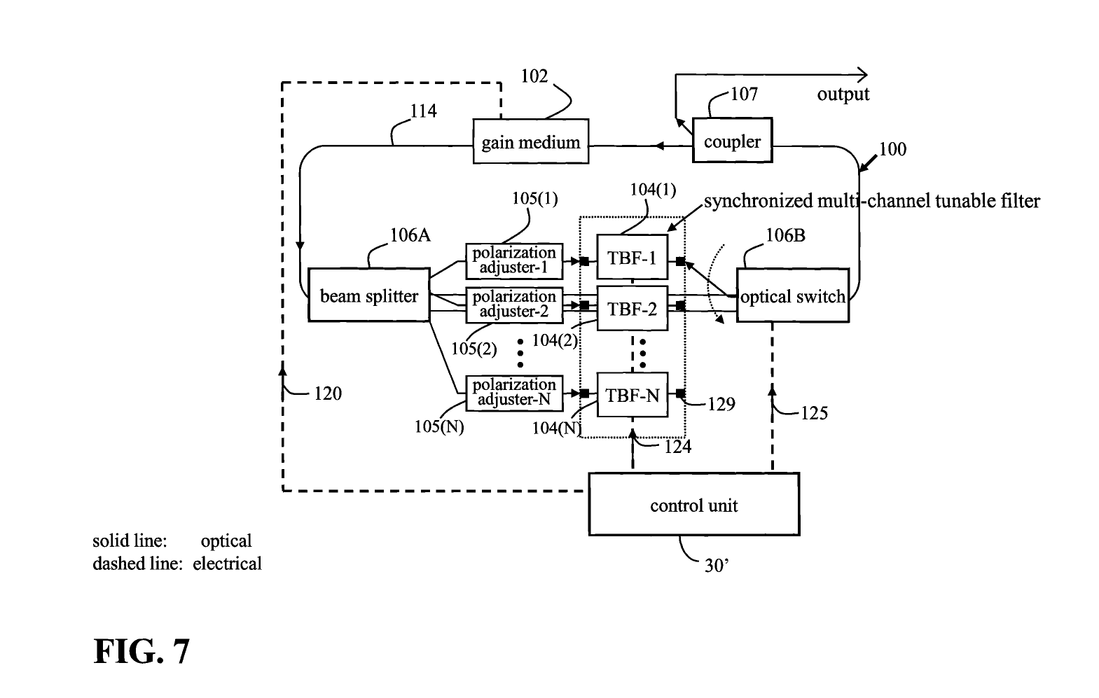

FIG. 7 is a schematic diagram illustrating a tunable modulated optical light source;

FIG. 7A is an example of a schematic diagram illustrating a SOA-based tunable modulated optical light source;

FIG. 8A is a schematic diagram illustrating a tunable pulsed light source with a delay that can be used for both single-ended overall PMD measurement and single-ended cumulative PMD measurement;

FIG. 8B is a schematic diagram illustrating another alternative tunable pulsed light source without a delay that can be used for single-ended overall PMD measurement;

FIG. 8C illustrates schematically another yet another alternative tunable pulsed light source that can be used for both single-ended overall PMD measurement and single-ended cumulative PMD measurement;

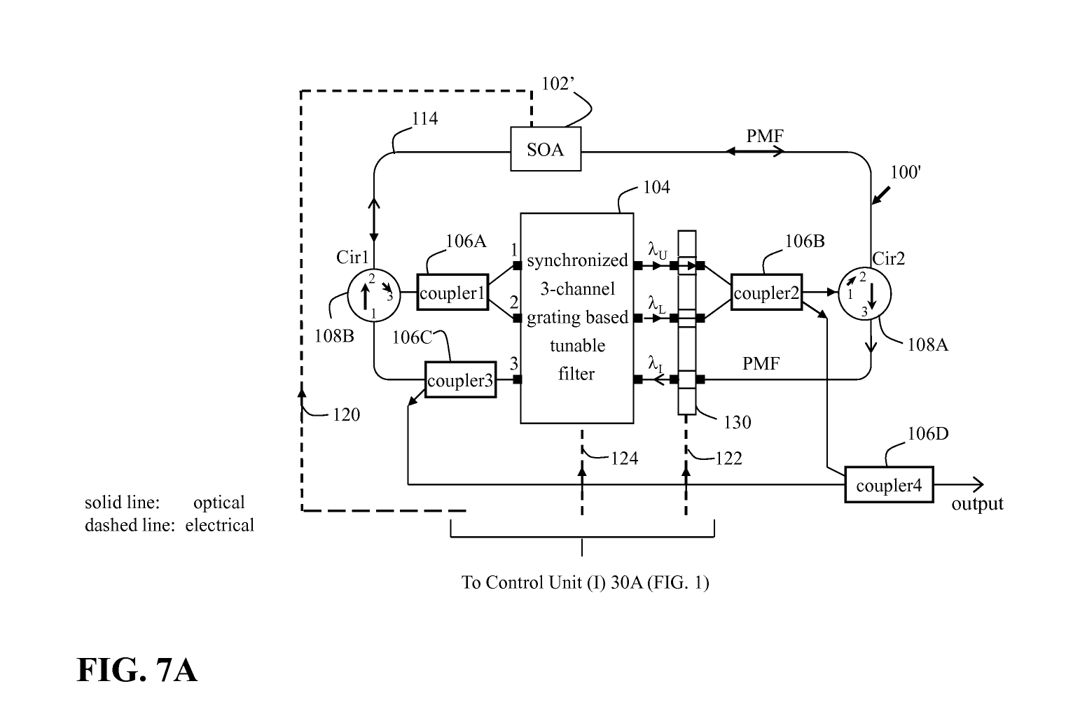

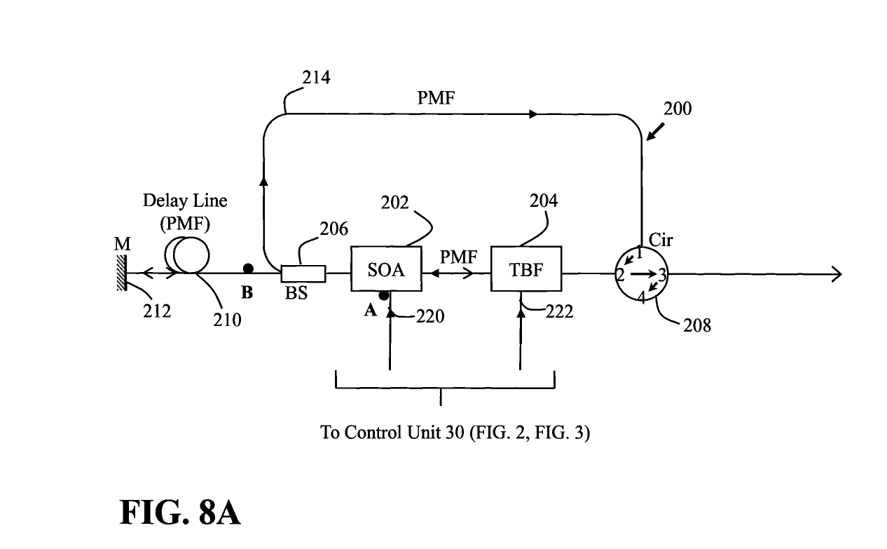

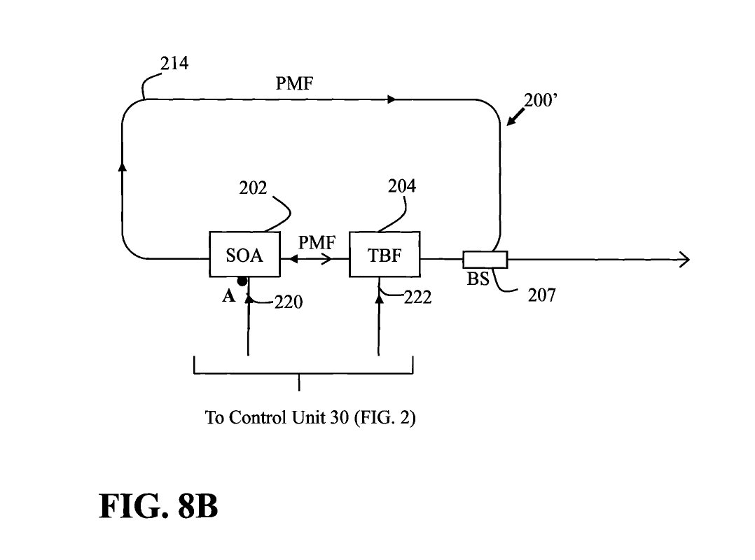

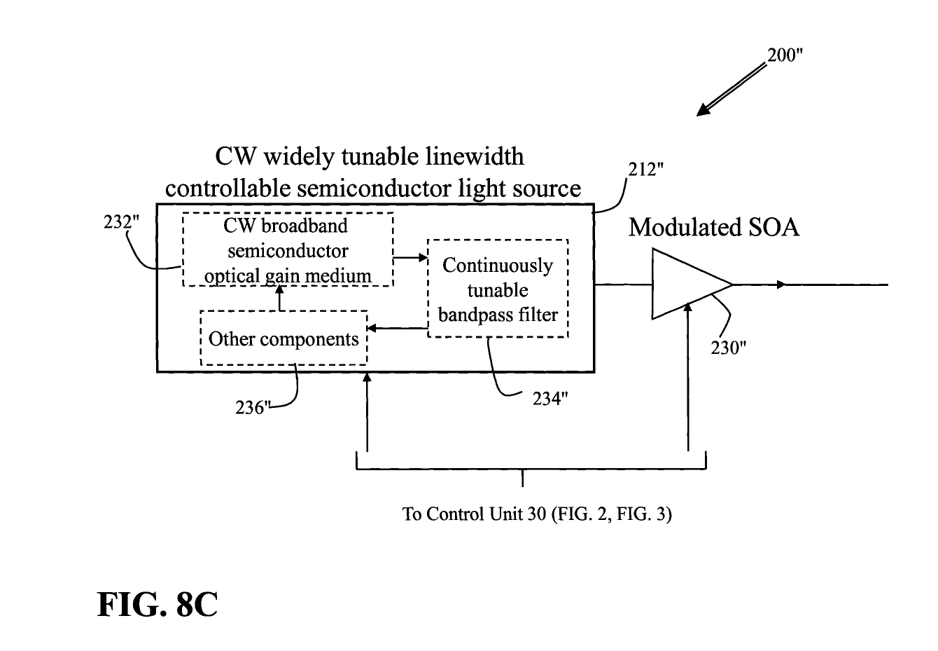

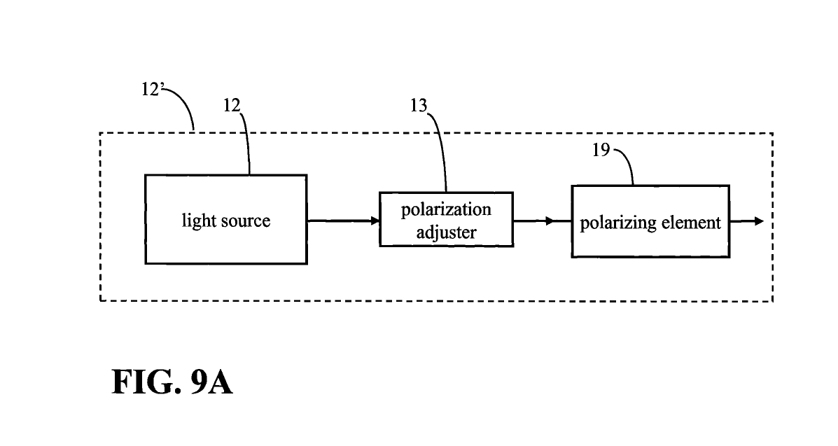

FIG. 9A is a simplified schematic diagram of a laser source that has been modified to ensure that the emitted light has a high degree of polarization (DOP);

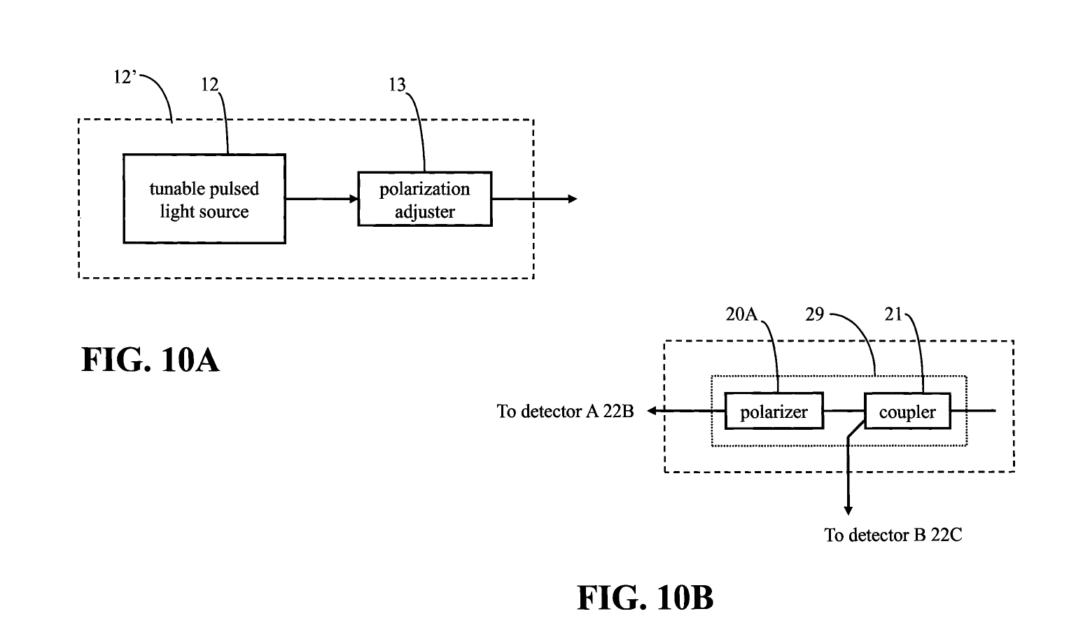

FIGS. 10A and 10B are schematic representations of alternative tunable pulsed light sources that can be used for both single-ended overall PMD measurement and single-ended cumulative PMD measurement.

### DESCRIPTION OF PREFERRED EMBODIMENTS

In the drawings, the same or similar components in the different Figures have the same reference numeral, where appropriate with a prime indicating a difference.

The various aspects of the present invention, and their respective implementations, are predicated upon the same underlying theory. Embodiments of these aspects can be advantageously used for two-ended measurement of PMD or wavelength-dependent DGD, for either a narrow optical channel or over a prescribed wide wavelength range, single-ended overall PMD measurement, single-ended cumulative PMD measurement, and other related variants.

In each of the preferred embodiments of this invention described hereinafter, there will usually be three main parts, namely (i) an optical source means, (ii) an analyzer-and-detection means and (iii) an analog and digital processing means, together with one or more control units. In so-called two-ended cases, the optical source means will be located at a proximal end of the FUT while the analyzer-and-detection means and, conveniently, the analog and digital processing means will be located at the distal end of the FUT. A first control unit at the proximal end of the FUT controls the optical source means and a second control unit at the distal end of the FUT controls the analyzer-and-detection means and the analog-and-digital signal processing means. In the majority of so-called single-ended cases, all of the components of the measuring instrument are at the proximal end of the FUT, and hence the two control units may be combined into a single control unit. (In so-called single-ended cases where the “overall PMD” is being measured, a highly-reflective element may be connected to the distal end of the FUT to improve the dynamic range of the measurement.)

Although each instrument embodying this invention usually will have the above-described three parts or sections, there will be many detailed differences in configuration according to the three different PMD-related measurements types, namely (i) two-ended overall wavelength-dependent DGD measurement (from which a PMD estimate may be extracted), (ii) single-ended overall PMD measurement and (iii) single-ended cumulative PMD measurement.

Thus, the optical source means will comprise an at least partially polarized light source, for example a tunable laser or a broadband source, and an input SOP controller for controlling the SOP of light from the light source before it is injected into the FUT. The analyzer-and-detection means may comprise, in addition to an output SOP controller, a polarizer and one detector, or a PBS and two detectors, or a coupler and a polarizer with two detectors, and so on. Where the light source is broadband, the analyzer-and-detection means may also comprise a tunable filter for selecting the optical frequency. (Alternatively, but less advantageously, the light source could comprise such a tunable filter.) The analog-and-digital processing means may comprise a data acquisition unit, a sampling and averaging unit and a data processor unit, analog-to-digital conversion being carried out in the sampling and averaging unit.

Using the single-ended measurement method, an overall PMD can be estimated by analyzing backreflected light from a strong localized reflection at the distal end of FUT (e.g. Fresnel reflection, a Bragg reflector, etc.), so a long pulse may advantageously be used, since virtually all of the backreflected light arises from the localized reflection and not from Rayleigh backscattering distributed along the pulse length. This estimation is generally improved by using a plurality of different closely-spaced wavelength pairs for the measurement. (The meaning of closely-spaced in this specification will be explained hereinafter). To use the single-ended measurement method to measure cumulative PMD, however, OTDR traces as a function of fiber length must be analyzed, so it may be preferable to use a short pulse in order to obtain clear POTDR traces that do not suffer undue spatial depolarization due to the PMD-induced evolution of the SOP of the “leading edge” of the pulse with respect to its “trailing edge”.

In addition, typically, there may be an approximately “continuous” increase in the cumulative PMD “curve” as a function of fiber length required to be measured for one acquisition. Since, for a given closely-spaced wavelength separation, there is a maximum PMD value (due to saturation) and a minimum PMD value (due to detection sensitivity) that can be measured, it may hence also be preferred to inject light pulses having two or more (e.g. three or four) closely spaced wavelengths. In this way, measurements taken with different closely-spaced wavelength spacings can be “stitched” together in the processing, and hence the effective difference between the measurable minimum and maximum PMD values can be significantly enhanced.

For a two-ended PMD measurement the analyzer-and-detection means and the analog and digital processing means must be configured to measure two or more closely spaced wavelengths. For example, where the optical source at the proximal end emits broadband polarized light, this could be effected using narrow-band optical filtering at the analyzer-and-detection means. Alternatively, the source at the proximal end may be a laser that is able to set or modulate its optical frequency to produce two or more closely spaced wavelengths at different times, in which case the analyzer-and-detection means does not necessarily comprise optical filtering.

Preferred embodiments of the three main aspects for PMD measurement, including methods and instrument configurations for two-ended PMD measurement, single-ended overall PMD measurement and single-ended cumulative PMD measurement according to the invention, and modifications, alternatives and substitutions thereto, will now be described with reference to FIGS. 1 to 3C.

### Two-Ended PMD Measurement

In the following description for the two-ended PMD measurement, the term “modulated optical pulse” is used to refer to propagating light, which, over a defined time interval, is differentiated from at least some other pulses by one or more of a characteristic wavelength, characteristic average power, characteristic pulse duration, characteristic superposed amplitude or phase modulation at a frequency much greater than the reciprocal of the pulse duration, characteristic extinction ratio following its duration, characteristic duration of sampling of the said light in the acquisition process, or any other measurable distinguishing property.

In a first preferred embodiment of this present invention illustrated in FIG. 1, test/measurement apparatus for two-ended measurement of DGD/PMD comprises an optical source means 42 situated at or adjacent the proximal end of FUT 18 and connected thereto by a connector 16A and analyzer-and-detection means 44 situated at or adjacent the distal end of the FUT 18 and connected thereto by a connector 16B. The optical source means 42 comprises a light source 12 and an input SOP controller means 14A (conveniently referred to as an I-SOP controller or scrambler means), which controls the SOP of light from the light source 12 before injecting it into the FUT 18 via connector 16A.

In the event that the degree of polarization (DOP) of the light source 12 is not high, the DOP may be increased by inserting a polarizing element 19 (e.g. polarizer, polarization beam splitter, etc.) into the optical path downstream from the light source 12. However, if polarization maintaining fiber (PMF) is not used between the light source 12 and the polarizing element 19, it may be necessary to add an additional polarization adjuster 13 (generally a “factory-set” polarization controller), as shown in FIG. 9A, in order to approximately maximize the power transmitted through the polarizing element 19. It should also be noted that the polarizing element 19 may be the same as the polarizing element (20,20A, 20C) for particular embodiments of one-sided measurement, as shown for instance in FIGS. 2B-G and 3A and 3B.

A first (input) control unit 30A controls the wavelength of the tunable laser source 12A and the setting of the input I-SOP controller 14A, specifically to scramble the SOP of the light from light source 12 before it is injected into the FUT 18.

The analyzer-and-detection means 44 comprises an output SOP controller (A-SOP) 14B (conveniently referred to as an A-SOP controller or scrambler means), followed by a polarization discriminator 20, and detection means 22. If the detection means 22 is not able to measure high light power correctly, power controller means (not shown), for example an optical attenuator, may be interposed to attenuate the light extracted from the FUT 18 before it is applied to the detection means 22. The purpose of the optical attenuator is to ensure that the light level at the distal end is not so high as to potentially “saturate” or render non-linear the detection means 22. Such may be the case if, for instance, the measurement is carried out over a short optical fiber link, wherein the overall attenuation induced by the fiber is small. For long links, the optical attenuator will normally be set to induce minimum attenuation.

The analog-and-digital processing unit 40 comprises a sampling-and-averaging unit 32 and a data processor means 34, optionally with a display means 36 for displaying the results. The components of the analyzer-and-detection unit 44 (except for the polarization discriminator) and the analog-and-digital signal processing unit 40 are controlled by a second, output control unit 30B.

Under the coordination of control unit 30B, the sampling and/or averaging circuitry 32, in known manner, uses an internal analog-to-digital converter to sample the corresponding electrical signals from the detectors 22B and 22C as a function of time (as shown, for example, in FIGS. 1C, 1D, 1G), and the sampled signal is time-averaged over a portion of its duration to provide a corresponding digital level. This portion is chosen so as to avoid transient effects and/or bandwidth limiting effects in the detected power, polarization, and/or wavelength due to the light source means 12, the I-SOP controller 14A, the analyzing means comprising the A-SOP controller means 14B and the polarization discriminator means 20, and/or any distortion in the (pulsed) signal arising from bandwidth limitations of the analog electronics.

The resulting averaged powers are used by data processor 34 to derive the DGD at a particular wavelength or PMD value over a prescribed wavelength range of the FUT 18, as will be described in more detail hereinafter according to the particular aspect of the invention.

Various configurations of the two-ended instrument of FIG. 1 are illustrated in FIGS. 1B to 1J and will now be described briefly. The instrument configurations depicted in FIGS. 1 to 1H have in common that they use a tunable laser source whereas those depicted in FIGS. 1I to 1K use a broadband source.

Thus, in each of the “two ended” instruments illustrated in FIGS. 1 to 1H, the light source 12A comprises a tunable optical modulated laser source 12A whose output is coupled to either a polarization maintaining fiber (PMF) or singlemode fiber (SMF), as appropriate, for injecting modulated optical pulses into the fiber-under-test (FUT) 18 via the (input) state of polarization (I-SOP) controller means 14A and input connector 16A. The output light extracted from the FUT 18 is analyzed by the polarization discriminator 20 and the analyzed light is measured during a time period during which light from the light source means 12 is detected, successively, at each of two different wavelengths, λ_{L}^{(k)} and λ_{U}^{(k)}, that are closely-spaced relative to each other.

The main differences between the different configurations lie in the analyzer-and-detection means 44. Thus, in the analyzer-and-detection means 44 of the instrument shown in FIG. 1B, the polarization discriminator comprises a linear polarizer 20A and the detection means comprises a single detector 22A.

FIG. 1C shows an instrument similar to that shown in FIG. 1B but which differs in that it has two detectors 22B and 22C and a coupler 21 interposed between the A-SOP controller 14B and the polarization discriminator (polarizer) 20A. Detector 22B is connected to the polarizer 20A and measures analyzed light therefrom and detector 22C is connected directly to the coupler 21 and measures light that is proportional to a total power of the light extracted from the FUT 18. Thus, the SOP of the extracted light is transformed by the A-SOP controller or scrambler 14B, following which the light is split into two parts by coupler 21. The first detector 22B connected to one of the two outputs of the coupler 21 via the polarizer detects one of the polarization components and the second detector 22C connected to the other output of the coupler 21 measures a power that is proportional to a total output light power from FUT. The light may be approximately simultaneously detected by detectors 22B and 22C. It should be noted, however, such that truly simultaneous detection of the analyzed light with two detectors of 22B and 22C may not be necessary; it may be detected instead at slightly different times.

The instrument illustrated in FIG. 1D is similar to that illustrated in FIG. 1C but differs in that the polarizer 20A and coupler 21 are transposed, the two detectors 22B and 22C being connected to respective outputs of the coupler 21 to measure two repeated powers.

The instrument shown in FIG. 1E is similar to that shown in FIG. 1C in that it comprises a coupler 21 and a polarizer 20A, but differs in that it has only one detector 22A. An optical switch 23 controlled by control unit 30B connects the input of detector 22A alternatively to the output of the coupler 21 and the output of polarizer 20A to measure, respectively, the analyzed light and total output light power from the FUT 18.

The instrument shown in FIG. 1F is similar to that shown in FIG. 1E in that it uses a single detector 22A and an optical switch 23, but with a PBS 20C instead of a linear polarizer. The control unit 30B causes the switch 23 to connect the detector 22A alternatively to the respective output ports of the PBS 20C to measure the analyzed light from each port.

Because the optical switch 23 is used to route the output light from two optical paths from the coupler 21 and polarizer 20A (FIG. 1E), or from the PBS 20C (FIG. 1F), into the same detector, the light from the two different optical paths may be detected at different times. This would allow the use of only one detector (and associated electronics) while maintaining many of the advantages associated with the use of two detectors. Of course, the cost reduction associated with the use of only one detector would be largely counteracted by the increased cost of introducing the optical switch, and there would also be a measurement time penalty.

The instrument shown in FIG. 1G is similar to that shown in FIG. 1F but differs in that the switch is omitted and the two detectors 22B and 22C are connected to respective output ports of the PBS 20C, each to measure analyzed light therefrom. The SOP of the light from the distal end of the FUT 18 is transformed by the A-SOP controller or scrambler 14B, following which the light is decomposed by the PBS 20C into two components having orthogonal SOPs, typically linear SOPs at 0- and 90-degree relative orientations. The first detector 22B is connected to one of the two outputs of the PBS 20C to receive one of these orthogonal components and the other output (with respect to light from the FUT 18) is connected to the second detector B 22C to receive the other orthogonal component. Once suitably calibrated to take into account the relative detector efficiencies, wavelength dependence, etc., as will be described hereinafter, the sum of the detected powers from detectors 22B and 22C, respectively, is proportional to the total incident (i.e. non-analyzed) power (often referred to as the Stokes parameter S₀). The light may be approximately simultaneously detected by detectors 22B and 22C.

It should be appreciated that, where the polarization discriminator 20 comprises a polarizer 20A and coupler 21 (FIG. 1C), the detector 22C connected to the coupler 21 receives light that is not polarization-dependent.

The instrument illustrated in FIG. 1H is similar to that shown in FIG. 1B but differs in that the analyzer-and-detection means 44 comprises a polarimeter 45 having its input connected to the FUT 18 via connector 16B and its output connected to sampling and averaging unit 32. The polarimeter 45 is controlled by control unit 30B to perform the analysis and detection of the light received from the FUT 18.

Preferred embodiments of the invention which use, instead of a tunable laser source 12A, a broadband source 12B that has a very wide spectrum (well suited for determining the PMD value without initially determining the DGD at a plurality of wavelengths), or a tunable broadband source that has a moderately wide spectrum whose center wavelength is tunable (well suited for determining the DGD at a particular desired DWDM wavelength) will now be described with reference to FIGS. 1I, 1J and 1K. The measurement/test apparatus illustrated in FIG. 1I is similar to that described with reference to and as shown in FIG. 1B, but differs in that its optical source means 42 comprises a polarized broadband light source 12B instead of a tunable laser source and its analyzer-and-detection means 44 differs from that shown in FIG. 1B because it comprises a narrow-band tunable filter 27 interposed between the polarizer 20A and the detector 22A. The tunable filter 27 is controlled by the control unit 30B.

It should be appreciated that the tunable filter 27 could alternatively be placed anywhere in the optical path between the output of the FUT 16B and the detector 22A, while remaining in close proximity to control unit 30B and is not limited to being placed between the polarizer 20A and the detector 22B as shown in FIG. 1I. Indeed, more generally the tunable filter 27 could be placed anywhere between the broadband source 12B and the detector 22A. However, placing the filter in the optical source means 42 at the proximal end of the FUT 18 may lead to control and synchronization difficulties, as communication between the tunable filter 27 at the proximal end and the control unit 30B at the distal end of the FUT would be difficult.

In the embodiments of FIG. 1I to 1K, if the inherent DOP of the broadband source is not very high, “highly-polarized” broadband light may be obtained by adjusting incident SOP of light from broadband light source 12B by passing the light through a polarizer before injecting it into the FUT 18. (See FIG. 9A). In this case, an additional polarization adjuster (i.e. polarization controller) and a polarizer (See FIGS. 10A, 10B and 2D) would be inserted between broadband light source 12B and I-SOP controller 14A. The polarization controller would adjust the input SOP of light to obtain an approximately maximum output power of light from the polarizer.

The instrument illustrated in FIG. 1J is similar to that shown in FIG. 1I but differs in that the tunable filter 27 is replaced by a spectrometer means or multi-channel filter means, specifically a dispersion element 27′, for example a grating-based wavelength separator, to separate the different wavelengths of light as a function of angle. The single detector is replaced by detection means for detecting light powers at these wavelengths approximately simultaneously, for example, a multi-channel detector array 22D or similar means. Alternatively, a detector array may be replaced by several fiber pigtailed photodetectors that may be connected to a fiber array to detect light at different spatial positions, or simply to launch light at different spatial positions having different optical wavelengths into different photodetectors. Although this design has a higher cost, it can measure DGD or PMD rapidly.

In another embodiment, shown in FIG. 1K, the instrument is similar to that shown in FIG. 1I, but differs in that the tunable filter 27 of FIG. 1I is replaced by two synchronously-controlled narrow-band tunable filters 27A, 27B, conveniently a two-channel grating-based scanning monochromator 27, and the polarizer 20A of FIG. 1I is replaced by a PBS 20C. The two orthogonal analyzed outputs from the PBS 20C are conveyed (via optical fiber) to respective ones of the two channels of the scanning monochromator. Detectors 22B, 22C, detect light, substantially simultaneously, from respective ones of the two outputs of the two-channel scanning monochromator, resulting in “polarization-diverse” detection as a function of wavelength. (An example of an optical spectrum analyzer based on such a polarization-diverse two-channel scanning monochromator design is described in commonly-owned patent He et al, U.S. Pat. No. 6,636,306.) The analog-and-digital signal processing unit 40 then can process this data to extract DGD and PMD information.

Once suitably calibrated to take into account the relative detector efficiencies, wavelength dependence, etc., as will be described hereinafter, the sum of the detected powers from detectors 22B and 22C, respectively, is proportional to the total incident (i.e. non-analyzed) power (often referred to as the Stokes parameter S₀) within the monochromator 27 bandwidth.

For the embodiments where the tunable filter 27 is used, the tunable filter 27 is operated to allow the selection and subsequent detection of each of the wavelengths corresponding to the groups comprising the wavelength pair and the selected filtered light corresponding to the two or more wavelengths being subsequently detected by respective two (or more) detectors, e.g. detectors 22B and 22C. It should be noted that the tunable filter 27 can be a single channel filter that is operated under a continuously sweeping mode, however, it can also be operated under a step wavelength selection mode where each step correspondence one selected wavelength is used to take two detected powers (i.e. repeated powers). It should be also noted that that tunable filter can be designed as a spectrometer, for example as shown in FIG. 1J, enabling powers at different wavelengths to be measured contemporaneously. Also note that different polarization components may be detected by different detectors, as shown in FIG. 1K, or the same detector but at different time by using appropriate polarization controlling means.

Preferably, in the “two-ended” measurement instruments shown in FIGS. 1 to 1J there is no “upstream” communication between the control unit 30B at the distal end of the FUT 18 and the control unit 30A at the proximal end. For the embodiments shown in FIGS. 1 to 1H, the control unit 30B comprises software or firmware that allows it to determine, from information encoded onto the optical signal by the optical source means 42, conveniently under the control of control unit 30A, as to whether a particular detected modulated optical pulse extracted from the FUT 18 corresponds to an uppermost, lowermost, or, where applicable, intermediate closely-spaced wavelength. If a “widely broadband” source means is employed in the embodiments shown in FIGS. 1I to 1K, there is advantageously no need for the control unit 30B to receive wavelength information from the optical source means, as all wavelength selection is performed at the same end of the FUT as the control unit 30B. If a tunable “moderately broadband” source means is employed in the embodiments shown in FIGS. 1I to 1K, suitable for measuring the DGD of a particular DWDM channel, there is a need to initially tune (“set”) the source means to encompass all or most of the passband of the desired DWDM channel, which may require communications between operators at the two corresponding sites.

The preferred embodiment described hereinbefore is common to principal aspects of this invention. However, the details of the preferred embodiments, including details of their operation, corresponding to each of these principal aspects will be described in more detail in the next sub-sections.

In the description that follows, the term “modulated optical pulse” is used to refer to propagating light, which, over a defined time interval, is differentiated from at least some other pulses by one or more of a characteristic wavelength, characteristic average power, characteristic pulse duration, characteristic superposed amplitude or phase modulation at a frequency much greater than the reciprocal of the pulse duration, characteristic extinction ratio following its duration, characteristic duration of sampling of the said light in the acquisition process, or any other measurable distinguishing property. The meaning of “modulated optical pulse” will become clearer in the context of the following more detailed description.

### Measurement of DGD at a Particular Wavelength

In a narrow DWDM channel, it is frequently not practical to measure the DGD at more than one wavelengths (λ_{mid}) within the channel (or at least not more than a very limited number of wavelengths), since the optical-frequency spacing of the closely-spaced wavelengths may be a significant fraction of the useable optical passband of the DWDM channel and, consequently, measurement at another midpoint wavelength may cause one of the two closely-spaced wavelengths to experience excessive attenuation, polarization-dependent loss, and other deleterious effects that may render the measurement unreliable or impractical. (As will be described in more detail hereinafter, the use of a very small optical-frequency spacing may not suffice to permit the measurement of a small DGD value.) In general, however, when the PMD of the FUT is relatively small, for example less than 0.2-0.5 ps, the DGD within a small in-channel wavelength range (such as 30 GHz), may exhibit a small variation, and it is often still desirable to obtain DGD at each wavelength so as to obtain mean DGD or rms DGD within this small wavelength range of the channel passband.

In addition, the determination of the DGD as a function of optical frequency, for at least two optical frequencies (“midpoint wavelengths”), within an optical channel enables an estimation of at least one component of the second-order PMD, i.e. the component proportional to d(DGD(u))/du. As known in the prior art (see for instance Foschini et al, Journal of Lightwave Technology, vol. 17(9), pp 1560-1565 (1999), in particular Eq. 8) for a strongly mode-coupled FUT, such as is the case with almost all long single-mode fibers used in telecommunications, this measurement of this second-order PMD component provides an independent (i.e. uncorrelated) additional estimate of the DGD. If this measurement is repeated for a plurality of DWDM channels, for instance, these additional DGD estimates can be used to improve the overall uncertainty of the PMD value determined by the rms or mean of all the DGD estimates, whether derived directly, or indirectly via the second-order PMD. It should also be noted that the measurement of DGD at a particular wavelength is not limited to “in-channel” applications such as testing optical links through DWDM channels.

Note that, for DGD measurement in a “dedicated” DWDM channel, i.e., a measurement that is always to be undertaken at approximately the same particular wavelength, it is not necessary that the optical source means 12 be widely tunable or very broadband, but only that it be either:
a “moderately” tunable coherent light source capable of emitting coherent light at each of two different closely-spaced wavelengths centered about the aforesaid “particular wavelength”, for the case where there is no narrowband optical filtering in the analyzing and detecting means;
a “moderately” broadband source capable of emitting at least partially polarized light having a spectral width encompassing at least the “closely-spaced wavelengths” separation, and preferably all or most of the bandpass of the “dedicated” DWDM channel-under-test, for the case where the analyzing and detecting means comprises narrow-band optical filtering.

Thus, depending upon the particular measurement embodiment, the optical source means 12 should be one of a tunable coherent source (e.g., a laser), a “widely” broadband source (for instance, having a spectral width encompassing all desired DWDM channels to be measured, for instance), or a “hybrid” thereof, for instance, a tunable “moderately” broadband source. In this latter case, the source should be at least sufficiently broadband to encompass all or most of the DWDM channel passband, thereby clarifying the meaning of “moderately”, and this broadband “spectral slice” may be tuned or “set” to be centered upon any one of a number of other DWDM channel wavelengths, for instance in the telecommunications C and/or L bands. A more detailed description of the operation of preferred embodiments for the tunable light source, widely broadband light source, or tunable moderately broadband source means will be given in a later sub-section.

As described in the “Background” section hereinbefore, the DGD can vary with time and/or environmental conditions. For many measurement applications, the speed (“update rate”) of the measurement is not critical. Consequently, it is advantageous for cost reasons to use inexpensive polarization scramblers for the Input-SOP controller 14A and the analyzing means. An example of a low-cost SOP scrambler that may be suitable for both of the I-SOP and A-SOP controllers 14A and 14B is described in co-owned U.S. patent application Ser. No. 12/292,778 published as 2009-0135409 on 28 May 2009, the contents of which are incorporated herein by reference.

The actual SOP of light exiting the input I-SOP controller 14A is, in general, unknown, but undergoes “continuous scanning”, i.e. is varied slightly between groups of closely-spaced wavelengths, such that over a sufficiently long time, normally corresponding to the minimum time for a reliable DGD measurement, the SOPs will cover the Poincaré sphere approximately uniformly.

The output A-SOP controller 14B, located at the distal end of the FUT 18, may also causes the SOP of the light exiting the FUT 18 to be varied slowly in a similar manner to the input I-SOP controller 14A, although in general the respective rates of variation would not be the same and the SOPs exiting either the I-SOP controller 14A or the A-SOP controller 14B are uncorrelated. Alternatively, the output A-SOP controller 14B may vary SOP in a discrete and random fashion, since there are normally no synchronization difficulties with the co-located control unit 30B.

More specifically, for a particular measurement sequence k, the control unit 30B causes the light signal, analyzed by the intervening polarization discriminator, such as a polarization beam splitter (PBS) or polarizer, to be measured during a portion of time during which light from the light source means 12/12A is detected, successively, at each of two different wavelengths, λ_{L}^{(k)} and λ_{U}^{(k)}, that are closely-spaced relative to each other, during which portion of time the SOPs exiting the I-SOP controller 14A and A-SOP controller 14B, respectively, are approximately constant and form a k-th SOP couple (I-SOP (k), A-SOP (k)). (Preferably, the aforementioned portion is less than 50% of the “physical” pulse length, for reasons that will be explained further below.) The midpoint wavelength of the pair of modulated light pulses is defined as the average of the actual optical frequencies of the modulated light pulses, which to a very high degree of approximation can be expressed in terms of wavelength as λₘᵢₙ^{(k)}(λ_{L}^{(k)}+λ_{U}^{(k)})/2. (The labels L and U refer, for convenience and ease of understanding, to “lowermost” and “uppermost” with respect to the midpoint wavelength λₘᵢₙ^{(k)} and more accurately the midpoint wavelength is expressed as

$${λ}_{mid}^{( k )} = \frac{2 {λ}_{L}^{( k )} \cdot {λ}_{U}^{( k )}}{{λ}_{L}^{( k )} + {λ}_{U}^{( k )}} . )$$

The measured analyzed light signal is converted to an electrical signal by the sampling and averaging means 32 and subsequently digitized before application to the data processor 34 for subsequent processing thereby.

During the transition from one closely-spaced wavelength to the other, the light from the light source means 12A is briefly extinguished, say for about 40 μs, a period that is much shorter than the typical reaction period of DWDM channel equalizers found in many optical networks. The precise period of this extinction is used by the control unit 30B to identify whether the subsequent pulse corresponds to an uppermost or lowermost wavelength.

The measurement sequence described above is repeated for K different groups, each group corresponding to a slightly different I-SOP and A-SOP. In practice, for the continuous SOP scanning approach over the aforesaid “sufficiently long time”, K should be greater than 1000 to obtain satisfactory results.

The time period corresponding to light emission at each closely-spaced wavelength is not particularly critical, but clearly a longer duration will lead to a longer overall measurement time for this method. A good compromise between measurement time and limitations on the optical source wavelength switching speeds has been found to be a period of about 1 ms.

If the expected DGD to be measured is not roughly known, it is possible that the optical frequency difference of the closely-spaced wavelength pairs is, for instance, too large to permit accurate measurement of high DGD values, or alternatively, too small to permit measurement of a low DGD values. In such a case, it may be desirable to perform a preliminary rough DGD estimation using this method using only a limited number of K values. (It should be noted that, with the continuous SOP scanning approach, K necessarily must still be relatively large, e.g. >500, for a rough measurement, whereas if the alternative “macroscopic-step SOP selection” approach is used, as described hereinafter, K may be a much smaller value, e.g. approximately 10.) Then, depending on the result, the spacing of the closely-spaced wavelengths may be adjusted, while maintaining the midpoint wavelength at the same value. However, as mentioned above, in a narrow DWDM channel, which may, for instance, only have a useable passband width of approximately 35 GHz, it is not always possible to increase the wavelength spacing.

An alternate approach for “adapting” the optical frequency difference between the closely-spaced wavelengths is to use more than two closely-spaced wavelengths in each group, the wavelength spacing between pairs of wavelengths being unequal. If, as described above, the preliminary DGD estimation indicates that the wavelength spacing should be different, one need only slightly shift the midpoint wavelength corresponding to the “optimal” closely-spaced wavelength pair to the midpoint wavelength corresponding to the initial closely-spaced wavelength pair. Such an approach is well adapted to the preferred light source means 12 whose embodiment will be described in more detail hereinafter.

Advantageously, in order to estimate, and partially compensate for, the contribution of noise in the measurements, “repeated measurements” are taken for each group at the same two closely-spaced wavelengths, these repeated measurements being in principle substantially perfectly correlated to the “original” measurements, in the absence of noise (i.e. identical if taken under the same polarization analysis conditions, or perfectly complementary if taken under orthogonal polarization conditions, e.g. via the two outputs of a polarization beam splitter). In practice, such noise may arise from any combination of ASE noise (from intervening optical amplifiers in the fiber link), polarization noise (caused by swaying aerial cables, for instance), optical source power fluctuations, uncorrelated electronic noise, etc. The method by which this technique is used to improve the measurement sensitivity will be described in more detail hereinafter.

It should be noted, however, that it is convenient to not actually transmit distinct “physical” repeated pulses in the preferred embodiment, but rather to perform the functional equivalent in the acquisition process by sampling the “physical pulse” (corresponding to the period during which the laser emits at a particular wavelength) during a different portion of time than the portion during which the “initial” measurement was taken. Consequently, in a preferred embodiment, each “physical pulse” comprises two “optical modulated pulses”.

The computational method by which the data thus acquired can be converted into a reliable DGD measurement, including in the presence of significant ASE noise, will be described in more detail hereinafter.

### RMS or Mean DGD Measurement Using Repeated DGD(λ) Measurements

By repeatedly applying the above-described method of measuring DGD at a particular wavelength of the invention over a prescribed wavelength range, it is possible to estimate the polarization mode dispersion (PMD) of a fiber link (according to either or both of the “rms” or “mean” PMD definitions) from the DGD as a function of wavelength. Preferably, the wavelengths should be approximately uniformly distributed across a prescribed wavelength range.

For reasons of overall measurement time, it is advantageous to replace the continuous SOP scanning described in the Summary of Invention hereinbefore with “macroscopic-step SOP selection”, i.e. where I-SOP controller 14A and A-SOP controller 14B set the different input and output SOPs in a pseudo-random manner, such that the points whereby such SOPs conventionally are represented on the Poincaré sphere are uniformly-distributed over the surface of said sphere, whether the distribution is random or a uniform grid of points. An example of a suitable commercially-available controller for such an application is the General Photonics Model PolaMight™ (multifunction polarization controller).

As mentioned in the context of the above-described measurement of DGD at a particular wavelength, it is frequently the case that the optical frequency difference of the closely-spaced wavelength pairs is, for instance, too large to permit accurate measurement of high DGD values, or too small to permit measurement of low DGD values. In such a case, it may be desirable to perform a preliminary rough DGD estimation using this method but with a limited number of K values (e.g. 10), and then, depending on the result, change the spacing of the closely-spaced wavelengths. Note that, in this case, where the rms or mean DGD is calculated over a prescribed wavelength range, it is usually not necessary to maintain exactly the same midpoint wavelength for this measurement with a different optical-frequency difference. The final DGD averaging over the wavelengths can take into account this slightly different wavelength.

A preferred method of implementing this approach with the preferred embodiments of the optical source means 12 will now be described. (For simplicity of the foregoing description, we assume that the “repeated pulse” method, described in the measurement of DGD at a particular wavelength above, is not applied. The “intermediate wavelength” method described here can be readily generalized to include the “repeated pulse” method.)

First, the optical source means 42 injects into the FUT 18, for each group of two optical pulses, a third additional optical pulse having a wavelength (λ_{1I}) intermediate and unequally spaced with respect to the uppermost and lowermost wavelengths (λ_{1U},λ_{1L}) respectively, of the group. The input-SOP 14A and the output-SOP 14B, respectively, are approximately constant for all three optical pulses. All three analyzed pulses are detected by the detection system means 22, and are identified by their respective “extinction periods”, as described in the measurement of DGD at a particular wavelength above. The three aforementioned optical pulses correspond to three different combinations of optical-frequency differences (in comparison with two different close-spaced wavelengths, which of course correspond to only one possible optical frequency difference), and hence only add about 50% to the overall measurement time. Using the computation method described in more detail hereinafter, noise- and/or sensitivity-optimized DGD measurements can be made at different approximately uniformly spaced (midpoint) wavelengths over the prescribed wavelength range.

It should be noted that, if a significantly uneven distribution of the same number of DGD(λ) were used, a PMD value could still be calculated by a straightforward modification of the method that would be obvious to someone of average skill in the art, but this PMD value would not be, in general, as reliable as a PMD value obtained with approximately uniformly distributed wavelengths.

For the case where the optical source means 42 comprises a tunable laser 12A (FIG. 1(B-H)), it is desirable that the choice of midpoint wavelengths defined by the closely-spaced wavelengths that are generated by the tunable laser source 12A (FIG. 1(B-H) or by tunable filter 27 (FIG. 1I) be predetermined for the prescribed wavelength range (e.g. C band, from 1530-1565 nm), in order to avoid having to use potentially complicated communication between the optical source means 42 and the analyzer-and-detection means 44. In this way, there is no need for the numerical values of the injected wavelengths to be explicitly communicated, as these values can be inferred by the control unit 30B from simple coding information in the extinction times, as discussed earlier. It may, however, be desirable for an initial “ready” signal to be sent from the optical source means 42 to begin the measurement sequence. Again, this signal could be encoded in the light injected into the FUT, via the extinction period or other simple pulse frequency modulation.

Once a set of DGD(λ) values have been obtained as described above, it is straightforward to compute, using standard statistical definitions, either or both of the rms DGD and the mean DGD from the different value of DGD obtained within the prescribed wavelength range. Note that such a measurement is particularly useful, since most current commercial approaches do not permit the PMD to be directly measured using both rms and mean definitions.

RMS DGD Measurement (without Individual DGD(λ) Measurements)

The underlying measurement approach can be applied for the direct measurement of the rms DGD (i.e. PMD according to the rms definition) across a prescribed wavelength range. If information concerning the DGD as a function of wavelength is not required, this aspect of the invention allows for a much more rapid PMD measurement (for the same overall level of accuracy) than the method of RMS measurement using repeated DGD(λ) measurements described above. In addition, since the analyzing and detecting light controller means 44 does not need to “know” the actual value of the wavelength being transmitted (only whether the wavelength corresponds to the “uppermost”, “lowermost” or one or more “intermediate” wavelengths), there is no need for the use of predetermined wavelengths or an explicit “start” signal for the measurement, thereby simplifying the measurement procedure.

The computational method by which the data thus acquired can be converted into a reliable DGD measurement, including in the presence of significant ASE noise, is much the same as in the above described measurement of DGD at a particular wavelength, except that individual measurements taken with each group of closely-spaced wavelengths are averaged over “center wavelengths” (see later for a definition of center wavelength) approximately uniformly distributed across the prescribed range, as well as over different I-SOPs and A-SOPs. In certain embodiments, the choice of mid-point wavelengths may be quasi-random, or at least not sequential in ascending or descending wavelength. In other embodiments, it may be preferable to perform the measurements sequentially in ascending or descending wavelengths. Computational details will be described hereinafter.

As with the above described rms or mean DGD measurement using repeated DGD(λ) measurements, it is advantageous to inject more than two different closely-spaced wavelengths in each group of wavelengths, in order that the optimal optical-frequency spacing can be used in the computational process.

Before the measurement procedure for these above aspects is described in more detail, and with a view to facilitating an understanding of such operation, the theoretical basis will be explained, it being noted that such theory is not to be limiting.

### RMS DGD Measurement Using Rapid Wavelength Sweeping

An alternative approach to measuring the rms and/or mean DGD over a prescribed wavelength range is to use a rapidly swept tunable laser (FIGS. 1B-1H) (or polarized broadband source/tunable narrowpass filter combination (FIG. 10, or a polarized broadband source/polarization-diverse scanning monochromator combination (FIG. 1K)), where either or both of I-SOP and A-SOP vary little or not at all during the sweep. If the detection electronics are sufficiently rapid, this “spectral acquisition step” will provide a quasi-continuum of detected polarization-analyzed transmitted coherent optical power data as a function of optical frequency. In the subsequent data analysis, any desired closely-spaced wavelength step could be selected, and the average DGD determined from different wavelength pairs so selected in a similar fashion to that described earlier. Of course, if I-SOP and A-SOP vary during the sweep, this would further improve the accuracy of the measurement, provided that neither I-SOP nor A-SOP varies significantly between any two closely-spaced wavelengths in the sweep. Furthermore, repeating this procedure with multiple sweeps will of course further improve its accuracy.

This alternative approach also has the advantage that there is no need for encoding in the source (12A, 30A; 12B, 30A) to identify “upper, lower and intermediate” closely-spaced wavelengths, as described earlier. (Of course, for the swept tunable laser case, there may be a need to indicate the beginning of the sweep, but such an indication would be simple to implement.).

### Various Modifications to the Two-Ended PMD Measurement Means

The invention encompasses various modifications to the two-ended PMD measurement embodiment shown in FIGS. 1-1K. For example, if the degree-of-polarization of the light from the light source means 12 is not close to 100%, the light may be rendered essentially fully polarized by passing it through a polarizing element 19, preferably a linear polarizer. However, in order to ensure that the output power through the polarizing element is maximized, the light may first be passed through a polarization adjuster (i.e. polarization controller) 13 (see FIG. 9A), connected by non-polarization-maintaining fiber to the tunable pulsed laser source 12 and the polarizing element 19, respectively. The output from the polarizing element 19 is then maximized (generally in the factory) by suitably adjusting the polarization adjuster 13. Although these modifications may be applied separately, certain embodiments of the invention may include several such modifications.

A person of ordinary skill in this art would be able, without undue experimentation, to adapt the procedure for calibrating the relative sensitivities of the two detectors 22B and 22C, as shown in FIG. 1G or 1K, including the losses induced by the intervening coupler, etc., described hereinbefore with reference to the two-ended PMD measurement of FIGS. 1G and 1K. That said, it should be appreciated that, in the embodiment of FIG. 1C, calibration of the mean relative gain is not required; the measured total power is independent of SOP, and there is no need for an “absolute” calibration to directly measure absolute transmission values; they can be obtained to within an unknown constant factor. The subsequent normalization over the mean powers averaged over SOPs, as described hereinbefore, eliminates the unknown factor.

Where the detection means 22 comprises a single detector 22A (e.g., FIG. 1B), normalized powers (or transmissions) can be obtained by computing an average of all of the powers in first and second groups of powers, and dividing each of the powers by the said average power to obtain first and second groups of normalized powers, as described in detail hereinbefore.

FIG. 1B illustrates a PMD measurement instrument suitable for obtaining the DGD or PMD using normalized powers obtained in this way. The PMD measurement illustrated in FIG. 1B is similar to that illustrated in FIG. 1C but with coupler 21 and detector B 22C omitted. The data processor 34 will simply use the different normalization equations.

Where a polarimeter 45 is used (see FIG. 1H), several (typically three) different polarization components of light exiting from FUT 18 can be measured, either simultaneously or at different times, dependent on the polarimeter design.

It should be noted that the single-ended measurement instrument of FIG. 2 could also be adapted to use a polarimeter 45 in its analyzer-and-detection means 44.

In the polarized broadband light source based two-ended PMD measurement shown in FIG. 1I, a tunable filter 27 is used to select light wavelength. This tunable filter can be located after polarizer 20A (FIG. 1I) or before polarizer 20A. It is normally preferable that the tunable filter must be a polarization insensitive filter. Normally, the tunable filter is operable to select different wavelengths at different times.

It should be noted that, if the tunable filter is highly polarization sensitive, e.g. polarization-dependent loss (PDL)>20 dB, it may combine the functions of polarizer 20A and (low or modest PDL) tunable filter 27 in FIG. 1I.

In any of the above-described embodiments, the input SOP controller 14A and output SOP controller 14B operate in such a manner that, for a given SOP of the light received at its input (which can be any SOP on the Poincaré Sphere), the SOP of the light leaving its output (either the input SOP 14A and output SOP 14B) will be any other one of a number of substantially uniformly distributed SOPs on the Poincaré Sphere, whether the distribution is of random or deterministic nature. Typically, the number of input and output states of polarization is about 100-100,000, but it could be any practical number allowing for a reasonable coverage of the Poincaré sphere. However, it may also be possible to use one for both input and output SOP. It is noted that the distribution of the SOPs need not, and generally will not, be truly random; so “pseudo-random” might be a more appropriate term in the case where a random distribution is indeed used for convenience because it is easier and less expensive to implement than a uniform grid of SOPs (the latter being in any case very susceptible to movement of the FUT 18 during measurement).

The detection system means 22, whether a single detector, a pair of detectors, a filter plus detector, or a detector array, and the sampling or sampling and averaging circuitry unit 32, may be as used in standard commercial power meters that are known to a person skilled in this art.

The control unit 30B may advantageously be a separate computer. However, it is noted that a single computer could perform the functions of the data processor 34 and the control unit 30B.

Various other modifications to the above-described embodiments may be made within the scope of the present invention. For instance the tunable modulated optical source 12 and input SOP controller 14A and analyzer-and-detection means 14B, 20 and 22 could be replaced by some other means of providing the different polarization states of the modulated optical sources entering the FUT 18 and analyzing the resulting signal or power caused leaving the distal end of FUT 18.

The polarimeter used in the instrument shown in FIG. 1H, (typically splitters with three or four analyzers and photodetectors in parallel), measures more than one polarization component of the signal or power approximately simultaneously, but other similar configurations are feasible. Alternatively, an I-SOP controller 14A may launch three or more pre-defined input SOPs of light, for example having a Mueller set, which is well known in the art, and a polarimeter may be used as an analyzer-and-detection means as shown in FIG. 1G.

It should be noted that each group is not limited to one pair of modulated optical pulses or one pair of series of modulated optical pulses. Indeed, it may use three or more different closely-spaced wavelengths per group of powers, instead of the minimally-required two closely-spaced wavelengths λ_{L} and λ_{U}.

However, it should also be noted that more than one pair of modulated optical pulses and more than one pair of light pulses usually may not be required for two-ended overall PMD measurement if one may know a rough PMD value of the FUT. Otherwise, such as discussed previously for auto pre-scan, more than one pair of modulated optical pulses or more than one pair of series of light pulse may be used for the acquisition.

It should also be noted that a single DGD at one given midpoint wavelength may be obtained by averaging over a large number of randomly input and output SOPs for a given constant midpoint wavelength having two closely-spaced wavelengths. Therefore, the DGD as a function of wavelength in a given wavelength range may also be obtained by measuring many individual DGDs at different midpoint wavelengths within the given wavelength range. The mean DGD and/or rms DGD may be then be computed therefrom by averaging over all or most of these individual DGD values at different wavelengths in the given wavelength range. Alternatively, the rms DGD may also be computed from a mean-squared difference that is obtained by averaging over wavelength and/or SOP, without ever explicitly measuring the DGD at a particular wavelength.

It must also be appreciated that the midpoint wavelength is defined as the mean of the two closely-spaced wavelengths, and is particularly useful for facilitating description of the basic one wavelength pair implementation. It is not explicitly needed anywhere in the computations, and the actual laser wavelength is not “set” at the midpoint wavelength. Only the knowledge of the step is needed, i.e., the difference between any pair that is used in the computations of cumulative PMD, irrespective of the midpoint wavelength, even if it were to be random and unknown. (When more than one wavelength pair is used per group, as mentioned above, it is useful to introduce the concept of “center wavelength” as a wavelength “label” corresponding to the particular group. This will be discussed further hereinafter.)

Although the above-described method of operation changes the midpoint wavelength for each SOP, this is not an essential feature of the present invention. While superior performance can be obtained by covering a large wavelength range in order to obtain the best possible average of DGD, as per the definition of PMD, a PMD measurement embodying the present invention will work with no bias and may provide acceptable measurements of PMD, with a constant center-wavelength or even both constant input and output SOPs and constant center-wavelength with one pre-defined wavelength step (or frequency difference).

### Single-Ended Overall PMD Measurement

As mentioned hereinbefore, if DGD/PMD is to be measured from one end of the FUT 18, the analyzer and detection unit 44 and the analog and digital signal processing unit 40 can be located with the optical source means 42 at the proximal end of the FUT 18, together with a single control unit 30 performing the control functions of the control units 30A and 30B in the two-ended embodiments. Also, because the parts are co-located, certain parts may be combined, their components being modified as appropriate. Single-end measuring instrument configurations will now be described with reference to FIGS. 2 to 2G, which correspond to FIGS. 1 to 1G for the two-ended measuring instrument configurations.

Thus, FIG. 2 shows a tunable OTDR-based single-ended overall PMD measurement apparatus similar to the two-ended measurement instrument of FIG. 1 but in which the optical source means 42 and analyzer-and-detection means 44 are co-located at the proximal end of the FUT 18 and share a backreflection extractor 52 which connects the input I-SOP controller 14A and the output A-SOP controller 14B to the FUT 18 via connector 16. The backreflection extractor 52 is bidirectional in that it conveys the light from the I-SOP controller 14A to the FUT 18 and conveys the backreflected light from the FUT 18 to the A-SOP controller 14B. As was the case in FIG. 1 the tunable pulsed light source 12 is connected to I-SOP controller 14A by a PMF 29A.

A fiber patchcord with either a PC (FC/PC or FC/UPC) connector or a fiber pigtailed mirror 50 is connected to the distal end of FUT 18 to produce a localized reflector at the distal end of the FUT. In fact, any type of reflector may be used if it can reflect the light from the end of FUT 18 back into the measuring instrument.

The other change, as compared with FIG. 1, is that the instrument shown in FIG. 2 has a single control unit 30 which controls the tunable pulsed light source 12, the two SOP controllers 14A and 14B, the sampling and averaging unit 32 and the data processor 34. Otherwise, the components of the measuring unit shown in FIG. 2 are similar or identical to those of the measuring instrument shown in FIG. 1 and operate in a similar manner. The signal processing, however, must be adapted so as to allow for the fact that the extracted light comprises light from the light source 12 that traveled the FUT 18 for at least part of its length and then was backreflected and traveled the same path to the backreflection extractor.

It should be noted that the term “tunable OTDR” mentioned hereinbefore in the context of this single-ended overall PMD measurement is not limited to a fully functional, commercial-type OTDR, but rather refers to an apparatus that can provide optical pulses for injection into a fiber, and subsequently detect and perform time-gate averaging only on those pulses corresponding to reflections corresponding to a particular time delay (i.e. distance corresponding to the end of the fiber). Nonetheless, the use of an OTDR permits the FUT end to be identified and the FUT length measured, thereby enabling the time-gate window to be correctly selected.

It should be noted that the various modifications and alternatives described with reference to the two-ended measurement instrument of FIGS. 1 to 1H could, for the most part, be applied to the single-ended measurement instrument shown in FIG. 2. Such modified configurations of the single-ended measuring instrument will now be described briefly with reference to FIGS. 2B to 2G.

In the instrument shown in FIG. 2B, the optical source means 42 and the analyzer and detection unit 44 share a polarization discriminator (polarizer) 20A and a I/O-SOP controller 14 both of which are bidirectional in the sense that they convey input light towards the FUT 18 via the connector 16 and backreflected light returning from the FUT 18 in the opposite direction. The I/O-SOP controller 14 hence combines the functions of the separate I-SOP 14A and A-SOP 14B controllers, but where the scrambling is necessarily highly correlated for light traversing it in either direction. The backreflection extractor comprises a circulator/coupler 52A connected to the light source 12 by PMF 29A and to the input of the polarization discriminator (polarizer) 20A by a second PMF 29B. The circulator/coupler 52A conveys the backreflected light to a detection system which, in FIG. 2B, is shown as a single detector 22A. The output of the polarization discriminator (polarizer) 20A is connected to the input of the bidirectional I/O-SOP controller by regular fiber. Other components are the same as in FIG. 2.

The alignment of PMF 29A and 29B is fixed in the factory in such a manner that substantially all of the optical power from the tunable pulsed laser source 12 is maintained in one of the two axes of the fiber 29A and 29B (conventionally, the “slow” axis). Since the circulator/coupler 52A is polarization-maintaining, this alignment is to its point of attachment to PBS or polarizer. During attachment of each end of the PMFs 29A and 29B to the component concerned, the azimuthal orientation of the PMF is adjusted to ensure maximum transmission of the optical pulses towards the FUT 18.

In use, in the instrument shown in FIG. 2G, the input light from optical source means 42 is launched into FUT 18 via fiber connector 16 and backreflected light caused by any localized reflection (such as Fresnel reflection from the distal end 50 of FUT 18) returns back to analyzer- and detection-means 44 via fiber connector 16, entering the I/O-SOP controller 14 in the reverse direction. Its SOP is transformed by the SOP controller (or scrambler) 14, following which the light is decomposed by the polarization discriminator 20, specifically a PBS, into two components having orthogonal SOPs, typically linear SOPs at 0- and 90-degree relative orientations. The first detector 22B is connected to one of the two outputs of the PBS 20 to receive one of these orthogonal components and the backreflection extractor 52 (e.g. circulator/coupler) is connected to the other output (with respect to backreflected light from the FUT 18). The second detector 22C is in turn connected to that output port of the backreflection extractor 52 that transmits light from the PBS 20, so as to receive the other orthogonal component. Once suitably calibrated to take into account the relative detector efficiencies, wavelength dependence, circulator loss, etc., as will be described hereinafter, the sum of the detected powers from detectors 22B and 22C is proportional to the total backreflected power (S₀). The backreflected light may be detected approximately simultaneously by detectors 22B and 22C.

In the instrument shown in FIG. 2C, the optical source means 42 comprises tunable pulsed light source 12, and shares a backreflection extractor, a polarizer 20A and I/O SOP controller means 14 with the analyzer-and-detection means 44. The backreflection extractor is shown as a circulator/coupler 52A. As before, the input light from the light controller means 42 is injected into FUT 18 via a fiber connector 16 and backreflected light reflected from any localized reflection (such as Fresnel reflection) from the distal end 50 of FUT 18 returns back to the analyzing and detecting light controller means 44 and enters the I/O-SOP controller 14 in the reverse direction, following which the light returns back the polarizer 20A. The detectors 22B and 22C are connected to an output of circulator/coupler 52A and to one output port of coupler 21, respectively.

In the instrument shown in FIG. 2D, the backreflected light reflected from any localized reflection from the distal end 50 of FUT 18 returns back to the I/O-SOP controller 14 in the reverse direction, following which the light returns back the polarizer 20A and then is divided two parts by coupler 21. The detector 22B and 22C are connected to two outputs of coupler 21 to produce two repeated measured powers.

It should be noted that simultaneously detecting the backreflected light with two detectors of 22B and 22C may not be always necessary. It may also be detected at slightly different time.

Also note that one detector with one optical switch 23 may also be used. In this case, two detectors of 22B and 22C may be replaced by one detector 22A plus one optical switch 23 (FIGS. 2E and 2F). The optical switch is used to route the backreflected light from different optical paths, either from circulator (or coupler) 52A or the PBS 20C (FIG. 2F) or the coupler 21 (FIG. 2E), into same detector and thereby the backreflected light from different optical paths are detected at different time.

It should also be noted that in those configurations, such as polarizer 20A based design in FIGS. 2B, 2C, and 2D and PBS 20C based design in FIG. 2G, polarized light from a tunable light source may also be obtained by adjusting incident SOP of lights from tunable light source before going through either polarizer or PBS. This is to say no any additional polarizer being required if a tunable (pulsed) light source may not be well polarized or experienced different light SOP at different wavelength, but an additional polarization controller is still required to insert position between tunable (pulsed) light source 12 and circulator/coupler 52A. For this case, 29A and 29B is preferred to be replaced by SMF.

Under the control of control unit 30, which also controls the tunable laser source 12, the sampling and averaging circuitry 32, in known manner, uses an internal analog-to-digital converter to sample the corresponding electrical signals from the detector 22 as a function of time to obtain the corresponding electrical response signals, and corresponding electrical response pulse signals then may be sampled and averaged to provide the mean response pulse for a particular series of light pulses, and the backreflected light power for that series obtained by averaging said mean response pulse over a substantial portion of its duration to provide a backreflected light power, the resulting plurality of powers of light backreflection. This averaging ‘time’ window (or “time-gate”) may depend upon the pre-filtering of the sampling and averaging electronics. The resulting averaged powers are used by a data processor 34 to derive the DGD or PMD value, i.e., the differential group delay (DGD or polarization mode dispersion (PMD) of the FUT 18 from its distal end or any other connectors. It will be appreciated that the usual conversions will be applied to convert time delay to distance according to refractive index to obtain the length of fiber.

In addition to controlling the sampling and averaging circuit 32, the control unit 30 controls the wavelength of the tunable pulsed laser source 12 and the I/O-SOP selected by I/O-SOP controller 14. More specifically, for each setting k of the I/O-SOP controller 14, the control unit 30 causes the light backreflected power to be measured at least one pair of wavelengths λ_{L}^{(k)} and λ_{U}^{(k)}, respectively, that are closely-spaced relative to each other. The midpoint wavelength of the pair of series of light pulses is defined as the average of the actual wavelengths of the series of light pulses, i.e., λₖ=(λ_{L}^{(k)}+λ_{U}^{(k)})/2. (The labels L and U refer, for convenience and ease of understanding, to “lower” and “upper” with respect to the midpoint wavelength λₖ).

It should be appreciated that, where the group comprises one or more than one pair of series of light pulses, the midpoint wavelength as defined above in fact differs for each pair in the group.

The one, or more than one, pair of wavelengths in one group may also be used to measure the powers of the backreflections from the localized reflection at the distal end of FUT and then to extract PMD values for the FUT 18. However, it may not be necessary to use more than one pair of wavelengths for the single-ended PMD measurement unless for auto pre-scan acquisition (see more detailed discussion about auto pre-scan below). An optimal pair of wavelength may be satisfy the PMD_{FUT}˜α_{L}(πδν)⁻¹, where ν_{L}^{(k)}−ν_{U}^{(k)}=δν, and the ν_{L}^{(k)} and ν_{U}^{(k)} corresponding to the pair of wavelengths λ_{L}^{(k)} and λ_{U}^{(k)} under ν=c/λ, where c is light speed in vacuum.

It must also be appreciated that the center wavelength is only a conceptual definition, defined only for the purpose of facilitating description when a group comprises more than two wavelengths. In the limit where a group comprises only two wavelengths, it is of course equivalent to the “midpoint wavelength” defined hereinbefore. Center wavelength is not needed anywhere in the computations, and there is no need for accurately “centering” the group on some target center wavelength since the latter is defined as the midpoint wavelength, and there is no need to set the laser wavelength at the center wavelength. Only the knowledge of the step(s) is needed, i.e., the difference between any pair that is used in the computations of cumulative PMD, irrespective of the center wavelength.

The I/O-SOP controller 14 sets the different I-SOPs and A-SOPs in a pseudo-random manner, such that the points conventionally representing SOPs on the Poincaré sphere are uniformly-distributed over the surface of said sphere, whether the distribution is random or a uniform grid of points.

Before the tunable OTDR based single-ended overall PMD measurement procedure is described in more detail, and with a view to facilitating an understanding of such operation, the theoretical basis will be explained, it being noted that such theory is not to be limiting.

### Various Modifications to the Single-Ended PMD Measurement Means

The invention encompasses various modifications to the single-ended overall PMD measurement instrument shown in FIG. 2. For example, in the tunable pulsed light source means 12, the PMF 29A may be replaced by a polarization adjuster 14 (see FIG. 10A) connected by non-polarization-maintaining fiber to the tunable pulsed laser source 12 and to the input of backreflection extractor 52, respectively.

If the optical path between the output of tunable pulsed light source means 12 and the input of the polarization discriminator 20 (e.g. PBS in FIG. 2G) is polarization-maintaining, the polarization-maintaining circulator 52, e.g. in FIG. 2G could be replaced by a polarization-maintaining coupler (e.g., a 50/50 coupler). The circulator is preferred, however, because it gives about 3 dB more dynamic range than a 50/50 coupler.

It is also envisaged that the polarization discriminator 20 could be a polarizer or polarizer and coupler, as shown in FIGS. 2B and 2C. In that case, the detector 22C would be connected to the coupler 21 to receive backreflected light that is not polarization-dependent.

If the optical path between the output of the tunable pulsed laser source 12 and the input of the polarization discriminator, e.g. polarizer 20A and polarization beam splitter (PBS) 20C, is not polarization maintaining, the backreflection extractor, i.e., coupler or circulator 52A, need not be polarization-maintaining.

A patchcord with either a FC/PC (or FC/UPC) connector or a fiber-pigtailed mirror may be used to connect at the distal end of FUT to create a localized reflection for measuring an overall PMD from the FUT.

The light pulse length or duration from tunable OTDR may prefer to be long, for example of 1 to over 20 us, but a short pulse length or duration may also be applied.

Although these modifications may be applied separately, the embodiment of the invention illustrated in FIGS. 2 and 2B-2G includes several such modifications. Specifically, the optical path between the tunable pulsed laser source 12 and the I/O-SOP controller 14 is not polarization maintaining, i.e., the PMFs 29A and 29B of FIGS. 2B-2G are replaced by a polarization state adjuster connected by single-mode optical-fiber (e.g. a non-PMF fiber marketed as SMF-28 by Corning, Inc.)-based components (such as circulator, polarizer and polarizing splitter), and then a polarization state adjuster maximizes the pulsed laser optical power passing through the I/O-SOP controller 14.

Instead of PBS 20C in FIG. 2G, the polarization discriminator 20 may comprise a polarizer 20A and coupler 21 combination (FIG. 2C), at the expense of approximately 3 dB dynamic range for the case of a 50/50 coupler. The second detector 22C (FIG. 2C) is connected to one of the arms of the coupler 21 so as to detect a fraction of the backreflected light for processing to deduce the total backreflected power of the pulses.

A person of ordinary skill in this art would be able, without undue experimentation, to adapt the procedure described hereinbefore for calibrating the relative sensitivities of the two detectors A and B (22B and 22C), including the losses induced by the intervening circulator or coupler, etc., for use with the single-ended overall PMD measurement instrument of FIG. 2G. It should be appreciated that, in the embodiment of FIG. 2C, calibration of the mean relative gain is not required; the measured total power is independent of SOP, and there is no need for an “absolute” calibration to directly measure absolute transmission values; they can be obtained to within an unknown constant factor. The subsequent normalization over the mean traces averaged over SOPs, as described hereinbefore, eliminates the unknown factor.

It is envisaged that, where the detection means 22 comprises a single detector 22A (FIG. 2B), normalized powers can be obtained by computing an average of all of the powers in first and second groups of powers, and dividing each of the powers by the said average power to obtain first and second groups of normalized powers, as described in detail hereinbefore.

FIG. 2B illustrates a single-ended PMD measurement suitable for obtaining the PMD using normalized powers obtained in this way. The single-ended overall PMD measurement illustrated in FIG. 2B is similar to that illustrated in FIG. 2C but with coupler 21 and detector B 22C omitted. The data processor 34 will simply use the different normalization equations.

In any of the above-described embodiments, the operation of the I/O-SOP controller 14 is such that, for a given SOP of the light (which can be any SOP on the Poincaré Sphere) received at its input, the SOP of the light leaving its output will be any one of a number of substantially uniformly distributed SOPs on the Poincaré Sphere, whether the distribution is of random or deterministic nature. Typically, the number of output states of polarization is about 100-500, but it could be any practical number. However, it may also be possible to use one I/O-SOP controller (rather than two SOP controller for the two-ended PMD measurement as shown in FIG. 1). It is noted that the distribution of the SOPs need not, and generally will not, be truly random; so “pseudo-random” might be a more appropriate term in the case where a random distribution is indeed used for convenience because it is easier and less expensive to implement than a uniform grid of SOPs.

The detector means 22, whether a single detector or a pair of detectors, and the sampling and averaging circuitry unit 32, may be as used in standard commercial OTDRs that are known to a person skilled in this art.

Where the polarization discriminator 20 comprises a PBS 20C or a polarizer 20A and coupler 21 combination, there will be a penalty of approximately 3 dB dynamic range for the case of a 50/50 coupler where the second detector 22C is connected to one of the arms of the coupler 21 so as to detect a fraction of the light for processing to deduce the total light power, however, such reduced power may not be critical for the measurement.

The control unit 30 may advantageously be a separate computer. However, it is noted that a single computer could perform the functions of the data processor 34 and the control unit 30.

### Single-Ended Cumulative PMD Measurement

The polarization-sensitive optical time domain reflectometer (POTDR) illustrated in FIG. 3 comprises tunable pulsed light source means 12, bidirectional polarization controller means 14 (conveniently referred to as an I/O SOP controller means), sampling and averaging unit 32 and data processor means 34, all controlled by a control unit 30, and detection means 22 comprising first and second detectors A and B, 22B and 22C, respectively. The tunable pulsed light source means 12 is coupled to a polarization maintaining fiber (PMF) 29A for producing light pulses for launching into a fiber-under-test (FUT) 18 from connector 16 via the I/O state of polarization (I/O-SOP) controller means 14, which, as explained later, also receives corresponding backreflected light from the FUT 18 via connector 16.

The optical source means 42 and analyzer-and-detection means 44 comprise a backreflected light extractor, specifically a polarization-maintaining circulator 52 in FIG. 3, a polarization discriminator (PD) means 20, specifically a polarization beam splitter (PBS) in FIG. 3, and a input and output SOP controller (or scrambler) 14. The circulator 52 is coupled to the input of PBS 20 by a second PMF 29B so that the optical path from the tunable laser source 12 to the PBS 20 is polarization-maintaining. Preferably, a single-mode fiber is used to couple the PBS 20 to the I/O-SOP controller (or scrambler) 14.

The alignment of PMF 29A and 29B is fixed in the factory in such a manner that substantially all of the optical power from the tunable pulsed laser source 12 is maintained in one of the two axes of the fiber 29A and 29B (conventionally, the “slow” axis). Since the circulator 52 is polarization-maintaining, this alignment is maintained until the distal end of PMF 29B, at its point of attachment to PBS 20. During attachment of each end of the PMFs 29A and 29B to the component concerned, the azimuthal orientation of the PMF 29A/B is adjusted to ensure maximum transmission of the optical pulses towards the FUT 18.

Backreflected light caused by Rayleigh scattering and, in some cases, discrete (Fresnel) reflections, from the FUT 18 enters the I/O-SOP controller 14 in the reverse direction. Its SOP is transformed by the SOP scrambler 14, following which the light is decomposed by the PBS 20 into two components having orthogonal SOPs, typically linear SOPs at 0- and 90-degree relative orientations. The first detector 22C is connected to one of the two outputs of the PBS 20 to receive one of these orthogonal components and the circulator 52 is connected to the other output (with respect to backreflected light from the FUT 18). The second detector 22B is in turn connected to that output port of the circulator 52 that transmits light from the PBS 20, so as to receive the other orthogonal component. Once suitably calibrated to take into account the relative detector efficiencies, wavelength dependence, circulator loss, etc., as will be described hereinafter, the sum of the detected powers from detectors 22B and 22C is proportional to the total backreflected power (S₀).

Under the control of control unit 30, which also controls the tunable laser source 12, the sampling and averaging circuitry 32, in known manner, uses an internal analog-to-digital converter to sample the corresponding electrical signals from the detectors 22B and 22C as a function of time to obtain the corresponding electrical impulse response signals, then averages the impulse-response signals corresponding to a particular series of light pulses to produce an OTDR trace for that series. The resulting OTDR traces are used by a data processor 34 to derive the cumulative PMD curve PMD(z), i.e., the polarization mode dispersion (PMD) as a function of the distance z along the FUT 18 from its proximal end, that is the end which is coupled to the analyzer-and-detection means 44. It will be appreciated that the usual conversions will be applied to convert time delay to distance according to refractive index.

In addition to controlling the sampling and averaging circuit 32, the control unit 30 controls the wavelength of the tunable pulsed laser source 12 and the I-SOP and A-SOP couple selected by I/O-SOP controller 14. More specifically, for each setting k of the I/O-SOP controller 14, the control unit 30 causes the backreflected power to be measured at least one pair of wavelengths λ_{L}^{(k)} and λ_{U}^{(k)}, respectively, that are closely-spaced relative to each other. The midpoint wavelength of the pair of series of light pulses is defined as the average of the actual wavelengths of the series of light pulses, i.e., λₖ=(λ_{L}^{(k)}+λ_{U}^{(k)})/2. (The labels L and U refer, for convenience and ease of understanding, to “lower” and “upper” with respect to the midpoint wavelength λₖ).

It should be appreciated that, where the group comprises more than one pair of series of light pulses, the center wavelength as defined above in fact differs for each pair in the group. It must also be appreciated that the center wavelength is only a conceptual definition, and was defined only for the purpose of facilitating description of the basic one pair implementation. It is not needed anywhere in the computations, and there is no need for accurately “centering” the pair on some target center wavelength since the latter is defined as the mean of the actual pair. Nor is the laser wavelength set at the center wavelength. Only the knowledge of the step is needed, i.e., the difference between any pair that is used in the computations of cumulative PMD, irrespective of the center wavelength, even if it were to be random and unknown.

The I/O-SOP controller 14 sets the different (I-SOP, A-SOP) couples in a pseudo-random manner, such that the points conventionally representing SOPs corresponding to each member of the couple are uniformly distributed over the surface of the Poincaré sphere, whether the distribution is random or a uniform grid of points.

Before the operation of the POTDR is described in more detail, and with a view to facilitating an understanding of such operation, the theoretical basis will be explained, it being noted that such theory is not to be limiting.

### Various Modifications to the Single-Ended Cumulative PMD Measurement Means

The invention encompasses various modifications to the embodiment shown in FIG. 3. For example, in the tunable pulsed light source means 12, the PMF 29A may be replaced by a polarization adjuster 13 (see FIG. 10A) connected by non-polarization-maintaining fiber to the tunable pulsed laser source 12 and to the input of backreflection extractor 52, respectively.

If the optical path between the output of tunable pulsed light source means 12 and the input of the polarization discriminator 20 is polarization-maintaining, the polarization-maintaining circulator 18 in FIG. 3 could be replaced by a polarization-maintaining coupler (e.g., a 50/50 coupler). The circulator is preferred, however, because it gives about 3 dB more dynamic range than a 50/50 coupler.

If the optical path between the output of the tunable pulsed laser source 12 and the input of the polarization discriminator 20 is not polarization maintaining, the backreflection extractor, i.e., coupler or circulator 52 need not be polarization-maintaining.

Although these modifications may be applied separately, the embodiment of the invention illustrated in FIG. 3 includes several such modifications. Specifically, the optical path between the tunable pulsed laser source 12 and the I/O-SOP controller 14 is not polarization maintaining, i.e., the PMFs 29A and 29B of FIG. 3 are replaced by a polarization state adjuster 14 connected by single-mode optical-fiber (e.g. a non-PMF fiber marketed as SMF-28 by Corning, Inc.)-based components (such as circulator 52 and polarizing splitter 20), to maximize the pulsed laser optical power passing through the I/O-SOP controller 14 and launching into FUT 18.

Instead of a PBS for the polarization discriminator 20, the polarization discriminator 20 may comprise a polarizer 20A and coupler 21 combination, as shown in FIG. 3B, at the expense of approximately 3-dB of dynamic range for the case of a 50/50 coupler. The detector 22C is connected to one of the arms of the coupler 21 so as to detect a fraction of the backreflected light for processing to deduce the total backreflected power of the pulses.

In the POTDR of FIG. 3, an analogous procedure to that described above with respect to the embodiment of FIG. 3 could then be carried out, although not required as stated above, to calibrate the relative sensitivities of the two detectors 22B and 22C, including the losses induced by the intervening circulator or coupler, etc.

A person of ordinary skill in this art would be able, without undue experimentation, to adapt the calibration procedure described hereinbefore with reference to the POTDR of FIG. 3 for use with the embodiment of FIG. 3. It should be appreciated that, in the embodiment of FIG. 3B, calibration of the mean relative gain is not required; the measured total power is independent of SOP, and there is no need for an “absolute” calibration to directly measure absolute transmission values; they can be obtained to within an unknown constant factor. The subsequent normalization over the mean traces averaged over SOPs, as described hereinbefore, eliminates the unknown factor.

It is envisaged that the detection means 22 might comprise a single detector and normalized OTDR traces be obtained by computing an average of all of the OTDR traces in first and second groups of OTDR traces, and dividing each of the OTDR traces by the said average OTDR trace, point by point, to obtain first and second groups of normalized OTDR traces, as described in detail hereinbefore.

FIG. 3A illustrates a POTDR suitable for obtaining the PMD using normalized OTDR traces obtained in this way. The POTDR illustrated in FIG. 3A is similar to that illustrated in FIG. 3B but with coupler 21 and detector B 22C omitted. The data processor 34 will simply use the different normalization equations given in the Method of Operation provided hereinbefore.

In any of the above-described embodiments, the operation of the I/O-SOP controller 14 is such that, for a given SOP of the light (which can be any SOP on the Poincaré Sphere) received at its input, the SOP of the light leaving its output will be any one of a number of substantially uniformly distributed SOPs on the Poincaré Sphere, whether the distribution is of random or deterministic nature. The number of I-SOPs and A-SOPs is preferably greater than 10, in each case, and typically is about 100-200 for high quality results; but it could be any practical number. It is noted that the distribution of each of the I-SOPs and A-SOPs need not, and generally will not, be truly random; so “pseudo-random” might be a more appropriate term in the case where a random distribution is indeed used for convenience because it is easier and less expensive to implement than a uniform grid of I-SOPs and A-SOPs.

Although it is preferred to use two detectors to obtain two orthogonal polarization components simultaneously, it is envisaged that the two detectors in the embodiments of FIGS. 3 and 3B could be replaced by one detector plus one optical switch. The optical switch is used to route the two orthogonal polarization components (FIG. 3) or to route the one output from polarizer and another output directly from coupler (FIG. 3B) of the backreflected light to the same detector, for example alternately, so that two orthogonal polarization components or one output from polarizer and another output directly from coupler of the backreflected light can be detected sequentially by the same detector.

A normalized OTDR trace for that series of light pulses would be obtained by dividing at least one of the OTDR traces corresponding to the two detected different polarization components for that series by the sum of the OTDR traces corresponding to the two detected different polarization components for that series. This alternative may be used regardless of whether the analyzer-and-detector unit comprises a PBS or a coupler. Any modification to the normalization and processing is expected to be minor and within the common general knowledge of a person skilled in this art.

Alternatively, such an arrangement of one detector plus one optical switch could be used to detect one polarization component and the total optical power sequentially by the same detector. As before, the optical switch would route one polarization component and the total reference optical power to the same detector, and the normalized OTDR trace corresponding to that particular series of light pulses would be obtained by dividing the OTDR trace for that series by the OTDR trace for that series corresponding to total power. It is also worth noting that, while the use of one detector with one optical switch instead of two detectors disadvantageously at least doubles the total acquisition time in comparison with embodiments using two detectors,

It is also envisaged that a rotating polarization discriminator (PD), whether it is a polarizer or a PBS, may be used to sequentially acquire two orthogonal components for example via rotating the polarization discriminator by 90° to switch from detecting Px to detecting Py, or from detecting Py to detecting Px. The detector means 22, whether a single detector or a pair of detectors, and the sampling and averaging circuitry unit 232, may be as used in standard commercial OTDRs that are known to a person skilled in this art.

The control unit 30 may advantageously be a separate computer. However, it is noted that a single computer could perform the functions of the data processor 34 and the control unit 30.

Various other modifications to the above-described embodiments may be made within the scope of the present invention.

For instance, the tunable pulsed laser source 12 and I/O-SOP controller 14 could be replaced by some other means of providing the different polarization states of the pulses entering the FUT 18 and analyzing the resulting backreflected signal caused by Rayleigh scattering and/or discrete reflections leaving the FUT 18.

Thus, a polarimeter may be used (splitters with three or more analyzers and photodetectors in parallel), which measures more than one polarization component of the backreflected signal simultaneously, or some other configuration, so that the power that reaches the photodetectors is dependent on the state of polarization (SOP) of the backreflected light.

It should be noted that each group is not limited to one pair of series of light pulses. Indeed, it may be advantageous to use three or more different closely-spaced wavelengths per group of traces obtained with a common SOP, instead of the minimally-required two closely-spaced wavelengths λ_{L} and λ_{U} (each group then comprises 2·N_{λ}, OTDR traces instead of four, two sets of 2·N_{λ} traces in the case of the two-photodetector embodiments, where N_{λ} is the number of wavelengths in a group of series of light pulses). For example, in the case where three closely-spaced wavelengths are used, one can choose the series of light pulses at the lowermost and intermediate wavelengths as one pair, and the series of light pulses at the intermediate and uppermost wavelengths as a second pair, such that the wavelength step between the light pulses in one pair is greater than the wavelength step between the light pulses in the other pair, perhaps a few times larger.

Since there are three combinations of wavelength steps corresponding to three wavelengths (i.e., N_{λ}(N_{λ}−1)/2), one can simultaneously obtain the data corresponding to two significantly different wavelength steps within a measurement time that is only 1.5 times greater than the time required to perform a one-step measurement. Thus, proceeding with three wavelengths (or more) per group proves highly advantageous because the cumulative PMD value can increase significantly along the length of the FUT 16 (from zero to the overall PMD of the FUT), and hence the use of two, three, or more different steps allows one to maintain a satisfactory relative precision (e.g. in %) at all positions along the fiber. It will be appreciated that one could also select the light series at the lowermost and uppermost wavelengths as a third pair, with a wavelength step greater than both of the others. The use of only one step gives a particular absolute uncertainty, as for example ±0.1 ps, which represents a small percentage uncertainty at a distance where the PMD has grown to a value of 10 ps, but is not good in percentage at short distances where the PMD is, for example, only 0.2 ps. To obtain a smaller uncertainty for smaller PMD values, a larger step must be selected. Hence the obvious advantage of implementing such an alternate embodiment where more than two wavelengths per group are used. It changes nothing to the setup, nor to the principle of the invention as described above, but saves time in the overall measurement process.

Although the above-described embodiment changes the center wavelength for each SOP, this is not an essential feature of the present invention. While superior performance can be obtained by covering a large wavelength range in order to obtain the best possible average of DGD, as per the definition of PMD, a POTDR embodying the present invention will work with no bias and may provide acceptable measurements of PMD(z), with a constant center-wavelength.

### Underlying Theory, Data Processing and Computational Method

Although the applicant does not wish to be constrained by theory, the following discussion of the underlying theory is provided so as to facilitate understanding of the various embodiments of the invention.

The computation of the DGD or rms DGD (i.e. PMD) based on PMD measurement principle of randomly input and output State of polarization Scrambling Analysis (SSA) method makes use of prior-art PMD-related measurement theory including Poincaré Sphere Analysis (PSA) and Generalized Interferometric Method (GINTY) with appropriate adaptations resulting in the equations given below. The specific theory applied to the various aspects of this invention is closely related to the theory described in international patent application No. PCT/CA2006/001610 and the above-identified United States Continuation-in-Part application Ser. No. 11/727,759, the entire contents of each of which are incorporated herein by reference.

Throughout this specification, wavelength λ, where λ is the vacuum wavelength of the light, and optical frequency y are used, but they are of course related by the well known relationship λ=c/ν. Although the use of optical frequency is more “natural” in this theory, in practice, for closely-spaced wavelengths, wavelengths can be used, it being understood that the appropriate conversion factors are applied to the equations presented herein.

It should be recalled that PMD is the statistical RMS value of differential group delay DGD(λ), estimated by averaging over a large wavelength range, or over a period of time, ideally both, so that the largest possible number of random occurrences of DGD are observed to obtain its RMS value.

### Fundamental Theory

### Random Input/Output Sop Scrambling Analysis for PMD Measurement

In the this section, we will describe the fundamental theory of ‘Random Input and Output Sate of Polarization Scrambling Analysis (SSA) Method for Polarization Mode Dispersion Measurement’ and its applications to measure a PMD by accessing either both ends or single end of FUT. The three main applications are: (1) ‘Two-ended PMD measurement method and apparatus for determining DGD and PMD of an optical link’ (simply tilted as ‘Two-ended PMD measurement’), (2) ‘Single-ended overall PMD measurement using tunable OTDR and its method of determining PMD’ (simply tilted as ‘Single-ended overall PMD measurement’), and (3) ‘Polarization-sensitive optical time domain reflectometer (POTDR) and its method for determining cumulative PMD as function of fiber length’ (simply tilted as ‘Single-ended cumulative PMD measurement’). The methods of operation, data processing and computational methods for these applications will be described in details in following sections.

If a tunable laser and polarization controller are used to launch and control the input light incident at an one end of FUT and a polarization state analyzer and a power meter are used to measure the power from the FUT, from either the same or different end of FUT, at two closely spaced optical frequencies, ν_{U} and ν_{L}, around a given midpoint frequency, ν_{mid}, for a large number K of input/output state of polarizations, i.e., comprising a large number of “SOP couples” (I-SOPₖ, A-SOPₖ) each referring to both the input-SOP and the analyzer axis “seen” by the received light. Both the I-SOP and the A-SOP values should be chosen in a random manner, such that the points conventionally representing SOPs on the Poincaré sphere are uniformly-distributed over the surface of said sphere, whether the distribution is random or a uniform grid of points. It has been found that, on average over a sufficiently large, uniformly distributed number K of said “SOP couples”, the mean-square difference between normalized powers observed at ν_{U} and ν_{L} is related to the DGD at its midpoint optical frequency ν_{mid} (ν_{mid}=(ν_{U}+ν_{L})/2) by a simple relationship, valid in all cases for any type of practical FUT regardless of its degree of randomness or its polarization coupling ratio, including the extreme case of a PMF fiber, i.e.,

$$DGD ( v ) = \frac{1}{π δ v} arc sin ( {α}_{ds} \sqrt{{〈 Δ {T}^{2} ( v ) 〉}_{SOP}} ) \qquad ( 1 )$$

where [symbol] _{SOP} represents the average over the K SOP couples, δν=(ν_{U}−ν_{L}) is the “step”, and α_{ds} is a theoretical constant that is dependent on measurement set-up configuration, i.e. either two- or one-sided measurement configuration. ΔT(ν) is a difference between the analyzed normalized powers (i.e. transmissions) observed at optical frequencies ν_{U} and ν_{L}, respectively, and its mean-square difference is,

$${〈 Δ {T ( v )}^{2} 〉}_{SOP} = {〈 {( {T}_{U} - {T}_{L} )}^{2} 〉}_{SOP} = \frac{1}{K} {\sum }_{k} {( {T}_{U}^{( k )} - {T}_{L}^{( k )} )}^{2} \qquad ( 2 a )$$

where the index k corresponds to a particular SOP couple, and where the normalized powers for a polarizer-based one-detector embodiment as shown in FIGS. 1B, 2C and 3A are,

$${T}_{L}^{( k )} = {u}_{o} \frac{{P}_{L}^{( k )}}{{〈 {P}_{L} 〉}_{SOP}} \\ {T}_{U}^{( k )} = {u}_{o} \frac{{P}_{U}^{( k )}}{{〈 {P}_{U} 〉}_{SOP}} \qquad ( 2 b )$$

where the reference mean-value uₒ is a theoretical constant that is dependent on measurement set-up configuration, i.e. either two-ended (FIG. 1B) or single-ended (FIGS. 2C and 3A) measurement configuration, and the average power is defined,

$${〈 {P}_{L} 〉}_{SOP} = \frac{1}{K} {\sum }_{k} {P}_{L}^{( k )} . \\ {〈 {P}_{U} 〉}_{SOP} = \frac{1}{K} {\sum }_{k} {P}_{U}^{( k )} \qquad ( 2 c )$$

Furthermore, for a prescribed wavelength range, in preferred embodiments of the invention the averages indicated in equation (1) are preferably carried out over both many SOP couples and midpoint optical frequencies, both of which are changed from one group of two closely-spaced wavelengths to the next, thus obtaining the rms DGD (i.e. PMD) over the prescribed wavelength range, expressed as:

$$PMD = \frac{1}{π δ v} arc sin ( {α}_{ds} \sqrt{{〈 Δ {T}^{2} ( v ) 〉}_{SOP ; v}} ) \qquad ( 3 )$$

where [symbol] _{SOP;ν} is averaged over both SOP and optical frequency (i.e. wavelength) or optical frequency across a prescribed wavelength range.

In the limit of a sufficiently small optical-frequency difference (“step”) between the closely-spaced wavelengths, equations (1) and (3) simplify to yield the simpler differential formula that follows,

$$\begin{matrix}DGD ( v ) = \frac{{α}_{ds}}{π δ v} \cdot \sqrt{{〈 Δ {T}^{2} ( v ) 〉}_{SOP}} & ( 1 a ) \\ PMD = \frac{{α}_{ds}}{π δ v} \cdot \sqrt{{〈 Δ {T}^{2} ( v ) 〉}_{SOP ; v}} & ( 3 a )\end{matrix}$$

(Of course, any other alternative mathematical function that provides a numerical result that falls within an acceptable difference from the said following differential formula for realistic values of DGD and PMD could be used instead, but such a formula would not be based on firm theoretical underpinnings. This would be true for any of the other analogous formulas presented elsewhere in this specification.)

The DGD or PMD value extracted from above equations (1) and (3) are valid for both two-ended and single-ended measurement configurations and they represent measured values between input and output ports. For a two-ended measurement configuration, or a single-ended measurement configuration using two independent scramblers, the theoretical constant α_{ds} is

$${α}_{ds} = \sqrt{\frac{9}{2}} \qquad ( 4 a )$$

and, for a single-ended measurement configuration, if a common (same) state of polarization controller (scrambler) is used to control the SOP of both the light input into and output from the FUT, such as for FIGS. 2, 2C-G, the theoretical constant α_{ds} is

$${α}_{ds} = \sqrt{\frac{15}{4}} \qquad ( 4 b )$$

The reference mean-value uₒ is also different for different measurement configurations. For a two-ended measurement configuration or a single-ended measurement configuration using two independent scramblers, the reference mean-value uₒ is

$${u}_{0} = \frac{1}{2} \qquad ( 5 )$$

and, for a single-ended measurement configuration, if an incident state of polarization (I-SOP) of light is parallel to the analyzer axis, for example in FIG. 2C, the reference mean-value uₒ is

$${u}_{0} = \frac{2}{3} \qquad ( 6 )$$

It should be noted that the relationship in equation (1) holds for DGD·δν<½ for two-ended measurement configurations and DGD·δν<0.3 for single-ended measurement configurations, these relationships thus defining the meaning of “closely-spaced wavelengths”.

It should be noted that DGD(ν) and PMD computed from equations (1) and (3), respectively, are exact measured DGD and PMD values between input connector (16A) and output connector (16B) of FUT, and they may not present the one-way (forward) DGD or PMD from the FUT, for example, for the single-end measurement configuration, the measured values of DGD and PMD are a roundtrip value for FUT, but, for the two-end measurement configuration, a measured DGD or PMD extracted from equations (1) and (2) are an one-way (forward) DGD or PMD of the FUT. For the single-end PMD measurement configuration, a roundtrip factor

$$( {α}_{rt} = \sqrt{\frac{3}{8}} )$$

is required to multiply on a measured roundtrip PMD from equation (2) to provide one-way (forward) PMD of FUT.

The normalized power will in fact be obtained differently in each embodiment, i.e., by suitable programming of the data processor 34. This explanation of the theory is provided for the basic one-photodetector embodiment of FIGS. 1B, 2C and 3A, where normalization over the average power is both necessary and sufficient, assuming total power is stable when the (I-SOP, A-SOP) couple is changed, or as a function of time. Note that the normalization procedure for the two-ended measurement configuration (FIG. 1B) and single-ended (FIGS. 2C and 3A) are very similar, but reference mean-values (u₀) (see equations (5) and (6)) are different. Also note, for the single-ended cumulative PMD measurement, a normalized power trace (T(z)) as function of distance z is computed. A detailed description of this normalization procedure is provided hereinafter.

It should be note that equation (1) produces a DGD value at a given midpoint wavelength, defined as the average wavelength of the particular closely-spaced wavelengths used in the measurement and also it gives a DGD as function of optical wavelength/frequency. The equation (3) produces a PMD value for a prescribed wavelength range. The PMD is defined as the root-mean-square (rms) value of DGD by averaged over wavelength.

### Two-Ended PMD Measurement

The two-ended PMD measurement is often a case for most available PMD measurement techniques used in the field. The basic theory of randomly input and output SSA method described above can be applied for two-ended PMD measurement, where the test link may involve either no optical amplifier or with optical amplifiers. When optical amplifiers are used in the test link, the ASE lights from amplifiers will be mixed launched polarized coherent lights and, consequently, both ASE and launched lights are measured by photodetector 22A (FIG. 1B).

Below we describe how to apply our basic theory of SSA to two-ended PMD measurement that can be applied for these both cases, without or with optical amplifiers, for the test link, by accessing two ends of FUT.

Two-Ended Measurement: DGD Measurement without Amplifiers in the Test Link

If a tunable laser source, which can select its optical frequency by either step tuning, or frequency sweeping, or frequency modulation, or similar means, or if a polarized broadband light source is used, then tunable filter may be used to select the optical frequency (wavelength), and an input polarization controller are placed at a proximal of FUT and a polarization state analyzer, usually an output polarization controller, polarizer (or PBS) and a photodetector or power meter (combined with tunable filter if polarized broadband light source is used instead of tunable laser source) are located at the opposing end of FUT for measuring the power from fibers at two closely spaced optical frequencies, ν_{U} and ν_{L}, around a given midpoint frequency, ν_{mid}, for a large number K of input/output state of polarizations, i.e., comprising a large number of “SOP couples” (I-SOPₖ, A-SOPₖ) each referring to both the input-SOP and the analyzer axis “seen” by the received light. Both the I-SOP and the A-SOP values should be chosen in a pseudo-random manner, such that the points conventionally representing SOPs on the Poincaré sphere are substantially uniformly-distributed over the surface of said sphere, whether the distribution is random or approximately a uniform grid of points. By averaging over a sufficiently large, uniformly distributed number K of said SOP couples, the forward DGD at its midpoint frequency ν_{mid} (ν_{mid}=(ν_{U}+ν_{L})/2) can be calculated from equation (1) as,

$$DGD ( v ) = \frac{1}{π δ v} arcsin ( {α}_{ds} \sqrt{{〈 Δ {T}^{2} ( v ) 〉}_{SOP}} ) \qquad ( 7 )$$

It should be noted that equation (7) yields a one-way (forward) DGD value (i.e. DGD) at a given midpoint frequency (wavelength) for the FUT.

If the scrambling is carried out in such a way that either or both of the I-SOP and A-SOP is/are significantly different than its/their respective predecessor(s) or successor(s), i.e. when they are randomly or quasi-randomly selected on the Poincaré sphere, K should be greater than 10, typically about 100 to 200 for good quality results.

If, on the other hand, the scrambling is carried out in a slow, continuous fashion, as described in more detail hereinafter, such that either or both the I-SOP and A-SOP is/are only slightly different than its/their respective predecessor(s) or successor(s), then K should be greater than 500, typically about 10,000, to ensure a substantially uniformly distributed about the respective Poincaré spheres, and hence obtain good quality results.

As already mentioned, the PMD is defined as the root-mean-square (rms) value of DGD by averaged over wavelength (note the DGD averaged over time may give rms DGD, not mean DGD). An rms DGD (i.e. PMD) over the prescribed wavelength range now is computed by equation (2) as:

$$PMD = \frac{1}{π δ v} arcsin ( {α}_{ds} \sqrt{{〈 Δ {T}^{2} ( v ) 〉}_{SOP ; v}} ) \qquad ( 8 )$$

$${α}_{ds} = \sqrt{\frac{9}{2}}$$

It should be appreciated that, in equations (7) and (8), must be used for the two-ended PMD measurement configuration or a single-ended measurement configuration using two independent scramblers. The relationship holds for DGD·δν<0.5, thus clarifying the meaning of “closely-spaced wavelengths”.

In the limit of a sufficiently small optical-frequency difference (“step”) between the closely-spaced wavelengths, equations (7) and (8) can simplify to yield the simpler differential formula that follows,

$$\begin{matrix}DGD ( v ) = \frac{{α}_{ds}}{π δ v} \cdot \sqrt{{〈 Δ {T}^{2} ( v ) 〉}_{SOP}} & ( 7 a ) \\ PMD = \frac{{α}_{ds}}{π δ v} \cdot \sqrt{{〈 Δ {T}^{2} ( v ) 〉}_{SOP ; v}} & ( 8 a )\end{matrix}$$

Note that equations (7) and (8) can directly adapt basic theoretical equations in (1) and (3) to compute the forward DGD and PMD of FUT.

Two-Ended Measurement: DGD Measurement with Amplifiers in the Test Link

In many field applications, optical amplifiers (typically erbium-doped optical amplifiers) have been inserted into the link. That is, the FUT 18 may comprise at least one, and possibly several, optical amplifiers at various spacings (e.g. 60 km) within the FUT 18. When an optical amplifier is present, a power meter located at distal end of FUT 18 will likely also detect (substantially unpolarized) amplification spontaneous emission (ASE) light in addition to the signal emitted by the optical generator means. The presence of ASE in the detected signal can be taken into account by “scaling down” the mean-square differences [symbol] ΔT(ν)² [symbol] _{SOP} by a factor that can be computed independently from the same raw data. This factor, σᵣ²(ν), is a relative variance of the normalized powers defined as,

$${σ}_{r}^{2} ( v ) = {( \frac{1}{{σ}_{20}} )}^{2} [ {〈 T ( v ) {T}^{″} ( v ) 〉}_{SOP} - {〈 T ( v ) 〉}_{SOP}^{2} ] \qquad ( 9 )$$

where the reference variance is σ₂₀²= 1/12. The notation [symbol] T(ν)T″(ν) [symbol] _{SOP} and [symbol] T(ν) [symbol] _{SOP} refer to averages over both normalized powers at ν_{U} and ν_{L} and T(ν) and T″(ν) are the normalized powers from repeated measurements in one group at one given optical frequency. (Note, if noise can be neglected for the measured normalized power, T(ν) and T″(ν) may be the same normalized power, i.e. corresponding to only one measurement in one group at one given optical frequency. Also note for the normalized powers T(ν) averaged over a sufficient number of randomly scrambled SOPs,

$${〈 T ( v ) 〉}_{SOP}^{2} = \frac{1}{4} ) .$$

Then a forward DGD (one-way) at a given midpoint wavelength is obtained by dividing the mean-square differences by the relative variance in equation (9) as,

$$DGD ( v ) = \frac{1}{π δ v} arc sin ( {α}_{ds} \sqrt{\frac{{〈 Δ {T}^{2} ( v ) 〉}_{SOP}}{{σ}_{r}^{2} ( v )}} ) \qquad ( 10 )$$

And, moreover, a forward rms PMD (one-way) for a prescribed wavelength range can be expressed by,

$$PMD = \frac{1}{π δ v} arc sin ( {α}_{ds} \sqrt{\frac{{〈 Δ {T}^{2} ( v ) 〉}_{SOP ; v}}{{σ}_{r}^{2}}} ) \qquad ( 11 )$$

where the average over SOP in equation (10) is now replaced by the average over both SOP and optical frequency (wavelength), and a relative variance of the normalized powers now is expressed as,

$${σ}_{r}^{2} = {( \frac{1}{{σ}_{0}} )}^{2} [ {〈 T ( v ) {T}^{″} ( v ) 〉}_{SOP ; v} - {〈 T ( v ) 〉}_{SOP ; v}^{2} ] \qquad ( 12 )$$

In the limit of a small step, equations (10) and (11) simplify to a differential formula as,

$$\begin{matrix}DGD ( v ) = \frac{{α}_{ds}}{π δ v} \cdot \sqrt{\frac{{〈 Δ {T}^{2} ( v ) 〉}_{SOP}}{{σ}_{r}^{2} ( v )}} & ( 10 a ) \\ PMD = \frac{{α}_{ds}}{π δ v} \cdot \sqrt{\frac{{〈 Δ {T}^{2} ( v ) 〉}_{SOP ; v}}{{σ}_{r}^{2}}} & ( 11 a )\end{matrix}$$

It should be noted that if two launched powers of “closely-spaced wavelengths” are equal and there is negligible differential spectral attenuation from FUT for these “closely-spaced wavelengths”, the measured powers for “closely-spaced wavelengths” can directly be applied into equations (10) and (11), i.e. no need any normalization for measured powers (note in this case, [symbol] T(ν) [symbol] _{SOP}² may not be equal %). This is because, under this condition, the normalization procedure described above (see Eq. 2b) may only produce a ‘constant factor’ that is multiplied on measured powers in order to obtain normalized power (between 0 and 1), but by using equations (10) and (11) to compute DGD or PMD, this constant ‘factor’ is eventually cancelled because there is an exactly the same ‘factor’ multiplied on both mean-square difference and relative variance if they are both directly computed from measured powers. In other words, if equations (10) and (11) are used, only relative powers that are proportional to normalized powers are required to be obtained to calculate the DGD or PMD.

It should be appreciated to note that equations (10) and (11) are applicable with or without the presence of amplifier noise on the link under test.

An alternative method of the invention, an estimate of the PMD (i.e. rms or mean DGD value over an optical frequency range) can be obtained by well-known root-mean square or mean averaging all single DGD(ν) values at different midpoint wavelengths indicated in equation (7) or (10) over an optical frequency range.

### Single-ended PMD Measurement

The single-ended PMD measurement is a very important measurement technique for the field application. The above basic theory of SSA described above can also be applied for single-ended PMD measurement. The single-ended PMD measurement described here is divided into two cases: the first case is to measure all overall PMD of a FUT by analyzing backreflected light from another distal end of FUT, and the second case is to measure cumulative PMD as function of FUT length. Both cases only access one end of FUT.

### Single-Ended Measurement: Overall PMD

For the single-ended PMD measurement using backreflected light from the distal end of fiber, it may be often involving the test fiber without optical amplifiers. Below we describe our basic SSA theory being applied for the single-ended overall PMD measurement by accessing only one end of FUT.

If a mirror (such as a fiber pigtailed mirror) is connected at the distal end of the FUT, and if one could neglect Rayleigh backscattering and any spurious discrete reflections (e.g. from any connectors or splices) along the FUT, the tunable OTDR could be replaced by a tunable CW laser (no pulses) and a power meter for measuring the power reflected from the mirror at the distal end of the FUT at two closely spaced optical frequencies, ν_{U} and ν_{L}, around a given midpoint frequency, ν_{mid}, for a large number K of (I-SOP, A-SOP) couples, i.e., one such setting referring to both the input-SOP and the analyzer axis “seen” by the backreflected light. (N.B. λ=c/ν, where λ is the vacuum wavelength of the light. Although the use of optical frequency is more “natural” in this theory, in practice, for closely-spaced wavelengths, wavelengths can be used, it being understood that the appropriate conversion factors are applied to the equations presented herein.). It has been found from basic PMD measurement theory above that, on average over a sufficiently large, uniformly distributed number K of said (I-SOP, A-SOP) couples, the mean-square difference between normalized powers (i.e. transmission) observed at ν_{U} and ν_{L} is related to the roundtrip-DGD(ν) at its midpoint optical frequency ν_{mid} (ν_{mid}=(ν_{U}+ν_{L})/2) by a simple relationship as Equation (1), valid in all cases for any type of practical FUT regardless of its degree of randomness or its polarization coupling ratio, including the extreme case of a PMF fiber, as,

$${DGD}_{RoundTrip} ( v ) = \frac{1}{π δ v} arcsin ( {α}_{ds} \sqrt{{〈 Δ {T}^{2} ( v ) 〉}_{SOP}} ) \qquad ( 12 )$$

where a theoretical constant value

$${α}_{ds} = \sqrt{\frac{15}{4}}$$

for the single-ended roundtrip DGD measurement, [symbol] _{SOP} represents the average over the K (I-SOP, A-SOP) couples, δν=(ν_{U}−ν_{L}) is the “step”, ΔT is the difference between the normalized powers observed at ν_{U} and ν_{L}, respectively.

The relationship holds for DGD_{RoundTrip}·δν<½, thus clarifying the meaning of “closely-spaced wavelengths”.

The roundtrip DGD(ν) derived by equation (12) is not double the forward DGD(ν). The roundtrip DGD_{RMS} extracted from rms of DGD(ν) over a wavelength range is also not double. For the late case, however, when averaged over wavelength, or time, the PMD value (statistical average) (i.e. rms DGD) is related to the roundtrip-PMD (i.e. rms DGD_{RoundTrip}) through a simple factor, the roundtrip factor αᵣₜ=\sqrt{⅜}, i.e., DGD_{RMS}=αᵣₜ·DGD_{RoundTripRMS} or PMD=αᵣₜ·PMD_{RoundTrip}, where PMD is defined as the root-mean-square (RMS) value of DGD.

It should be noted that a different roundtrip factor results if the alternative definition of PMD, i.e., the mean value of DGD, is used instead of the RMS-DGD definition.

Typically, in order to measure an overall PMD reliable, a tunable OTDR should be used. The tunable OTDR launches relatively long pulses into the FUT, the at least one photodetector in the OTDR then detecting the backreflected power of the localized reflection at the distal end of FUT.

The roundtrip DGD of the FUT section comprised between the output of the instrument and the selected reflection is obtained as previously from equation (12), where the power observed for a given (I-SOP, A-SOP) couple is now obtained as, for example, the power of the pulse backreflected from the selected reflection averaged over a predetermined portion of the pulse duration.

It is noteworthy that the above defined backreflected power may be obtained by averaging each response pulse over a substantial portion of its duration, therefore it is preferable to apply a long OTDR pulse (e.g. 1 to 20 us) for this single-ended PMD measurement technique.

Furthermore, in preferred embodiments of the invention if an overall total PMD is desirable to be measured, the averages indicated in equation (12), are preferably carried out over both I-SOP, A-SOP and midpoint-wavelengths, all three of which are changed from one group of two closely-spaced wavelengths to the next, thus obtaining the roundtrip PMD instead of only one particular DGD at one particular wavelength. A roundtrip rms DGD (i.e. roundtrip PMD) over the prescribed wavelength range is expressed as:

$$P M {D}_{RoundTrip} = \frac{1}{π δ v} arcsin ( {α}_{ds} \sqrt{{〈 Δ {T}^{2} ( v ) 〉}_{SOP ; v}} ) \qquad ( 13 )$$

Moreover, the forward PMD value (simply denoted as “PMD”) is related to the round-trip PMD by a proportionality factor, the “round trip factor”, αᵣₜ=\sqrt{⅜}, that is:

PMD=αᵣₜ·PMD_{RoundTrip} (14)

In the limit of a sufficiently small optical-frequency difference (“step”) between the closely-spaced wavelengths, equations (12) and (13) simplify to yield the simpler differential formula that follows,

$$\begin{matrix}D G {D}_{RoundTrip} ( v ) = \frac{{α}_{ds}}{π δ v} \cdot \sqrt{{〈 Δ {T}^{2} ( v ) 〉}_{SOP}} & ( 12 a ) \\ P M {D}_{RoundTrip} = \frac{{α}_{ds}}{π δ v} \cdot \sqrt{{〈 Δ {T}^{2} ( v ) 〉}_{SOP ; v}} & ( 13 a )\end{matrix}$$

A PMD measured based on equation (13) or (13a) has an advantage of short acquisition time. However, a rms DGD_{RoundTrip} or mean DGD_{RoundTrip} can also be obtained from measured DGD_{RoundTrip}(ν) for many different midpoint wavelengths (i.e. optical frequencies ν) by root-mean square or mean DGD_{RoundTrip}(ν) from equation (12) or (12a) over a prescribed optical frequency (i.e. wavelength) range, e.g.

$$rms D G {D}_{RoundTrip} = \sqrt{{〈 D G {D}_{RoundTrip}^{2} ( v ) 〉}_{v}}$$

$$and$$

$$mean D G {D}_{RoundTrip} = {〈 D G {D}_{RoundTrip} ( v ) 〉}_{v} .$$

A forward rms DGD and mean DGD are then obtained by simply multiplying a roundtrip factor of \sqrt{⅜} and 2/π on rms DGD_{RoundTrip} and mean DGD_{RoundTrip}, respectively.

It should be noted that the pulse length used for the single-ended overall PMD measurement should be less than fiber (FUT) length, preferably significantly less (to avoid excessive Rayleigh scattering noise, for instance), e.g. 1 us corresponds to a fiber length of 100 m. It is also preferred to average the detected backreflected light power over several or many optical pulses, e.g. from 10 to 1000 pulses.

Also, it should be emphasized preferred PMD measurement from the single-ended overall PMD measurement should use several or many different midpoint wavelengths, e.g. 20 to 2000, in order to improve the fundamental PMD measurement accuracy.

### Single-Ended Measurement: Cumulative PMD

Above equations (12) and (13) described for the single-ended overall PMD measurement can apply for measuring single-ended cumulative PMD as a function of distance z by analyzing the Rayleigh backscattering lights for each location (z) along FUT length. In order to resolve fiber beat length it is necessary to use a short light pulse, for example from a tunable OTDR. Note that to use a too short light pulse would limit a measurable FUT length but a too long pulse may not be able to resolve the beat length of fiber.

Indeed, if a very short light pulse is used, OTDR ‘traces’, or backreflected power as a function of distance z, are the same as if the above single-ended overall PMD measurement were repeated an infinite number of times, with the end reflector shifted by a distance increment dz between measurements. Providing that the pulses are very short, and also ignoring the fact that the “coherence noise” always adds to an OTDR trace, the same result as in equation (12) is obtained, except that it is obtained as a function of distance z in one step. The different ΔT(ν,z) values obtained with different (I-SOP, A-SOP) couples are now differences between whole OTDR traces as a function of z, instead of just one number, and give DGD_{RoundTrip}(ν,z). Note T(ν,z) is a normalized trace as function of fiber length z.

It is generally impractical to use very short pulses in the field, however, because attaining a useful dynamic range would require an exceedingly long measurement time. Also, reduction of the high level of coherence noise resulting from the use of short pulses may require an unacceptably large equivalent laser linewidth, which results in a small maximum measurable PMD. The present invention takes account of the finding that, with large pulses, the mean-square differences [symbol] ΔT(ν,z)² [symbol] _{SOP} are simply ‘scaled down’ by a factor that can be computed independently from the same raw data. (Note that here the subscript SOP denotes an average over the (I-SOP, A-SOP) couples.) This factor, σᵣ²(z, ν), is the relative variance of the traces, a function of z depending on local characteristics of the fiber, defined as,

$${σ}_{r}^{2} ( z , v ) = {( \frac{1}{{σ}_{10}} )}^{2} [ {〈 T ( z , v ) {T}^{′′} ( z , v ) 〉}_{SOP} - {〈 T ( z , v ) 〉}_{SOP}^{2} ] \qquad ( 14 )$$

where the reference variance is σ₁₀²= 4/45. The roundtrip DGD at a given midpoint wavelength then is obtained by dividing the mean-square differences in equation (12) by the relative variance in equation (14), i.e.

$$D G {D}_{RoundTrip} ( z , v ) = \frac{1}{π δ v} arc sin ( {α}_{ds} \sqrt{\frac{{〈 Δ {T}^{2} ( z , v ) 〉}_{SOP}}{{σ}_{r}^{2} ( z , v )}} ) \qquad ( 15 )$$

Furthermore, in preferred embodiments of the invention the averages indicated in equations (14) and (15) are preferably carried out over both (I-SOP, A-SOP) couples and center wavelengths, both of which are changed from one group of two closely-spaced wavelengths to the next, thus obtaining the roundtrip PMD instead of only one particular DGD at one particular wavelength.

$$P M {D}_{RoundTrip} ( z ) = \frac{1}{π δ v} arc sin ( {α}_{ds} \sqrt{\frac{{〈 Δ {T}^{2} ( z , v ) 〉}_{SOP ; v}}{{σ}_{r}^{2} ( z )}} ) \qquad ( 16 )$$

Moreover, since the typical user will prefer the more practically useful “forward” PMD value to be displayed instead of the roundtrip value, the result is multiplied by the above-specified roundtrip factor, αᵣₜ=\sqrt{⅜}. Thus, the forward PMD is as,

PMD(z)=αᵣₜ·PMD_{RoundTrip}(Z) (17)

where the average over (I-SOP, A-SOP) couples in equation (14) is also replaced by the average over both (I-SOP, A-SOP) couples and wavelength, i.e.

$${σ}_{r}^{2} ( z ) = {( \frac{1}{{σ}_{10}} )}^{2} [ {〈 T ( z , v ) {T}^{′′} ( z , v ) 〉}_{SOP ; v} - {〈 T ( z , v ) 〉}_{SOP ; v}^{2} ] \qquad ( 18 )$$

It should be noted that a roundtrip rms DGD or a roundtrip mean DGD (i.e. roundtrip PMD) can also be obtained by root-mean square average or mean average roundtrip DGD at given midpoint wavelength over prescribed wavelength range as

$$rms D G {D}_{RoundTrip} ( z ) = \sqrt{{〈 {DGD}_{RoundTrip}^{2} ( z , v ) 〉}_{v}}$$

$$and$$

$$mean D G {D}_{RoundTrip} ( z ) = {〈 {DGD}_{RoundTrip} ( z , v ) 〉}_{v} .$$

A forward rms DGD(z) and mean DGD(z) are then obtained by simply multiplying a roundtrip factor of \sqrt{⅜} and 2/π on rms DGD_{RoundTrip} and mean DGD_{RoundTrip}, respectively.

In the limit of a sufficiently small optical-frequency difference (“step”) between the closely-spaced wavelengths, equations (15) and (16) simplify to yield the simpler differential formula that follows,

$$\begin{matrix}D G {D}_{RoundTrip} ( z , v ) = \frac{{α}_{ds}}{π δ v} \cdot \sqrt{\frac{{〈 Δ {T}^{2} ( z , v ) 〉}_{SOP}}{{σ}_{r}^{2} ( z , v )}} & ( 15 a ) \\ P M {D}_{RoundTrip} ( z ) = \frac{{α}_{ds}}{π δ v} \cdot \sqrt{\frac{{〈 Δ {T}^{2} ( z , v ) 〉}_{SOP ; v}}{{σ}_{r}^{2} ( z )}} & ( 16 a )\end{matrix}$$

It should be note that, as yet another possible, although undesirable alternative, it is also envisaged that, in the above equations (8), (11), (13) and (16), the averages over (I-SOP, A-SOP) couples and wavelengths could be replaced by averages over a large range of optical frequencies (i.e., wavelengths) only, where the (I-SOP, A-SOP) couple is kept constant. However, in this “constant-SOP” case, the method loses its applicability to all FUT types, i.e., if only the midpoint wavelength is scanned without scrambling of the (I-SOP, A-SOP) couples being applied, these relationships are no longer universally valid, and may be significantly less reliable and/or accurate—even if still roughly valid. Generally, if no scrambling is performed, the methods are only valid if the FUT is “ideal” or “nearly ideal”, i.e., it exhibits excellent random coupling and has an infinite or “near-infinite” polarization coupling ratio, and if one chooses a large value of the PMD·Δν product (typically >10), where Δν is the width of the optical frequency range. As a consequence, small PMD values cannot be measured with any reasonable uncertainty in practice. In addition, one frequently wishes to perform measurement on older installed fibers, which are generally much less “ideal” than fibers produced since about 2001.

It should be noted that the equations for computed DGD or PMD described above as well as below sections as the simple differential formula are fundamental equations for the limit of a sufficiently small optical-frequency difference (“step”) between the closely-spaced wavelengths and large “step” arcsine formula are obtained from the simple differential formula in order to achieve a best performance for the instrument.

It should also be noted that any equations for computed DGD or PMD described above as well as below sections that use relative variance may be applied for both normalized power (including normalized OTDR trace) and relative power (including relative OTDR trace). And also note that a relative power (or relative OTDR trace) is proportional to a normalized power (or normalized OTDR trace).

It should be noted that a pulse length used for the single-ended cumulative PMD measurement should be not very much greater than the fiber beat length, preferably less than ten times the beat length.

As well, each measured OTDR trace should comprise an average over several or many optical pulses, e.g. from 10 to 10,000 pulses.

Also note that preferred PMD measurement from the single-ended cumulative PMD measurement should use several or many different midpoint wavelengths, e.g. 10 to 1000, as a greater number of such midpoint wavelengths will lead to a better fundamental PMD measurement accuracy.

### Method of Operation, Data Processing and Computation

Two-ended PMD measurement, single-ended overall PMD measurement and single-ended cumulative PMD measurement have their common basic fundamentals of the ‘randomly input and output sate of polarization scrambling analysis (SSA) for PMD measurement’, but their detailed operations for designed instruments are not the same. For example, the two-ended measurement must place the optical source means at one end of FUT and analyzer-and-detection means at another end of FUT. The applied light source may also be different, for example, two-ended PMD measurement may employ either a continuous wave (CW) or pulsed light source if it can select or modulate optical frequency of light to produce two or three closely spaced wavelengths for the measurement, but for the single-ended PMD measurement, it is necessary to use a pulsed light source (usually a tunable OTDR) to resolve the reflecting from the distal end of FUT. Even for the single-ended PMD measurements of overall PMD and cumulative PMD measurements, they still have slightly different operations regarding pulse length, number of closely spaced wavelengths, acquired data and data processing.

Therefore, below we will describe the method of operation, data processing and computation in three different sections for Two-Ended PMD Measurement, Single-ended Overall PMD Measurement and Single-ended Cumulative PMD Measurement.

Method of Operation: Two-Ended DGD and/or PMD Measurement

The method of operation for the two-ended PMD measurement instrument shown in FIG. 1 for measuring DGD and/or PMD will now be described in more detail with reference to the flowcharts shown in FIGS. 4A, 4B, 4C and 4D. In steps 4.1 and 4.2, the user first installs the application and inserts the test modules in the platforms, then starts testing software to cause the system to initialize the test modules, specifically initializing the wavelength of the polarized light source 12 (either tunable laser source 12A or broadband light source 12B), the Input SOP controller 14A, the analyzing means 14B and 20 and the detection 22 and processing section 34. Then the one end of fiber under test (FUT) 18 would be connected to source module before Input-SOP controller 14A and the distal end of FUT 18 would be connected to analyzer-and-detection module, and patch cords with either a PC or an APC connector (such as FC/PC or FC/APC), or direct bulkhead connectors, are used to connect the modules with the FUT. Most instrument parameters will usually be factory set according to customer requirements, but the user may manually select parameters for both light source and analyzer by steps 4.1c and 4.3, respectively. Assuming that the user selects manual parameter setting, the program proceeds to the manual parameter setting steps 4.1c and 4.4 and prompts the user as follows:

(a) To set a center wavelength for the tunable laser source 12A or tunable filter 27.
(b) To set a wavelength range [λmin, λmax] for the group center wavelengths that will be encompassed by the light source 12 providing that is correspond to an accessible wavelength range of the FUT 18.
(c) If available (i.e. not fixed at factory), to set the step or difference δν (or δλ) between the pairs closely-spaced optical frequencies ν_{U} and ν_{L} (or wavelengths). Alternately, the user may enter the anticipated PMD value for the FUT and leave the processor to compute and then select the wavelength (i.e. optical frequency) step. As an example, the step can be conveniently set as δν=α_{δν}·PMD⁻¹ where α_{δν}˜0.15 to 0.2 and, thus, δλ can be extracted from δλ≈(c/ν_{c}²)·δν where ν_{c}=(ν_{U}+ν_{L})/2. (Note: there is an optimal step for a given PMD value, as large as possible so as to maximize signal-to-noise ratio, but small enough to satisfy the above condition, i.e., PMD·δν<0.15 to 0.2. It is also noted that closely-spaced optical frequencies (or wavelengths) may also be more than two and this may be especially interesting for testing and monitoring where DGD or PMD from FUT may be varied versus time.)
(d) To set the number K of center-wavelengths and/or states of polarization selected by the I-SOP scrambler 14A and A-SOP scrambler 14B, i.e., the number (K) of groups of data to be acquired. For example, K may be set as 1000 to 100,000. Or, optionally, for the continuously scanning input and output SOP mode, only to set the number K of center-wavelengths and then to set a scanning time for both input SOP controller 14A and analyzing means 14B and 20. Or, optionally, if only one center-wavelengths is selected, to set the number K of states of polarization selected by the I-SOP scrambler 14A and A-SOP scrambler 14B or a scanning time for the continuously scanning both I-SOP scrambler 14A and A-SOP scrambler 14B.
(f) Optionally, set the number of durations of pulses to be averaged to obtain each individual power (for example 2 or >100) if series of modulated optical pulses are set into the FUT. No any setting required if only one modulated optical pulses being launched into the FUT.
(g) Set an overall total acquisition time for each individual PMD measurement and number of PMD measurement as well as its waiting time between any two measurements.
(h) Select the modulated optical pulse duration Tp. Typically, a long pulse length is selected for the measurement because it has leads to a high dynamic range, and a high signal-to-noise ratio although a short pulse may still be used. (Typically, the modulated optical pulse length is chosen to be between 100 μs to 1 s, although pulse lengths outside of this range are also feasible.
(i) Optionally, set an input power of the tunable optical source means.
(j) Optionally, adjusting the power entering the analyzer module from the FUT by means of an optical attenuator in the optical path, for example, at a location just after the input of the analyzer module. But it is usually automatically set by the instrument.
(k) Optionally, enter the cable or fiber name and/or its relevant information.
(l) Save all measurement parameters to a data file that will be retrieved for data processing by the data processor 34.

If, in decision step 4.3, the user selects automatic parameter setting, the program starts the auto parameter setting procedure in step 4.5 and carries out the following steps:

(a) Select pre-defined certain default measurement parameters, namely
(1) The center wavelength range [λmin, λmax] that will be covered by the light source 12,
(2) Number K of SOPs and/or center wavelengths by the I-SOP scrambler 14A and A-SOP scrambler 14B (for example, 1000-10,000) for one PMD data acquisition, or, alternatively, a scanning time of both or either of I-SOP scrambler 14A and A-SOP scrambler 14B,
(3) Time for each individual acquisition (measurement), waiting time between any two individual acquisitions, and number of repeated acquisitions,
(4) Frequency pulse duration Tp (or length) for tunable coherent source, and
(5) Launched light power and received power.
   (b) The test module may also be designed to have a pre-scan acquisition using a reduced number of groups, such as K=50-100, to obtain estimations of optimal wavelength step frequency difference δν (or δλ) between the two closely-spaced optical frequencies ν_{U} and ν_{L} (or wavelengths λ_{U} and λ_{L}). Pre-scan data acquisition is performed to find the appropriate step or difference δν (frequency) or δλ (wavelength) between the two closely-spaced optical frequencies ν_{U} and ν_{L}, (or λ_{U} and λ_{L}). For example, such data acquisition may be carried out by using, for each group, four different laser wavelengths to obtain a total combination of six different frequency or wavelength steps. In this case, good communications between the two ends of the FUT may be required.
   (c) Auto mode may also be designed to automatically produce cable or fiber name and/or with relevant information;

Once the measurement parameters have been entered, whether manually or automatically, the program proceeds to step 4.6 and computes wavelength step δλ (or frequency difference δν) if the anticipated total PMD of the FUT has been specified or estimated via the aforementioned auto-setting procedure, and the appropriate sequence of wavelengths λs based on the parameter settings. It is preferred to use three or four (or even more) different laser wavelengths to produce three or six (or even more) different wavelength steps to cover wide measurable PMD range.

Finally, all the measurement parameters, whether directly specified or computed as described above, are stored in the header of the data file or instrument (Step 4.7).

It should be noted that a linewidth of the tunable coherent source will usually be set, in the factory or by design, at a relatively small level (e.g. of <1 to 2 GHz) in order to ensure the ability to measure a high PMD (e.g. >50 ps) from the FUT.

It should be noted that, conveniently, at each SOP and/or center wavelength, the frequency difference δν (or wavelength step δλ) between the two closely-spaced optical frequencies ν_{U} and ν_{L} (wavelengths λ_{U} and λ_{L}) may remain the same or similar. Each SOP and/or wavelength may only be set in a short time period.

It should be re-emphasized, that in order to obtain a reliable PMD measurement of the FUT, it is preferable that the acquisition should be undertaken for several or many (I-SOP, A-SOP) couples and/or different center wavelengths.

FIG. 4(C) shows in more detail of the data acquisition step 4.10 to acquire a kth group of powers. The pre-defined wavelength step of δλ can be used to compute a sequence of wavelengths λs as already discussed in step 4.6. The frequencies νᵢ^{(k)} and ν_{U}^{(k)} are calculated with satisfaction of ν_{L}^{(k)}−ν_{U}^{(k)}=δν where δν is the frequency difference (or when the wavelength difference δλ, is used, it satisfies λ_{U}^{(k)}−λ_{L}^{(k)}=δλ). The maximum measurable PMD, PMDₘₐₓ corresponding to a given step δν, can be estimated as PMDₘₐₓ˜αᵣₜ(πδν)⁻¹ and δλ can be extracted from δλ=(λ₀²/c)·δν where λ₀=(λₘᵢₙ+λₘₐₓ)/2. The control unit 30 control (b) of the test module to obtain the kth group of powers as follows:
Set SOPₖ by the I-SOP scrambler 14A and A-SOP scrambler 14B (Step of 4.3.1 of FIG. 4(C)) if macroscopic SOP step selection is used for either or both of the scramblers (14A,14B), or, if continuous SOP scanning is used for either or both of the scramblers (14A,14B), set a scan time for both or either of input and output SOP scramblers (14A,14B) where the input and output SOPs may be slowly continuously randomly scanned to uniformly cover Poincaré sphere. It should be noted that input and output SOP scramblers (14A,14B) may be set as any one of two polarization control modes of step SOP adjustment or continuous SOP scanning.
Control the light source 12 or tunable filter 27 to set the lower wavelength to λ_{L}^{(k)} (Step of 4.3.2 of FIG. 4C). Detection and processing unit 34 will acquire data of powers as P_{xL} and P_{yL} (Step of 4.3.3 of FIG. 4C). More details of this data acquisition are shown in FIG. 4D will be described below. The same data acquisition process is repeated to obtain duplicate or repeated powers of P_{xL}″ and P_{yL}″ (Step of 4.3.4 of FIG. 4C).
Repeat the same data acquisition for the upper wavelength λ_{U}^{(k)} (where the λ_{U}^{(k)} is also set by the light source 12 or tunable filter 27 while keeping the approximately same input and output SOPs controlled for both I-SOP scrambler 14A and A-SOP scrambler 14B. The detection and processing unit 36 then acquiring data of powers P_{xU} and P_{yU} and duplicates P_{xU}″ and P_{yU}″ (Steps of 4.3.5, 4.3.6 and 4.3.7 of FIG. 4C), or alternatively, the data may be acquired from one short period time but to split it as two data that present at different time.

FIG. 4D gives more detail of the data acquisition of step 4.3.3 shown in FIG. 4C for acquiring of P_{yL} and P_{xL} in the kth group of powers. The launched modulated optical pulses from the light source 12 are sent into FUT 18 and the output modulated optical pulses are exited from the distal end of FUT 18. The exited modulated optical pulses are then sent into the test analyzer module of instrument to be split into two routes—y and x—by either a PBS 20 or 20C or a coupler 21, for example a 3-dB coupler, with one of two output arms being connected with a linear polarizer 20A. The split light optical pulses entering into routes y and x are detected by two photodetectors, for example, two APDs such as 22B and 22C (or 20) (Steps of 4.4.1 and 4.4.2 of FIG. 4D). Alternatively, the exited modulated optical pulses incident into the test analyzer module are directly sent to a linear polarizer. The light pulses are either directly detected by one photodetector, for example, one APD such as 22A (FIG. 1B) or split into two routes—y and x—by a coupler 21, for example a 3-dB coupler, entering into routes y and x are detected by two photodetectors, for example, two APDs such as 22B and 22C (FIG. 1H). The ‘durations’ of the response signals of modulated optical pulses from the distal end of FUT are sampled or sampled and averaged to obtain ‘response pulse signals, such as P_{y}(t) and Pₓ(t) (Steps of 4.4.3 and 4.4.4 of FIG. 4D). The final sampled or sampled and averaged power of P_{yL} or P_{xL} are then obtained by averaging said previously acquired response pulse signals over its substantial portion of its duration around centre of the pulse of impulse response signals, Py(t) or Px(t), (Steps of 4.4.5 and 4.4.6 of FIG. 4D). The length of pulse duration to be averaged usually depends on pre-filtering of electronics.

Once the kth group of powers has been acquired as described above, in Step 4.10 (see FIG. 4B), the data of group k is saved into the data file in Step 4.11. Step 4.12 then increments the group number register.

The data acquisition step 4.10 and group storing step 4.11 will be repeated for different center-wavelengths and/or input and output SOP selected by the I-SOP scrambler 14A and A-SOP scrambler 14B in accordance with the manual parameter setting step of 4.4 or from auto parameter setting of step 4.5 or default parameter setting until K groups of powers have been acquired and stored in the data file.

The step 4.9 will decide whether or not this individual acquisition is completed. If decision step 4.9 gives a positive result and, in step 4.11, the program saves data in step 4.11. If not completed, acquisition will process the steps 4.10 and 4.11 again.

The step 4.8 will decide whether or not stat a new individual acquisition. If the entire measurement acquisition is finished, the step 4.15 will save all individual data for the overall entire acquisition. If not, the processor will reset k=0 to start a new individual acquisition for steps of 4-9, 4.10, 4.11 and 4.12. Step 4.16 will decide whether or not to start another acquisition.

At this stage, the measurement parameters and all groups of powers have been saved in the proper files.

The decision step 4.17 may launch data processor, step 4.18 may load currently available acquired data from data file, step 4.19 may process them to estimate the DGD value at given center wavelength or mean DGD or rms DGD (i.e. PMD) value over a wavelength range for the FUT and step 4.21 may display it. Optionally step 20 may allow the user to save the processed result, such as DGD or mean DGD or RMS DGD values versus time.

Optional decision from step 4.16 then may give the user an opportunity to initiate another acquisition process for the same FUT. If the user decides to do so, the program returns to the parameter setting step 4.3. If not, decision step 4.17 gives the user the option of exiting acquisition, in which case the data stored in the data file will be retained for later processing, or to initiate processing of already acquired and stored data of powers.

If processing is initiated, step 4.18 allows the user to select the date file to be processed in a conventional “open file” dialog box and the data processor 34 accesses the previously saved acquisition data comprising detected powers and associated measurement parameters from the data file, and uses the data to compute DGD or mean DGD or RMS DGD of the FUT.

It should note the above steps may obtain rms DGD (i.e. PMD) as well as to obtain DGD at given midpoint wavelength or DGD as function of wavelength, and a rms DGD or mean DGD may be computed as the method described in below sections that may also be included in data processing step 4.19.

Note that, for the case of K=1, i.e. the powers of light may be obtained in a similar manner for only one group having both the same input and output SOPs and same center-wavelength, one may also be able to roughly evaluate the PMD although this simple case may not be able to provide a sufficiently accurate and meaningful result, as there will likely be a very significant uncertainty on the measured result.

### Method of Operation: Single-Ended Overall PMD Measurement

The method of operation of the tunable OTDR based single-ended PMD measurement illustrated in FIGS. 2G and 2C will now be described with reference to the flowcharts shown in FIGS. 5A, 5B and 5C. In step 5.1, the user first installs the application and inserts the test module in the platform, then starts testing software to cause the system to initialize the test module, specifically initializing the tunable pulsed light source 12, the I/O-SOP controller 14 and the OTDR detection and processing section 34. Then the fiber under test (FUT) 18 would be connected to test module (i.e. instrument) and a patch cord with either a PC connector (such as FC/PC or FC/UPC) or a fiber-pigtailed mirror 50 is connected to the distal end of the FUT. This would create a localized reflection at the end of FUT that is used for the PMD measurement.

Decision step 5.2 prompts the user to select either manual parameter setting or automatic parameter setting. Assuming that the user selects manual parameter setting, the program proceeds to the manual parameter setting step 5.3 and prompts the user as follows:

(a) To set a wavelength range [λmin, λmax] for the group center wavelengths that will be encompassed by the tunable pulsed laser source 12.
(b) To set the step or difference δν (or δλ) between the pairs closely-spaced optical frequencies ν_{U} and ν_{L} (or wavelengths). Alternately, the user may enter the anticipated PMD value for the FUT and leave the processor 34 to select the wavelength step. As an example, the step can be conveniently set as δν=α_{δν}·PMD⁻¹ where α_{δν}˜0.1 to 0.15 and, thus, δλ can be extracted from δλ≈(c/ν_{c}²)·δν where ν_{c}=(ν_{U}+ν_{L})/2. (Note: there is an optimal step for a given PMD value, as large as possible so as to maximize signal-to-noise ratio, but small enough to satisfy the above condition, i.e., PMD·δν<0.1 to 0.15.)
(c) To set the number K of center-wavelengths and/or states of polarization selected by the I/O-SOP controller 14, i.e., the number (K) of groups of data to be acquired. For example, K may be set as 200.
(d) To set the averaging time Δt of each individual power (for example, Δt=0.05 or 0.10 second), or set the number of durations of pulses reflected from the distal end of the FUT to be averaged to obtain each individual power (for example 50 or 100). Note that after setting the averaging time Δt and the number K of center-wavelengths and/or states of polarization a total acquisition time for PMD measurement may also be obtained.
(e) To select the pulse duration Tp (e.g. 275, 1000, 2500, 5000, 10000, 20000 ns) or pulse length for OTDR. In order for the pulse reflected from the selected reflection not to be superposed in time with some portion of a pulse reflected from another reflection, the pulse length, Lₚ, shall be selected such that Lₚ<Δz, where Δz is the distance along the FUT between the selected reflection and the nearest of anyone or all other reflections. Typically, a long pulse length is selected for the single-ended PMD measurement because it has advantages of leading to high dynamic range, and/or a high signal to noise ratio, and/or a short averaging time (thereby a short overall acquisition time) although a short pulse may still be used.
(f) To set the FUT length, normally the full effective optical length of the FUT.
(g) Optionally to select a high dynamic range or a low dynamic range according to the optical fiber length. Typically, in a normal operation the test module prompts the user to select a high dynamic range, but it may also allow the user to test a very short fiber by choosing a low dynamic range for acquisition. With the low dynamic range mode, the output peak power of the launched OTDR pulses is reduced, either by inserting an optical attenuator in the optical path, for example, at a location just before the output of the test module, or electrically, for example, by decreasing the bias current of the gain medium of the tunable pulsed laser.
(h) Optionally to enter the cable or fiber name and/or its relevant information.
(i) Save all measurement parameters to a data file that will be retrieved for data processing by the data processor 34.

If, in decision step 5.2, the user selects automatic parameter setting, the program starts the auto parameter setting procedure in step 5.4 and carries out the following steps:

(a) Select pre-defined certain default measurement parameters, namely
(6) The center wavelength range [λmin, λmax] that will be covered by the tunable pulsed laser source 12,
(7) Number K of (I-SOP, A-SOP) couples and/or center wavelengths to be set by the I/O-SOP controller 14 (for example, 200) for a real single-ended PMD data acquisition,
(8) Averaging time Δt (for example, Δt=0.05 or 0.1 second) or the number of duration of pulse reflected from the distal end of the FUT to be averaged (for example 50 or 100) for each individual power, and
(9) Pulse duration Tp (or length) for OTDR.
   It is noted that these default parameters set in (1), (3) and (4) will also be used for pre-scan acquisition.
   (b) The test module will conduct a pre-scan acquisition using a reduced number of groups, such as K=50, to obtain estimations of the FUT length, of total loss from FUT and of optimal wavelength step frequency difference δν (or δλ) between the two closely-spaced optical frequencies ν_{U} and ν_{L} (or wavelengths λ_{U} and λ_{L}). The OTDR will launch a standard OTDR pulse (e.g, 1 or 10 μs) to detect the end of the fiber (or a user defined localized reflection) so that the FUT length can be obtained and the pulse repetition period (Tr) can also be deduced according to the round-trip time through the length of the fiber. From this OTDR acquisition, a loss of FUT may also be estimated, otherwise, a saturation situation on photodetectors may be observed if there is any. Then a decision can automatically be made on whether or not to reduce the output peak power for the OTDR light pulses. Pre-scan data acquisition is performed to find the appropriate step or difference δν (frequency) or δλ (wavelength) between the two closely-spaced optical frequencies ν_{U} and ν_{L} (or or λ_{U} and λ_{L}). For example, such data acquisition may be carried out by using, for each group, four different laser wavelengths to obtain a total combination of six different frequency or wavelength steps. The optimally appropriate wavelength step to be used in the actual single-ended PMD measurement data acquisition may be found by processing of these pre-scan acquisition data of powers. To save all automatically-selected measurement parameters to the header of the data file that will be retrieved for data processing by the data processor 34.
   (c) Auto mode may also be designed to automatically produce cable or fiber name and/or any other relevant information.

Once the measurement parameters have been entered, whether manually or automatically, the program proceeds to step 5.5 and computes wavelength step δλ (or frequency difference δν) if the anticipated total PMD of the FUT has been specified or estimated via the aforementioned auto-setting procedure, the repetition period Tᵣ according to the round-trip time through the length of the fiber, and the appropriate sequence of wavelengths λs based on the parameter settings.

Finally, all the measurement parameters, whether directly specified or computed as described above, are stored in the header of the data file (Step 5.6).

It should be noted that a linewidth of the tunable pulsed light source will usually be set, in the factory, to a relatively small value (e.g. of <4 GHz) in order to ensure the ability to measure a high PMD of the FUT.

With the group number register initialized to k=0, decision step 5.7 determines whether the total number of groups of powers have been acquired. If not, the program proceeds to step 5.8 to acquire the kth group of powers.

It should be noted that, conveniently, at each SOP and/or center wavelength, the frequency difference δν (or wavelength step δλ) between the two closely-spaced optical frequencies ν_{U} and ν_{L} (wavelengths λ_{U} and λ_{L}) may remain the same or similar. Each SOP and/or wavelength may only be set in a short time period.

It should be also noted, that it is preferable to acquire data for several or many SOP couples and different midpoint wavelengths, in order to determine the overall PMD.

FIG. 5B shows in more detail of the data acquisition step 5.8 to acquire a kth group of powers. The pre-defined wavelength step of δλ can be used to compute a sequence of wavelengths λs as already discussed in step 4.5. The frequencies ν_{L}^{(k)} and ν_{U}^{(k)} are calculated with satisfaction of ν_{L}^{(k)}−ν_{U}^{(k)}=δν where δν is the frequency difference (or when the wavelength difference δλ is used, it satisfies λ_{U}^{(k)}−λ_{L}^{(k)}=δλ). The maximum measurable PMD, PMDₘₐₓ corresponding to a given step δν, can be estimated as PMDₘₐₓ˜αᵣₜ(πδν)⁻¹ and δλ can be extracted from δλ≈(λ₀²/c)·δν where λ₀=(λₘᵢₙ+λₘₐₓ)/2. The control unit 30 controls the test module to obtain the kth group of powers as follows:
Set SOPₖ by the I/O-SOP controller (Step of 5.3.1 of FIG. 5B).
Control the tunable pulsed laser 12 to set the lower wavelength to λ_{L}^{(k)} (Step of 5.3.2 of FIG. 5B). Detection and processing unit 36 will acquire data of powers as P_{xL} and P_{yL} (Step of 5.3.3 of FIG. 5B). More details of this data acquisition are shown in FIG. 4C will be described below. The same data acquisition process is repeated to obtain duplicate or repeated powers of P_{xL}″ and P_{yL}″ (Step of 5.3.4 of FIG. 5B).
Repeat the same data acquisition for the upper wavelength λ_{U}^{(k)} (where the λ_{U}^{(k)} is also set by the tunable pulsed laser 12) while keeping the same (I-SOP, A-SOP) couple. The detection and processing unit 36 then acquiring data of powers Pₓᵤ and P_{yU} and duplicates P_{xU}″ and P_{yU}″ (Steps of 5.3.5, 5.3.6 and 5.3.7 of FIG. 5B).

FIG. 5C gives more detail of the data acquisition of step 5.3.3 shown in FIG. 5B for acquiring of P_{yL} and P_{xL} in the kth group of powers. The launched light pulses from the OTDR are sent into FUT and a small fraction (or most) of pulse lights are reflected from the localized reflector such as using either a PC connector of the patchcord or a fiber pigtailed mirror connected at the end of FUT. The reflected light pulses are then returned into the test module or instrument to be split into two routes—y and x—by either a PBS or a coupler, for example a 3-dB coupler, with one of two output arms being connected with a linear polarizer. The split light pulses entering into routes y and x are detected by two photodetectors, for example, two APDs such as 22′B and 22′C (Steps of 5.4.1 and 5.4.2 of FIG. 5C). The ‘durations’ of the response signals from the reflected light pulses by the distal end of FUT or any other locations along fiber are sampled and averaged to obtain ‘averaged’ mean response pulse signals, such as P_{y}(t) and Pₓ(t) (Steps of 5.4.3 and 5.4.4 of FIG. 5C). The final averaged power of P_{yL} or P_{xL} are then obtained by averaging said previously sampled and averaged mean response pulse signals over its substantial portion of its duration around centre of the pulse of impulse response signals, Py(t) or Px(t), (Steps of 5.4.5 and 5.4.6 of FIG. 5C). The length of pulse duration to be averaged usually depends on pre-filtering of electronics.

Once the kth group of powers has been acquired as described above, in Step 5.9 (see FIG. 5A), the data of group k is saved into the data file. Step 5.10 then increments the group number register.

The data acquisition step 5.8 and group storing step 5.9 will be repeated for different center-wavelengths and/or (I-SOP, A-SOP) couples selected by the I/O-SOP controller 14 in accordance with the manual parameter setting step of 5.3 or from auto parameter setting of step 5.4 until K groups of powers have been acquired and stored in the data file.

At this stage, the measurement parameters and all groups of powers have been saved in the same data file associated with the header information of measurement parameters.

During the data acquisition the step 5.20 (optionally) may load any currently available acquired data from data file and process them to estimate the RIMS DGD (i.e. PMD) value for the FUT 18 and step 5.21 may display it as well as elapsed time of the acquisition, length and loss of the FUT. Note the estimated PMD value may frequently be varied until the end of the data acquisition. Optionally step 5.22 may allow the user to save the processed result.

Also at this stage, decision step 5.7 gives a positive result and, in step 5.11, the program saves and closes the data file in step 5.11.

Optional decision from step 5.12 then may give the user an opportunity to initiate the acquisition of another K groups of powers for the same FUT. If the user decides to do so, the program returns to the parameter setting step 5.2. If not, decision step 5.13 gives the user the option of exiting acquisition, in which case the data stored in the data file will be retained for later processing, or to initiate processing of already acquired and stored data of powers.

If processing is initiated, step 5.14 allows the user to select the date file to be processed in a conventional “open file” dialog box, whereupon, in step 5.16, the data processor 34 accesses the pre-saved acquisition data of powers and associated measurement parameters from the data file, and uses the data to compute total RMS DGD (i.e., PMD) of the FUT. On the other hand, box 5.15, which is not a “step” as such, indicates that the user may launch the data processing software independently at any time, allows the user may launch the data processing software independently at any time to process any previously acquired data file. In step 5.17, the data processor 34 saves the result of computed PMD value and measurement parameters in a file and in step 5.18 displays or otherwise outputs the measured PMD value with possible other results such as length and loss of the FUT.

Note that, for the case of K=1, i.e. the powers of light backreflection may be obtained in a similar manner for only one group having both the same (I-SOP, A-SOP) couple and same center-wavelength, one may also be able to roughly evaluate the PMD although this simple case may not be able to provide a sufficiently accurate result, as there may be a significant uncertainty on the measured result.

The manner in which the data processing step 5.16 processes the stored data will be described in the sections below.

It should note the above step may obtain rms DGD (i.e. PMD), but it can also obtain DGD as function of optical frequency (wavelength) and then rms DGD or mean DGD may be computed as the method described in below sections that may also be included in data processing step 5.16.

### Method of Operation: Single-Ended Cumulative PMD Measurement

The method of operation of the POTDR illustrated in FIG. 3 for measuring cumulative PMD as function of FUT length will now be described with reference to the flowchart shown in FIGS. 6A and 6B. In step 6.1, the user causes the system to initialize the POTDR, specifically initializing the tunable pulsed light source 12, the I/O-SOP controller 14 and the OTDR detection and processing section. Decision step 6.2 prompts the user to select either manual parameter setting or automatic parameter setting. Assuming that the user selects manual parameter setting, the program proceeds to the manual parameter setting step 6.3 and prompts the user as follows:

(a) To set the wavelength range [λmin, λmax] of the group center wavelengths that will be covered by the tunable pulsed laser source 12.
(b) To set the step or difference δν (or δλ) between the pairs of closely-spaced optical frequencies ν_{U} and ν_{L} (or wavelengths). Alternately, the user may enter the anticipated total PMD value of the FUT and leave the processor to select the wavelength step. As an example, the step can be conveniently set as δν=α_{δν}·PMD⁻¹ where α_{δν}˜0.1 to 0.15. It should be noted that the POTDR may be configured to allow the user to select a number M of steps larger than one; the control program will then select M steps based on the anticipated total PMD of the FUT, with appropriate ratios between the steps (note: there is an optimal step for a given PMD value, as large as possible so as to maximize signal-to-noise ratio, but small enough to satisfy the above condition, i.e., PMD·δν<0.1 to 0.15. But the apparatus here described must perform the challenging task of measuring simultaneously a large range of cumulative PMD values as a function of z, from PMD=0, at z=0, to PMD=Total PMD of the FUT, at z=FUT length. This is the reason why a few measurements with different steps in order to measure all different “sections” of the FUT with similar relative (e.g. in %) accuracy is desirable, or alternatively as mentioned here and above, use more than two closely-spaced wavelengths per group, a number Nₐ, of wavelengths per group leading to a theoretical number of M=N_{λ}·(N_{λ}−1)/2 pairs with different steps in each scan, so as to save time).
(c) To set the number (K) of center-wavelengths and/or (I-SOP, A-SOP) couples selected by the I/O-SOP controller 14, i.e., the number (K) of groups of traces to be acquired.
(d) To set the averaging time Δt of each individual trace (for example, Δt=1 or 2 seconds), or set the number electrical impulse response signals to be averaged to obtain each individual trace (for example 1250 or 2500).
(e) To set the pulse duration (e.g. Tp=10, 30, 50, 100, 200, 300, 500 ns);
(f) To specify the FUT length, normally the full effective optical length of the FUT.

If, in decision step 6.2, the user selects automatic parameter setting, the program proceeds to step 6.4 and carries out the following steps:
Select certain default measurement parameters, namely
(1) center wavelength range [λmin, λmax] that will be covered by the tunable pulsed laser source 12, typically the whole wavelength range that the actual tunable laser can access.
(2) number K of (I-SOP, A-SOP) couples and/or center wavelengths to be set by the I/O-SOP controller 14, for example, 100 or 200, for final POTDR data acquisition,
(3) averaging time Δt (for example, Δt=1 or 2 seconds) or number of electrical impulse response signals to be averaged (for example 1250 or 2500) for each individual OTDR trace,
(4) pulse duration (e.g., Tp=10, 30, 50, 100, 200, 300, 500 ns), and
(5) linewidth of tunable pulsed laser (optional).
It is noted that these default parameters set in (1), (3), (4) and (5) will also be used for pre-scan acquisition.
The POTDR conducts a pre-scan using a reduced number of groups, such as K=20, to obtain rough estimates of the FUT length and the optimal wavelength step δλ (or frequency difference δν) between the two closely-spaced optical frequencies ν_{U} and σ_{L} (or λ_{U} and λ_{L}). Thus, the OTDR will launch a standard OTDR pulse (e.g. 1 μs) to detect the end of the fiber so that the FUT length can be obtained and the pulse repetition period deduced according to the round-trip time through the length of the fiber. Acquisition of OTDR traces then will be performed to find the best suited step or difference δν (or δλ) between the two closely-spaced optical frequencies ν_{U} and ν_{L} (or λ_{U} and λ_{L}) via a fast estimate of the overall PMD of the FUT. For example, such acquisition may be carried out by using, for each group, four different laser wavelengths (N_{λ}=4) to obtain a total combination of six different wavelength steps (M=6). The best suited wavelength step to be used in the actual POTDR data acquisition may be found by processing of these pre-scan data.

Once the measurement parameters have been entered, whether manually or automatically, the program proceeds to step 6.5 and computes wavelength step δλ (or frequency difference δν) if the anticipated total PMD of the FUT has been specified or estimated via the aforementioned auto-setting procedure, the repetition period Tᵣ according to the round-trip time through the length of the fiber, and the appropriate sequence of wavelengths based on the parameter settings.

Finally, all the measurement parameters, whether directly specified or computed as described above, are stored in the header of the data file (Step 6.6).

FIG. 6A shows an optional step (following step 6.5) for setting the laser linewidth, if allowed by the laser light source 12, according to the previously-entered parameters. For example, a small (large) linewidth may be chosen to measure large (small) total PMD. In the case where the total PMD is not specified and no auto-setting procedure has been carried out, the specified wavelength step (δλ) may be used to estimate the total PMD and then the laser linewidth may also be selected accordingly.

With the group number register initialized to k=0, decision step 6.7 determines whether the total number of groups of traces have been acquired; if not, the program proceeds to step 6.8 to acquire the group k of OTDR traces.

FIG. 6B shows in more detail the trace acquisition step 6.8 to acquire a kth group of OTDR traces. As described previously, there is at least one pre-defined frequency difference δν (i.e. wavelength step δλ) between the two closely-spaced optical frequencies ν_{U} and ν_{L} (i.e. wavelengths), and hence the number of total selected laser wavelengths must be at least two. If a plurality of different wavelength steps δλ are used, then these wavelength steps may be selected to optimally measure different ranges of PMD values. For example, one may choose to have two wavelength steps, δλ₁ and δλ₂, which requires N_{λ}=3 different wavelengths per group. Furthermore, a judicious choice of the ratio of said two steps may be, for example, δλ₁/δλ₂=5. The maximum measurable PMD, PMDₘₐₓ corresponding to a given step δν can be estimated as PMDₘₐₓ˜αᵣₜ(πδν)⁻¹, and δλ can be extracted from δλ=(λ₀²/c)·δν, where λ₀=(λₘᵢₙ+λₘₐₓ)/2. The control unit 30 controls the POTDR to obtain the kth group of traces as follows:
Set couple (I-SOPₖ, A-SOPₖ) by means of the I/O-SOP controller 14 (step 6.8.1 of FIG. 6B).
Control the tunable pulsed laser 12 to set wavelength to λ_{L}^{(k)} (step 6.8.2 of FIG. 6B) and then launch OTDR light pulses. Detection and processing unit 36 acquires OTDR traces Px_{L} and Py_{L} (step 6.8.3 of FIG. 6B). The same data acquisition process is repeated to obtain duplicate or repeated traces Px_{L}″ and Py_{L}″ (step 6.8.4 of FIG. 6B).
Repeat the same data acquisition for the upper wavelength λ_{U}^{(k)} while keeping the same (I-SOPₖ, A-SOPₖ). The detection and processing unit 36 then acquires OTDR traces Px_{U}, Py_{U} and duplicates Px_{U}“, Py_{U}” (steps 6.8.9 and 6.8.10 of FIG. 6B).
Where the group comprises more than one pair of series of light pulses, to set the wavelength to at least one additional wavelength λ_{I}^{(k)} intermediate the lower and upper wavelengths (step 6.8.5 of FIG. 6B). The detection and processing unit 36 acquires OTDR traces Px_{I} and Py_{I} (step 6.8.6 of FIG. 6B). The same data acquisition procedure is repeated to obtain the repeated traces Px_{I}″ and Py_{I}″ (step 6.8.7 of FIG. 6B).

Once the kth group of OTDR traces have been acquired as described above, in step 6.9 (see FIG. 6A) the group is saved into the data file. Step 6.10 then increments the group number register.

The data acquisition step 6.8 and group storing step 6.9 will be repeated for different center-wavelengths and/or (I-SOPₖ, A-SOPₖ) selected by the I/O-SOP controller 14 in accordance with the parameter setting step 6.2 or 6.3 until K groups of traces have been acquired and stored in the data file.

At this stage, the measurement parameters and all groups of OTDR traces have been saved in the same data file.

Also at this stage, decision step 6.7 gives a positive result and, in step 6.11, the program closes the data file. Optional decision step 6.12 then gives the user an opportunity to initiate the acquisition of another K groups of traces for the same FUT. If the user decides to do so, the program returns to the parameter setting step 6.2. If not, decision step 6.13 gives the user the option of exiting, in which case the data stored in the data file will be retained for later processing, or initiating processing of already acquired and stored data.

If processing is initiated, step 6.14 allows the user to select the data file to be processed in a conventional “open file” dialog box, whereupon, in step 6.16, the data processor 32 accesses the pre-saved acquisition data and associated measurement parameters from the data file, and uses the data to compute cumulative PMD as a function of distance (z) along the FUT. On the other hand, box 6.15, which is not a “step” as such, indicates that the user may launch the data processing software independently at any time, even if no acquisition was just completed, to process any previously acquired data file. In step 6.17, the data processor 32 saves the results (e.g. the cumulative PMD curve as a function of z and measurement parameters in a file retrievable by a spreadsheet software) and in step 6.18 displays or otherwise outputs the resulting cumulative PMD curve in a tangible form.

The manner in which the data processing step 6.16 processes the stored data will be described in the sections below.

It should note the above steps may obtain rms DGD (i.e. PMD), but it can also obtain DGD as function of wavelength and then rms DGD or mean DGD may be computed as the method described in below sections that may also be included in data processing step 6.16.

It should be also noted, it is preferable that the data be acquired for several or many SOPs and different midpoint wavelengths.

### Data Processing and Computation: Two-Ended Measurement

### 1. Two-Ended DGD and PMD: Data Processing and Computation for Non-Polarization-Diverse Measurement

The manner in which the data processing step 6.19 processes the stored data will now be described.

### 1.1 The Data Structure

Each light power from the FUT, obtained with one given setting of the wavelength and of the input and output SOPs as described in the Method of Operation for the two-ended PMD measurement, constitutes an elementary data cell, i.e. one datum consists of one power value. The next data unit is one group of four powers (i.e. four data cells), two sets of four powers for the embodiments of FIG. 1C and FIG. 1G where two powers are obtained simultaneously from photodetectors 22B and 22C, all obtained with given input and output SOPs as set by I-SOP scrambler 14A and A-SOP scrambler 14B. The two sets of four powers forming group k preferably have been obtained in the following sequence (time flowing from left to right) or other similar means, such as of two repeated powers being measured at the same time but with different detectors (such as simultaneously measuring the same power by two detectors and a coupler), as:

$$I \text{-} {SOP}_{k}^{I} , A \text{-} {SOP}_{k}^{O} and \text{/} or {λ}_{k} \text{:} { \begin{matrix}{Px}_{L}^{( k )} & {Px}_{L}^{′′ ( k )} & {Px}_{U}^{( k )} & {Px}_{U}^{′′ ( k )} \\ {Py}_{L}^{( k )} & {Py}_{L}^{′′ ( k )} & {Py}_{U}^{( k )} & {Py}_{U}^{′′ ( k )}\end{matrix}}^{ \overbrace{λ = {λ}_{L}^{( k )}} \overbrace{λ = {λ}_{U}^{( k )}}}$$

where the labels x and y refer to the power obtained simultaneously or at slightly different time from photodetectors 22B and 22C, respectively, λ_{U}^{(k)}−λ_{L}^{(k)} is equal to the step δλ, the midpoint wavelength is defined as λₖ=(λ_{U}^{(k)}+λ_{L}^{(k)})/2, and the double prime indicates the repeated powers.

Finally, the overall data stored in the data file after acquisition is depicted as a matrix in Eq. (18) below, to which we will refer in all that follows. The matrix comprises K groups each of four powers of light (two sets of four when two photodetectors are used):

$$Data = \\ {\begin{matrix}{SOP}_{0}^{I} , {SOP}_{0}^{O} and \text{/} or {λ}_{0} \to & {Px}_{L}^{( 0 )} & {Px}_{L}^{′′ ( 0 )} & {Px}_{U}^{( 0 )} & {{Px}^{′′}}_{U}^{( 0 )} \\ & {Py}_{L}^{( 0 )} & {Py}_{L}^{′′ ( 0 )} & {Py}_{U}^{( 0 )} & {Py}_{U}^{′′ ( 0 )} \\ {SOP}_{1}^{I} , {SOP}_{1}^{O} and \text{/} or {λ}_{1} \to & {Px}_{L}^{( 1 )} & {Px}_{L}^{′′ ( 1 )} & {Px}_{U}^{( 1 )} & {Px}_{U}^{′′ ( 1 )} \\ & {Py}_{L}^{( 1 )} & {Py}_{L}^{′′ ( 1 )} & {Py}_{U}^{( 1 )} & {Py}_{U}^{′′ ( 1 )} \\ ⋮ & ⋮ & ⋮ & ⋮ & ⋮ \\ {SOP}_{k}^{I} , {SOP}_{k}^{O} and \text{/} or {λ}_{k} \to & {Px}_{L}^{( k )} & {Px}_{L}^{′′ ( k )} & {Px}_{U}^{( k )} & {Px}_{U}^{′′ ( k )} \\ & {Py}_{L}^{( k )} & {Py}_{L}^{′′ ( k )} & {Py}_{U}^{( k )} & {Py}_{U}^{′′ ( k )} \\ ⋮ & ⋮ & ⋮ & ⋮ & ⋮ \\ {SOP}_{K - 1}^{I} , {SOP}_{K - 1}^{O} and \text{/} or {λ}_{K - 1} \to & {Px}_{L}^{( K - 1 )} & {Px}_{L}^{′′ ( K - 1 )} & {Px}_{U}^{( K - 1 )} & {Px}_{U}^{′′ ( K - 1 )} \\ & {Py}_{L}^{( K - 1 )} & {Py}_{L}^{′′ ( K - 1 )} & {Py}_{U}^{( K - 1 )} & {Py}_{U}^{′′ ( K - 1 )}\end{matrix}}^{ \overbrace{λ = {λ}_{L}^{( k )}} \overbrace{λ = {λ}_{U}^{( k )}}} \qquad ( 17 )$$

It should be noted that the input and output SOPs can each be selected randomly (“macroscopic SOP step”) from one to another or undergo slow continuous SOP scanning, in both cases in such a way that, over time, each substantially uniformly covers the Poincaré sphere.

### 1.2. Auto Calibration of the Relative Gain

For the PBS-based embodiment of FIG. 1G, it is necessary to perform a calibration procedure described in Section 2.2 hereinafter of the relative gain of the two detectors 22B and 22C before proceeding with any further computation. The same procedure is not performed for the other embodiments, e.g. if there is only one detector

### 1.3. Computation

The powers are processed to obtain the PMD value as will now be described. It should be note that, in all that follows, the symbols refer to the matrix “Data” in equation (17). The labels x and y refer to the backreflected light powers obtained from photodetectors 22B and 22C, respectively.

### 1.3.1 The Normalized Powers

The normalized powers, labelled hereinafter as T, are computed differently according to the embodiment.

(i) For the embodiment of FIG. 1D (two photodetectors with a PBS), the transmissions (normalized power) is computed as follows either

$$\begin{matrix}\begin{matrix}{T}_{L}^{( k )} = \frac{{Px}_{L}^{( k )}}{{Px}_{L}^{( k )} + {Py}_{L}^{( k )}} & {T}_{L}^{′′ ( k )} = \frac{{Px}_{L}^{′′ ( k )}}{{Px}_{L}^{′′ ( k )} + {Py}_{L}^{′′ ( k )}} \\ {T}_{U}^{( k )} = \frac{{Px}_{U}^{( k )}}{{Px}_{U}^{( k )} + {Py}_{U}^{( k )}} & {T}_{U}^{′′ ( k )} = \frac{{Px}_{U}^{′′ ( k )}}{{Px}_{U}^{′′ ( k )} + {Py}_{U}^{′′ ( k )}}\end{matrix} \\ or & ( 18 a ) \\ \begin{matrix}{T}_{L}^{( k )} = \frac{1}{2} \cdot \frac{{Px}_{L}^{( k )} - {Py}_{L}^{( k )}}{{Px}_{L}^{( k )} + {Py}_{L}^{( k )}} & {T}_{L}^{′′ ( k )} = \frac{1}{2} \cdot \frac{{Px}_{L}^{′′ ( k )} - {Py}_{L}^{′′ ( k )}}{{Px}_{L}^{′′ ( k )} + {Py}_{L}^{′′ ( k )}} \\ {T}_{U}^{( k )} = \frac{1}{2} \cdot \frac{{Px}_{U}^{( k )} - {Py}_{U}^{( k )}}{{Px}_{U}^{( k )} + {Py}_{U}^{( k )}} & {T}_{U}^{′′ ( k )} = \frac{1}{2} \cdot \frac{{Px}_{U}^{′′ ( k )} - {Py}_{U}^{′′ ( k )}}{{Px}_{U}^{′′ ( k )} + {Py}_{U}^{′′ ( k )}}\end{matrix} & ( 18 b )\end{matrix}$$

where it should be appreciated that the different Py powers have been pre-multiplied by the measured relative gain, g_{Forward}, as indicated in the description of the auto-calibration procedure, before they are used in equations (18a) and (18b).
(ii) For the embodiment of FIG. 1C (two photodetectors with a coupler), the ratio of trace Px over trace Py is first computed as,

$$\begin{matrix}{R}_{L}^{( k )} = \frac{{Px}_{L}^{( k )}}{{Py}_{L}^{( k )}} & {R}_{L}^{′′ ( k )} = \frac{{Px}_{L}^{′′ ( k )}}{{Py}_{L}^{′′ ( k )}} \\ {R}_{U}^{( k )} = \frac{{Px}_{U}^{( k )}}{{Py}_{U}^{( k )}} & {R}_{U}^{′′ ( k )} = \frac{{Px}_{U}^{′′ ( k )}}{{Py}_{U}^{′′ ( k )}}\end{matrix} \qquad ( 18 c )$$

and then the above ratio is normalized with respect to its average over the K groups as,

$$\begin{matrix}{T}_{L}^{( k )} = {u}_{o} \frac{{R}_{L}^{( k )}}{{〈 {R}_{L} 〉}_{SOP}} & {T}_{L}^{′′ ( k )} = {u}_{o} \frac{{R}_{L}^{′′ ( k )}}{{〈 {R}_{L} 〉}_{SOP}} \\ {T}_{U}^{( k )} = {u}_{o} \frac{{R}_{U}^{( k )}}{{〈 {R}_{U} 〉}_{SOP}} & {T}_{U}^{′′ ( k )} = {u}_{o} \frac{{R}_{U}^{′′ ( k )}}{{〈 {R}_{U} 〉}_{SOP}}\end{matrix} \qquad ( 18 d )$$

where the reference mean-value is uₒ=½ and the average ratio R is defined as,

$${〈 {R}_{L} 〉}_{SOP} = \frac{1}{2 K} {\sum }_{k} ( {R}_{L}^{( k )} + {R}_{L}^{′′ ( k )} ) \\ {〈 {R}_{U} 〉}_{SOP} = \frac{1}{2 K} {\sum }_{k} ( {R}_{U}^{( k )} + {R}_{U}^{′′ ( k )} ) \qquad ( 18 e )$$

or, when the coupler ratio changing against wavelength is negligible within a prescribed wavelength range, then [symbol] R_{L} [symbol] _{SOP} and [symbol] R_{U} [symbol] _{SOP} can be replaced by:

$${〈 R 〉}_{SOP ; v} = \frac{1}{4 K} {\sum }_{k} ( {R}_{L}^{( k )} + {R}_{L}^{″ ( k )} + {R}_{U}^{( k )} + {R}_{U}^{″ ( k )} ) \qquad ( 18 f )$$

Here, the auto calibration procedure is not required, i.e. above mentioned pre-multiplication of the powers Py by the measured relative gain may be skipped.

(iii) For the embodiment of FIG. 1B (single photodetector), the only available powers are the Px powers (obtained here from photodetector 22A). The normalized power is obtained as in (19d) but without computing the ratio of power x over power y first, i.e.

$${T}_{L}^{( k )} = {u}_{o} \frac{{Px}_{L}^{( k )}}{{〈 {P}_{L} 〉}_{SOP}} \\ {T}_{L}^{″ ( k )} = {u}_{o} \frac{{Px}_{L}^{″ ( k )}}{{〈 {P}_{L} 〉}_{SOP}} \\ {T}_{U}^{( k )} = {u}_{o} \frac{{Px}_{U}^{( k )}}{{〈 {P}_{U} 〉}_{SOP}} \\ {T}_{U}^{″ ( k )} = {u}_{o} \frac{{Px}_{U}^{″ ( k )}}{{〈 {P}_{U} 〉}_{SOP}} \qquad ( 18 h )$$

where the average power is defined as,

$${〈 {P}_{L} 〉}_{SOP} = \frac{1}{2 K} {\sum }_{k} ( {Px}_{L}^{( k )} + {Px}_{L}^{″ ( k )} ) \\ {〈 {P}_{U} 〉}_{SOP} = \frac{1}{2 K} {\sum }_{k} ( {Px}_{U}^{( k )} + {Px}_{U}^{″ ( k )} ) . \qquad ( 18 i )$$

Here, the detected power is assumed to be roughly constant during the time period for measurement of the initial and repeated powers.

(iv) For the embodiment of FIG. 1D with two photodetectors combined with a coupler after analyzer, two powers of the Px and Px″ powers are obtained from photodetectors 22B and 22C, respectively. The normalized powers are now obtained as,

$${T}_{L}^{( k )} = {u}_{o} \frac{{Px}_{L}^{( k )}}{{〈 {Px}_{L} 〉}_{SOP}} \\ {T}_{L}^{″ ( k )} = {u}_{o} \frac{{Px}_{L}^{″ ( k )}}{{〈 {Px}_{L}^{″} 〉}_{SOP}} \\ {T}_{U}^{( k )} = {u}_{o} \frac{{Px}_{U}^{( k )}}{{〈 {Px}_{U} 〉}_{SOP}} \\ {T}_{U}^{″ ( k )} = {u}_{o} \frac{{Px}_{U}^{″ ( k )}}{{〈 {Px}_{U}^{″} 〉}_{SOP}} \qquad ( 18 j )$$

where the average power is defined as,

$${〈 {Px}_{L} 〉}_{SOP} = \frac{1}{K} {\sum }_{k} {Px}_{L}^{( k )} \\ {〈 {Px}_{L}^{″} 〉}_{SOP} = \frac{1}{K} {\sum }_{k} {Px}_{L}^{″ ( k )} \\ {〈 {Px}_{U} 〉}_{SOP} = \frac{1}{K} {\sum }_{k} {Px}_{U}^{( k )} \\ {〈 {Px}_{U}^{″} 〉}_{SOP} = \frac{1}{K} {\sum }_{k} {Px}_{U}^{″ ( k )} \qquad ( 18 k )$$

Here the auto calibration procedure is also not required. Note that this embodiment has an advantage of only requiring approximately half the acquisition time of other embodiments.

Note for the above (iii) and (iv) normalization, the power during measurement must be stable. Also, if power is constant for all wavelengths within a prescribed wavelength range, [symbol] _{SOP} can be averaged over either SOP or wavelength, both SOP and wavelength.

Fundamentally all of these relationships are valid in all cases if sufficiently random input and output SOP scrambling is applied, giving the correct value of the DGD at one particular midpoint wavelength, and then it is possible to obtain DGD against midpoint wavelength. Therefore, one can also compute a mean DGD or rms DGD value for a given wavelength range.

In other case, scanning the midpoint wavelength serves the purpose of averaging DGD over wavelength as per the definition of the statistical PMD value so as to obtain a rms DGD value (not a mean DGD). On the contrary, as discussed earlier, averaging only over wavelength while keeping the input and output SOPs unchanged requires that assumptions about the FUT be met, and also requires a large value of the product PMD·Δν. The same remarks apply for the equations presented hereinafter.

### 1.3.2 Noise Variance

The second motivation for sampling repeated traces, which are substantially identical in the absence of noise for each setting of SOP and midpoint wavelength λ_{mid}, is the ability to obtain an accurate estimate of the variance noise from variations of light polarization and/or laser frequency and/or power (intensity). If this noise variance is known, it may be subtracted. Thanks to the repeated traces, the variance from polarization noise and/or laser frequency and/or power noise and/or any other noises etc. can be estimated independently as follows:

$${σ ( v )}_{noise}^{2} = {( \frac{1}{{σ}_{20}} )}^{2} {〈 ( {T}_{L} ( v ) - {T}_{L}^{″} ( v ) ) ( {T}_{U} ( v ) - {T}_{U}^{″} ( v ) ) 〉}_{SOP} \qquad ( 19 a )$$

which is particularly appropriate for determining a DGD estimate at a given wavelength; and

$${σ}_{noise}^{2} = {( \frac{1}{{σ}_{20}} )}^{2} {〈 ( {T}_{L} - {T}_{L}^{″} ) ( {T}_{U} - {T}_{U}^{″} ) 〉}_{SOP ; v} \qquad ( 19 b )$$

which is particularly appropriate for determining a PMD estimate; and where, for both cases, σ₂₀²= 1/12.

It should be noted that this ‘noise’ variance could come from a randomly varied input and output SOP (such as might be induced by a swaying aerial cable, for instance), and/or an instability of laser frequency and intensity, or any other noise sources.

In order to obtain a reliable measurement result, the variance noise, e.g. from polarization variation and similar other effects, such as instability of laser frequency and intensity, should be less than few percent (e.g. of <2%) compared to the mean-square difference (see below Sub-section 3.4).

### 1.3.3 Relative Variance

The relative variance, for example mainly due to un-polarized ASE light from optical amplifiers in the test link (or any other depolarizing effects), as used in equations (10) and (11), is computed here as the average of the two available estimates, i.e.,

$$\begin{matrix}{σ}_{r}^{′2} ( v ) = {( \frac{1}{{σ}_{20}} )}^{2} [ \frac{δ ( {T}_{L} ( v ) ) + δ ( {T}_{U} ( v ) )}{2} ] & ( 20 a ) \\ {σ}_{r}^{′2} = {( \frac{1}{{σ}_{20}} )}^{2} [ \frac{δ ( {T}_{L} ) + δ ( {T}_{U} )}{2} ] & ( 20 b )\end{matrix}$$

where σ₂₀²= 1/12, and the function “δ” is defined as,

$$δ ( {T}_{L} ( v ) ) = ⌊ {〈 {T}_{L} ( v ) {T}_{L}^{″} ( v ) 〉}_{SOP} - {〈 {T}_{L} ( v ) 〉}_{SOP}^{2} ⌋$$

$$δ ( {T}_{U} ( v ) ) = ⌊ {〈 {T}_{U} ( v ) {T}_{U}^{″} ( v ) 〉}_{SOP} - {〈 {T}_{U} ( v ) 〉}_{SOP}^{2} ⌋$$

$$δ ( {T}_{L} ) = ⌊ {〈 {T}_{L} {T}_{L}^{″} 〉}_{SOP ; v} - {〈 {T}_{L} 〉}_{SOP ; v}^{2} ⌋$$

$$δ ( {T}_{U} ) = ⌊ {〈 {T}_{U} {T}_{U}^{″} 〉}_{SOP ; v} - {〈 {T}_{U} 〉}_{SOP ; v}^{2} ⌋ .$$

Alternatively, the relative variance can also be computed via polarization component sₚ, for example,

$$\begin{matrix}{σ}_{r}^{′2} ( v ) = {( \frac{1}{{σ}_{s 0}} )}^{2} [ \frac{{〈 {s}_{{p}_{L}} ( v ) {s}_{{p}_{L}}^{″} ( v ) 〉}_{SOP} + {〈 {s}_{{p}_{U}} ( v ) {s}_{{p}_{U}}^{″} ( v ) 〉}_{SOP}}{2} ] & ( 20 c ) \\ {σ}_{r}^{′2} = {( \frac{1}{{σ}_{s 0}} )}^{2} [ \frac{{〈 {s}_{{p}_{L}} {s}_{{p}_{L}}^{″} 〉}_{SOP ; v} + {〈 {s}_{{p}_{U}} {s}_{{p}_{U}}^{″} 〉}_{SOP ; v}}{2} ] & ( 20 d )\end{matrix}$$

where σ₂₀²=⅓, and sₚ as,

$${s}_{{p}_{L}} = 2 {T}_{L} - 1$$

$${s}_{{p}_{L}}^{″} = 2 {T}_{L}^{″} - 1$$

$${s}_{{p}_{U}} = 2 {T}_{U} - 1$$

$${s}_{{p}_{U}}^{″} = 2 {T}_{U}^{″} - 1$$

But note that a relative variance computed from equation (20b) cannot be applied to any above- or below-mentioned ‘relative power’ related computation for extracting DGD or PMD, i.e. the measured power must be normalized properly.

It should be noted that above equation is valid under the condition of uniformly distributed I-SOPs and A-SOPs on Poincaré sphere from either or both input and output polarization controllers. It can be only averaged over SOP or average over both SOP and wavelength.

The noise variance (equation 19) is then subtracted from the first estimation of the relative variance (equation 20a) in the computation, and a final relative variance is as follows,

σᵣ²(ν)=σ′ᵣ²(ν)−σₙₒᵢₛₑ²(ν) (21a)

which is particularly appropriate for determining a DGD estimate at a particular wavelength; and

σᵣ²=σ′ᵣ²−σₙₒᵢₛₑ² (21b)

which is particularly appropriate for determining a PMD estimate at a particular wavelength.

### 1.3.4 Mean-Square Differences

The calculation here differs from the simple mean-square found in equations (10) and (11) which, for greater clarity, did not take into account the noise. Instead, the product of the repeated differences between normalized power at λ_{U} and λ_{L} is averaged as follows,

$$\begin{matrix}\begin{matrix}{〈 Δ {T}^{2} ( v ) 〉}_{SOP} = {〈 ( {T}_{U} ( v ) - {T}_{L} ( v ) ) \cdot ( {T}_{U}^{″} ( v ) - {T}_{L}^{″} ( v ) ) 〉}_{SOP} \\ = \frac{1}{K} {\sum }_{k} ( {T}_{U}^{( k )} ( v ) - {T}_{L}^{( k )} ( v ) ) \cdot ( {T}_{U}^{″ ( k )} ( v ) - {T}_{L}^{″ ( k )} ( v ) )\end{matrix} & ( 22 a ) \\ \begin{matrix}{〈 Δ {T}^{2} ( v ) 〉}_{SOP ; v} = {〈 ( {T}_{U} - {T}_{L} ) \cdot ( {T}_{U}^{″} - {T}_{L}^{″} ) 〉}_{SOP ; v} \\ = \frac{1}{K} {\sum }_{k} ( {T}_{U}^{( k )} - {T}_{L}^{( k )} ) \cdot ( {T}_{U}^{″ ( k )} - {T}_{L}^{″ ( k )} )\end{matrix} & ( 22 b )\end{matrix}$$

In conventional mathematical terms, each of equations (22) may be referred to as the second-order joint moment of the repeated differences.

Doing so, the noise averages to zero instead of being “rectified”, because the noise superimposed on a given trace is not correlated with the noise superimposed on the corresponding repeated power. That is the first motivation for acquiring repeated data.

Note that [symbol] _{SOP} in Eq. (22a) can refer to averaging over the SOP at a given midpoint frequency (ν_{mid}) (i.e. midpoint wavelength, λ_{mid}), i.e., only changing the SOP from one group of powers to other, which is particularly appropriate for determining the DGD at this wavelength, and [symbol] _{SOP;ν} in Eq. (22b) can refer to averaging over both the SOP and the midpoint frequency (ν_{mid}) (i.e. midpoint wavelength λ_{mid}), i.e., changing both SOP and frequency (wavelength) from one group of powers to other, which is particularly appropriate for determining the PMD over a particular wavelength range.

### 1.3.5 Computation of the DGD or PMD Value

The DGD or rms DGD (i.e. PMD) then is computed according to the arcsine formula as,

$$D G D ( v ) = \frac{1}{πδ v} arcsin ( {α}_{ds} \sqrt{\frac{{〈 Δ {T}^{2} ( v ) 〉}_{SOP}}{{σ}_{r}^{2} ( v )}} ) \qquad ( 23 )$$

where [symbol] _{SOP} refers to only averaging over the SOP only.

$$P M D = \frac{1}{πδ v} arcsin ( {α}_{ds} \sqrt{\frac{{〈 Δ {T}^{2} ( v ) 〉}_{SOP ; v}}{{σ}_{r}^{2}}} ) \qquad ( 24 )$$

where [symbol] _{SOP;ν} refers to averaging over both the SOP and optical frequency (wavelength), and a theoretical constant

$${α}_{ds} = \sqrt{\frac{9}{2}} .$$

It should be appreciated that the arcsine formula, in equations (23) and (24), is not the only possible one. The purpose of using this formula is to obtain a result that is unbiased even if using a relatively large step, such that PMD·δν˜0.2, without introducing a significant error; this in order to maximize the signal-to-noise ratio and therefore the dynamic range of the instrument. Although applicable to any step size, if one were not concerned with maximizing the dynamic range, one could select a small step, in which case the following simpler differential formula is valid:

$$\begin{matrix}D G D ( v ) = \frac{{α}_{ds}}{π δ v} \cdot \sqrt{\frac{{〈 Δ {T}^{2} ( v ) 〉}_{SOP}}{{σ}_{r}^{2} ( v )}} & ( 23 a ) \\ P M D = \frac{{α}_{ds}}{π δ v} \cdot \sqrt{\frac{{〈 Δ {T}^{2} ( v ) 〉}_{SOP ; v}}{{σ}_{r}^{2}}} & ( 24 a )\end{matrix}$$

This is not to infer that these formula are better or particularly advantageous, but merely that it may conveniently be used if the step is much smaller, i.e., satisfying the condition PMD·δν<0.01.

It should be noted that in an ideal situation where there is no ASE from optical amplifiers, ‘depolarization’ effect and other ‘noise’ of light polarization, frequency and intensity etc., then o=1, the above equations (23) and (24) simplify to,

$$\begin{matrix}D G D ( v ) = \frac{1}{π δ v} arcsin ( {α}_{ds} \sqrt{{〈 Δ {T}^{2} ( v ) 〉}_{SOP}} ) & ( 25 ) \\ P M D = \frac{1}{π δ v} arcsin ( {α}_{ds} \sqrt{{〈 Δ {T}^{2} ( v ) 〉}_{SOP ; v}} ) & ( 26 )\end{matrix}$$

and their corresponding simpler differential formulas are,

$$\begin{matrix}D G D ( v ) = \frac{{α}_{ds}}{π δ v} \cdot \sqrt{{〈 Δ {T}^{2} ( v ) 〉}_{SOP}} & ( 25 a ) \\ P M D = \frac{{α}_{ds}}{π δ v} \cdot \sqrt{{〈 Δ {T}^{2} ( V ) 〉}_{SOP ; v}} & ( 26 a )\end{matrix}$$

Note that a mean DGD or rms DGD may be computed from averaging DGD(ν) from many different midpoint wavelengths over a prescribed wavelength range, such as

$$\begin{matrix}RMS D G D = \sqrt{{〈 D G {D}^{2} ( v ) 〉}_{v}} & ( 27 ) \\ mean D G D = {〈 D G D ( v ) 〉}_{v} & ( 28 )\end{matrix}$$

As shown in the equations (23) and (24), if the DGD(ν) and PMD calculation involves to use the relative variance, σᵣ²(ν) and σᵣ² respectively, of the normalized power (T), then the normalized power may not be necessary to have to be computed to be normalized between 0 and 1. In other words, some steps of above normalization procedure for obtaining normalized powers may be skipped.

For example, for the embodiment of FIG. 1C (two photodetectors with a coupler), the relative power (P_{R}) can simply be obtained from the ratio of trace Px over trace Py as,

$${P}_{RL}^{( k )} = \frac{{Px}_{L}^{( k )}}{{Py}_{L}^{( k )}} {P}_{RL}^{″ ( k )} = \frac{{Px}_{L}^{″ ( k )}}{{Py}_{L}^{″ ( k )}} \\ {P}_{RU}^{( k )} = \frac{{Px}_{U}^{( k )}}{{Py}_{U}^{( k )}} {P}_{RU}^{″ ( k )} = \frac{{Px}_{U}^{″ ( k )}}{{Py}_{U}^{″ ( k )}} \qquad ( 29 )$$

For the embodiments in FIG. 1D (two photodetectors with a PBS) and in FIG. 1C (two photodetectors with a coupler), any reference constants and averaging for over SOP and/or wavelength in order to obtain a normalized power may be ignored (skipped) for the procedure to obtain a relative power (P_{R}). Then DGD and PMD may be computed to use following arcsine formula as,

$$D G D ( v ) = \frac{1}{π δ v} arcsin ( {α}_{ds} \sqrt{\frac{{〈 Δ {P}_{R}^{2} ( v ) 〉}_{SOP}}{{σ}_{R}^{2} ( v )}} ) \qquad ( 30 )$$

where [symbol] _{SOP} refers to only averaging over the SOP only.

$$P M D = \frac{1}{π δ v} arcsin ( {α}_{ds} \sqrt{\frac{{〈 Δ {P}_{R}^{2} ( v ) 〉}_{SOP ; v}}{{σ}_{R}^{2}}} ) \qquad ( 31 )$$

where [symbol] _{SOP;ν} refers to averaging over both the SOP and wavelength.

Here mean-square [symbol] ΔP_{R}²(ν) [symbol] _{SOP} and [symbol] ΔP_{R}²(ν) [symbol] _{SOP;ν} can be found as follows,

$$\begin{matrix}\begin{matrix}{〈 Δ {P}_{R}^{2} ( v ) 〉}_{SOP} = {〈 ( {P}_{RU} ( v ) - {P}_{RL} ( v ) ) \cdot ( {P}_{RU}^{″} ( v ) - {P}_{RL}^{″} ( v ) ) 〉}_{SOP} \\ = \frac{1}{K} {\sum }_{k} ( {P}_{RU}^{( k )} ( v ) - {P}_{RL}^{( k )} ( v ) ) \cdot ( {P}_{RU}^{″ ( k )} ( v ) - {P}_{RL}^{″ ( k )} ( v ) )\end{matrix} & ( 32 a ) \\ \begin{matrix}{〈 Δ {P}_{R}^{2} ( v ) 〉}_{SOP ; v} = {〈 ( {R}_{RU} - {P}_{RL} ) \cdot ( {P}_{RU}^{″} - {P}_{RL}^{″} ) 〉}_{SOP ; v} \\ = \frac{1}{K} {\sum }_{k} ( {P}_{RU}^{( k )} - {P}_{RL}^{( k )} ) \cdot ( {P}_{RU}^{″ ( k )} - {P}_{RL}^{″ ( k )} )\end{matrix} & ( 32 b )\end{matrix}$$

and the relative variance, σ_{R}², is computed here as the average of the four available estimates, i.e.,

$$\begin{matrix}{σ}_{R}^{2} ( v ) = {( \frac{1}{{σ}_{20}} )}^{2} [ \frac{δ ( {P}_{RL} ( v ) ) + δ ( {P}_{RU} ( v ) )}{2} ] & ( 32 c ) \\ {σ}_{R}^{2} = {( \frac{1}{{σ}_{20}} )}^{2} [ \frac{δ ( {P}_{RL} ) + δ ( {P}_{RU} )}{2} ] & ( 32 d )\end{matrix}$$

where σ₂₀²= 1/12, and the function “δ” is defined as,

$$δ ( {P}_{RL} ( v ) ) = ⌊ {〈 {P}_{RL} ( v ) {P}_{RL}^{″} ( v ) 〉}_{SOP} - {〈 {P}_{RL} ( v ) 〉}_{SOP}^{2} ⌋$$

$$δ ( {P}_{RU} ( v ) ) = ⌊ {〈 {P}_{RU} ( v ) {P}_{RU}^{″} ( v ) 〉}_{SOP} - {〈 {P}_{RU} ( v ) 〉}_{SOP}^{2} ⌋$$

$$δ ( {P}_{RL} ) = ⌊ {〈 {P}_{RL} {P}_{RL}^{″} 〉}_{SOP ; v} - {〈 {P}_{RL} 〉}_{SOP ; v}^{2} ⌋$$

$$δ ( {P}_{RU} ) = ⌊ {〈 {P}_{RU} {P}_{RU}^{″} 〉}_{SOP ; v} - {〈 {P}_{RU} 〉}_{SOP ; v}^{2} ⌋$$

Note that [symbol] _{SOP;ν} can refer to averaging over either the SOP, or the optical frequency (wavelength), or over both, i.e., changing both SOP and optical frequency from one group of powers to the next.

If one selected a small step, the arcsine formula, in equations (30) and (31) may be written as a simpler differential formula:

$$\begin{matrix}D G D ( v ) = \frac{{α}_{ds}}{π δ v} \cdot \sqrt{\frac{{〈 Δ {P}_{R}^{2} ( v ) 〉}_{SOP}}{{σ}_{R}^{2} ( v )}} & ( 30 a ) \\ P M D = \frac{{α}_{ds}}{π δ v} \cdot \sqrt{\frac{{〈 Δ {P}_{R}^{2} ( v ) 〉}_{SOP ; v}}{{σ}_{R}^{2}}} & ( 31 a )\end{matrix}$$

For the case where the tunable light source has a relatively large linewidth and a high-PMD fiber is under test, a further linewidth ‘correction factor’ may be applied in equations in order to extract a DGD or PMD value of the FUT having a greater accuracy.

It should be appreciated noted that the above-computed forward DGD or PMD for two-ended PMD measurement is in fact the DGD or PMD of FUT.

It should also be noted that repeated powers may be obtained from two or more measurements at different times using the same detectors, or from measurements using different detectors, e.g. after light power being split by a coupler (FIG. 1D), where the powers detected by the different detectors are measured contemporaneously.

2. Two-Ended DGD and PMD: Data Processing and Computation Using Two Detected Polarization Components with Rapid Wavelength Sweeping

### 2.1. The Data Structure

The data structure for the exemplary polarization-diverse detection embodiments shown in FIGS. 1K and 1G, where the wavelength of the detected light is rapidly swept over a prescribed wavelength range, differs somewhat from the other embodiments. Each light power from the FUT 18, obtained with either one given setting of the wavelength from tunable filter A 27B and tunable filter B 27C (FIG. 1K) or from swept tunable laser source 12A (FIG. 1G) and of the SOP couple (I-SOP; A-SOP), as described in the Method of Operation for the two-ended PMD measurement provided hereinafter, constitutes an elementary data cell, i.e. one datum consists of one power value. The data unit is one group of N powers, two sets of N powers for the embodiments of FIGS. 1K and 1G where two powers are obtained simultaneously from photodetectors 22B and 22C, all obtained with given approximately same SOP couples as set by I-SOP scrambler 14A and A-SOP scrambler 14B. Preferably, the I-SOP scrambler 14A operates in a slow “continuous scanning” mode, randomly scanning its input SOP, while the A-SOP scrambler 14B sets one output SOP for one group data with N powers.

By “slow” continuous scanning, one means that the I-SOP scrambler 14A scans sufficiently slowly that, in the absence of DGD or PMD from the FUT, the mean-squared equalized transmission (equalized normalized power) difference over a large number of SOPs caused by the input SOP changing is much smaller (e.g. less than few percent) than that (i.e. a mean-squared equalized transmission difference) generated from a given DGD of the FUT for one set optical frequency difference between two closely-spaced frequencies that is used to compute the DGD or PMD of the FUT as used in equations (11) and (12). The two sets of N powers forming group k preferably have been obtained in the following sequence (time flowing from left to right), for I-SOPₖ^{I}, A-SOPₖ^{O} and ν₁ to ν_{N}, as:

$$\begin{matrix}{P}_{x}^{( k )} ( {v}_{1} ) & {P}_{x}^{( k )} ( {v}_{2} ) & … & {P}_{x}^{( k )} ( {v}_{i} ) & … & {P}_{x}^{( k )} ( {v}_{N} ) \\ {P}_{y}^{( k )} ( {v}_{1} ) & {P}_{y}^{( k )} ( {v}_{2} ) & … & {P}_{y}^{( k )} ( {v}_{i} ) & … & {P}_{y}^{( k )} ( {v}_{N} )\end{matrix}$$

where the labels x and y refer to the power obtained simultaneously or at very slightly different time from photodetectors 22B and 22C, respectively, δν=νᵢ₊ₙ−νᵢ is an optical frequency difference (wavelength step) between two closely-spaced optical frequencies, and its midpoint optical frequency (wavelength) is defined as

$${v}_{i , mid} = \frac{{v}_{i} + {v}_{i + n}}{2} ( {λ}_{i , mid} = \frac{2 {λ}_{i} \cdot {λ}_{i + n}}{{λ}_{i} + {λ}_{i + n}} )$$

(where n is an acquired data number difference for the optical frequency difference, δν, between two closely-spaced optical frequencies (wavelengths)).

Typically an optical frequency being scanned from ν₁ to ν_{N} is actually incrementally or decrementally stepped in, preferably approximately equal, small optical frequency (wavelength) steps, for example, ˜125-1250 MHz (˜1-10 pm). The precise value of each step need not be known. Also it should be noted that as long as knowing accurate optical frequency, for example optical frequency being measured by a wavelength meter during data acquisition, a step from one frequency to next may be different. However, it is desirable for equations (11a) and (11b), for the sake of convenience, to use approximately equal optical frequency differences to calculate a rms DGD or PMD.

The overall data can be acquired by many scans, for example 3-10,000 wavelength scans, that can be either achieved by tunable filter means 27 or tunable laser 12A for different input and output SOPs. A desirable tunable filter means (FIG. 1K) may be based on a a polarization-diverse two-channel scanning monochormator, such as comprised within a commercial optical spectrum analyzer such as the model FTB-5240, manufactured by EXFO Electro-Optical Engineering Inc

The acquired data are stored in the data file as above matrix (34). The matrix comprises K groups each of 2×N light powers (i.e. two sets of N) are acquired from two photodetectors 22B and 22C (FIGS. 1K and 1G):

$$\begin{matrix}\begin{matrix}{SOP}_{0}^{I} , {SOP}_{0}^{O} & {P}_{x}^{( 0 )} ( {v}_{1} ) & {P}_{x}^{( 0 )} ( {v}_{2} ) & … & {P}_{x}^{( 0 )} ( {v}_{i} ) & … & {P}_{x}^{( 0 )} ( {v}_{N} ) \\ & {P}_{y}^{( 0 )} ( {v}_{1} ) & {P}_{y}^{( 0 )} ( {v}_{2} ) & … & {P}_{y}^{( 0 )} ( {v}_{i} ) & … & {P}_{y}^{( 0 )} ( {v}_{N} ) \\ {SOP}_{1}^{I} , {SOP}_{1}^{O} & {P}_{x}^{( 1 )} ( {v}_{1} ) & {P}_{x}^{( 1 )} ( {v}_{2} ) & … & {P}_{x}^{( 1 )} ( {v}_{i} ) & … & {P}_{x}^{( 1 )} ( {v}_{N} ) \\ & {P}_{y}^{( 1 )} ( {v}_{1} ) & {P}_{y}^{( 1 )} ( {v}_{2} ) & … & {P}_{y}^{( 1 )} ( {v}_{i} ) & … & {P}_{y}^{( 1 )} ( {v}_{N} ) \\ ⋮ & ⋮ & ⋮ & ⋮ & ⋮ & ⋮ & ⋮ \\ {SOP}_{k}^{I} , {SOP}_{k}^{O} & {P}_{x}^{( k )} ( {v}_{1} ) & {P}_{x}^{( k )} ( {v}_{2} ) & … & {P}_{y}^{( k )} ( {v}_{i} ) & … & {P}_{y}^{( k )} ( {v}_{N} ) \\ & {P}_{y}^{( k )} ( {v}_{1} ) & {P}_{y}^{( k )} ( {v}_{2} ) & … & {P}_{y}^{( k )} ( {v}_{i} ) & … & {P}_{y}^{( k )} ( {v}_{N} ) \\ ⋮ & ⋮ & ⋮ & ⋮ & ⋮ & ⋮ & ⋮ \\ {SOP}_{K - 1}^{I} , {SOP}_{K - 1}^{O} & {P}_{x}^{( K - 1 )} ( {v}_{1} ) & {P}_{x}^{( K - 1 )} ( {v}_{2} ) & … & {P}_{x}^{( K - 1 )} ( {v}_{i} ) & … & {P}_{x}^{( K - 1 )} ( {v}_{N} ) \\ & {P}_{y}^{( K - 1 )} ( {v}_{1} ) & {P}_{y}^{( K - 1 )} ( {v}_{2} ) & … & {P}_{y}^{( K - 1 )} ( {v}_{i} ) & … & {P}_{y}^{( K - 1 )} ( {v}_{N} )\end{matrix} & ( 34 )\end{matrix}$$

### 2.2 Auto Calibration of the Relative Gain

For the embodiment of FIGS. 1K and 1G, it is necessary to perform the below described calibration procedure of the relative gain of the two detectors 22B and 22C before proceeding with any further computation. The same procedure is not performed for the other embodiments, e.g. if there is only one detector.

The calibration principle is predicated upon the fact that, when input and output SOP scramblers are used to generate a sufficiently large number of SOPs so as to substantially cover the Poincaré Sphere, the average power of the light from the FUT 18 will exit from the two ports of the PBS with a 1:1 ratio (equal). Hence, any observed deviation from this 1:1 ratio for the observed detector powers can be quantified and taken into account, as follows.

After data acquisition is completed, K groups of 2×N light powers obtained from both photodetectors have been stored, i.e., a total number of K·N powers (data) from detector 22B and also K·N powers from detector 22C, as depicted in matrix (34). For any one of the i^{th} powers at optical frequency νᵢ (ideally to select an optical frequency that has approximately maximum power or along central frequency of test channel or device under test or FUT) from 22B and 22C are referred to below as Pₓ(νᵢ) and P_{y}(νᵢ), respectively, if the overall losses in the two arms of the PBS were identical and the gains of both photodectors and associated electronics were also equal, the ratio of the powers Pₓ(νᵢ) and P_{y}(νᵢ) after averaging over all K, i.e. all input and output SOPs, would be

$$\frac{< {P}_{x} ( {v}_{i} ) >}{< {P}_{y} ( {v}_{i} ) >} ≡ \frac{{\sum }_{K} {P}_{x}^{k} ( {v}_{i} )}{{\sum }_{K} {P}_{y}^{k} ( {v}_{i} )} = 1 \qquad ( 35 )$$

In practice, the ratio obtained from the average of the measured powers for Pₓ(νᵢ) and P_{y}(νᵢ) does not equal 1 because of different losses in the arms of the PBS and different “effective” gains of the photodetectors, which includes the photodiode responsivity as well as the overall gains of the following electronics, amplifiers and sampling circuitry. (Note that it is not necessary to determine the individual gains separately.) Therefore, before proceeding with the rest of the computations, all the K·N powers obtained from photodetector 22C, i.e. all the P_{y}^{(k)}(νᵢ) (i=1, 2 . . . N; and k=1, 2, . . . K), are multiplied as follows:

P_{y}^{(k)}(νᵢ)≡g_{Forward}·P_{y}^{(k)}(νᵢ) (36)

where

$${g}_{Forward} = \frac{< {P}_{x} ( {v}_{i} ) >}{< {P}_{y} ( {v}_{i} ) >} ≡ \frac{{\sum }_{K} {P}_{x}^{k} ( {v}_{i} )}{{\sum }_{K} {P}_{y}^{k} ( {v}_{i} )}$$

It should be noted that above auto-calibration assumes the relative gain to have negligible wavelength (optical frequency) dependence. Indeed it holds for a narrow wavelength range, especially for a narrow DWDM channel under test. However, if a wide optical frequency range may be used for the test, e.g. in C/L band or C+L band, an auto calibration for the relative gain may be performed at every optical frequency. The calibration process may need only be carried out once per PMD measurement sequence.

2.3. Computation for Embodiments Using Two Physically Orthogonal Polarization Analyzers with a Polarization Beam Splitter

The powers are processed to obtain the DGD(ν) and PMD values using detected two physically orthogonal (i.e. 180 degree in Poincare sphere) polarization components from a polarization beam splitter by rapid wavelength sweeping of either tunable filter means or swept tunable laser, as will now be described. The labels x and y refer to the probed light powers obtained from photodetectors 22B and 22C, respectively.

### 2.3.1 The Normalized Powers

The transmissions (normalized powers), labelled as Tₓ and T_{y}, are computed for the embodiment of FIGS. 1K and 1G for two photodetectors with a PBS as follows either

$$\begin{matrix}{T}_{x}^{( k )} ( v ) = \frac{{P}_{x}^{( k )} ( v )}{{〈 {P}_{x}^{( k )} ( v ) + {P}_{y}^{( k )} ( v ) 〉}_{SOP}} \\ {T}_{y}^{( k )} ( v ) = \frac{{P}_{y}^{( k )} ( v )}{{〈 {P}_{x}^{( k )} ( v ) + {P}_{y}^{( k )} ( v ) 〉}_{SOP}} \\ or & ( 37 a ) \\ {T}_{x}^{( k )} ( v ) = \frac{{P}_{x}^{( k )} ( v )}{{u}_{0} {〈 {P}_{x}^{( k )} ( v ) 〉}_{SOP}} \\ {T}_{y}^{( k )} ( v ) = \frac{{P}_{y}^{( k )} ( v )}{{u}_{0} {〈 {P}_{y}^{( k )} ( v ) 〉}_{SOP}} & ( 37 b )\end{matrix}$$

where [symbol] _{SOP} is referred to average over all or many input and output SOPs at a given optical frequency ν, and the reference mean-value is uₒ=½. Equations (37a) and (37b) assume a measured overall total power, i.e. the sum of two measurements detector A 22B and detector B 22C, is stable over entire measurement time.

If a measured overall total power, i.e. sum of two measurements detector A 22B and detector B 22C, has negligible noise (that may be typically hold for most of commercial instruments if an incident light power is not too low, for example a power meter or an optical spectral analyzer), the transmissions (normalized powers) can then be written as:

$${T}_{x}^{( k )} ( v ) = \frac{{P}_{x}^{( k )} ( v )}{{P}_{x}^{( k )} ( v ) + {P}_{y}^{( k )} ( v )} \\ {T}_{y}^{( k )} ( v ) = \frac{{P}_{y}^{( k )} ( v )}{{P}_{x}^{( k )} ( v ) + {P}_{y}^{( k )} ( v )} \qquad ( 37 c )$$

Advantageously, the transmissions (normalized powers) being obtained in the way as described in equation (37c) have negligible dependence on the test light source stability, which otherwise might be important for a test being performed in the live DWDM network systems where there may be many live channels being operated during the data acquisition.

It should be noted that above normalized power is computed at each optical frequency (ν), i.e. from one wavelength to others, for the entire optical frequency range. This is because there may be different measured light power levels and light noise (i.e. ASE) levels at different frequency (wavelength), especially for the measurement is performed in a narrow optical channel, e.g. a DWDM channel, so that their relative variance may be different from one optical frequency to another.

### 2.3.2 Relative Variance

The relative variance, for example mainly due to un-polarized ASE light from optical amplifiers in the test network fiber link or any other depolarizing effects, as used in equations (7) below, is computed at each optical frequency as

$$\begin{matrix}{σ}_{r}^{2} ( v ) = {( \frac{1}{{σ}_{20}} )}^{2} [ \begin{matrix}- 1 \cdot {〈 {T}_{x} ( v ) {T}_{y} ( v ) 〉}_{SOP} + \\ \frac{1}{4} \cdot {〈 {T}_{x} ( v ) + {T}_{y} ( v ) 〉}_{SOP}^{2}\end{matrix} ] \\ or & ( 38 a ) \\ {σ}_{r}^{2} ( v ) = {( \frac{1}{{σ}_{20}} )}^{2} [ \begin{matrix}- 1 \cdot {〈 {T}_{x} ( v ) {T}_{y} ( v ) 〉}_{SOP} + \\ {〈 T ( v ) 〉}_{SOP}^{2}\end{matrix} ] & ( 38 b )\end{matrix}$$

where σ₂₀²= 1/12, [symbol] _{SOP} refers to an average over all or many (I-SOP, A-SOP) couples at each given optical frequency ν, and [symbol] T(ν) [symbol] _{SOP} refers to an average over all or many input and output SOP couples at each given optical frequency, ν, for these transmissions (normalized powers) measured from two photodetectors.

Advantageously, the above computed relative variance exhibit negligible or minimal dependence on noise in the detected powers. However, under an assumption of negligible noise from the measured powers for each individual detectors of A and B (22B and 22C), a relative variance may be obtained as

$$\begin{matrix}{σ}_{r}^{2} ( v ) = {( \frac{1}{{σ}_{20}} )}^{2} [ \frac{{〈 {T}_{x}^{2} ( v ) 〉}_{SOP} + {〈 {T}_{y}^{2} ( v ) 〉}_{SOP} - 2 \cdot {〈 T ( v ) 〉}_{SOP}^{2}}{2} ] & ( 39 a ) \\ {σ}_{r , x}^{2} ( v ) = {( \frac{1}{{σ}_{20}} )}^{2} [ {〈 {T}_{x}^{2} ( v ) 〉}_{SOP} - {〈 {T}_{x} ( v ) 〉}_{SOP}^{2} ] & ( 39 b ) \\ {σ}_{r , y}^{2} ( v ) = {( \frac{1}{{σ}_{20}} )}^{2} [ {〈 {T}_{y}^{2} ( v ) 〉}_{SOP} - {〈 {T}_{y} ( v ) 〉}_{SOP}^{2} ] & ( 39 c )\end{matrix}$$

It should be noted that Equation (39b) or (39c) can be applied to the embodiments of FIGS. 1K and 1G where the PBS is replaced by a linear polarizer 20A (as embodiments in FIGS. 1I and 1B) and only one photodetector 22A is used.

Also note that after averaging over sufficient large number of input and output SOP couples, relative variances being obtained from equations (39a), (39b) and (39c) are equal, i.e. σᵣ²(ν)=σ_{r,x}²(ν)=σ_{r,y}²(ν).

### 2.3.3 Equalization of Normalized Powers

The transmissions (or normalized powers) computed in Section 3.1 normally does not consider any equalization, i.e. they may be affected from ASE and any depolarization effects etc., therefore they may not be equalized between 0 and 1 even with an uniformly distributed input and output SOPs. However, to compute the DGD and PMD as used in equations (11) and (12) below, it requires to equalize the measured transmissions (or normalized powers) so that they can have an uniform distribution between 0 and 1 for the uniform distributed input and output SOPs. The procedure of equalization for the normalized powers is to remove away these ‘depolarization’ effects on the polarized test light source, and thereby these equalized transmissions (or equalized normalized powers) can be directly used to calculate the mean-square difference for the DGD and PMD computation.

The equalized transmissions (or equalized normalized powers), labelled as T_{e,x} and T_{e,y}, are computed for the embodiments of FIGS. 1K and 1G for two photodetectors with a PBS as follows

$${T}_{e , x}^{( k )} ( v ) = \frac{{T}_{x}^{( k )} ( v )}{{σ}_{r} ( v )} - \frac{1}{2} \cdot ( \frac{1}{{σ}_{r} ( v )} - 1 ) \\ {T}_{e , y}^{( k )} ( v ) = \frac{{T}_{y}^{( k )} ( v )}{{σ}_{r} ( v )} - \frac{1}{2} \cdot ( \frac{1}{{σ}_{r} ( v )} - 1 ) \qquad ( 40 a )$$

where σᵣ(ν) can be obtained from equations (5).

Under the assumption of negligible noise from the measured powers for each individual detectors of A and B (22B and 22C) the equalized transmissions (or equalized normalized powers) can also be expressed as

$${T}_{e , x}^{( k )} ( v ) = \frac{{T}_{x}^{( k )} ( v )}{{σ}_{r , x} ( v )} - \frac{1}{2} \cdot ( \frac{1}{{σ}_{r , x} ( v )} - 1 ) \\ {T}_{e , y}^{( k )} ( v ) = \frac{{T}_{y}^{( k )} ( v )}{{σ}_{r , y} ( v )} - \frac{1}{2} \cdot ( \frac{1}{{σ}_{r , y} ( v )} - 1 ) \qquad ( 40 b )$$

where σ_{r,x}(ν) and σ_{r,y} (ν) can be obtained from equations (6).

Note that Equation (40b) can be applied to the embodiments of FIGS. 1K and 1G in which the PBS is replaced by a linear polarizer 20A (e.g. embodiments shown in FIGS. 1I and 1B) and only one photodetector 22A is used.

It should be noted that the equalization for transmissions (or normalized powers) needs to be performed at each optical frequency. This is because a relative variance may be different at different optical frequency (wavelength), especially for a narrow bandwidth channel of the DWDM network system under test with ASE from optical amplifiers. However, if there is no difference for relative variance against optical frequency (wavelength), one or an averaged relative variance may be calculated.

### 2.3.4 Mean-Square Differences

The calculation of mean-square differences using equalized transmissions (or equalized normalized powers), T_{e,x} and T_{e,y}, from two photodetectors with a PBS for the embodiments of FIGS. 1K and 1G, can be found as

$$\begin{matrix}\begin{matrix}{〈 Δ {T}_{e}^{2} ( v ) 〉}_{SOP} = {〈 \begin{matrix}- 1 \cdot ( {T}_{e , x}^{( k )} ( v + \frac{1}{2} δ v ) - {T}_{e , x}^{( k )} ( v - \frac{1}{2} δ v ) ) \cdot \\ ( {T}_{e , y}^{( k )} ( v + \frac{1}{2} δ v ) - {T}_{e , y}^{( k )} ( v - \frac{1}{2} δ v ) )\end{matrix} 〉}_{SOP} \\ = - \frac{1}{K} {\sum }_{k} ( {T}_{e , x}^{( k )} ( v + \frac{1}{2} δ v ) - {T}_{e , x}^{( k )} ( v - \frac{1}{2} δ v ) ) \cdot \\ ( {T}_{e , y}^{( k )} ( v + \frac{1}{2} δ v ) - {T}_{e , y}^{( k )} ( v - \frac{1}{2} δ v ) )\end{matrix} & ( 41 a ) \\ \begin{matrix}{〈 Δ {T}_{e}^{2} ( v ) 〉}_{SOP , v} = {{〈 \begin{matrix}- 1 \cdot ( {T}_{e , x}^{( k )} ( v + \frac{1}{2} δ v ) - {T}_{e , x}^{( k )} ( v - \frac{1}{2} δ v ) ) \cdot \\ ( {T}_{e , y}^{( k )} ( v + \frac{1}{2} δ v ) - {T}_{e , y}^{( k )} ( v - \frac{1}{2} δ v ) )\end{matrix} 〉}_{SOP}}_{, v} \\ = - \frac{1}{K \cdot {N}^{′}} {\sum }_{k , n} ( {T}_{e , x}^{( k )} ( v + \frac{1}{2} δ v ) - {T}_{e , x}^{( k )} ( v - \frac{1}{2} δ v ) ) \cdot \\ ( {T}_{e , y}^{( k )} ( v + \frac{1}{2} δ v ) - {T}_{e , y}^{( k )} ( v - \frac{1}{2} δ v ) )\end{matrix} & ( 41 b )\end{matrix}$$

where K is total input and output SOP couples and N′ is total midpoint optical frequency number.

As shown in equations (41a) and (41b), by using equalized transmissions (or equalized normalized powers), T_{e,x} and T_{e,y}, to compute the mean-square difference for the PBS-based embodiments of FIGS. 1K and 1G with two photodetectors, the noise averages to zero instead of being ‘rectified’, because the noise superimposed on a measured power by one detector is not correlated with the noise superimposed on the measured power by a different detector. That is achieved from acquiring data with different detectors A and B (22B and 22C) in the exemplary embodiments of FIGS. 1K and 1G.

Equalized transmissions (or equalized normalized powers) obtained from one photodetector connected either after one of two ports of a PBS or after a linear polarizer, for example for embodiments in FIGS. 1I and 1B where only one photodetector 22A is used, can also be used to calculate mean-square difference as,

$$\begin{matrix}\begin{matrix}{〈 Δ {T}_{e}^{2} ( v ) 〉}_{SOP} = {〈 {( {T}_{e , x}^{( k )} ( v + \frac{1}{2} δ v ) - {T}_{e , x}^{( k )} ( v - \frac{1}{2} δ v ) )}^{2} 〉}_{SOP} \\ = \frac{1}{K} {\sum }_{k} {( {T}_{e , x}^{( k )} ( v + \frac{1}{2} δ v ) - {T}_{e , x}^{( k )} ( v - \frac{1}{2} δ v ) )}^{2}\end{matrix} & ( 42 a ) \\ \begin{matrix}{〈 Δ {T}_{e}^{2} ( v ) 〉}_{SOP} = {〈 {( {T}_{e , y}^{( k )} ( v + \frac{1}{2} δ v ) - {T}_{e , y}^{( k )} ( v - \frac{1}{2} δ v ) )}^{2} 〉}_{SOP} \\ = \frac{1}{K} {\sum }_{k} {( {T}_{e , y}^{( k )} ( v + \frac{1}{2} δ v ) - {T}_{e , y}^{( k )} ( v - \frac{1}{2} δ v ) )}^{2}\end{matrix} & ( 42 b ) \\ \begin{matrix}{〈 Δ {T}_{e}^{2} ( v ) 〉}_{SOP , v} = {〈 {( {T}_{e , x}^{( k )} ( v + \frac{1}{2} δ v ) - {T}_{e , x}^{( k )} ( v - \frac{1}{2} δ v ) )}^{2} 〉}_{SOP , v} \\ = \frac{1}{K \cdot {N}^{′}} {\sum }_{k , n} {( {T}_{e , x}^{( k )} ( v + \frac{1}{2} δ v ) - {T}_{e , x}^{( k )} ( v - \frac{1}{2} δ v ) )}^{2}\end{matrix} & ( 43 a ) \\ \begin{matrix}{〈 Δ {T}_{e}^{2} ( v ) 〉}_{SOP , v} = {〈 {( {T}_{e , y}^{( k )} ( v + \frac{1}{2} δ v ) - {T}_{e , y}^{( k )} ( v - \frac{1}{2} δ v ) )}^{2} 〉}_{SOP , v} \\ = \frac{1}{K \cdot {N}^{′}} {\sum }_{k , n} {( {T}_{e , y}^{( k )} ( v + \frac{1}{2} δ v ) - {T}_{e , y}^{( k )} ( v - \frac{1}{2} δ v ) )}^{2}\end{matrix} & ( 43 b )\end{matrix}$$

where K is total input and output SOP couples and N′ is total midpoint optical frequency number. Equations (9) and (10) are under an assumption of negligible noise for the measured powers for each individual detectors of A or B (22B and 22C) or photodetector 22A of FIGS. 1I and 1B.

Note that [symbol] _{SOP} in above equations refer to only averaging over the SOP at a given midpoint frequency (ν_{i,mid}) (or midpoint wavelength, λ_{i,mid}), i.e., only changing the (I-SOP, A-SOP) s from one group of powers to other, and [symbol] _{SOP,ν} in above equations refer to averaging over the (I-SOP, A-SOP) couples and midpoint frequency (ν_{i,mid}).

### 2.3.5 Computation of the DGD and PMD Value Using Mean-Square Differences of Equalized Transmissions

The DGD(ν) is computed according to the arcsine formula from calculated mean-square differences using equalized transmissions (or equalized normalized powers) in equation (42) or (43) for the embodiments of FIGS. 1K and 1G with PBS and two photodetectors as,

$$DGD ( v ) = \frac{1}{πδ v} arcsin ( {α}_{ds} \sqrt{{〈 Δ {T}_{e}^{2} ( v ) 〉}_{SOP}} ) \qquad ( 44 a )$$

where [symbol] _{SOP} refers to average over the (I-SOP, A-SOP) couples only.

A rms DGD can be written as

$$rms DGD = \frac{1}{πδ v} arcsin ( {α}_{ds} \sqrt{{〈 Δ {T}_{e}^{2} ( v ) 〉}_{SOP ; v}} ) \qquad ( 45 a )$$

where [symbol] _{SOP;ν} refers to averaging over both the (I-SOP, A-SOP) couples and optical frequency (i.e. wavelength), and a theoretical constant

$${α}_{ds} = \sqrt{\frac{9}{2}} ,$$

and, δν=νᵢ₊ₙ−νᵢ, an optical frequency difference between two closely-spaced optical frequencies, νᵢ and νᵢ₊ₙ, is used for computing DGD and PMD.

It should be appreciated that the arcsine formula, in above equations, is not the only possible one. The purpose of using this formula is to obtain a result that is unbiased even if using a relatively large step, such that PMD·δν˜0.2, without introducing a significant error; thereby to maximize the signal-to-noise ratio and therefore the dynamic range of the instrument. Although applicable to any step size, if one were not concerned with maximizing the dynamic range, one could select a small step, in which case the following simpler differential formula is valid:

$$\begin{matrix}DGD ( v ) = \frac{1}{πδ v} ( {α}_{ds} \sqrt{{〈 Δ {T}_{e}^{2} ( v ) 〉}_{SOP}} ) & ( 44 b ) \\ RMS DGD ( v ) = \frac{1}{πδ v} ( {α}_{ds} \sqrt{{〈 Δ {T}_{e}^{2} ( v ) 〉}_{SOP ; v}} ) & ( 45 b )\end{matrix}$$

This is not to infer that these formula are better or particularly advantageous, but merely that it may conveniently be used if the step is much smaller, i.e., satisfying the condition DGD·δν or rms DGD·δν<0.01.

For the equations (44) and (45), an optical frequency difference, δν, is the same or approximately the same for all midpoint optical frequencies.

Note that the relationships in equations (44a) and (45a) hold for DGD·δν<0.5 or PMD·δν<0.2 for the two-ended measurement configuration, thus clarifying the meaning of ‘closely-spaced optical frequencies’.

Also note that in equation (45b) an averaging optical frequency range can be small, for example as small as of <20 GHz, or very wide, for example close to 10 THz.

It should also be noted that above equations can be used for any situation where there is no any ASE or with significant ASE from optical amplifiers, for example signal-to-noise ratio may be as low as of ˜3 dB, and accompanied by other ‘depolarization’ effects etc. This is because the equalization for transmissions (or normalized powers) has been performed (in Section 3.3).

A mean DGD or RMS DGD may be computed from averaging DGD(ν) (obtained from equation (44a) or (44b)) from many different midpoint optical frequencies over a prescribed optical frequency range, such as

$$\begin{matrix}RMS DGD = \sqrt{{〈 {DGD}^{2} ( v ) 〉}_{v}} & ( 13 a ) \\ mean DGD = {〈 DGD ( v ) 〉}_{v} & ( 13 b )\end{matrix}$$

### 2.4. Computation for Embodiments Using Two Polarization Analyzers Having an Arbitrary Relative Orientation

The powers are processed, for exemplary rapid wavelength-sweeping embodiments employing either a tunable filter or a swept laser, to obtain the DGD(ν) and PMD values, for the more general case where the two analyzers have a relative angle of θ (as measured on the Poincaré sphere), without restricting θ to be 0 degrees (e.g. from a 50/50 polarization-independent splitter) or 180 degrees (e.g. from a PBS). As will become apparent, the relative angle must not be 90 or 270 degrees (as measured on the Poincare sphere). The labels x and y refer to the measured light powers obtained by two photodetectors followed two polarization analyzers.

### 2.4.1 The Normalized Powers

The transmissions (normalized powers) can be written as

$${T}_{x}^{( k )} ( v ) = \frac{{P}_{x}^{( k )} ( v )}{{u}_{0} {〈 {P}_{x}^{( k )} ( v ) 〉}_{SOP}} \\ {T}_{y}^{( k )} ( v ) = \frac{{P}_{y}^{( k )} ( v )}{{u}_{0} {〈 {P}_{y}^{( k )} ( v ) 〉}_{SOP}} \qquad ( 47 )$$

where [symbol] _{SOP} refers to an average over all or many (I-SOP, A-SOP) couples at a given optical frequency ν, and the reference mean-value is uₒ=½. Equation (47) assumes that the overall total power is stable over entire measurement time.

### 2.4.2 Relative Variance

The relative variance, for example mainly due to un-polarized ASE light from optical amplifiers in the test network fiber link or any other depolarizing effects, as used in equation (49) below, is computed at each optical frequency as

$$\begin{matrix}{σ}_{r}^{2} ( v ) = {( \frac{1}{{σ}_{20}} )}^{2} [ \frac{{〈 {T}_{x } ( v ) {T}_{y} ( v ) 〉}_{SOP} - \frac{1}{4} \cdot {〈 {T}_{x} ( v ) + {T}_{y} ( v ) 〉}_{SOP}^{2}}{cos θ} ] \\ or & ( 48 a ) \\ {σ}_{r}^{2} ( v ) = {( \frac{1}{{σ}_{20}} )}^{2} [ \frac{{〈 {T}_{x} ( v ) {T}_{y} ( v ) 〉}_{SOP} - {〈 T ( v ) 〉}_{SOP}^{2}}{cos θ} ] & ( 48 b )\end{matrix}$$

where θ is an angle between two polarization analyzers (not 90 or 270 degree (in Poincare sphere)), σ₂₀²= 1/12, [symbol] _{SOP} refers to an average over all or many (I-SOP, A-SOP) couples at each given optical frequency ν, and [symbol] T(ν) [symbol] _{SOP} is referred to average over all or many (I-SOP, A-SOP) couples at each given optical frequency, ν, for these transmissions (normalized powers) measured from two photodetectors. Advantageously, the above computed relative variance exhibits negligible or very small dependence on noise in the detected powers.

### 2.4.3 Equalization of Normalized Powers

The equalized transmissions (or equalized normalized powers), labelled as T_{e,x} and T_{e,y}, are computed for two photodetectors from two analyzers as the same way as in equation (40a) as follows

$${T}_{e , x}^{( k )} ( v ) = \frac{{T}_{x}^{( k )} ( v )}{{σ}_{r} ( v )} - \frac{1}{2} \cdot ( \frac{1}{{σ}_{r} ( v )} - 1 ) \\ {T}_{e , y}^{( k )} ( v ) = \frac{{T}_{y}^{( k )} ( v )}{{σ}_{r} ( v )} - \frac{1}{2} \cdot ( \frac{1}{{σ}_{r} ( v )} - 1 ) \qquad ( 40 a )$$

where σᵣ(ν) can be obtained from equation (48).

### 2.4.4 Mean-Square Differences

The calculation of mean-square differences using equalized transmissions (or equalized normalized powers) from two photodetectors with two arbitrary orientated polarization analyzers having an angle, θ, but not 90 or 270 degree (in Poincare sphere) between them can be found as

$$\begin{matrix}\begin{matrix}{〈 Δ {T}_{e}^{2} ( v ) 〉}_{SOP} = {〈 \begin{matrix}( {T}_{e , x}^{( k )} ( v + \frac{1}{2} δ v ) - {T}_{e , x}^{( k )} ( v - \frac{1}{2} δ v ) ) \cdot \\ ( {T}_{e , y}^{( k )} ( v + \frac{1}{2} δ v ) - {T}_{e , y}^{( k )} ( v - \frac{1}{2} δ v ) )\end{matrix} 〉}_{SOP} \\ = \frac{1}{K} {\sum }_{k} ( {T}_{e , x}^{( k )} ( v + \frac{1}{2} δ v ) - {T}_{e , x}^{( k )} ( v - \frac{1}{2} δ v ) ) \cdot \\ ( {T}_{e , y}^{( k )} ( v + \frac{1}{2} δ v ) - {T}_{e , y}^{( k )} ( v - \frac{1}{2} δ v ) )\end{matrix} & ( 49 a ) \\ \begin{matrix}{〈 Δ {T}_{e}^{2} ( v ) 〉}_{SOP , v} = {〈 \begin{matrix}( {T}_{e , x}^{( k )} ( v + \frac{1}{2} δ v ) - {T}_{e , x}^{( k )} ( v - \frac{1}{2} δ v ) ) \cdot \\ ( {T}_{e , y}^{( k )} ( v + \frac{1}{2} δ v ) - {T}_{e , y}^{( k )} ( v - \frac{1}{2} δ v ) )\end{matrix} 〉}_{SOP , v} \\ = - \frac{1}{K \cdot {N}^{′}} {\sum }_{k} ( \begin{matrix}{T}_{e , x}^{( k )} ( v + \frac{1}{2} δ v ) - \\ {T}_{e , x}^{( k )} ( v - \frac{1}{2} δ v )\end{matrix} ) \cdot \\ ( {T}_{e , y}^{( k )} ( v + \frac{1}{2} δ v ) - {T}_{e , y}^{( k )} ( v - \frac{1}{2} δ v ) )\end{matrix} & ( 49 b )\end{matrix}$$

where K is total (I-SOP, A-SOP) couples and N′ is total midpoint optical frequency number.

As shown in equations (49a) and (49b), by using equalized transmissions (or equalized normalized powers), T_{e,x} and T_{e,y}, to compute the mean-square difference from two polarization analyzers followed by two tunable filters and two photodetectors (for the embodiment using broadband source) or two photodetectors (for the embodiment using tunable laser source), the noise averages to zero instead of being ‘rectified’, because the noise superimposed on a given measured power from one detector is not correlated with the noise superimposed on the another power measured by a different detector.

### 2.4.5 Computation of the DGD and PMD Value Using Mean-Square Differences of Equalized Transmissions

The DGD(ν) is computed according to the arcsine formula from calculated mean-square differences using equalized transmissions (or equalized normalized powers) in equation (49) measured by two photodetectors for an arbitrary orientated two polarization analyzers with an angle, θ, but not 90 or 270 degree (in Poincare sphere) between them as

$$D G D ( v ) = \frac{1}{π δ v} arcsin ( {α}_{ds} \sqrt{\frac{{〈 Δ {T}_{e}^{2} ( v ) 〉}_{SOP}}{cos θ}} ) \qquad ( 50 a )$$

where [symbol] _{SOP} refers to average over the (I-SOP, A-SOP) couples only.

A rms DGD can be written as

$$rms D G D = \frac{1}{π δ v} arcsin ( {α}_{ds} \sqrt{\frac{{〈 Δ {T}_{e}^{2} ( v ) 〉}_{SOP ; v}}{cos θ}} ) \qquad ( 51 b )$$

where [symbol] _{SOP;ν} refers to an average over both the (I-SOP, A-SOP) couples and optical frequency (i.e. wavelength), and a theoretical constant

$${α}_{ds} = \sqrt{\frac{9}{2}} ,$$

and, δν=νᵢ₊ₙ−νᵢ, an optical frequency difference between two closely-spaced optical frequencies, νᵢ and νᵢ₊ₙ, is used for computing DGD and PMD.

Note that, for equations (50) and (51), an angle, θ, between two polarization analyzer axes must not be 90 or 270 degree (in Poincare sphere).

It should be appreciated that the arcsine formula, in above equations, is not the only possible one. For selected a small step, i.e. satisfying the condition DGD·δν or rms DGD·δν<0.01, the following simpler differential formula is also valid:

$$\begin{matrix}D G D ( v ) = \frac{1}{π δ v} ( {α}_{ds} \sqrt{\frac{{〈 Δ {T}_{e}^{2} ( v ) 〉}_{SOP}}{cos θ}} ) & ( 50 b ) \\ RMS D G D = \frac{1}{π δ v} ( {α}_{ds} \sqrt{\frac{{〈 Δ {T}_{e}^{2} ( v ) 〉}_{SOP ; v}}{cos θ}} ) & ( 51 b )\end{matrix}$$

A mean DGD or RMS DGD may be computed from averaging DGD(ν) (obtained from equation (17a) or (17b)) from many different midpoint optical frequencyies over a prescribed optical frequency range, such as

$$\begin{matrix}RMS D G D = \sqrt{{〈 D G {D}^{2} ( v ) 〉}_{v}} & ( 52 a ) \\ mean D G D = {〈 D G D ( v ) 〉}_{v} & ( 52 b )\end{matrix}$$

It should be noted that the two analyzer axes may also be oriented in exactly the same direction or even to use only one polarization analyzer followed by a coupler 21 and two detectors A and B (22B and 22C) as shown in the embodiment of FIG. 1D.

### Data Processing and Computation: Single-Ended Overall PMD Measurement

### 1. Single-Ended Overall PMD: the Data Structure

Each backreflected light power from the localized reflection (such as Fresnel reflection) at the distal end of FUT, obtained with one given setting of the wavelength and of the (I-SOP, A-SOP) couples, as described in the Method of Operation for the single-ended overall PMD measurement, constitutes the elementary data cell, i.e. one data consists of one power value. The next data unit is one group of four powers (i.e. four data cells), two sets of four backreflected powers for the embodiments of FIG. 2C and FIG. 2G where two backreflected powers are obtained simultaneously from photodetectors 22B and 22C, all obtained with a given (I-SOPₖ, A-SOPₖ) as set by I/O-SOP controller 14. The two sets of four powers forming group k preferably are obtained in the following sequence (time flowing from left to right):

$$( I \text{-} {SOP}_{k} , A \text{-} {SOP}_{k} , {λ}_{k} ) \overbrace{\begin{matrix}{Px}_{L}^{( k )} & {Px}_{L}^{″ ( k )} \\ {Py}_{L}^{( k )} & {Py}_{L}^{″ ( k )}\end{matrix}}^{λ = {λ}_{L}^{( k )}} \overbrace{\begin{matrix}{Px}_{L}^{( k )} & {Px}_{L}^{″ ( k )} \\ {Py}_{L}^{( k )} & {Py}_{L}^{″ ( k )}\end{matrix}}^{λ = {λ}_{U}^{( k )}}$$

where the labels x and y refer to the power obtained simultaneously (or at slightly different time) from photodetectors 22B and 22C, respectively, λ_{U}^{(k)}−λ_{L}^{(k)} is equal to the step δλ, the midpoint wavelength is defined as λₖ=(λ_{U}^{(k)}+λ_{L}^{(k)})/2, and the double prime indicates the repeated powers.

Finally, the overall data stored in the data file after acquisition is depicted as a matrix in Equation (53) below, to which we will refer in all that follows. The matrix comprises K groups each of four powers of light backreflections (two sets of four when two photodetectors are used):

$$Data = {\begin{matrix}{SOP}_{0} and \text{/} or {λ}_{0} \to & {Px}_{L}^{( 0 )} & {Px}_{{L}_{ }}^{″ ( 0 )} & {Px}_{U}^{( 0 )} & {Px}_{U}^{″ ( 0 )} \\ & {Py}_{L}^{( 0 )} & {Py}_{{L}_{ }}^{″ ( 0 )} & {Py}_{U}^{( 0 )} & {Py}_{U}^{″ ( 0 )} \\ {SOP}_{1} and \text{/} or {λ}_{1} \to & {Px}_{L}^{( 1 )} & {Px}_{{L}_{ }}^{″ ( 1 )} & {Px}_{U}^{″ ( 1 )} & {Px}_{U}^{″ ( 1 )} \\ & {Py}_{L}^{( 1 )} & {Py}_{{L}_{ }}^{″ ( 1 )} & {Py}_{U}^{( 1 )} & {Py}_{U}^{″ ( 1 )} \\ ⋮ & ⋮ & ⋮ & ⋮ & ⋮ \\ {SOP}_{k} and \text{/} or {λ}_{k} \to & {Px}_{L}^{( k )} & {Px}_{L}^{″ ( k )} & {Px}_{U}^{( k )} & {Px}_{U}^{″ ( k )} \\ & {Py}_{L}^{( k )} & {Py}_{L}^{″ ( k )} & {Py}_{U}^{( k )} & {Py}_{U}^{″ ( k )} \\ ⋮ & ⋮ & ⋮ & ⋮ & ⋮ \\ {SOP}_{K - 1} and \text{/} or {λ}_{K - 1} \to & {Px}_{L}^{( K - 1 )} & {Px}_{L}^{″ ( K - 1 )} & {Px}_{U}^{( K - 1 )} & {Px}_{U}^{″ ( K - 1 )} \\ & {Py}_{L}^{( K - 1 )} & {Py}_{L}^{″ ( K - 1 )} & {Py}_{U}^{( K - 1 )} & {Py}_{U}^{″ ( K - 1 )}\end{matrix}}^{ \overbrace{λ = {λ}_{L}^{( k )}} \overbrace{λ = {λ}_{U}^{( k )}}} \qquad ( 53 )$$

### 2. Single-Ended Overall PMD: Auto Calibration of the Relative Gain

For the preferred embodiment of FIG. 2 using a polarization beam splitter (PBS), as shown in FIG. 2G, it is necessary to perform the below-described calibration procedure of the relative gain of the two detectors 22B and 22C before proceeding with any further computation. The same procedure is not performed for the other embodiments.

The calibration principle is predicated upon the fact that, when an I/O-SOP scrambler 14 is used to generate a sufficiently large number of SOPs so as to substantially cover the Poincaré Sphere, the average power of the backreflected light from the distal end (or other positions) of the FUT 18 will exit from the two ports of the PBS with a 2:1 ratio, the higher power corresponding to the port to which detector 22B is connected and the lower power corresponding to the port to which detector 22C is connected. Hence, any observed deviation from this 2:1 ratio for the observed detector powers can be quantified and taken into account, as follows.

After data acquisition is completed, K groups of four backreflected light powers obtained from both photodetectors have been stored, i.e., a total number of J=4·K powers (data) from detector 22B and also J=4·K traces from detector 22C, as depicted in matrix (53). The j^{th} powers (j=0, 1 . . . (J−1)) from 22B and 22C are referred to below as Pxⱼ and Pyⱼ, respectively. If the overall losses in the two arms of the PBS were identical and the gains of both photodectors and associated electronics were also equal, the ratio of the powers Py and Px after averaging both populations over all J occurrences would be

$$\frac{〈 Px 〉}{〈 Py 〉} ≡ \frac{{\sum }_{j} {Px}_{j}}{{\sum }_{j} {Py}_{j}} = 2$$

In practice, the ratio obtained from the average of the measured powers does not equal 2 because of different losses in the arms of the PBS and different “effective” gains of the photodetectors, which includes the photodiode responsivity as well as the overall gains of the following electronics, amplifiers and sampling circuitry. (Note that it is not necessary to determine the individual gains separately.) Therefore, before proceeding with the rest of the computations, all the J powers obtained from photodetector 22C, i.e. all the Pyᵢ, are multiplied as follows:

Pyⱼ≡g_{RoundTrip}·Pyⱼ;

where

$${g}_{RoundTrip} = \frac{1}{2} \frac{〈 Px 〉}{〈 Py 〉} = \frac{{\sum }_{j} {Px}_{j}}{{\sum }_{j} {Py}_{j}}$$

In practice, for center wavelengths that are relatively closely-spaced (e.g. <20 nm), the relative wavelength dependence of the components, detectors, etc. may be negligible and this calibration process need only be carried out once per single-ended PMD measurement sequence. Otherwise, this calibration may need to be carried out at every center wavelength, thereby increasing the overall measurement time of the measurement sequence.

As a result of the calibration, i.e. after all Py powers (data) have been multiplied by the measured relative gain as described above, the data processor 34 can compute the normalized backreflected light powers. More precisely, the normalized powers in the case of the embodiment of FIG. 2 using a PBS are obtained by dividing the sampled and averaged signal Px from detector 22B, or the signal Py from detector 22C, or (and preferably) the difference (Px−Py)/2 or (Py−Px)/2, as will be described in more detail in the next section, or any weighted difference (1+w)⁻¹(Px−w·Py), where w is a weighting factor, by the sum (Px+Py) of the sampled and averaged signals from both of the detectors 22B and 22C, which sum represents the total power impinging on the PBS, i.e., without selection of a particular polarization component.

It should be noted that other calibration may also be possible. For example, a potential alternative calibration technique is to use an internal reference with fiber couplers (splitters) or internal reflector to send a predefined amount (percentage) of light power from launched OTDR light to two different detectors.

The preferred computations giving the normalized powers of all preferred embodiments will now be described in detail.

### 3. Single-Ended Overall PMD: Computation

The powers are processed to obtain the DGD or PMD values, as will now be described. It should be note that, in all that follows, the symbols refer to the matrix “Data” in Equation (53). The labels x and y refer to the backreflected light powers obtained from photodetectors 22B and 22C, respectively.

### 3.1 The Normalized Powers

The normalized powers (i.e. transmissions), labelled hereinafter as T, are computed differently according to the embodiment.

(i) For the embodiment of FIG. 2 (two photodetectors with a PBS), the normalized power is computed exactly the same as a normalization procedure for the embodiment of FIG. 1D (two photodetectors with a PBS) for the two-ended PMD measurement as already in the previous related section. But note that the different Py powers must have been pre-multiplied by the measured relative gain, g_{RoundTrip}, from single-ended measurement, as indicated in the description of the auto calibration procedure, before they are used in this normalization procedure.
(ii) For the embodiment of FIG. 2D (two photodetectors with a coupler), the normalized power is computed also exactly the same as a normalization procedure for the embodiment of FIG. 1C (two photodetectors with a coupler) for the two-ended PMD measurement as already in the previous related section. But note that a different reference mean-value uₒ=⅔ for single-ended measurement is used in this normalization procedure.

Here, the auto calibration procedure is not required, i.e. the above mentioned pre-multiplication of the powers Py by the measured relative gain may be skipped.

(iii) For the embodiment of FIG. 2C (single photodetector), again the normalized power is computed the same as a normalization procedure for the embodiment of FIG. 1B (two photodetectors with a coupler) for the two-ended PMD measurement as already in the previous related section and a reference mean-value of uₒ=⅔ for single-ended measurement must also be used in this normalization procedure.

Here we assume that light powers being launched into FUT at λ_{U}^{(k)} and λ_{L}^{(k)} is nearly the same.

It should be noted that, in the equations above, [symbol] _{SOP;ν} can refer to averaging over either the I-SOPs, the A-SOPs, or the midpoint optical frequency (wavelength), ideally over all three, i.e., changing both the (I-SOP, A-SOP) couple and wavelength from one group of powers to the next. All of these relationships are fundamentally valid in all cases even if only polarization scrambling is applied, giving the correct value of the DGD at one particular midpoint wavelength. Then, scanning the midpoint wavelength only serves the purpose of averaging DGD over wavelength as per the definition of the statistical PMD value. On the contrary, as discussed earlier, averaging only over wavelength while keeping the (I-SOP, A-SOP) couple unchanged requires that assumptions about the FUT be met, and also requires a large value of the product PMD·Δν. The same remarks apply for the equations presented hereinafter.

### 3.2 Mean-Square Differences

The calculation here differs from the simple mean-square found in Eqs. (1) (3) (12) and (13) which, for greater clarity, did not take into account the noise. Instead, the product of the repeated differences between normalized traces at λ_{U} and λ_{L} is averaged as follows,

$$\begin{matrix}{〈 Δ {T}^{2} ( v ) 〉}_{SOP ; v} = {〈 ( {T}_{U} - {T}_{L} ) \cdot ( {T}_{U}^{″} - {T}_{L}^{″} ) 〉}_{SOP ; v} \\ = \frac{1}{K} {\sum }_{k} ( {T}_{U}^{( k )} - {T}_{L}^{( k )} ) \cdot ( {T}_{U}^{″ ( k )} - {T}_{L}^{″ ( k )} )\end{matrix} \qquad ( {22}^{′} )$$

Note the equation (22′) is the same as equation (22). In conventional mathematical terms, equation (22′) may be referred to as the second-order joint moment of the repeated differences. Doing so, the noise averages to zero instead of being “rectified”, because the noise superimposed on a given trace is not correlated with the noise superimposed on the corresponding repeated trace. That is the first motivation for sampling repeated traces.

### 3.3 Computation of the PMD Value

The PMD then is directly computed according to the arcsine formula as,

$$P M D = {α}_{rt} \frac{1}{π δ v} arcsin ( {α}_{ds} \sqrt{{〈 Δ {T}^{2} ( v ) 〉}_{SOP ; v}} ) \qquad ( 54 )$$

where a roundtrip factor

$${α}_{rt} = \sqrt{\frac{3}{8}} .$$

A theoretical constant

$${α}_{ds} = \sqrt{\frac{15}{4}}$$

is valid for the cases where a common (same) state of polarization controller (scrambler) is used to control both input and output light SOPs, such as for FIGS. 2, 2C-G.

It should be appreciated that the arcsine formula, in Eq. (54), is not the only possible one. The purpose of using this formula is to obtain a result that is unbiased even if using a relatively large step, such that PMD·δν˜0.15, without introducing a significant error; this in order to maximize the signal-to-noise ratio and therefore the dynamic range of the instrument. If one were not concerned with maximizing the dynamic range, or keeping the overall measurement time reasonable, one might select a much smaller step, and use the simpler differential formula that follows,

$$PMD = {α}_{rt} \cdot \frac{{α}_{ds}}{π δ v} \cdot \sqrt{{〈 Δ {T}^{2} ( v ) 〉}_{SOP ; v}} \qquad ( 54 a )$$

This is not to infer that this formula is better or particularly advantageous, but merely that it may conveniently be used if the step is much smaller, i.e., satisfying the condition PMD·δν<0.01.

It should be noted that a forward PMD calculated from equations (54) and (54a) is a PMD or rms DGD of FUT.

It should also be noted that roundtrip rms DGD or roundtrip mean DGD can also obtained from a root-mean-square for DGD_{RoundTrip}(ν) or mean for DGD_{RoundTrip}(ν)ₐₜ many different wavelengths for a given wavelength range and DGD_{RoundTrip}(ν) at each given wavelength can be computed the arcsine formula as either,

$${DGD}_{RoundTrip} ( v ) = \frac{1}{π δ v} arcsin ( {α}_{ds} \sqrt{{〈 Δ {T}^{2} ( v ) 〉}_{SOP}} ) . \qquad ( 55 )$$

or use the simpler differential formula that follows,

$${DGD}_{RoundTrip} ( v ) = \frac{{α}_{ds}}{π δ v} \cdot \sqrt{{〈 Δ {T}^{2} ( v ) 〉}_{SOP}} . \qquad ( 55 a )$$

where normalized power (T) is obtained from each give wavelength.

A rms DGD and mean DGD (forward) can also be obtained by simply multiplying a roundtrip factor of \sqrt{⅜} and 2/π on rms DGD_{RoundTrip} and mean DGD_{RoundTrip}, respectively, where a rms DGD_{RoundTrip} or mean DGD_{RoundTrip} can be obtained from measured DGD_{RoundTrip}(ν) for many different midpoint wavelengths by root-mean square or mean DGD_{RoundTrip}(ν) from equations (35) or (35a) over a prescribed wavelength range, e.g.

$$rms {DGD}_{RoundTrip} = \sqrt{{〈 {DGD}_{RoundTrip}^{2} ( v ) 〉}_{v}}$$

$$and$$

$$mean {DGD}_{RoundTrip} = {〈 {DGD}_{RoundTrip} ( v ) 〉}_{v} .$$

It should also noted that above computation equations for extracting DGD and PMD using normalized power (usually a normalized power is ranged between 0 to 1) may be replaced by other method. For example, only a relative power may be computed from measured powers, then a ‘normalization factor’ may be used in the equations (54) and (55) to cancel this factor that is multiplied on mean-square difference so as to obtain correct a DGD or PMD value.

It should be noted that the above equations for calculating the DGD or PMD have a theoretical constant

$${α}_{ds} = \sqrt{\frac{15}{4}} .$$

This theoretical constant value is valid for the cases where the same common state of polarization controller (scrambler) is used as both input and output light SOP controlling, such as for FIGS. 2, 2C-G. However, when two separated independent input and output state of polarization controllers (scramblers) are used with a polarizer or PBS being located just before the detector, for example as shown in FIG. 2G, a different theoretical constant i.e.

$${α}_{ds} = \sqrt{\frac{9}{2 }} ,$$

must be used, (note this theoretical constant is the same as for two-ended PMD measurement equations as already described related above section).

For the case where the tunable pulsed light source has a relatively big linewidth and a high PMD fiber is under test, a linewidth ‘correction factor’ may need to be applied in Eq. (54,54a) in order to extract an accurate PMD value from the FUT.

It should also be noted that repeated powers may be obtained from two or more measurements at different times using the same detectors, or from measurements using different detectors, e.g. after light power being split by a coupler, where the powers detected by the different detectors are measured contemporaneously.

### Data Processing and Computation: Single-Ended Cumulative PMD Measurement

### 1. Single-Ended Cumulative PMD: The Data Structure

Each OTDR trace, obtained with one given setting of the wavelength and of the (I-SOP, A-SOP) couple, as described in the Method of Operation for the single-ended cumulative PMD measurement (also called as single-ended POTDR based cumulative PMD measurement), constitutes the elementary data cell. One trace consists of N power values corresponding to N values zₙ of the distance z, with n=

The next larger data unit is one group of four traces, two sets of four traces for the embodiments of FIG. 3 and FIG. 3B where two traces are obtained simultaneously from photodetectors 22B and 22C (or sequentially in the case where an optical switch is used with one detector), all obtained with a given (I-SOP, A-SOP) couple as set by I/O-SOP controller 14. The two sets of four traces forming group k preferably have been obtained in the following sequence (time flowing from left to right), where the labels x and y refer to the traces obtained simultaneously from photodetectors 22B and 22C, respectively, λ_{U}^{(k)}−λ_{L}^{(k)} is equal to the step δλ, the midpoint wavelength is defined as λₖ=(λ_{U}^{(k)}+λ_{L}^{(k)})/2, and the double prime indicates the repeated traces:

$$( I \text{-} {SOP}_{k} , A \text{-} {SOP}_{k} , {λ}_{k} ) \overbrace{\begin{matrix}{Px}_{L}^{( k )} & {Px}_{L}^{″ ( k )} \\ {Py}_{L}^{( k )} & {Py}_{L}^{″ ( k )}\end{matrix}}^{λ = {λ}_{L}^{( k )}} \overbrace{\begin{matrix}{Px}_{U}^{( k )} & {Px}_{U}^{″ ( k )} \\ {Py}_{U}^{( k )} & {Py}_{U}^{″ ( k )}\end{matrix}}^{λ = {λ}_{U}^{( k )}}$$

Finally, the overall data stored in the data file after acquisition is depicted as a matrix in Eq. (56) below, to which we will refer in all that follows. The matrix comprises K groups each of four OTDR traces (two sets of four when two photodetectors are used), each trace consisting of N points corresponding to N values of distance zₙ, where n=0 . . . (N−1):

$$Data = \\ {\begin{matrix}{SOP}_{0} and \text{/} or {λ}_{0} \to & {Px}_{L}^{( 0 )} & {Px}_{L}^{″ ( 0 )} & {Px}_{U}^{( 0 )} & {Px}_{U}^{″ ( 0 )} \\ & {Py}_{L}^{( 0 )} & {Py}_{L}^{″ ( 0 )} & {Py}_{U}^{( 0 )} & {Py}_{U}^{″ ( 0 )} \\ {SOP}_{1} and \text{/} or {λ}_{1} \to & {Px}_{L}^{( 1 )} & {Px}_{L}^{″ ( 1 )} & {Px}_{U}^{( 1 )} & {Px}_{U}^{″ ( 1 )} \\ & {Py}_{L}^{( 1 )} & {Py}_{L}^{″ ( 1 )} & {Py}_{U}^{( 1 )} & {Py}_{U}^{″ ( 1 )} \\ ⋮ & ⋮ & ⋮ & ⋮ & ⋮ \\ {SOP}_{k} and \text{/} or {λ}_{k} \to & {Px}_{L}^{( k )} & {Py}_{L}^{″ ( k )} & {Px}_{U}^{( k )} & {Px}_{U}^{″ ( k )} \\ & {Py}_{L}^{( k )} & {Py}_{L}^{″ ( k )} & {Py}_{U}^{( k )} & {Py}_{U}^{″ ( k )} \\ ⋮ & ⋮ & ⋮ & ⋮ & ⋮ \\ {SOP}_{K - 1} and \text{/} or {λ}_{K - 1} \to & {Px}_{L}^{( K - 1 )} & {Px}_{L}^{″ ( K - 1 )} & {Px}_{U}^{( K - 1 )} & {Px}_{U}^{″ ( K - 1 )} \\ & {Py}_{L}^{( K - 1 )} & {Py}_{L}^{″ ( K - 1 )} & {Py}_{U}^{( K - 1 )} & {Py}_{U}^{″ ( K - 1 )}\end{matrix}}^{ \overbrace{λ = {λ}_{L}^{( k )}} \overbrace{λ = {λ}_{U}^{( k )}}} \qquad ( 56 )$$

The data structure of equation (56) is the similar as that of equation (53), but data in equation (56) is OTDR traces as function of distance z instead of powers in equation (53) reflected from the distal end of FUT.

### 2. Single-Ended Cumulative PMD: Auto Calibration of the Relative Gain

For the preferred embodiment of FIG. 3, it is necessary to perform the below described calibration procedure of the relative gain of the two detectors 22B and 22C before proceeding with any further computation. The same procedure is not performed for the other embodiments.

The calibration principle is predicated upon the fact that, when an I/O-SOP scrambler 14 is used to generate a sufficiently large number of SOPs so as to substantially cover the Poincaré Sphere, the average power of the backreflected light over any segment along the FUT 16 will exit from the two ports of the PBS with a 2:1 ratio, the higher power corresponding to the port to which detector 22B is connected and the lower power corresponding to the port to which detector 22C is connected. Hence, any observed deviation from this 2:1 ratio for the observed detector powers can be quantified and taken into account, as follows.

After data acquisition is completed, K groups of four OTDR traces obtained from both photodetectors have been stored, i.e., a total number of J=4·K traces from detector 26A and also J=4·K traces from detector 22B, as depicted in matrix (56). The j^{th} traces (j=0, 1 . . . (J−1)) from 22C and 22B are referred to below as Px(z)ᵢ and Py(z)ⱼ, respectively. If the overall losses in the two arms of the PBS were identical and the gains of both photodetectors and associated electronics were also equal, the ratio of the traces Py and Px after averaging both populations over all J occurrences and over all the N values of z would be

$$\frac{< Px >}{< Py >} ≡ \frac{{\sum }_{j} {\sum }_{n} {Px ( {z}_{n} )}_{j}}{{\sum }_{j} {\sum }_{n} {Py ( {z}_{n} )}_{j}} = 2$$

In practice, the ratio obtained from the average of the measured traces does not equal 2 because of different losses in the arms of the PBS and different “effective” gains of the photodetectors, which includes the photodiode responsivity as well as the overall gains of the following electronics, amplifiers and sampling circuitry. (Note that it is not necessary to determine the individual gains separately.) Therefore, before proceeding with the rest of the computations, all the J traces obtained from photodetector 22C, i.e. all the Py(z)ⱼ, are multiplied as follows:

Py(z)ⱼ≡g_{RoundTripC}·Py(zₙ)ⱼ

where

$${g}_{RoundTripC} = \frac{1}{2} \frac{< Px >}{< Py >} = \frac{{\sum }_{j} {\sum }_{n} {Px ( {z}_{n} )}_{j}}{{\sum }_{j} {\sum }_{n} {Py ( {z}_{n} )}_{j}}$$

In practice, for midpoint wavelengths that are relatively closely-spaced (e.g. <20 nm), the relative wavelength dependence of the components, detectors, etc. may be negligible and this calibration process need only be carried out once per POTDR measurement sequence. Otherwise, this calibration may need to be carried out at every midpoint wavelength, thereby increasing the overall measurement time of the measurement sequence.

As a result of the calibration, i.e. after all Py traces have been multiplied by the measured relative gain as described above, the data processor 34 can compute the normalized OTDR traces. More precisely, the normalized traces in the case of the embodiment of FIG. 1 are obtained by dividing either the sampled signal Px from detector 22B, or signal Py from detector 22C, preferably the difference between the sampled signals from detectors 22B and 22C, (Px−Py)/2 or (Py−Px)/2, as will be described in more details in the next section, or any weighted difference (1+w)⁻¹(Px−w·Py), by the sum (Px+Py) of the sampled signals from both of the detectors 22B and 22C which represents the total backreflected power impinging on the PBS, i.e., without selection of a particular polarization component.

The preferred computations giving the normalized OTDR traces for all preferred embodiments will now be described in detail.

### 3. Single-Ended Cumulative PMD: The Point-by-Point Computation

The OTDR traces are processed to obtain the cumulative PMD as will now be described. It should be noted that the computation of PMDₙ at each point zₙ along the FUT 18 is performed independently of any other point n. Each is deduced from averages over the (I-SOP, A-SOP) couples and/or wavelength. Thus, in the computations described below it is inappropriate to use the index n; it must simply be understood that the calculation is repeated in the same way for each point n, or, in other words, effectively at each distance zₙ. In all that follows, the symbols refer to the matrix “Data” in Eq. (56). It should also be emphasized that the labels x and y refer to the traces obtained from photodetectors 22B and 22C, respectively.

### 3.1 The Normalized Traces

The normalized traces, labelled hereinafter as T(z), are computed differently according to the embodiment.

(i) For the embodiment of FIG. 3 (two photodetectors with a PBS), the normalized OTDR trace is computed as follows, either

$${T}_{L}^{( k )} = \frac{{Px}_{L}^{( k )}}{{Px}_{L}^{( k )} + {Py}_{L}^{( k )}} {T}_{L}^{″ ( k )} = \frac{{Px}_{L}^{″ ( k )}}{{Px}_{L}^{″ ( k )} + {Py}_{L }^{″ ( k )}} \\ {T}_{U}^{( k )} = \frac{{Px}_{U}^{( k )}}{{Px}_{U}^{( k )} + {Py}_{U}^{( k )}} {T}_{U}^{″ ( k )} = \frac{{Px}_{U}^{″ ( k )}}{{Px}_{U}^{″ ( k )} + {Py}_{U}^{″ ( k )}} \\ or \\ {T}_{L}^{( k )} = \frac{1}{2} \cdot \frac{{Px}_{L}^{( k )} - {Py}_{L}^{( k )}}{{Px}_{L}^{( k )} + {Py}_{L}^{( k )}} {T}_{L}^{″ ( k )} = \frac{1}{2} \cdot \frac{{Px}_{L}^{″ ( k )} - {Py}_{L}^{″ ( k )}}{{Px}_{L}^{″ ( k )} + {Py}_{L}^{″ ( k )}} \\ {T}_{U}^{( k )} = \frac{1}{2} \cdot \frac{{Px}_{U}^{( k )} - {Py}_{U}^{( k )}}{{Px}_{U}^{( k )} + {Py}_{U}^{( k )}} {T}_{U}^{″ ( k )} = \frac{1}{2} \cdot \frac{{Px}_{U}^{″ ( k )} - {Py}_{U}^{″ ( k )}}{{Px}_{U}^{″ ( k )} + {Py}_{U}^{″ ( k )}} \qquad ( 57 a )$$

where it should be appreciated that the different Py traces have been pre-multiplied by the measured relative gain, g_{RoundTripC}, as indicated in the description of the auto calibration procedure, before they are used in Eq. (57a).
(ii) For the embodiment of FIG. 3B (two photodetectors with a coupler), the ratio of trace Px over trace Py is first computed as,

$${R}_{L}^{( k )} = \frac{{Px}_{L}^{( k )}}{{Py}_{L}^{( k )}} {R}_{L}^{″ ( k )} = \frac{{Px}_{L}^{″ ( k )}}{{Py}_{L}^{″ ( k )}} \\ {R}_{U}^{( k )} = \frac{{Px}_{U}^{( k )}}{{Py}_{U}^{( k )}} {R}_{U}^{″ ( k )} = \frac{{Px}_{U}^{″ ( k )}}{{Py}_{U}^{″ ( k )}} \qquad ( 57 b )$$

and then the above ratio is normalized with respect to its average over the K groups as,

$${T}_{L}^{( k )} = {u}_{o} \frac{{R}_{L}^{( k )}}{{〈 R 〉}_{SOP ; v}} {T}_{L}^{″ ( k )} = {u}_{o} \frac{{R}_{L}^{″ ( k )}}{{〈 R 〉}_{SOP ; v}} \\ {T}_{U}^{( k )} = {u}_{o} \frac{{R}_{U }^{( k )}}{{〈 R 〉}_{SOP ; v}} {T}_{U}^{″ ( k )} = {u}_{o} \frac{{R}_{U}^{″ ( k )}}{{〈 R 〉}_{SOP ; v}} \qquad ( 57 c )$$

where the reference mean-value is uₒ=⅔ by assuming measured power for an input sate of polarization of light parallel to an axis analyzer, and the average ratio R is defined as,

$${〈 R 〉}_{SOP ; v} = \frac{1}{4 K} {\sum }_{k} ( {R}_{L}^{( k )} + {R}_{L}^{″ ( k )} + {R}_{U}^{( k )} + {R}_{U}^{″ ( k )} ) , \qquad ( 57 d )$$

Here, the auto calibration procedure is not required, i.e. the above-mentioned pre-multiplication of the traces Py by the measured relative gain may be skipped.

(iii) For the embodiment of FIG. 3A (single photodetector), the only available traces are the Px traces (obtained here from photodetector 22). The normalized trace is obtained as in (5c) but without computing the ratio of trace x over trace y first, i.e.

$${T}_{L}^{( k )} = {u}_{o} \frac{{Px}_{L}^{( k )}}{{〈 P 〉}_{SOP ; v}} {T}_{L}^{″ ( k )} = {u}_{o} \frac{{Px}_{L}^{″ ( k )}}{{〈 P 〉}_{SOP ; v}} \\ {T}_{U}^{( k )} = {u}_{o} \frac{{Px}_{U}^{( k )}}{{〈 P 〉}_{SOP ; v}} {T}_{U}^{″ ( k )} = {u}_{o} \frac{{Px}_{U}^{″ ( k )}}{{〈 P 〉}_{SOP ; v}} \qquad ( 57 e )$$

where the average trace is defined as,

$${〈 P 〉}_{SOP ; v} = \frac{1}{4 K} {\sum }_{k} ( {Px}_{L}^{( k )} + {Px}_{L}^{″ ( k )} + {Px}_{U}^{( k )} + {Px}_{U}^{″ ( k )} ) \qquad ( 57 f )$$

It should be noted that, in the equations above, [symbol] _{SOP;ν} can refer to averaging over either I-SOPₖ, A-SOPₖ, or the midpoint wavelength, ideally over all three, i.e., changing I-SOP, A-SOP and wavelength from one group of traces to the next. All of these relationships are fundamentally valid in all cases even if only I/O-SOP scrambling is applied, giving the correct value of the DGD at one particular midpoint wavelength. Then, scanning the midpoint wavelength only serves the purpose of averaging DGD over wavelength as per the definition of the statistical PMD value. On the contrary, as discussed earlier, averaging only over wavelength while keeping the I/O-SOP unchanged requires that assumptions about the FUT be met, and also requires a large value of the product PMD·Δν. The same remarks apply for the equations presented hereinafter.

It should be also noted that Equations (57d) and (57f) are assuming there is negligible wavelength dependence on coupling ratio and detected powers, respectively.

### 3.2 Relative Variance

The relative variance, as in equation (57b), is computed here as the average of the four available estimates, i.e.,

$${σ}_{r}^{′2} = {( \frac{1}{{σ}_{10}} )}^{2} [ \frac{var ( {T}_{L} ) + var ( {T}_{U} )}{2} ] \qquad ( 58 )$$

where the reference variance is σ₁₀²= 4/45, and the function “var” is defined as,

$$var ( {T}_{L} ) = ⌊ {〈 {T}_{L} {T}_{L}^{″} 〉}_{SOP ; v} - {〈 {T}_{L} 〉}_{SOP ; v}^{2} ⌋$$

$$var ( {T}_{U} ) = ⌊ {〈 {T}_{U} {T}_{U}^{″} 〉}_{SOP ; v} - {〈 {T}_{U} 〉}_{SOP ; v}^{2} ⌋ .$$

### 3.3 Mean-square Differences

The calculation here differs from the simple mean-square found in Eq. (3a) which, for greater clarity, did not take into account the noise. Instead, the product of the repeated differences between normalized traces at λ_{U} and λ_{L} is averaged as follows,

$$\begin{matrix}{〈 Δ {T}^{2} ( v ) 〉}_{SOP ; v} = {〈 ( {T}_{U} - {T}_{L} ) \cdot ( {T}_{U}^{″} - {T}_{L}^{″} ) 〉}_{SOP ; v} \\ = \frac{1}{K} {\sum }_{k} ( {T}_{U}^{( k )} - {T}_{L}^{( k )} ) \cdot ( {T}_{U}^{″ ( k )} - {T}_{L}^{″ ( k )} )\end{matrix} \qquad ( 59 )$$

In conventional mathematical terms, Eq. (59) may be referred to as the second-order joint moment of the repeated differences. Doing so, the noise averages to zero instead of being “rectified”, because the noise superimposed on a given trace is not correlated with the noise superimposed on the corresponding repeated trace. That is the first motivation for sampling repeated traces.

### 3.4 Noise Variance

The second motivation for sampling repeated traces, which are substantially identical in the absence of noise, for each setting of center wavelength λ, and SOP, is the ability to obtain an accurate estimate of the noise variance. That is because the relative variance, as computed in Eq. (58), includes both the variance of the hypothetical noiseless trace and the variance of the noise. However, if the noise variance is known, it can be subtracted since the variance of the sum of two independent random variables is equal to the sum of the variances. But thanks to the repeated traces, the noise variance can be estimated independently as follows:

$${σ}_{noise}^{2} = {( \frac{1}{{σ}_{10}} )}^{2} {〈 ( {T}_{L} - {T}_{L}^{″} ) ( {T}_{U} - {T}_{U}^{″} ) 〉}_{SOP ; v} \qquad ( 60 )$$

The noise variance (Eq. 60) is then subtracted from the first estimate of the relative variance (Eq. 58) in the computation of the final relative variance as follows,

σᵣ²=σ′ᵣ²−σₙₒᵢₛₑ² (61)

### 3.5 Computation of the Cumulative PMD

The cumulative PMD then is computed according to the arcsine formula as,

$$PMD ( z ) = {α}_{rt} \frac{1}{π δ v} arcsin ( {α}_{ds} \sqrt{\frac{{〈 Δ {T}^{2} ( v , z ) 〉}_{SOP ; v}}{{σ}_{r}^{2} ( z )}} ) \qquad ( 62 )$$

where a roundtrip factor

$${α}_{rt} = \sqrt{\frac{3}{8}} .$$

A theoretical constant

$${α}_{ds} = \sqrt{\frac{15}{4 }}$$

is valid for the cases where a common (same) state of polarization controller (scrambler) is used as both input and output light SOPs' controlling, such as for FIGS. 3, 3A and 3B. Note that [symbol] _{SOP;ν} can refer to averaging over either SOP couples, or the midpoint wavelengths, but ideally it prefers to both of them, i.e., changing (I-SOP, A-SOP) couple and midpoint frequency from one group of traces to the next.

It should be appreciated that the arcsine formula, (62), is not the only possible one. The purpose of using this formula is to obtain a result that is unbiased even if using a relatively large step, such that PMD·δν˜0.15, without introducing a significant error; this in order to maximize the signal-to-noise ratio and therefore the dynamic range of the instrument. If one were not concerned with maximizing the dynamic range, or keeping the overall measurement time reasonable, one might select a much smaller step, and use the simpler differential formula that follows,

$$PMD ( z ) = {α}_{rt} {α}_{ds} \frac{1}{π δ v} \cdot \sqrt{\frac{{〈 Δ {T}^{2} ( v , z ) 〉}_{SOP ; v}}{{σ}_{r}^{2} ( z )}} \qquad ( 63 )$$

This is not to infer that this formula is better or particularly advantageous, but merely that it may conveniently be used if the step is much smaller, i.e., satisfying the condition PMD·δν<0.01. The cumulative PMD curve as a function of z is obtained by repeating the computation above, from equations (57) to equation (62), at each point n corresponding to distance zₙ.

It should be noted that above equations for calculating PMD have a theoretical constant

$${α}_{ds} = \sqrt{\frac{15}{4}} .$$

This theoretical constant value is valid for the cases where one common same state of polarization controller (scrambler) is used as both input and output light SOP controlling, such as for FIGS. 3, 3A and 3B. However, when two separated independent input and output state of polarization controllers (scramblers) are used with a polarizer or PBS being located just before the detector, for example as shown in FIG. 3C, then a different theoretical constant must be used, i.e.

$${α}_{ds} = \sqrt{\frac{9}{2}}$$

(note this theoretical constant is the same as for two-ended PMD measurement equations as already described related above section).

It should also be noted that the above computation equations (62) and (63) for extracting cumulative PMD using a normalized OTDR trace may be replaced by using a relative OTDR trace that is proportional to a normalized OTDR trace.

It should be noted that a forward PMD calculated from equations (62) and (63) is a PMD or rms DGD of FUT.

It should further be emphasized that the cumulative PMD may also be obtained by averaging over (either rms or mean roundtrip DGDs at different optical frequencies, e.g.

$$rms {DGD}_{RoundTrip} ( z ) = \sqrt{{〈 {DGD}_{RoundTrip}^{2} ( z , v ) 〉}_{v}}$$

$$and$$

$$mean {DGD}_{RoundTrip} ( z ) = {〈 {DGD}_{RoundTrip} ( z , v ) 〉}_{v}$$

where a rms DGD_{RoundTrip}(z) or mean DGD_{RoundTrip}(z) can be obtained from measured DGD_{RoundTrip}(z,ν) for many different midpoint wavelengths by root-mean square or mean DGD_{RoundTrip}(z,ν) (see below) over a prescribed wavelength range. The measured and calculated roundtrip DGDs at different optical frequencies is

$${DGD}_{RoundTrip} ( z , v ) = \frac{{α}_{ds}}{π δ v} \sqrt{\frac{Δ {T}^{2} ( z , v )}{{σ}_{r}^{2} ( z , v )}}$$

$$where {σ}_{r}^{2} ( z , v ) = {( \frac{1}{{σ}_{10}} )}^{2} [ \begin{matrix}{〈 T ( z , v ) \cdot {T}^{″} ( z , v ) 〉}_{SOP , v} - \\ {〈 T ( z , v ) 〉}_{SOP , v}^{2}\end{matrix} ] .$$

A rms DGD(z) and mean DGD(z) (forward) can also be obtained by simply multiplying a roundtrip factor of \sqrt{⅜} and 2/π on rms DGD_{RoundTrip}(z) and mean DGD_{RoundTrip}(z), respectively.

As shown in the equations (42) and (43), if the PMD calculation involves the use of the relative variance, σᵣ²(z,ν), of the normalized power (T), then the normalized power may not be necessary to have to be computed to be normalized between 0 and 1. In other words, some steps of above normalization procedure for obtaining normalized powers may be skipped. This is, the relative power P_{R}(z,ν) and relative variance σ_{R}²(z,ν) computed from relative powers can be used to compute the cumulative PMD with equations similar as in (42) and (43).

It should also be noted that repeated powers may be obtained from two or more measurements at different times using the same detectors, or from measurements using different detectors, e.g. after light power being split by a coupler, where the powers detected by the different detectors are measured contemporaneously.

### 4. Optional Application of a Linewidth Correction Factor

If the effective spectral linewidth of the pulsed laser source is large, it may be desirable to perform an additional, although optional, data “post-processing” step to take into account the dependence of the measured cumulative PMD on the linewidth of the laser. Thus, one may multiply the N above-measured cumulative PMD values at zₙ, PMDₙ, by an appropriate linewidth-dependent correction factor. One expression of such a correction factor, suitable when the laser lineshape is approximately Gaussian, is:

$${α}_{LWn} = \frac{1}{\sqrt{1 - {( \frac{{PMD}_{n}}{{PMD}_{sat}} )}^{2}}} \qquad ( 63 )$$

where PMDₛₐₜ is the saturation cumulative PMD value, i.e., the limiting value towards which the measured cumulative PMD tends as the actual cumulative PMD grows toward infinity, if no linewidth correction factor is applied. It is given by:

$${PMD}_{sat} = \frac{1}{4 π} \cdot \frac{1}{{σ}_{vL}} \qquad ( 64 )$$

where σ_{νL} is the rms-width of the laser spectrum. (Note: for a Gaussian lineshape, the full-width at half-maximum is related to the rms-width by Δν_{L}=\sqrt{8·ln(2)}σ_{νL}.)

The last, optional, step comprises the computation of the N values of the correction factor according to Equation (64), and then the obtaining of the corrected PMD values, PMD′ₙ, via multiplication of the PMD values measured before correction by the correction factor, i.e.

PMD′ₙ=α_{LW}_{ₙ}·PMDₙ (65)

For example, if no correction factor is applied, Eqs. (44) and (45) indicate that the maximum cumulative PMD value corresponding to a bias of, say, −10%, is PMDₘₐₓ=0.0817Δν_{L}⁻¹. As a numerical example for this case, a full-width at half-maximum Δν_{L}=2 GHz gives PMDₛₐₜ˜93.7 ps and PMDₘₐₓ˜40.8 ps. If the measured value happens to be equal to this pre-determined maximum value of 40.8 ps corresponding to a bias of −10%, then the actual PMD is in fact 45.4 ps, i.e., the measured value suffers a bias of −10%, as stated. Such a residual bias level may be acceptable in many field applications.

However, under these same physical circumstances, if the correction factor α_{LW}=1.11 is applied according to Eq. (65), one obtains the actual cumulative PMD′ of 45.4 ps.

In practice, the uncertainty on the correction factor itself will grow if the correction factor becomes very large, i.e., when the directly measured (i.e., uncorrected) cumulative PMD is too close to PMDₛₐₜ, since any small error in the directly-measured PMD value or in the laser linewidth (or uncertainties as to the effective laser lineshape) can make the correction factor very unreliable, as can be appreciated from Equation (44). However, the uncertainty remains small if the maximum allowable value of the correction factor is limited to a predetermined value, which then determines the maximum PMD that can be measured when the correction factor is applied. Doing so, not only is PMDₘₐₓ larger than it would be without the correction, but more importantly, in contrast with the case where no correction is applied, there is no systematic bias when the actual PMD is equal to PMDₘₐₓ, but rather only a small additional, zero-mean uncertainty. Using the previous example, and setting the correction factor to a reasonable maximum value of 1.25, i.e., still close to unity, the maximum value of the actual PMD that can be measured, without bias, is PMDₘₐₓ˜70 ps, compared to 40.8 ps with a bias of −10% if no linewidth correction factor is used.

It is noted that, whenever the product PMD·Δν_{L} is much smaller than unity, the application of such a correction factor in the post-processing serves no purpose since the factor is very nearly equal to unity anyway. The purpose of applying the correction factor is to increase the maximum PMD value that can be measured with no bias given the real linewidth of the laser.

It should be appreciated that Equation (64) applies for the case of a nearly Gaussian-shaped laser spectrum, and is given by way of example. Other formulas or relationships can be computed either analytically or numerically for any particular laser lineshape that deviates substantially from a Gaussian lineshape. The Gaussian lineshape is a special, though practically relevant, case for which the correction factor can be expressed as a simple analytical formula, whereas such simple analytical formulas cannot be found for arbitrary laser lineshapes.

Optical Source Means Appropriate for Embodiments of this Invention

### Tunable Laser Source Suitable for Two-Ended PMD Measurement

It will be appreciated that according to another aspect there is provided light source apparatus for successively and repetitively generating coherent light at two or more closely spaced wavelengths, the apparatus comprising:

an optical gain medium;

at least two laser cavities, each cavity sharing a portion of their respective laser cavities, including the said optical gain medium;

at least one output coupler permitting extraction of a fraction of the intra-cavity light corresponding to each said at least two laser cavities;

a beam splitter for dividing the light into at least two spatially separated portions, each said at least two laser cavities corresponding to at least one of said at least two portions;

a multichannel wavelength tunable bandpass filter means comprising at least two channels corresponding to different closely-spaced wavelengths, operable to accept light corresponding to each of the said at least two spatially separated portions into respective channels, and operable to wavelength tune the said channels in a synchronized manner; and

a multichannel light blocking means, operable to permit the continuation of the optical path of not more than one said spatially separated light portions incident upon it and blocking all of the other light portions, the choice of light portion which is not blocked depending upon a parameter of the said multichannel light blocking means.

As mentioned hereinbefore, it is desirable to have a tunable coherent source that can be tuned to many midpoint wavelengths combined with many (I-SOP, A-SOP) s in order to either measure the DGD in any DWDM channel (as such in any spare DWDM channel with frequency spacing of about 35 GHz or 70 GHz) in either C or L band or to obtain accurately rms or mean DGD values (i.e. PMD) value where a sufficient wavelength range is available for the measurement. Consequently, it is desirable for the tunable coherent source to be tunable over a large range of wavelengths. Suitable tunable coherent sources, that are tunable over a range of several hundred nanometers, are known to those skilled in this art and so are not described in detail herein.

The tunable optical source of FIG. 7 comprises a fiber optical amplifier, such as an SOA, based fiber ring laser design where a common gain medium 102 used for each of at least two different cavities (1, 2, . . . , N) corresponding to at least two respective different wavelengths (1, 2, . . . , N). An optical switch 106B acts to switch on and off the lights in the at least two different cavities at different time periods where the at least two different wavelengths are selected by the at least two different TBFs from a synchronized multi-channel tunable filter 104. In FIG. 7, at least two polarization adjusters (1, 2, . . . , N) are to adjust cavity SOPs of light if cavities are based on SMF fiber cavity. A beam splitter 106A is used to combine N cavities together and coupler 107 provides an output of light from laser cavities. The control unit 30′ is used to adjust the tunable filer 104 center wavelength, control optical switch to turn ‘ON’ different laser cavities to emit different wavelengths as well as to control the gain medium, e.g. to supply the current for SOA if a SOA is used as a gain medium.

FIG. 7A shows schematically an example of a preferred embodiment of such a tunable modulated optical source (used in 12A in FIG. 1(B-H)), designed to emit three closely-spaced wavelength, in rapid sequence, where an optical chopper 130 acts as the optical switch. In a preferred embodiment, the functions of the TBFs 104 can be realized using a single bulk diffraction grating, wherein the light paths of each of the three laser cavities is incident upon the said grating at slightly different angles in the diffraction plane, these slightly different angles having been selected to correspond to desired closely-spaced wavelengths about the nominal “center wavelength” of the laser. The TBFs may tune the “center-wavelength” (as defined hereinbefore) in one or more of the S, C and L or 0 and E bands, the particular accessible wavelength region depending upon the choice of the SOA 102′ and the tunable filter 104 excess loss and wavelength-dependent loss. Preferably the SOA 102′ is “polarization dependent”, that is it optimally amplifies input light of a particular incident linear polarization and does not significantly amplify the corresponding orthogonally polarized. An example of such an SOA is the Model BOA 1004 manufactured by Covega Corporation.

Thus, tunable modulated optical source 12A of FIG. 7A comprises a SOA 102′, tunable optical bandpass filters (TBFs) 104, beamsplitting couplers 106A, 106B and 106C, an optical chopper 130 and three-port circulators 108A and 108B connected in three ring cavity topology by polarization-maintaining fibers (PMF). The coupler 106D combines light outputs from couplers 106B and 106C.

A control unit 30 is coupled to the SOA 102′, chopper 122 and the TBFs 104 by lines 120, 122 and 124, respectively, whereby it supplies control signals to selectively turn the lights on and off in different cavities at different time, as will be described in more detail later, and to adjust the wavelength by the TBFs.

The continuously tunable TBFs are typically grating based bandpass filters with bandwidth of 20 to 40 pm (FWHM), which are used to tune the laser wavelength accurately and also to confine the light (photons) in this small TBF bandwidths so as to give an accurate laser wavelength with a narrow linewidth. If a PMF cavity is used, no any additional component is required. But if the cavity is based on SMF-28 fiber, for instance, one or two polarization controllers are still required to adjust state-of-polarization (SOP) in the laser cavity.

The spectral linewidth of the tunable modulated optical coherent sources in the various above-described embodiments might range from less than 1 GHz to about 4 GHz.

It may be advantageous for this linewidth to be known, at least approximately, in order to facilitate application of the linewidth correction factor as described hereinbefore.

It should be appreciated that other kinds of tunable modulatable optical source could be used instead of that described hereinbefore. For example, it is envisaged that an external phase modulator could be used to generate optical sidebands on the output of an external cavity laser (ECL), distributed Bragg reflector laser (DBR), or distributed feedback laser (DFB).

A person skilled in this art will be aware of other alternatives for this tunable modulatable coherent source.

### Tunable Moderately Broadband Optical Source For Two-Ended PMD Measurement

A preferred embodiment of a broadband source 12B, a tunable moderately broadband light source 12B′, is depicted schematically in FIG. 1L. This source could be advantageously used in the exemplary embodiments of Figures I, J, and K, for two-ended measurement of the DGD within one or more narrow DWDM channels lying within a prescribed spectral range (e.g. such as the telecom C and/or L bands).

The tunable moderately broadband light source 12B′ comprises a broadband light source 252, which could be an a substantially un-polarized light source such as an amplified spontaneous emission (ASE) source, or a partially or substantially polarized source such as a superluminescent diode (SLED) or light emitting diode (LED).

The broadband light source 252 is filtered by an optical bandpass filter 254 to provide moderately broadband CW light, e.g. sufficient to encompass most or all of the bandwidth corresponding to a DWDM channel, for instance. For example, appropriate bandwidth (FWHM) values of the optical bandpass filter 254 may be from 0.5-2.0 nm, but should not be considered to be limited to this range. The optical bandpass filter 254 is preferably a tunable optical bandpass filter, whose center bandpass wavelength can be tuned or adjusted over a much wider wavelength range than the spectral extent of the filter bandpass. It is often desirable to amplify the filtered light, for instance to a power level of about 0 dBm that would make it compatible with power levels expected in active optical networks, especially if the broadband light source 252 is a low-power (and hence low-cost) SLED or LED, for instance. To this end, the filtered moderately broadband light, e.g. usually a CW light source, then passes through an optional semiconductor optical amplifier (SOA) 256 where it is amplified. If the resulting light exiting the SOA 256 is not highly or sufficiently polarized, it may be transformed into a nearly 100% degree of polarization (DOP) using an optional polarizer 258 (possibly using a polarization controller—not shown—disposed between the SOA 256 and polarizer 258 to maximize the exiting output power. However, if the output light from the SOA is well polarized, the polarizer 258 may not be required.

It is envisaged that this tunable moderately tunable light source 12B′ could be easily modified to render it appropriate as a source for in-channel relative group delay (i.e. chromatic dispersion) measurements, using a variant of the well known “phase shift” method, as described in commonly-owned patent Babin et al, U.S. Pat. No. 6,429,929. To this end, the gain of the SOA 256 could be modulated by a sinusoidal RF modulation 260. A typical modulation frequency may be in the range from 100 MHz to 2 GHz. (It should be emphasized that such an rf modulation is not required for the two-ended PMD or DGD measurement embodiments described herein.)

Note in the case if the light from the broadband light source 252 is well polarized light, e.g. polarized light from a SLED being used, and the optical bandpass filter 254 and SOA 256 are also polarization sensitive components, then it is preferable to employ PMF (polarization maintaining fiber) to interconnect these components. (Alternatively, factory-adjustable polarization controllers may be placed between each component to ensure optimal polarization alignment.)

It should be noted for the two-ended chromatic dispersion measurement, the light exiting the tunable moderately-broadband light source 12B′ needs to have a DOP close to 0%. This may be achieved by operating the I-SOP controller 14A as a very rapid light polarization scrambler, e.g. scrambling the SOP faster than the acquisition time of the sampling circuitry in the analog-and-digital processing unit 40. Alternatively, such fast light polarization scrambling is not required for the chromatic dispersion measurement if an output light from the SOA 256 is un-polarized, for example a polarization insensitive SOA being used with un-polarized light from optical bandpass filter 254 incident into the (polarization-insensitive) SOA 256.

It should be also noted that the different design for the broadband source 12B/12B′ for the two-ended PMD and DGD measurement is also possible, for example a (wavelength tunable or fixed) filtered moderately broadband optical light source may be amplified by an erbium doped optical amplifier (EDFA) rather than a SOA. However, advantageously if a SOA is used it can not only amplify the input light power but it can also act as a fast optical light modulator because of its fast response time so that this filtered moderately broadband optical light source can be used for both the PMD and DGD measurement and the chromatic dispersion measurement in which a phase-shift dispersion measurement method may be used.

### Tunable OTDR for Single-Ended PMD Measurements

As mentioned hereinbefore, it is desirable to use many midpoint wavelengths Xid as well as many I-SOPs and A-SOPs. Consequently, it is desirable for the tunable OTDR to be tunable over a large range of wavelengths. Suitable tunable OTDRs, that are tunable over a range of several hundred nanometers, are known to those skilled in this art and so are not described in detail herein.

FIG. 8A shows schematically an example of such a tunable pulsed laser source 12 which is disclosed in commonly-owned U.S. patent application Ser. No. 12/373,986 filed Jul. 18, 2007, the contents of which are incorporated herein by reference. The tunable OTDR is based on a ring fiber laser design where a semiconductor optical amplifier (SOA) acts both as (i) a laser gain medium, and (ii) an external modulator that also amplifies the optical pulses when “on”. (The SOA can amplify the input light pulses from 3-6 dBm (input) to 17-20 dBm (output)).

Thus, tunable pulsed laser source 12 of FIG. 8A comprises a SOA 202, a tunable optical bandpass filter (TBF) 204, a beamsplitting coupler 206 and a four-port circulator 208 connected in a ring topology by polarization-maintaining fibers (PMF). The coupler 206 has a first port connected to the SOA 202 by way of the TBF 104, a second port connected via a PMF loop 214 to the circulator 208 and a third port connected to one end of a delay line 210, the opposite end of which is terminated by a reflector 212. Thus, the ring comprises a first, amplification path extending between the circulator 208 and the coupler 206 and containing the SOA 202 and a second, feedback path between coupler 206 and circulator 208 provided by PMF 214.

The coupler 206 extracts a portion, typically 25-50%, of the light in the cavity and launches it into the delay line 210. Following reflection by the reflector 212, the light portion returns to the coupler 206 and re-enters the cavity after a delay Δt equivalent to the round trip propagation time of the delay line 210. Conveniently, the delay line 210 comprises a fiber pigtail of polarization-maintaining fiber and the reflector 212 comprises a mirror with a reflectivity of about 95% at the end of the fiber pigtail. Of course, other suitable known forms of delay line and of reflector could be used.

A control unit 30 is coupled to the SOA 202 and the TBF 204 by lines 220 and 222, respectively, whereby it supplies control signals to selectively turn the SOA 202 on and off, as will be described in more detail later, and to adjust the wavelength of the TBF 204.

It should be noted that instead of producing short- and high-power light pulses from design in FIG. 5(A), it can also generate long pulses by turning on the current of SOA for a much longer time than the delay time from the delay line 210.

Such a tunable pulsed laser source 12′ may provide a high output power at a low cost. For further details of this tunable pulsed laser source 12 and its operation, the reader is directed to U.S. Provisional patent application No. 60/831,448 for reference.

It should be appreciated that other kinds of tunable pulsed light source could be used instead of that described hereinbefore. For example, FIG. 8B is an alternative design of FIG. 8A where no delay line is used. The design in FIG. 8B can effectively generate a long pulse from 275 ns to 20 us with a low cost, however, it may not suitable to produce an OTDR pulse of less than 275 ns.

Tunable pulsed laser source 12 of FIG. 8B comprises a SOA 202, a TBF 204 and a beamsplitting coupler 207 connected in a ring topology by PMF to form a fiber ring laser cavity. The coupler 207 extracts a portion, typically 25-50%, of the light from the cavity as an output. A control unit 30 is coupled to the SOA 202 and the TBF 204 by lines 220 and 222, respectively, whereby it supplies the bias current on the SOA 202 and adjusts the wavelength of the TBF 104. The control unit 30 controls the SOA 202 by way of line 220, turning its bias current on and off to cause it to generate light pulses.

Also for example, a suitable tunable pulsed light source where an acousto-optic modulator is used to pulse the light from a continuous-wave tunable laser is disclosed by Rossaro et al. (J. Select. Topics Quantum Electronics, Vol. 7, pp 475-483 (2001)), specifically in FIG. 3 thereof.

FIG. 8C illustrates schematically another suitable alternative tunable pulsed light source comprising a continuous wave (CW) widely-tunable linewidth-controllable light source 212″ in combination with an independent SOA 230″ which serves only as an amplifying modulator. The CW light source comprises a broadband semiconductor optical gain medium 232″, typically an optical semiconductor optical amplifier (SOA), and a tunable banpass filter (TBF) 234″, controlled by the control unit 30 (FIG. 2). The minimum small optical signal gain of >3-5 dB can be close to 200 nm (e.g. from 1250-1440 nm or 1440-1640 nm). This minimum small-signal gain is required to compensate the cavity loss so as to achieve a laser oscillation.

The continuously tunable TBF is typically a grating based bandpass filter with a bandwidth of 30 to 80 pm (FWHM), which is used to tune the laser wavelength accurately and also to confine the light (photons) in this small TBF bandwidth so as to give an accurately laser wavelength with a narrow linewidth. The “other components” identified in FIG. 8C by reference number 136″ will include an output coupler (typically 25/75 coupler and 25% is output port, but it can also be 50/50 coupler in order to get a more output power) and an optical isolator (can be integrated into optical gain medium, such as in the input of SOA).

If a PMF cavity is used, no any additional component is required. But if the cavity is based on SMF-28 fiber, for instance, one or two polarization controllers are still required to adjust state-of-polarization (SOP) in the laser cavity.

Use of the SOA 230″ as an external modulator yields several advantages: one is a high light extinction (ON/OFF) ratio of about 50-60 dB, and a second is to amplify the input light to 10-20 dBm with a relative input power (of 0-6 dBm). (Note that the output power intensity is dependent on the operating wavelength). It is also worth noting that the device of FIG. 8C will not produce a very narrow linewidth laser. The laser linewidth strongly depends on the TBF bandpass width. Typically, the tunable pulsed light source of FIG. 6 can be designed to have a wavelength accessible range close to 200 nm (for example, from 1250-1440 nm or 1440-1640 nm) by choosing properly SOAs (such as SOAs centered at 1350 nm and 1530 nm, respectively with a 3-dB gain bandwidth extending beyond 70 nm and the maximum gain >22 dB).

It should also be noted that the device of FIG. 8C will not produce a very narrow linewidth laser. The laser linewidth strongly depends on the TBF bandpass width. Typically, laser linewidth is about 4 to 15 GHz (for TBF bandwidth of 30-80 pm). However, a wide laser linewidth (bandwidth) is advantageous for any OTDR application (including POTDR) for reducing coherence noise on the OTDR traces.

The spectral linewidth of the tunable pulsed laser sources in the various above-described embodiments might range from less than 1 GHz to more than 15 GHz. In practice, it will usually be determined at the lower end by the need to minimize the coherence noise of the Rayleigh backscattering and at the upper end by the ability to measure moderately high PMD values. It may be advantageous for this linewidth to be known, at least approximately, in order to facilitate application of the linewidth correction factor as described hereinbefore. It may also be very advantageous for the laser linewidth to be adjustable in a known controlled manner, at least over some range, so as to circumvent or significantly mitigate the above mentioned limitation regarding maximum measurable PMD. If such ability to adjust the laser linewidth is available, one may select a larger linewidth where a small PMD value is to be measured, and select a smaller linewidth where a large PMD value is to be measured. Optimally, the laser linewidth would always be set as equal to approximately one half of the selected step δν.

A person skilled in this art will be aware of other alternatives to these tunable light sources.

### Scrambling

The term “pseudo-random-scrambling” as used herein is to emphasize that no deterministic relationship between one SOP and the next is needed or assumed by the computation. That is not to say, however, that the physical SOP controller 24 must be truly random as such. It may also follow, for example, that the SOPs define a uniform grid of points on the Poincaré-sphere, with equal angles between the Stokes vectors.

### Uniformly-Distributed

A “pseudo-random” SOP means that each of the three components (s1, s2, s3) of the Stokes vector that represents that SOP on the Poincaré sphere is a random variable uniformly distributed between −1 and 1, and that any one of the three components is uncorrelated with the two others (average of the product=0). Nonetheless, whether the SOPs are on a grid or form a random set, the points on the sphere must be uniformly-distributed.

However, if a grid is used instead of a random set, the calculation or processing must not assume a deterministic relationship between one SOP and the next. Otherwise, if the FUT 16 moves, as may occur in real telecommunications links, such deterministic relationships between traces obtained with a deterministic grid will be lost.

### ADVANTAGES OF EMBODIMENTS OF THE PRESENT INVENTION

### (1) Two-Ended PMD Measurement

a. The FUT 18 stability requirements are relaxed with the pseudo-random-scrambling approach in comparison with most other prior art techniques because no deterministic relationships have to be assumed between powers obtained with different SOPs and/or wavelengths. This relaxed FUT stability requirement can allow for FUT-induced SOP changes of as small as 10 ms or even smaller, depending upon the particular embodiment;
b. The measurement result is reliable for any type optical-fiber type;
c. Certain embodiments readily permit the measurement of DGD at one given wavelength, and, when repeated at different wavelengths, permits the determination of DGD as function of wavelength then to further obtain mean DGD or rms DGD;
d. Permits the measurement of very high DGD or overall PMD values (e.g. about 50 to 100 ps) from the FUT if relatively narrow linewidth (e.g. of 1-2 GHz or less) tunable coherent light is detected, while also be capable to measure a small PMD (e.g. less than 0.1 ps) in high accuracy due to randomly scrambling;
e. The dynamic range of this approach can be very high (typically 30 dB to over 60 dB for overall acquisition times ranging from less than tens to few minutes);
f. Permits measurement of a FUT comprising in-line optical amplifiers, for example erbium doped fiber amplifiers (EDFAs) or Raman fiber amplifiers, and reliable measurements can be taken even in the presence of significant ASE light from optical amplifiers; and
g. Most embodiments require minimal two-way communications between the two ends of the FUT.

### (2) Single-ended Overall PMD Measurement

a. FUT 18 stability requirement via the pseudo-random-scrambling approach because no deterministic relationships have to be assumed between powers obtained with different SOPs and/or wavelengths. The method can relax the FUT stability requirement for a very short time period, for example 0.2 to 0.4 seconds, depending upon the particular embodiment and the choice of optical source and/or tunable filter means;
b. The measurement result is reliable for any type of optical-fiber type;
c. They permit all measurement equipment to be located at only one end of the FUT,
d. They permit the use of very long pulses, e.g. about 1 to 20 μs or more, provided that the OTDR can distinguish the localized refection at the distal end from other reflections, leading to a significantly high dynamic range, an overall short acquisition time, and a reduction of interference or coherence noise. For example, it may range from 25 dB to over 35 dB for overall acquisition times ranging from less than 2 minutes to over 5 minutes;
e. Permit the measurement of very high overall PMD values (e.g. about 50 ps or over) from the FUT if the tunable pulsed laser has an appropriately narrow linewidth (e.g. of 1-2 GHz or less), but it still can satisfactorily measure a small PMD (e.g. less than 0.1 ps); and
f. In contrast to the case where a continuous-wave source may be used, embodiments of this single-ended overall PMD measurement method use an OTDR-based technique that can distinguish the Rayleigh backscattering from the localized reflection at the distal end of fiber, so that one does not need to take into account the Rayleigh backscattering or other reflections, such as from connectors between fiber sections, thereby improving the reliability of the PMD measurement.
g. Embodiments of this single-ended PMD measurement method disclosed here may measure a PMD from a test instrument to the any strong localized reflection along fiber, well separated from other localized reflections, for example from any connector or splicer of along FUT, if its backreflected light power may be high enough to be able to be measured properly.

### (3) Single-ended Cumulative PMD Measurement

a. Relaxes the FUT 18 stability requirement via the pseudo-random-scrambling approach because no deterministic relationships have to be assumed between traces obtained with different SOPs and/or wavelengths. Moreover, this advantageous relaxing of the FUT 18 stability requirement is obtained whether it is actually performed via I/O-SOP scrambling (the preferred method), or, in the case of an “ideal” FUT (as defined previously), by relying only on the “natural” scrambling of the FUT's PSPs (principal states of polarization) which occur randomly and uniformly as a function of wavelength and fiber length;
b. They permit the use of optical pulses having a spatial extent greater than the beat length of the FUT, leading to:
   (i) significantly increased dynamic range, for example from 10 dB to over 20 dB for overall acquisition times ranging from less than 10 minutes to over 30 minutes for s typical pulse length of 100 or 200 ns.
   (ii) reduction of OTDR coherence noise that may be superimposed on the traces,
   (iii) increased maximum measurable PMD for a given laser spectral linewidth;
c. They measure cumulative PMD directly, in contrast to previously-known POTDRs of the first type discussed herein, so no assumed specific birefringence model is needed, in particular, they are especially suitable for measuring cumulative PMD of spun fibers,
d. They produce results that are genuinely quantitative; and
e. The measurement result from this invention is a consequence of the random scrambling approach which leads notably to a simple relationship, Equation (62), that is valid for any FUT 18 and any pulse length according to theory, and of the associated signal processing. Embodiments of the invention can measure PMD over a range extending from a few hundredths of picoseconds to over 50 picoseconds and can be used to locate high PMD fiber sections with excellent spatial resolution.
   Relationships and Differences with Respect to Commonly-Owned Patent Applications

Commonly-owned International patent application number PCT/CA2006/001610 filed Sep. 29, 2006, and corresponding U.S. patent application Ser. No. 11/992,797 of which the present application is a Continuation-in-Part, disclose a method and apparatus for using an OTDR-based instrument for single-ended measurement of cumulative PMD of a FUT by launching groups of pairs of series of light pulses, series in each pair having closely-spaced wavelengths, and processing corresponding OTDR traces to obtain the PMD at any distance z along the fiber.

The two-ended PMD measurement method and apparatus embodying the present invention facilitate a two-ended measurement where the overall PMD and/or DGD at one or more particular wavelengths is required to be measured in an optical link, that may include (unidirectional) optical amplifiers. Accordingly, in embodiments of the present invention,
a) the measurement is a “straight-through” measurement without reflection, and the pulse lengths are very long, leading to an excellent signal to noise ratio;
b) the (“straight-through” or forward) DGD as a particular wavelength, which is not the case for the other applications;
c) the measurement is unidirectional and hence can be used if unidirectional elements, such as optical amplifiers (comprising optical isolators), are placed within the link;
d) measurements may be performed in the presence of significant ASE generated by intervening optical amplifiers;
e) concurrent determination of PMD and DGD(λ) may be made;
f) concurrent determination of PMD may be made according to both the rms and mean definitions, without assumptions on the FUT behavior;
g) embodiments of the invention may be adapted to permit rapid monitoring within a DWDM channel to detect sudden changes in DGD, thereby permitting correlation with possible observed system outages.

The single-ended overall PMD measurement embodying the present invention addresses the situation where only the overall PMD is required to be measured by accessing one end of FUT. Accordingly, in such embodiments of the present invention,
a) the FUT has at its distal end a localized reflection having a significant degree of reflectivity which is not in general the case for the above-cited commonly-owned applications;
b) using two detectors for high accuracy and reliable measurements which is not in a case for the above-cited commonly-owned applications where only one detector is used;
c) using long light pulses for one detector design for obtaining a long measurement distance or high dynamics which is not in a case for the above-cited commonly-owned applications where only short light pulse length of less than about five to ten times beating length is applied; and
d) the detected backreflected pulses (“response pulses”) have very nearly the same time duration as the pulses launched into the FUT, in contrast to the above-cited commonly-owned applications, where the backreflected signal is an impulse response corresponding to distributed backreflections induced by Rayleigh backscattering and possible spurious localized reflections along the length of the FUT.

### INDUSTRIAL APPLICABILITY

The entire contents of the various patents, patent application and other documents referred to hereinbefore are incorporated herein by reference.

Although embodiments of the invention have been described and illustrated in detail, it is to be clearly understood that the same are by way of illustration and example only and not to be taken by way of the limitation, the scope of the present invention being limited only by the appended claims.

In contrast to known PMD measurement most techniques of two end measurement methods for currently most of commercial available PMD test and measurement instrument for field application requires a wide wavelength range, embodiments of the present invention of two-ended PMD measurement can be applied for a both small and big wavelength ranges for DGD or PMD measurement.

Embodiments of the invention can permit measuring and monitoring of DGD or PMD within a narrow DWDM channel if there is any spare channel available. It can also permit rapid detecting sudden changes in DGD from a DWDM channel or any optical path, thereby permitting correlation with possible observed system outages.

Embodiments of the invention permit measurement of DGD or PMD in the presence of significant ASE generated by intervening optical amplifiers.

Also, in contrast to known techniques which rely upon the FUT 18 being stable over a relatively long period of time, typically tens seconds to few minutes, embodiments of the present invention do not require such long term stability, e.g. only requiring over about tens or hundreds of μs or ms averaging time. This is because acquired powers corresponding to different SOPs and/or wavelengths (over about tens or hundreds of μs or ms averaging time), are treated as statistically independent (pseudo-randomly scrambled), without assuming any deterministic relationship between them.

Also, a small equivalent laser linewidth may be used to achieve a high measurable PMD dynamic range (e.g. to have a maximum measurable PMD of more than 50, and even up to 100 ps). Therefore, as a consequence of these advantages, this two-ended PMD measurement embodying the present invention can measure PMD from very small value (e.g. less than 0.1 ps) to very large value (e.g. larger than 50 to about 100 ps) with a high distance dynamic range for the FUT within a very short measurement time.

Also this two-ended PMD measurement embodying the present invention can measure PMD of the FUT with optical amplifiers.

For single-ended overall PMD measurement, in contrast to known PMD measurement most techniques which rely upon two ended measurement methods for currently most of commercial available PMD test and measurement instrument, embodiments of the present invention for single-ended overall PMD measurement only require to access one end, i.e. a single end overall or total PMD measurement solution.

Also, in contrast to known techniques which rely upon the FUT 18 being stable over a relatively long period of time, typically several minutes to several tens of minutes, embodiments of the present invention for single-ended overall PMD measurement do not require such long term stability. This is because acquired powers corresponding to different SOPs and/or wavelengths (over about hundreds of milliseconds averaging time), are treated as statistically independent (pseudo-randomly scrambled), without assuming any deterministic relationship between them. In addition, the “repeated measurement” taken for each wavelength pair, useful to substantially reduce the effect of uncorrelated noise between the repeated measurements, is also very effective at suppressing the effective “noise” resulting from modest SOP changes between the repeated measurements.

The use of very long pulses allows a much larger SNR and also the OTDR technique (in comparison of CW laser) removes any other light reflections that are not come from the position for the testing (e.g. the end of fiber). Also a small equivalent laser linewidth may be used to achieve a high measurable PMD dynamic range (e.g. to have a maximum measurable PMD of about over 50 ps, and even up to 100 ps and beyond). Therefore, as a consequence of these advantages of using OTDR and long pulses, the single-ended PMD measurement embodying the present invention can measure PMD from very small value (e.g. less than 0.1 ps) to very large value (e.g. larger than 50 to about 100 ps) with a high dynamic range (i.e. capability to measure long FUTs) within a reasonably short measurement time.

For the single-ended cumulative PMD measurement, in contrast to known techniques which use short pulses and/or rely upon the FUT 18 being stable over a relatively long period of time, typically several minutes to several tens of minutes, embodiments of the invention for the cumulative PMD measurement do not require such long term stability. This is because OTDR traces corresponding to different SOPs and/or wavelengths (a few seconds averaging time), are treated as statistically independent (pseudo-randomly scrambled), without assuming any deterministic relationship between them.

The use of relatively long pulses (but generally shorter than the aforementioned pulses for the single-ended overall PMD measurement) allows a much larger SNR than otherwise achievable for a given averaging time. This is because (i) the optical energy of the backreflected light is proportional to the pulse length; and (ii) the detector bandwidth can be smaller, allowing both the bandwidth and spectral density of the noise to be reduced. Therefore, the effects of longer pulse length on SNR are three-fold and multiplicative.

With long pulses, the maximum measurable PMD value can also be larger for the following indirect reason: With short pulses, the “coherence noise” that superimposes over OTDR traces is larger. To reduce it when using short pulses, the “standard” solution is to increase the equivalent laser linewidth (the laser intrinsic linewidth as such, or alternatively, using dithering or other equivalent means). This limits the maximum measurable PMD. Therefore, as a consequence of these different advantages of using long pulses, the POTDR embodying the present invention can measure large values of cumulative PMD, that typically are seen at large values of z, within a reasonable measurement time.

In all OTDR applications, the power of the light backreflected by the FUT 18 decreases as a function of the distance from which local backscattering occurs, because any FUT 18 has a non-zero loss (typically 0.2-0.25 dB/km @ λ=1550 nm). The dynamic range of an OTDR can be defined as the maximum loss for which it is still possible to obtain a good measurement within some reasonable noise-induced uncertainty. Initial test results show a dynamic range of ˜15 dB when using 100-ns pulses and 1-s averaging time of single traces, for a noise-induced uncertainty smaller than 10-15%. Tests with a prototype according to FIG. 3A have shown that, with typical fiber loss (0.2-0.25 dB/km), a POTDR embodying this invention may reach up to 70 km with 200-ns pulses and 2-s averaging time. Similar or better performance it anticipated from the embodiments of FIGS. 3, 3B and 3C.

The combination of the above advantages, i.e., significantly relaxed stability requirement, much larger SNR (and hence measurement range) due to the longer pulse lengths, and a realistic maximum measurable PMD (such as 30 to 40 ps), make a POTDR embodying the present invention particularly suitable for “field measurements” of long, installed fibers, possibly even those including an aerial section.

### REFERENCES

[1] C. D. Poole, D. L. Favin, ‘Polarization-mode dispersion measurements based on transmission spectra through a polarizer’, Journal of Lightwave Technology, Vol. 12 (6), pp. 917-929 (1994).
[2] ‘Method and apparatus for measuring polarization mode dispersion’, U.S. Pat. No. 7,227,645 B2, Jun. 5, 2007.
[3] N. Cyr, ‘Polarization-mode dispersion measurement: generalization of the interferometric method to any coupling regime’, Journal of Lightwave Technology, Vol. 22(3), pp. 794-805 (2004).
[4] ‘Fiber optical dispersion method and apparatus’, U.S. Pat. No. 4,750,833, Jun. 14, 1988.
[5] P. A. Williams, A. J. Barlow, C. Mackechnie, J. B. Schlager, ‘Narrowband measurements of polarization-mode dispersion using the modulation phase shift technique’, Proceedings SOFM, Boulder Colo., 1998, pp. 23-26.
[6] R. Noe, et al, ‘Polarization mode dispersion detected by arrival time measurement of polarization-scrambled light’, Journal of Lightwave Technology, Vol. 20(2), pp. 229-235 (2002).
[7] ‘Monitoring Mechanisms for Optical Systems’, United States Patent Application Publication US 2005/0201751 A1, Sep. 15, 2005.
[8] S. X. Wang, A. M. Weiner, S. H. Foo, D. Bownass, M. Moyer, M. O'Sullivan, M. Birk, M. Boroditsky, ‘PMD Tolerance Testing of a Commercial Communication System Using a Spectral Polarimeter’, Journal of Lightwave Technology, Vol. 24 (11), pp. 4120-4126 (2006).
[9] ‘Method and apparatus for polarization mode dispersion monitoring in a multiple wavelength optical system’, U.S. Pat. No. 7,203,428, Apr. 10, 2007.
[10] S. Wielandy, M. Fishteyn, B. Zhu, ‘Optical performance monitoring using nonlinear detection’, Journal of Lightwave Technology, Vol. 22(3), pp. 784-793 (2004).
[11] N. Kikuchi, ‘Analysis of signal degree of polarization degradation used as control signal for optical polarization mode dispersion compensation’, Journal of Lightwave Technology, Vol. 19(4), pp. 480-486 (2001).
[12] F. Corsi, A. Galtarossa, L. Palmieri, M. Schiano, T. Tambosso, “Continuous-Wave Backreflection Measurement of Polarization Mode Dispersion Characterization”, IEEE Photonics Technology Letters, Vol. 11 No. 4, April 1999, pp. 451-453.
[13] A. Galtarossa, L. Palmieri, M. Schiano, T. Tambosso, “Single-End Polarization Mode Dispersion Measurement Using Backreflected Spectra Through a Linear Polarizer”, IEEE/OSA J. Lightwave Technology, Vol. 17 No. 10, October 1999, pp. 1835-1842.
[14] H. Sunnerud, B.-E. Olsson, M. Karlsson, P. A. Andrekson, J. Brentel “Polarization-Mode Dispersion Measurements Along Installed Optical Fibers Using Gated Backscattered Light and a Polarimeter”, IEEE/OSA J. Lightwave Technology, Vol. 18 No. 7, July 2000, pp. 897-904.
[15]H. Sunnerud, B.-E. Olsson, M. Karlsson, P. A. Andrekson, “Measurement of Polarization Mode Dispersion Accumulation Along Installed Optical Fibers”, IEEE Photonics Technology Letters, Vol. 11 No. 7, July 1999, pp. 860-862.
[16] U.S. Pat. No. 6,229,599 (A. Galtarossa).
[17] H. Dong, P. Shum, J. G. Zhou, Y. D. Gong, “Single-end Spectral Resolved Measurement of Polarization Mode Dispersion in Optical Fibers”, Paper JThA20, Optical Fiber Communications Conference, Mar. 25-29, 2007, Anaheim, Calif., USA.
[18] U.S. Pat. No. 6,724,469 (M. Leblanc).
[19] F. Corsi, A. Galtarossa, L. Palmieri, “Beat Length Characterization Based on Backscattering Analysis in Randomly Perturbed Single-Mode Fibers,” Journal of Lightwave Technology, Vol. 17, No. 7, July 1999.
[20] A. Galtarossa, L. Palmieri, A. Pizzinat, M. Schiano, T. Tambosso, “Measurement of Local Beat Length and Differential Group Delay in Installed Single-Mode Fibers”, Journal of Lightwave Technology, Vol. 18, No. 10, October 2000.
[21] A. Galtarossa, L. Palmieri, M. Schiano, T. Tambosso, “Measurement of Beat Length and Perturbation Length in Long Single-Mode Fibers,” Optics Letters, Vol. 25, No. 6, Mar. 15, 2000.
[22] B. Huttner, B. Gisin, N. Gisin, “Distributed PMD measurement with a polarization-OTDR in optical fibers”, Journal of Lightwave Technology, Vol. 17, pp. 1843-1948, Oct. 1999.
[23] U.S. Pat. No. 6,946,646 (Chen et al.)
[24] US published patent application number 2004/0046955, Fayolle et al.

1. A method of measuring at least one polarization-related characteristic of an optical path (FUT) using optical source means connected to the optical path at or adjacent a proximal end thereof, and analyzing-and-detection means connected to the optical path at or adjacent either the proximal end thereof or a distal end thereof, the optical source means comprising light source means for supplying at least partially polarized light and means for controlling the state of polarization (I-SOP) of said at least partially polarized light and injecting said light into the FUT, and analyzing-and-detection means comprising means for extracting corresponding light from the FUT, analyzing said extracted light and detecting said analyzed light corresponding to the at least one transmission axis of the analyzer means (A-SOP) to provide transmitted coherent optical power at each wavelength of light in each of at least two groups of wavelengths, wherein the lowermost (λ_{L}) and uppermost (λ_{U}) said wavelengths in each said group of wavelengths are closely-spaced;
and wherein the said group comprises a wavelength pair, said pair in each group corresponding to a small optical-frequency difference and defining a midpoint optical frequency or wavelength therebetween, and wherein the I-SOP and A-SOP are substantially constant for each said wavelength in each said group, and wherein at least one of the midpoint wavelength, I-SOP and A-SOP is different between the respective said groups, the method including the steps of:
i. Computing the at least one difference in a measured power parameter corresponding to each wavelength in said wavelength pair for each of the said at least two groups, said measured power parameter being proportional to the power of the said analyzed and subsequently detected light, thereby defining a set of at least two measured power parameter differences;
ii. Computing the mean-square value of said set of differences; and
iii. Calculating the at least one polarization-related FUT characteristic as at least one predetermined function of said mean-square value, said predetermined function being dependent upon the said small optical frequency difference between the wavelengths corresponding to the said each at least said two pairs of closely-spaced wavelengths.

2. A method according to claim 1, wherein the said output light means is connected to the optical path at or adjacent the distal end of the FUT.

3. A method according to claim 2, wherein:
(a) each said group comprises wavelength pairs having substantially said prescribed midpoint wavelength, and
(b) the said at least one polarization-related FUT characteristic is the differential group delay (DGD) at the said midpoint wavelength.

4. A method according to claim 3, wherein the said measured power parameter is the computed normalized power T(ν), and said predetermined function can be expressed, for small optical-frequency differences (δν), according to the following differential formula:
$$DGD ( v ) = \frac{{α}_{ds}}{πδ v} \cdot \sqrt{{〈 Δ {T}^{2} ( v ) 〉}_{SOP}}$$
where the constant
$${α}_{ds} = \sqrt{\frac{9}{2}} ,$$
ν is the optical frequency corresponding to the said midpoint frequency or wavelength, and [symbol] ΔT²(ν) [symbol] = [symbol] ΔT(ν)ΔT″(ν) [symbol] _{SOP} where ΔT(ν) and ΔT″(ν) are the normalized power differences that are either the same, i.e. obtained from the same measured powers at two closely-spaced frequencies, or different, i.e. obtained from two repeated measurements of optical powers at two closely-spaced frequencies.

5. A method according to claim 3, wherein the said measured power parameter is the computed normalized power T(ν), and the mean-square value computing step (ii) further comprises the computation of the relative variance (σᵣ²(ν)) of the normalized powers, according to the expression:
$${σ}_{r}^{2} ( v ) = {( \frac{1}{{σ}_{20}} )}^{2} [ {〈 T ( v ) {T}^{″} ( v ) 〉}_{SOP} - {〈 T ( v ) 〉}_{SOP}^{2} ]$$
where T(ν) and T″(ν) are the normalized powers that are either the same, i.e. obtained from the same measured optical powers, or different, i.e. obtained from two repeated measurements of optical powers and the reference variance σ₂₀²= 1/12 and the said predetermined function then is determined, for small optical-frequency differences δν, according to the following differential formula:
$$DGD ( v ) = \frac{{α}_{ds}}{π δ v} \cdot \sqrt{\frac{{〈 Δ {T}^{2} ( v ) 〉}_{SOP}}{{σ}_{r}^{2} ( v )}}$$
where the constant
$${α}_{ds} = \sqrt{\frac{9}{2}} ,$$
and ν is the optical frequency corresponding to the said midpoint wavelength.

6. A method according to claim 3, wherein
a) the said optical source means emits polarized broadband light, the spectral width of said broadband light encompassing the said small optical-frequency difference corresponding to the wavelength pair centered on said prescribed midpoint wavelength.
b) said lowermost and uppermost wavelengths separated by said small optical frequency difference about a prescribed midpoint wavelength;
c) the said analyzing and detection means includes spectral filter means, comprising a narrowband optical filter, the filter width being much less than the said small optical frequency difference, thereby rendering coherent the light selected therefrom;
d) the said spectral filter means being operable to allow selection and subsequent detection of each of the wavelengths corresponding to the said groups comprising the said wavelength pair;

7. A method according to claim 2, wherein:
a) each of said at least two groups of closely-spaced wavelengths being defined by a respective midpoint wavelength, and at least two of the said at least two groups having midpoint wavelengths that are different,
b) the said at least one polarization-related FUT characteristic is the rms DGD (i.e. PMD) over a prescribed wavelength range;

8. A method according to claim 2, wherein:
in each of at least one spectral acquisition step, at least a quasi-continuum of transmitted coherent optical powers as a function of optical frequency are detected and stored for further analysis in said step (i), said optical frequency spanning a prescribed wavelength range,
a) said measured power parameters are computed from said transmitted coherent optical powers;
b) none, either or both of the I-SOP and A-SOP vary with respect to the optical frequency and such respective variation, if present, is slow, such that both of I-SOP and A-SOP, respectively, are substantially the same for each said group of closely-spaced wavelengths;

9. A method according to claim 8, wherein the said at least one spectral acquisition is at least two spectral acquisitions, wherein either or both of the I-SOP and A-SOP corresponding to at least some of the stored optical frequencies in at least one spectral acquisition are substantially different than the either or both of the I-SOP and A-SOP, respectively, for the corresponding said stored optical frequencies in at least a second sweep, said at least one predetermined function comprising at least one of
a. the rms DGD value over a prescribed wavelength range; and
b. when the said at least some of the stored optical frequencies correspond to the said midpoint wavelengths, the DGD at least one of the said midpoint wavelengths.

10. A method according to claim 8, wherein
a) the said optical source means emits polarized broadband light, the spectral width of said broadband light encompassing the prescribed spectral range;
b) the said analyzing and detection means includes spectral filter means, comprising a narrowband optical filter, the filter width being much less than the said small optical-frequency difference, such that the light selected therefrom is coherent; and
c) the said spectral filter means is operable to sweep substantially continuously to sequentially select and subsequently detect each of the wavelengths corresponding to the said groups comprising the said wavelength pairs, said sweep enabling said spectral acquisition.

11. A method according to claim 8, wherein
c) said optical source means emits polarized broadband light, the spectral width of said broadband light encompassing the prescribed spectral range; and
d) said spectral filter means comprise a polarization-diverse dual-channel scanning monochromator;
e) said measured power parameters comprising pairs of orthogonally analyzed power parameters measured with said polarization-diverse dual-channel scanning monochromator.

12. A method according to claim 1, where the said light analyzing-and-detection means and processing means is connected to the optical path at or adjacent the proximal end of the FUT and there is provided a localized reflection at or adjacent the distal end of the FUT.

13. A method according to claim 12, wherein:
a) each of said at least two groups of closely-spaced wavelengths being defined by a respective midpoint wavelength, and at least two of the said at least two groups having midpoint wavelengths that are different, and
b) the said at least one polarization-related FUT characteristic is the rms forward DGD (i.e. PMD) over a prescribed wavelength range;

14. A method according to claim 13, wherein the said measured power parameter is the computed normalized power T, and said predetermined function is determined, for small optical-frequency differences δν, according to the following differential formula:
$$PMD = \frac{{α}_{rt} \cdot {α}_{ds}}{π δ v} \cdot \sqrt{{〈 Δ {T}^{2} ( v ) 〉}_{SOP ; v}}$$
where the roundtrip factor
$${α}_{rt} = \sqrt{\frac{3}{8}}$$
and the constant α_{ds} is dependent upon the respective optical paths traversed by the forward-propagating light from the optical source and the detected backreflected light.

15. A method according to claim 13, wherein the said measured power parameter is the computed normalized power T, and the mean square value computing step (ii), compensates for the possible presence of unpolarized noise, such as amplified spontaneous emission (ASE) light, in the detected signal, by the steps of:
a) computing the relative variance (σᵣ²) of the normalized transmitted signals; and
b) computing the ratio of the mean-square difference over said relative variance, said rms DGD computed as a function of said ratio as said predetermined function being determined for small optical-frequency differences δν, according to the following differential formula:
$$PMD = \frac{{α}_{rt} \cdot {α}_{ds}}{π δ v} \cdot \sqrt{\frac{{〈 Δ {T}^{2} ( v ) 〉}_{SOP ; v}}{{σ}_{r}^{2}}}$$
where the roundtrip factor
$${α}_{rt} = \sqrt{\frac{3}{8}} ,$$
the relative variance of the normalized powers is defined as,
$${σ}_{r}^{2} = {( \frac{1}{{σ}_{10}} )}^{2} [ {〈 T \cdot {T}^{″} 〉}_{SOP ; v} - {〈 T 〉}_{SOP ; v}^{2} ]$$
where the constant
$${σ}_{10}^{2} = \frac{4}{45} ,$$
the roundtrip factor
$${α}_{rt} = \sqrt{\frac{3}{8}} ,$$
and the constant α_{ds} is dependent upon the respective optical paths traversed by the forward-propagating light from the optical source and the detected backreflected light.

16. A method according to claim 1, wherein:
a. the said analyzing-and-detection means is connected to the optical path at or adjacent the proximal end of the FUT;
b. each group comprises at least one wavelength pair of series of light pulses, each series having the same I-SOP;
c. the light pulses in each series of the pair have substantially the same wavelength;
d. the said measured power parameter is the detected backreflected power as a function of distance along the FUT, this said measured power parameter being determined by:
i. for each of at least some of the light pulses in each series of light pulses in each said group, analyzing and subsequently detecting light comprising at least one polarization component of the resulting backreflected signal caused by Rayleigh scattering and/or discrete reflections along the FUT to provide a corresponding impulse-response, said at least one polarization component being the same for each of the said series in said group, and converting each of the impulse-responses into a corresponding electrical impulse-response signal;
ii. for each said series of light pulses in each said group, sampling and averaging the electrical impulse-response signals of said at least some of the light pulses to provide an OTDR trace as a function of time delay;
iii. converting said OTDR trace as a function of time delay to an OTDR trace representing detected backreflected power as a function of distance.

17. A method according to claim 16, wherein:
a. each of said at least two groups of closely-spaced wavelengths is defined by a respective center wavelength, this said center wavelength being the midpoint wavelength if the group comprises only two series corresponding to respective closely-spaced wavelengths, and at least two of the said at least two groups having center wavelengths that are different, and
b. the said at least one polarization-related FUT characteristic is the cumulative PMD value over a prescribed wavelength range corresponding to a distance z along the FUT, this said cumulative PMD value being estimated from the cumulative rms round-trip DGD for the same said prescribed wavelength range.

18. A method according to claim 17, wherein the said measured power parameter is the computed normalized power as a function of distance z along the FUT, T(z), and said predetermined function is determined for small optical-frequency differences δν, according to the following differential formula:
$$PMD ( z ) = \frac{{α}_{rt} \cdot {α}_{ds}}{π δ v} \cdot \sqrt{{〈 Δ {T}^{2} ( v , z ) 〉}_{SOP ; v}}$$
where the roundtrip factor
$${α}_{rt} = \sqrt{\frac{3}{8}} ,$$
and where the constant α_{ds} is dependent upon the respective optical paths traversed by the forward-propagating light from the optical source and the detected backreflected light.

19. A method according to claim 17, wherein the said measured power parameter is the computed relative power P_{R}(z), and mean square value computing step (ii) comprises the steps of:
a) computing the relative variance (σ_{R}²(z)) of the relative transmitted signals; and
b) computing the ratio of the mean-square difference over said relative variance, said rms DGD being computed as a function of said ratio as said predetermined function that is determined, for small optical-frequency differences δν), according to a differential formula.

20. A method according to claim 1, wherein each said group of closely-spaced wavelengths comprises the detection of each wavelength in at least one additional repeated said wavelength pair, corresponding to an initial first wavelength pair, wherein the I-SOP and A-SOP for each of these additional repeated wavelength pairs are substantially the same within each said group, the computation of the at least one said polarization-related FUT characteristic including the detected signals for these additional repeated wavelength pairs.

21. A method according to claim 1, wherein the measured power parameter of step (i) is a normalized power T proportional to the analyzed and subsequently detected light power, determined by one of the following methods:
a) one polarization component of the light power is detected, conveniently using one detector, and then the normalized power is obtained for each wavelength of coherent light in each said group of wavelengths having at least two wavelengths, respectively, by dividing the power for that coherent light by the average of at least some, and preferably all, of the powers of the coherent light in the different groups;
b) two orthogonal polarization components of the light power are detected simultaneously, conveniently using two detectors, and then the normalized power for each wavelength of coherent lights are obtained by dividing at least one of the powers corresponding to the two detected different polarization components for that coherent light by the sum of the powers corresponding to the two detected different polarization components for that coherent light; or by dividing a weighted difference of the powers corresponding to the two detected different polarization components for that coherent light by the sum of the powers corresponding to the two detected different polarization components for that coherent light;
c) one polarization component and one optical power directly proportional to the output of light from the FUT are detected, conveniently using two detectors, and the normalized power corresponding to each wavelength of coherent lights obtained by first dividing the power for that wavelength of coherent light corresponding to the optical power detected from one polarization component of light by the power for that coherent light corresponding to the optical power directly proportional to the output of light to obtain a ratio representing the relative power for that coherent light, and dividing said relative power for that coherent light by the average of at least some, and preferably all of the relative powers in the different groups;
d) using one detector plus one optical switch, two orthogonal polarization components of the light are detected at different times by the same detector where the optical switch is used to route the two orthogonal polarization components of the light to the same detector, and then the normalized power for each wavelength of coherent light is obtained by dividing at least one of the powers corresponding to the two detected different polarization components for that coherent light by the sum of the powers corresponding to the two detected different polarization components for that coherent light; or by dividing a weighted difference of the powers corresponding to the two detected different polarization components for that coherent light by the sum of the powers corresponding to the two detected different polarization components for that coherent light;
e) using one detector plus one optical switch, one polarization component and one optical power directly proportional to the light are detected at different times by the same detector where the optical switch is used to route one polarization component and optical power directly proportional to the output of light from the FUT to the same detector, and the normalized power corresponding to each wavelength of coherent light obtained by first dividing the power for that wavelength of coherent light corresponding to the optical power detected from one polarization component of light by the power for that coherent light corresponding to the optical power directly proportional to the output light to obtain a ratio representing the relative power for that coherent light, and dividing said relative power for that coherent light by the average of at least some, and preferably all of the relative powers in the different groups.

22. A method according to claim 1, wherein the measured power parameter of step (i) is a relative power P_{R} proportional to the analyzed and subsequently detected light power, determined by one of the following methods:
a) One polarization component of the light power is detected, conveniently using one detector, and then the relative power is obtained for each wavelength of coherent light in each said group of wavelengths having at least two wavelengths, respectively, by dividing the power for that coherent light by the average of at least some, and preferably all, of the powers of the coherent light in the different groups;
b) two orthogonal polarization components of the light are detected simultaneously, conveniently using two detectors, and then the relative power for each wavelength of coherent light is obtained by dividing at least one of the powers corresponding to the two detected different polarization components for that coherent light by the sum of the powers corresponding to the two detected different polarization components for that coherent light; or by dividing a weighted difference of the powers corresponding to the two detected different polarization components for that coherent light by the sum of the powers corresponding to the two detected different polarization components for that coherent light;
c) one polarization component and one optical power directly proportional to the output light from the FUT are detected using two detectors and the relative power corresponding to each wavelength of coherent light is obtained by dividing the power for that coherent light corresponding to the optical power detected from one polarization component of light by the power for that coherent light corresponding to the optical power directly proportional to the output of light to obtain a ratio representing the relative power for that coherent light;
d) using one detector plus one optical switch, then two orthogonal polarization components of the light are detected at different times by the same detector where the optical switch is used to route the two orthogonal polarization components of the light to the said one detector, and then the relative power for each wavelength of coherent light is obtained by dividing at least one of the powers corresponding to the two detected different polarization components for that coherent light by the sum of the powers corresponding to the two detected different polarization components for that coherent light, or by dividing a weighted difference of the powers corresponding to the two detected different polarization components for that coherent light by the sum of the powers corresponding to the two detected different polarization components for that coherent light;
e) using one detector plus one optical switch, one polarization component and one optical power directly proportional to the light are detected at different times by the said one detector where the optical switch is used to route one polarization component and optical power directly proportional to the output light from the FUT to the said one detector, and the relative power corresponding to each wavelength of coherent light is obtained by dividing the power for that coherent light corresponding to the optical power detected from one polarization component of light by the power for that coherent light corresponding to the optical power directly proportional to the output of light to obtain a ratio representing the relative power for that coherent light.

23. A method according to claim 1, wherein:
a) the at least one transmission axis of the analyzer means comprise two or more linearly-independent transmission axes; and
b) the transmitted coherent optical powers from the plurality of said transmission axes are detected substantially simultaneously by corresponding detectors in the said detector means.

24. Measurement instrumentation, for measuring at least one polarization-related characteristic of an optical path (FUT), comprising:
optical source means for connection to the optical path at or adjacent a proximal end thereof, and
analyzing-and-detection means for connection to the optical path at or adjacent either the proximal end thereof or a distal end thereof for extracting, analyzing and detecting light that has traveled at least part of the FUT and providing corresponding electrical signals, and
processing means for processing the electrical signals from the output light means to determine said at least one polarization-related characteristic;
the optical source means comprising
light source means for supplying at least partially polarized light at each wavelength in at least two groups of wavelengths, and
SOP controller means for controlling the state of polarization (I-SOP) of said at least partially polarized light and injecting said light into the FUT, wherein the lowermost (λₗ) and uppermost (λ_{U}) of said wavelengths in each said group of wavelengths are closely-spaced,
the said group comprises a wavelength pair, said pair in each group corresponding to a small optical-frequency difference and defining a midpoint wavelength therebetween, and
the SOP of the injected light and A-SOP are substantially constant for each said wavelength in each said group, and wherein at least one of the midpoint wavelength, I-SOP and A-SOP is different between the respective said groups, and
the analyzing-and-detection means comprising:
means for extracting corresponding light from the FUT and analyzing the extracted light, and detecting the analyzed light corresponding to at least one transmission axis of the analyzer means (A-SOP) to provide transmitted coherent optical power at each wavelength of the analyzed light in each of said at least two groups of wavelengths, wherein the lowermost (λₗ) and uppermost (λ_{U}) said wavelengths in each said group of wavelengths are closely-spaced;
the processing means being configured and operable for:
i. Computing the at least one difference in a measured power parameter corresponding to each wavelength in said wavelength pair for each of the said at least two groups, said measured power parameter being proportional to the power of the said analyzed and subsequently detected light, thereby defining a set of at least two measured power parameter differences; and
ii. Computing the mean-square value of said set of differences; and
iii. Calculating the at least one polarization-related FUT characteristic as at least one predetermined function of said mean-square value, said predetermined function being dependent upon the said small optical frequency difference between the wavelengths corresponding to the said each at least said two pairs of closely-spaced wavelengths; and
iv. outputting the value of said at least one polarization-related FUT characteristic for display, transmission or further processing.
